(19) United States
(12) Patent Application Publication
(10) Pub. No.: US 2025/0212209 A1
(43) Pub. Date: Jun. 26, 2025

(54) METHODS, DEVICES, AND COMPUTER READABLE MEDIUM FOR COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 18/848,258

(22) PCT Filed: Apr. 2, 2022
(86) PCT No.: PCT/CN2022/085169

§ 371 Date: Sep. 18, 2024

(51) Int. Cl. H04W 72/1268; H04B 7/0456; H04L 5/00; H04W 72/231

(52) U.S. Cl. CPC H04W 72/1268; H04B 7/0456; H04L 5/0044; H04L 5/0051; H04W 72/231

(57) ABSTRACT

Embodiments of the present disclosure relate to communications. According to embodiments of the present disclosure, a network device transmits at least one configuration associated with precoding matrix to a terminal device. The network device also transmits downlink control information (DCI) for scheduling a physical uplink shared channel (PUSCH) to the terminal device. The DCI comprises an indication of a precoding matrix index. The terminal device determines a precoding matrix based on the at least one configuration and the indication. The terminal device transmits the PUSCH based on the precoding matrix. In this way, the precoding matrix can be selected properly.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, multi input multi output (MIMO) has been proposed. MIMO includes features that facilitate utilization of a large number of antenna elements at base station for both sub-6 GHz and over-6 GHz frequency bands. In this situation, a plurality of antennas at a transmitter and/or receiver can be used to achieve array and diversity gain instead of capacity gain. In this case, a same symbol weighted by a complex-valued scale factor is sent from each transmit antenna so that the input covariance matrix has unit rank. This scheme is referred to as beamforming. When the receiver has multiple antennas, the single-layer beamforming cannot simultaneously maximize the signal power at every receive antenna, hence, precoding is used for multi-layer beamforming in order to maximize the throughput of a multi-antenna system. Precoding is a generalized beamforming scheme to support multi-layer transmission in a MIMO system. Using precoding, multiple streams are transmitted from the transmit antennas with independent and appropriate weighting per antenna such that the throughput is maximized at the receiver output.

### SUMMARY

In general, example embodiments of the present disclosure provide a solution for communication.

In a first aspect, there is provided a method for communication. The method comprises receiving, from a network device, at least one configuration associated with precoding matrixes; receiving, from the network device, downlink control information (DCI) for scheduling a physical uplink shared channel (PUSCH), the DCI comprising an indication of a precoding matrix index; determining a precoding matrix based on the at least one configuration and the indication; and transmitting the PUSCH based on the precoding matrix.

In a second aspect, there is provided a method for communication. The method comprises transmitting, to a terminal device, at least one configuration associated with precoding matrixes; transmitting downlink control information (DCI) for scheduling a physical uplink shared channel (PUSCH), the DCI comprising an indication of a precoding matrix index; and receiving the PUSCH based on the precoding matrix.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving, from a network device, at least one configuration associated with precoding matrixes; receiving, from the network device, downlink control information (DCI) for scheduling a physical uplink shared channel (PUSCH), the DCI comprising an indication of a precoding matrix index; determining a precoding matrix based on the at least one configuration and the indication; and transmitting the PUSCH based on the precoding matrix.

In a fourth aspect, there is provided a source network device. The source network device comprises a processing unit; and a memory coupled to the processing unit and storing instructions thereon, the instructions, when executed by the processing unit, causing the source network device to perform acts comprising: transmitting, to a terminal device, at least one configuration associated with precoding matrixes; transmitting downlink control information (DCI) for scheduling a physical uplink shared channel (PUSCH), the DCI comprising an indication of a precoding matrix index; and receiving the PUSCH based on the precoding matrix.

In a fifth aspect, there is provided a computer readable medium having instructions stored thereon, the instructions, when executed on at least one processor, causing the at least one processor to carry out the method according to any one of the first aspect, second or third aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for handover according to some embodiments of the present disclosure;

FIG. 3 is a flowchart of an example method in accordance with an embodiment of the present disclosure;

FIG. 4 is a flowchart of an example method in accordance with an embodiment of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably. The terms “common beam”, “common beam update/indicate/indication”, “unified TCI state”, “unified TCI state update/indicate/indication”, “beam indication”, “TCI state(s) indication”, “TCI_state_r17”, “tci_StateId_r17”, “TCI_state_r17 indicating a unified TCI state”, “TCI state shared/applied for all or subset of CORESETs and UE-dedicated reception on PDSCH”, “Rel-17 TCI state”, “TCI state with tci_StateId_r17”, “TCI state configured for TCI state update in unified TCI framework”, “TCI state indicated in DCI for common beam update/indicate/indication” and “TCI state indicated in DCI and to be applied for all/subset of CORESETs and PDSCH” may be used interchangeably. The terms “subset of CORESETs”, “subset of TCI states”, “subset of unified TCI states”, “subset of downlink (unified) TCI states” and “subset of joint (unified) TCI states” may be used interchangeably. The terms “subset of PUCCHs”, “subset of TCI states”, “subset of unified TCI states”, “subset of uplink (unified) TCI states” and “subset of joint (unified) TI states” may be used interchangeably. The terms “precoding matrix”, “precoding”, “beam”, “beamforming” and “precoder” may be used interchangeably.

As mentioned above, precoding is a generalized beamforming scheme to support multi-layer transmission in a MIMO system. Precoding is a technique that exploits transmit diversity by weighting the information stream, i.e. the transmitter sends the coded information to the receiver to achieve pre-knowledge of the channel. Using precoding, multiple streams are transmitted from the transmit antennas with independent and appropriate weighting per antenna such that the throughput is maximized at the receiver output. The terms “precoding matrix” and “precoder” may be used interchangeably is hereinafter. Moreover, it may be possible that uplink transmission with 8 antenna ports can support more than 4 layers.

According to some conventional technologies, for uplink (UL) codebook, a UE may support 1 antenna port or 2 antenna ports or 4 antenna ports. For single carrier frequency division multiple access (SC-FDMA) and OFDM, there may be full coherent, partial coherent/non-coherent (antenna selection) codebook. For codebook based UL transmission, rank indicator (RI) and precoding matrix indicator (PMI) are jointly encoded, and different numbers of layers (RI values) may be indicated in same table/field. For non-codebook based UL transmission, RI and SRS resource indication are jointly encoded. For both codebook and non-codebook based UL transmission, number of demodulation reference signal (DMRS) ports is determined based on the number of layers, and the antenna port field (DMRS port) only indicates DMRS port index(es).

However, it is unclear on 1-3 layers with 8 transmitting ports, which will have impact on signaling and codebook design. Targeting devices may need different kinds of transmission schemes/codebooks. For customer premises equipment/fixed wireless (CPE/FWA), changing of channel may be slow, e.g. if channel state suitable for more than 4 layers, the CSI is stable at least in a time duration. For vehicle, channel may be time variant, and seems not quite suitable for more than 4 layers. And vehicle seems not need more than 4 layers transmission. Further, 8 transmitting codebook seems to comprise full/partial/non-coherent precoders. For full-coherent precoders, DL codebook can be reused, while there may be more than one antenna structure 8-port codebook. For partial/non-coherent precoders (antenna selection), freely selecting N ports from 8 ports will cause large codebook size. Moreover, network may just indicate the needed transmission precoding matrix (TPMI), without indicated with the antenna structure. The codebook size will be quite huge to cover different structures/a large amount of antenna selection precoders, which will cause DCI payload increased significantly. Actually, for a given terminal device, some precoders may never be indicated. Additionally, at least for more than 4 layers, a second set of modulation scheme (MCS), new data indicator (NDI), redundancy version (RV) fields is needed. If reusing the RI, PMI, DMRS indication, the DCI payload may be large and unnecessary.

In order to solve at least part of the above problems, a solution on determining an uplink precoding matrix is proposed. According to embodiments of the present disclosure, a network device transmits at least one configuration associated with precoding matrix to a terminal device. The network device also transmits downlink control information (DCI) for scheduling a physical uplink shared channel (PUSCH) to the terminal device. The DCI comprises an indication of a precoding matrix index. The terminal device determines a precoding matrix based on the at least one configuration and the indication. The terminal device transmits the PUSCH based on the precoding matrix. In this way, the precoding matrix can be selected properly.

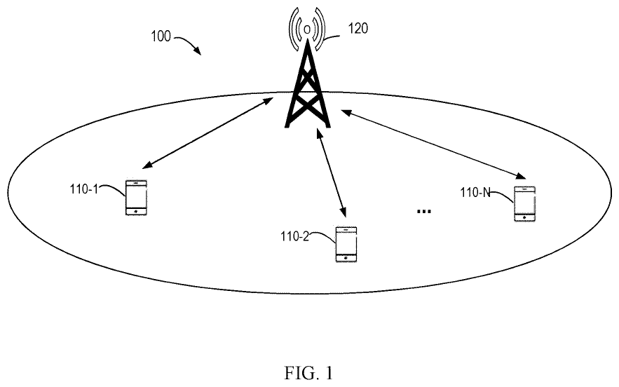

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network device 120. In some embodiments, the network device may be any suitable network device. In the communication system 100, the network device 120 and the terminal devices 110 can communicate data and control information to each other.

Communications in the communication system 100 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (EEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. For example, the number of symbols in one slot may be 12 or 14. The term “sub-slot” may refer to a number of symbols. For example, the number of symbols in one sub-slot may be 1, 2, 4, 7, 14. The sub-slot may comprise fewer symbols than one slot. The slot used herein may refer to a normal slot which comprises a predetermined number of symbols and also refer to a sub-slot which comprises fewer symbols than the predetermined number of symbols.

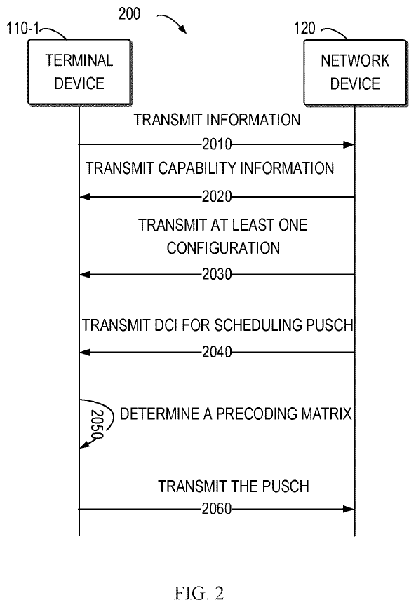

Embodiments of the present disclosure will be described in detail below. Reference is first made to FIG. 2, which shows a signaling chart illustrating process 200 among devices according to some example embodiments of the present disclosure. Only for the purpose of discussion, the process 200 will be described with reference to FIG. 1. The process 200 may involve the terminal device 110-1 and the network device 120 shown in FIG. 1.

In some embodiments, the network device 120 may transmit 2010 information to the terminal device 110-1. The information may indicate that a PUSCH is scheduled associated with 8 antenna ports. For example, total number of antenna ports for the PUSCH transmission may be 8. Alternatively, the information may indicate that the PUSCH is scheduled associated with a sounding reference signal (SRS) with 8 antenna ports. In other words, the total number of antenna ports of a SRS associated with the PUSCH transmission is 8. In some embodiments, the information may be transmitted in a SRS configuration.

In some embodiments, the terminal device 110-1 may be configured or indicated with a number of layers (e.g. represented as v_ri) for the PUSCH transmission. For example, the number of layers v_ri may be at least one of {1,2,3,4,5,6,7,8}. In some embodiments, the terminal device 110-1 may be configured or indicated with a precoding matrix for the PUSCH transmission. In some embodiments, the size of the precoding matrix may be 8*v_ri or v_ri*8. In some embodiments, there may be v_ri columns or rows in the precoding matrix. In some embodiments, in a column or row of the precoding matrix, there may be 8 elements, and index of an element may be represented as idx, idx may be non-negative integer. For example, 0<=idx<=7. For another example, 1<=idx<=8.

For example, there may be a set of precoding matrixes for 8 transmitting (TX) uplink transmission or for PUSCH transmission associated with 8-port SRS. In some embodiments, the set of precoding matrix may comprise one or more full coherent precoding matrixes. Alternatively or in addition, the set of precoding matrix may comprise one or more partial-coherent precoding matrixes. Alternatively or in addition, the set of precoding matrix may comprise one or more non-coherent precoding matrixes. Alternatively or in addition, the set of precoding matrix may comprise one or more mixed partial and non-coherent precoding matrixes. In some embodiments, the set of precoding matrix may comprise one or more partial-coherent precoding matrixes. Alternatively or in addition, the set of precoding matrix may comprise one or more mixed partial and non-coherent precoding matrixes. Alternatively or in addition, the set of precoding matrix may comprise one or more non-coherent precoding matrixes. In some embodiments, the set of precoding matrix may comprise one or more non-coherent precoding matrixes.

In some embodiments, there may be a parameter “N₁”, and “N₁” may represent a number of ports in a first dimension. For example, “N₁” may be at least one of {1, 2, 4, 8}. For another example, “N₁” may be 2 or 4. In some embodiments, there may be a parameter “N2”, and “N2” may represent a number of ports in a second dimension. For example, “N₂” may be at least one of {1, 2, 4, 8}. For another example, “N₂” may be 1 or 2. In some embodiments, there may be a parameter “O₁”, and “O₁” may represent a first discrete fourier transform (DFT) oversampling in the first dimension. For example, “O₁” may be at least one of {1, 2, 4}. For another example, “O₁” may be 2 or 4. In some embodiments, there may be a parameter “O₂”, and “O₂” may represent a second DFT oversampling in the second dimension. For example, “O₂” may be at least one of {1, 2, 4}. For another example, “O₂” may be 2 or 4.

In some embodiments, there may be a first vector uₘ. In some embodiments, uₘ may be a DFT vector. In some embodiments, if N₂>1,

$${u}_{m} = [ 1 , {e}^{j \frac{2 π m}{{O}_{2} {N}_{2}}} , … , {e}^{j \frac{2 π m ( {N}_{2} - 1 )}{{O}_{2} {N}_{2}}} ] .$$

In some embodiments, if N₂=2,

$${u}_{m} = [ 1 , {e}^{j \frac{2 π m}{{O}_{2} {N}_{2}}} ] .$$

In some embodiments, if N₂=1, uₘ=1. In some embodiments, m may be a non-negative integer. For example, 0≤m≤0₂N₂. For another example, m may be at least one of {0, 2, 4, 6, 8}. For another example, m may be at least one of {0, 1, 2, 3}. For another example, m may be 0 or 1. For another example, m may be 0.

In some embodiments, there may be a second vector v_{l,m}. In some embodiments,

$${v}_{l , m} = {[ {u}_{m} , {u}_{m} * {e}^{j \frac{2 π l}{{O}_{1} {N}_{1}}} , … , {u}_{m} * {e}^{j \frac{2 π l ( {N}_{1} - 1 )}{{O}_{1} {N}_{1}}} ]}^{T} .$$

In some embodiments, if N₁=2 and N₂=−2,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, if N₁=4 and N₂=1,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, l may be a non-negative integer. For example, 0≤l≤0₁N₁. For another example, l may be at least one of {0, 2, 4, 6, 8}. For another example, l may be at least one of {0, 1, 2, 3}. For another example, l may be 0 or 1. In some embodiments, [ ]^{T} may represent a transposition of a vector or a matrix.

In some embodiments, there may be a factor φₙ. In some embodiments,

$${φ}_{n} = {e}^{j \frac{π n}{2}} .$$

In some embodiments, n may be a non-negative integer. For example, n may be at least one of {0, 1, 2, 3}. For another example, n may be 0 or 1. For another example, n may be 0 or 2. For another example, n may be 0.

In some embodiments, if the terminal device 110-1 is indicated with the number of layers as 8, there may be a first set of precoding matrixes corresponding to 8 layers (e.g. a first set of full coherent precoding matrixes), and a full coherent precoding matrix may be represented as W_{l,l′,l″,l′″,m,m′,m″,m′″,n}⁽⁸⁾.

In some embodiments, W_{l,l′,l″,l′″,m,m′,m″,m′″,n}⁽⁸⁾ may be

$$\frac{1}{\sqrt{8 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}} & {φ}_{n} * {v}_{{l}^{′′′} , {m}^{′′′}} & - {φ}_{n} * {v}_{{l}^{′′′} , {m}^{′′′}}\end{matrix} ] .$$

In some embodiments, W_{l,l′,l″,l′″,m,m′,m″,m′″,n}⁽⁸⁾ may be

$$\frac{1}{\sqrt{8 \times P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {v}_{n} * {v}_{{l}^{″} , {m}^{″}} & - {v}_{n} * {v}_{{l}^{″} , {m}^{″}} & {v}_{n} * {v}_{{l}^{′′′} , {m}^{′′′}} & - {v}_{n} * {v}_{{l}^{′′′} , {m}^{′′′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, l′″=l+3O₁. In some embodiments, m and m′ and m″ and m′″ may be 0. In some embodiments, l′=l+O₁. In some embodiments, l″=l. In some embodiments, l′″=l+O₁. In some embodiments, m′=m. In some embodiments, m″=m+O₂. In some embodiments, m′″=m+O₂.

In some embodiments, there may be more than one subset of precoding matrixes corresponding to 8 layers. In some embodiments, the first set of precoding matrixes corresponding to 8 layers may comprise more than one subset. For example, there may be two subsets of precoding matrixes.

In some embodiments, there may be a first subset of precoding matrixes corresponding to 8 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ and m″ and m′″ may be 0. In some embodiments, corresponding to the first subset, l′=l+O₁, l″=l+2O₁ and l′″=l+3O₁ In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 8 layers may be 32 or 16 or 8 or 4 or 2.

In some embodiments, there may be a second subset of precoding matrixes corresponding to 8 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In sme embodiments, corresponding to the second subset, l′=l+O₁, l″=l and l′″+O₁. In some embodiments, corresponding to the second subset, m′=m, m″=m+O₂ and m′″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 8 layers may be 128 or 32 or 16 or 8 or 4 or 2.

In some embodiments, the first set of precoding matrixes corresponding to 8 layers may be shown as Table 1 below.

TABLE 1

| | i_{1,1} | i_{1,2} | i₂ | Precoding Matrix |
|---|---|---|---|---|
| N₁ = 4, N₂ =1 | $0 , … , \frac{{N}_{1} {O}_{1}}{2} - 1$ | 0 | 0, 1 | Wᵢ_{_{1,1}}_{,i}_{_{1,1}}_{+O}_{₁}_{,i}_{_{1,1}}_{+2O}_{₁}_{,i}_{_{1,1}}_{+3O}_{₁}_{,0,0,0,0,i}_{₂}⁽⁸⁾ |
| N₁ = 2, N₂ = 2 | 0, ... , N₁O₁ −1 | 0, ... , N₂O₂ −1 | 0, 1 | Wᵢ_{_{1,1}}_{,i}_{_{1,1}}_{+O}_{₁}_{,i}_{_{1,1}}_{,i}_{_{1,1}}_{+O}_{₁}_{,i}_{_{1,2}}_{,i}_{_{1,2}}_{,i}_{_{1,2}}_{+O}_{₂}_{,i}_{_{1,2}}_{-O}_{₂}_{,i}_{₂}⁽⁸⁾ |

$where {W}_{l , {l}^{′} , {l}^{″} , {l}^{′′′} , m , {m}^{′} , {m}^{″} , {m}^{′′′} , n}^{( 8 )} = \frac{1}{\sqrt{8 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}} & {φ}_{n} * {v}_{{l}^{′′′} , {m}^{′}}\end{matrix} ]$ or
${W}_{l , {l}^{′} , {l}^{″} , {l}^{′′′} , m , {m}^{′} , {m}^{″} , {m}^{′′′} , n}^{( 8 )} = \frac{1}{\sqrt{8 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {v}_{{l}^{″} , {m}^{″}} & - {v}_{{l}^{″} , {m}^{″}} & {v}_{{l}^{′′′} , {m}^{′′′}} & - {v}_{{l}^{′′′} , {m}^{′′′}}\end{matrix} ] .$

In some embodiments, the parameter “N₁” represents a number of ports in a first dimension. The parameter “N2” represents a number of ports in a second dimension. The parameter “O1” represents a first discrete fourier transform (DFT) oversampling in the first dimension and the parameter “O₂” represents a second DFT oversampling in the second dimension. The parameter “i” represents an element in the precoding matrix.

In some embodiments, N₁ may equal to 4, N₂ equals to 1, O₁ may equal to 2 and O₂ may equal to 1 and i_{1,1}, may be one of {0, . . . N₁O₁−1} or {0, 2, 4, 6} or {0, 4} or {0, 1} or 0 or {0, . . . N₁O₁/2-1} or {0, 2}. In some embodiments, the first subset of full coherent precoding matrixes corresponding to 8 layers “Set_f8_1” may comprise 16 precoding matrixes. In some embodiments, the subset of precoding matrixes “Set_f8_1” may comprise 8 precoding matrixes. Alternatively, the subset of precoding matrixes “Set_f8_1” may comprise 4 precoding matrixes. In other embodiments, the subset of precoding matrixes “Set_f8_1” may comprise 2 precoding matrixes.

Alternatively, N₁ may equal to 2, N₂ equals to 2, O₁ may equal to 1 or 4, and O₂ may equal to 2 or 4, i_{1,1} or i_{1,2} may be one of {0, . . . 7} or {0, 2, 4, 6} or {0, 4} or {0, . . . 3} or {0, 2} or {0,1} or 0. In some embodiments, the second subset of full coherent precoding matrixes corresponding to 8 layers “Set_f8_2” may comprise 128 precoding matrixes. In some embodiments, the subset of precoding matrixes “Set_f8_2” may comprise 32 precoding matrixes. Alternatively, the subset of precoding matrixes “Set_f8_2” may comprise 8 precoding matrixes. In other embodiments, the subset of precoding matrixes “Set_f8_2” may comprise 2 precoding matrixes.

In some embodiments, if the terminal device 110-1 is indicated with the number of layers as 8, there may be a second set of precoding matrixes (e.g. a second set of partial coherent precoding matrixes) corresponding to 8 layers. For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 8 layers, for example, represented as “Set_p8_1”, and the size of a partial coherent precoding matrix may be 8 multiplies 8. In some embodiments, there may be 8 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent precoding matrix may be with non-zero value. And the other 4 elements in the partial coherent precoding matrix may be with value of 0. In some embodiments, there may be 4 columns or rows out of the 8 columns or rows (e.g. a first set of 4 columns or rows) in the precoding matrix, and in each column or row, non-zero values may be mapped on 4 out of 8 elements and 0 may be mapped on the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of antenna ports in the first group with 4 antenna ports. In some embodiments, for the other 4 columns or rows out of the 8 columns or rows (e.g. a second set of 4 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 4 columns or rows. For example, the indexes of the 4 elements with non-zero values may be idx_2, and idx_2 may be 4 values out of {0,1,2,3,4,5,6,7} or {1,2,3,4,5,6,7,8}. For example, idx_2 may be {4,5,6,7} or {1,3,5,7} or {5,6,7,8} or {2,4,6,8}. In some embodiments, the 4 values of idx_2 may be based on the indexes of antenna ports in the second group with 4 antenna ports. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the set of precoding matrixes “Set_p8_1” may comprise 280 precoding matrixes which is C(2,1)*C(2,1)*C(8,4). In some embodiments, C(x,y) may represent permutation and combination. For example, C(x,y) may represent number of possibilities of selecting y values out of x values. In some embodiments, Table 2 below shows example of vectors of 4 non-zero values mapping on 4 elements out of 8 elements in a column or row in a partial coherent precoding matrix.

TABLE 2

```
                1 1 1 1
                1 −1 1 −1
                1 1 −1 −1
                1 −1 −1 1
a first set of vectors
                    1 1 1 1
                    1 −1 1 −1
                    j j −j −j
                    j −j −j j
or a second set of vectors
```

In some embodiments, examples of a precoding matrix of the second set of precoding matrixes corresponding to 8 layers may be as:

$$\begin{matrix}\frac{1}{\sqrt{{s}_{8}}} [ \begin{matrix}a 1 & b 1 & c 1 & d 1 & 0 & 0 & 0 & 0 \\ a 2 & b 2 & c 2 & d 2 & 0 & 0 & 0 & 0 \\ a 3 & b 3 & c 3 & d 3 & 0 & 0 & 0 & 0 \\ a 4 & b 4 & c 4 & d 4 & 0 & 0 & 0 & 0 \\ 0 & 0 & 0 & 0 & e 1 & f 1 & g 1 & h 1 \\ 0 & 0 & 0 & 0 & e 2 & f 2 & g 2 & h 2 \\ 0 & 0 & 0 & 0 & e 3 & f 3 & g 3 & h 3 \\ 0 & 0 & 0 & 0 & e 4 & f 4 & g 4 & h 4\end{matrix} ] or \\ \frac{1}{\sqrt{{s}_{8}}} [ \begin{matrix}a 1 & b 1 & c 1 & d 1 & 0 & 0 & 0 & 0 \\ 0 & 0 & 0 & 0 & e 1 & f 1 & g 1 & h 1 \\ a 2 & b 2 & c 2 & d 2 & 0 & 0 & 0 & 0 \\ 0 & 0 & 0 & 0 & e 2 & f 2 & g 2 & h 2 \\ a 3 & b 3 & c 3 & d 3 & 0 & 0 & 0 & 0 \\ 0 & 0 & 0 & 0 & e 3 & f 3 & g 3 & h 3 \\ a 4 & b 4 & c 4 & d 4 & 0 & 0 & 0 & 0 \\ 0 & 0 & 0 & 0 & e 4 & f 4 & g 4 & h 4\end{matrix} ]\end{matrix} \qquad Table 1$$

For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f3, f4], [g1, g2, g3, g4] and [h1, h2, h3, h4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1;−1;−1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4], [f1, f2, f3, f4], [g1, g2, g3, g4] and [h1, h2, h3, h4] may be [1; 1; 1; 1], [1; −1; 1; −1], [1;1;−1;−1] and [1;−1;−1;1], respectively. For another example, [e1, e2, e3, e4], [f1, f2, f3, f4], [g1, g2, g3, g4] and [h1, h2, h3, h4] may be [1; 1; j; j], [1; −1; j −j], [1; 1; −j; −j] and [1; −1; −j; j], respectively.

In some embodiments, s₈ may a positive integer. For example, 1≤s₈≤64. For example, s₈ may be 64 or 32 or 16 or 8 or 4 or 2.

In some embodiments, if the terminal device 110-1 is indicated with the number of layers as 8, there may be a third set of precoding matrixes (e.g. a third set of partial coherent precoding matrixes) corresponding to 8 layers. For example, the structure of 8 ports may be 2+2+2+2, which means that there are 4 groups, each group including 2 antenna ports and in each group, the 2 antenna ports can be coherent. For example, between the groups, the antenna ports may not be coherent. In some embodiments, there may be a third set of precoding matrixes (e.g. a third set of partial coherent precoding matrixes) corresponding to 8 layers, for example, represented as “Set_p8_2”, and the size of a precoding matrix may be 8 multiplies 8. In some embodiments, there may be 8 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 8 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 8 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of the other two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 2 columns or rows out of the 8 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 2 columns or rows out of the 8 columns or rows (e.g. a fourth set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of the other two of the 4 antenna ports in the first group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other.

In some embodiments, there may be a set of 4 length-2 vectors, and each one of the length-2 vector may be applied as the two non-zero values in a column or row of the precoding matrix. In some embodiments, for the third set of precoding matrix Set_p8_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [L1;−j]}. In some embodiments, the 2 values in each vector of the first set or of the second set may be mapped on 2 out of 8 elements, and 0 may be mapped on other 6 elements in a column or row of the precoding matrix. For example, Table 3 below shows example of the set of length-2 vectors. In some embodiments, for the first set of 2 columns or rows and/or for the second set of 2 columns or rows and/or for the third set of 2 columns or rows and/or for the fourth set of 2 columns or rows, the two vectors selected for mapping to 2 non-zero values on 2 elements out of 8 elements in each column or row may be {[1; 1] and [1; −1]} or {[1; j] and [1; −j]}.

TABLE 3

[1; 1], [1; −1], [1; j], [1; −j]

In some embodiments, examples of a precoding matrix of the third set of precoding matrixes corresponding to 8 layers may be as:

$$\frac{1}{\sqrt{{s}_{8}}} [ \begin{matrix}a 1 & b 1 & 0 & 0 & 0 & 0 & 0 & 0 \\ a 2 & b 2 & 0 & 0 & 0 & 0 & 0 & 0 \\ 0 & 0 & c 1 & d 1 & 0 & 0 & 0 & 0 \\ 0 & 0 & c 2 & d 2 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, each of [g1, g2] and [h1, h2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [g1, g2] and [h1, h2] may be [1; 1], [1; −1], respectively. For another example, [g1, g2] and [h1, h2] may be [1; j], [1; −j], respectively.

In some embodiments, if the terminal device 110-1 is indicated with the number of layers as 8, there may be a fourth set of precoding matrixes (e.g. a fourth set of non-coherent precoding matrixes) corresponding to 8 layers. For example, each one of 8 antenna ports may be non-coherent with each other. In some embodiments, there may be a fourth set of precoding matrixes corresponding to 8 layers (e.g. a fourth set of non-coherent precoding matrixes), for example, represented as “Set_n8_1”, and the size of a precoding matrix may be 8 multiplies 8. In some embodiments, there may be 8 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 8 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5, idx_6, idx_7, idx_8 for the first, second, third, fourth, fifth, sixth, seventh, eighth column or row of the precoding matrix, respectively, and for each one of idx_1, idx_2, idx_3, idx_4, idx_5, idx_6, idx_7, idx_8, the value may be 1 value out of {0,1,2,3,4,5,6,7} or {1,2,3,4,5,6,7,8}. For example, the value of idx_1, idx_2, idx_3, idx_4, idx_5, idx_6, idx_7, idx_8 may be 0, 1, 2, 3, 4, 5, 6, 7, respectively. For another example, the value of idx_1, idx_2, idx_3, idx_4, idx_5, idx_6, idx_7, idx_8 may be 1, 2, 3, 4, 5, 6, 7, 8, respectively. In some embodiments, the value of For example, the value of idx_1, idx_2, idx_3, idx_4, idx_5, idx_6, idx_7, idx_8 may be different from each other.

In some embodiments, if the terminal device 110-1 is indicated with number of layers is indicated as 8, there may be a fourth set of precoding matrixes corresponding to 8 layers. For example, there may be only one precoding matrix in the fourth set (e.g. non-coherent precoding matrix) corresponding to 8 layers. In some embodiments, Table 4 shows an example non-coherent precoding matrix. For example, the rows or columns of the precoding matrix in Table 4 can be swapped.

TABLE 4
$\frac{1}{\sqrt{{s}_{8}}} [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$

For example, s₈=8.

In some embodiments, if the terminal device 110-1 is indicated with the number of layers as 8, there may be a fifth set of precoding matrixes (for example, mixed partial coherent precoding matrixes) corresponding to 8 layers. For example, the structure of the 8 ports may be 4+2+2, which means that 4 antenna ports can be coherent, 2 antenna ports can be coherent, and the other 2 antenna ports can be coherent. In some embodiments, there may be a fifth set of precoding matrixes corresponding to 8 layers (e.g. mixed partial coherent precoding matrix), for example, represented as “Set_p8_3”, and the size of a partial coherent precoding matrix may be 8 multiplies 8. In some embodiments, there may be 8 columns or rows of the precoding matrix. In some embodiments, there may be 8 elements in a column or row of the precoding matrix. In some embodiments, there may be 4 columns or rows out of the 8 columns or rows (e.g. a first set of 4 columns or rows) in the precoding matrix, and in each column or row, non-zero values may be mapped on 4 out of 8 elements and 0 may be mapped on the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, there may be 2 columns or rows out of the 8 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. For example, idx_2 may be {4, 5} or {1, 3} or {5, 6} or {2, 4}. In some embodiments, there may be 2 columns or rows out of the 8 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. For example, idx_3 may be {6, 7} or {5, 7} or {7, 8} or {6, 8}. In some embodiments, any value of idx_1, any value of idx_2 and any value of idx_3 may be different from each other. In some embodiments, the values in a length-4 vector of the first set of length-4 vectors or of the second set of length-4 vectors may be applied for the 4 non-zero values mapping on 4 elements in a column or row in the first set of 4 columns or rows of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the two values in a length-2 vector of the first set of length-2 vectors or of the second set of length-2 vectors may be applied as the two non-zero values mapping on 2 elements in a column or row of the second set of 2 columns or rows of the precoding matrix. In some embodiments, the two values in a length-2 vector of the first set of length-2 vectors or of the second set of length-2 vectors may be applied as the two non-zero values mapping on 2 elements in a column or row of the third set of 2 columns or rows of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix.

In some embodiments, 4 out of 8 columns may be mapped with length-4 vectors, and for 2 out of remaining 4 columns, each column may be mapped with length-2 vectors, and f remaining 3 columns, each column may be mapped with length-2 vectors. Table 5 shows an example of the fifth set of precoding matrixes corresponding to 8 layers, e.g. Set_p8_3. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2], [f1, f2] may be [1; 1], [1; −1], respectively. For another example, [e1, e2], [f1, f2] may be [1; j], [1; −j], respectively. For example, [g1, g2] and [h1, h2] may be [1; 1], [1; −1], respectively. For another example, [g1, g2] and [h1, h2] may be [1; j], [1; −j], respectively.

TABLE 5
$\frac{1}{\sqrt{{s}_{8}}} [ \begin{matrix}a 1 & b 1 & c 1 & d 1 & 0 & 0 & 0 & 0 \\ a 2 & b 2 & c 2 & d 2 & 0 & 0 & 0 & 0 \\ a 3 & b 3 & c 3 & d 3 & 0 & 0 & 0 & 0 \\ a 4 & b 4 & c 4 & d 4 & 0 & 0 & 0 & 0 \\ 0 & 0 & 0 & 0 & e 1 & f 1 & 0 & 0 \\ 0 & 0 & 0 & 0 & e 2 & f 2 & 0 & 0 \\ 0 & 0 & 0 & 0 & 0 & 0 & g 1 & h 1 \\ 0 & 0 & 0 & 0 & 0 & 0 & g 2 & h 2\end{matrix} ]$

In other embodiments, if the terminal device 110-1 is indicated with the number of layers as 8, there may be a sixth set of precoding matrixes (for example, mixed partial and non coherent precoding matrixes) corresponding to 8 layers. For example, the structure of 8 antenna ports may be 4+1+1+1+1, which means that 4 antenna ports can be coherent, and remaining 4 antenna ports may be non-coherent. Table 6 shows an example of the sixth set of precoding matrix corresponding to 8 layers, e.g. Set_p8_4. For example, rows or columns rows can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively.

TABLE 6
$\frac{1}{\sqrt{{s}_{8}}} [ \begin{matrix}a 1 & b 1 & c 1 & d 1 & 0 & 0 & 0 & 0 \\ a 2 & b 2 & c 2 & d 2 & 0 & 0 & 0 & 0 \\ a 3 & b 3 & c 3 & d 3 & 0 & 0 & 0 & 0 \\ a 4 & b 4 & c 4 & d 4 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$

In some embodiments, if the terminal device 110-1 is indicated with the number of layers as 8, there may be a seventh set of precoding matrixes (for example, mixed partial and non coherent precoding matrixes) corresponding to 8 layers. For example, the structure of the 8 ports may be 4+2+1+1, which means that 4 antenna ports can be coherent and 2 antenna ports can be coherent. Table 7 shows an example of the seventh set of precoding matrix corresponding to 8 layers, e.g. Set_p8_5. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2], [f1, f2] may be [1; 1], [1; −1], respectively. For another example, [e1, e2], [f1, f2] may be [1; j], [1; −j], respectively.

TABLE 7
$\frac{1}{\sqrt{{s}_{8}}} [ \begin{matrix}a 1 & b 1 & c 1 & d 1 & 0 & 0 & 0 & 0 \\ a 2 & b 2 & c 2 & d 2 & 0 & 0 & 0 & 0 \\ a 3 & b 3 & c 3 & d 3 & 0 & 0 & 0 & 0 \\ a 4 & b 4 & c 4 & d 4 & 0 & 0 & 0 & 0 \\ 0 & 0 & 0 & 0 & e 1 & f 1 & 0 & 0 \\ 0 & 0 & 0 & 0 & e 2 & f 2 & 0 & 0 \\ 0 & 0 & 0 & 0 & 0 & 0 & 1 & 0 \\ 0 & 0 & 0 & 0 & 0 & 0 & 0 & 1\end{matrix} ]$

In some other embodiments, if the terminal device 110-1 is indicated with the number of layers as 8, there may be an eighth set of precoding matrixes (for example, mixed partial and non coherent precoding matrixes) corresponding to 8 layers. For example, the structure of the 8 ports may be 2+2+1+1+1+1, which means that 2 antenna ports can be coherent and 2 antenna ports can be coherent. Table 8 shows an example of the eighth precoding matrix corresponding to 8 layers, e.g. Set_p8_6. For example, rows or columns can be swapped. In some other embodiments, the antenna structure may be 2+1+1+1+1+1+1. Alternatively, the antenna structure may be 2+2+2+1+1. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively.

TABLE 8
$\frac{1}{\sqrt{{s}_{8}}} [ \begin{matrix}a 1 & b 1 & 0 & 0 & 0 & 0 & 0 & 0 \\ a 2 & b 2 & 0 & 0 & 0 & 0 & 0 & 0 \\ 0 & 0 & c 1 & d 1 & 0 & 0 & 0 & 0 \\ 0 & 0 & c 2 & d 2 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$

In some embodiments, the terminal device 110-1 is indicated with the number of layers as 7, there may be a first set of precoding matrixes corresponding to 7 layers (e.g. a first set of full coherent precoding matrixes), and a full coherent precoding matrix may be represented as W_{l,l′,l″,l′″,m,m′,m″,m′″,n}⁽⁷⁾.

In some embodiments, W_{l,l′,l″,l′″,m,m′,m″,m′″,n}⁽⁷⁾ may be

$$\frac{1}{\sqrt{7 * P}} [ \begin{matrix}{v}_{l , m} & {v}_{l , m} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}} & {φ}_{n} * {v}_{{l}^{′′′} , {m}^{′′′}} & - {φ}_{n} * {v}_{{l}^{′′′} , {m}^{′′′}}\end{matrix} ] .$$

In some embodiments, W_{l,l′,l″,l′″,m,m′,m″,m′″,n}⁽⁷⁾ may be

$$\frac{1}{\sqrt{8 \times P}} [ \begin{matrix}{v}_{l , m} & {v}_{l , m} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & {v}_{{l}^{″} , {m}^{″}} & - {v}_{{l}^{″} , {m}^{″}} & {v}_{{l}^{′′′} , {m}^{′′′}} & - {v}_{{l}^{′′′} , {m}^{′′′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, l′″=l+3O₁. In some embodiments, m and m′ and m″ and m′″ may be 0. In some embodiments, l′=l+O₁. In some embodiments, l″=l. In some embodiments, l′″=l+O₁. In some embodiments, m′=m. In some embodiments, m″=m+O₂. In some embodiments, m′″=m+O₂.

In some embodiments, there may be more than one subset of precoding matrixes corresponding to 7 layers. In some embodiments, the first set of precoding matrixes corresponding to 7 layers may comprise more than one subset. For example, there may be two subsets of precoding matrixes.

In some embodiments, there may be a first subset of precoding matrixes corresponding to 7 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments corresponding to the first subset, m and m′ and m″ and m′″ may be 0. In some embodiments, corresponding to the first subset, l′=l+O₁, l″=l+2O₁ and l′″=l+3O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 7 layers may be 32 or 16 or 8 or 4 or 2.

In some embodiments, there may be a second subset of precoding matrixes corresponding to 7 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l and l′″=l+O₁. In some embodiments, corresponding to the second subset, m′=m, m″=m+O₂ and m′″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 7 layers may be 128 or 32 or 16 or 8 or 4 or 2.

In some embodiments, the first set of precoding matrixes corresponding to 7 layers may be shown as Table 9 below.

TABLE 9

| | i_{1,1} | i_{1,2} | i₂ | Precoding Matrix |
|---|---|---|---|---|
| N₁ = 4, N₂ = 1 | $0 , … , \frac{{N}_{I} {O}_{I}}{2} - 1$ | 0 | 0, 1 | Wᵢ_{_{1,1}}_{,i}_{_{1,1}}_{+O}_{₁}_{,i}_{_{1,1}}_{+2O}_{₁}_{,i}_{_{1,1}}_{+3O}_{₁}_{,0,0,0,0,i}_{₂}⁽⁷⁾ |
| N₁ = 2, N₂ = 2 | 0, . . . , N₁O₁ − 1 | 0, . . . , N₂O₂ − 1 | 0, 1 | Wᵢ_{_{1,1}}_{,i}_{_{1,1}}_{+O}_{₁}_{,i}_{_{1,1}}_{,i}_{_{1,1}}_{+O}_{₁}_{,i}_{_{1,2}}_{,i}_{_{1,2}}_{,i}_{_{1,2}}_{+O}_{₂}_{,i}_{_{1,2}}_{+O}_{_{2,}}ᵢ_{₂}⁽⁷⁾ |

Where
${W}_{l , {l}^{′} , {l}^{″} , {l}^{′′′} , m , {m}^{′} , {m}^{″} , {m}^{′′′} , n}^{( 7 )} = \frac{1}{\sqrt{7 * P}} [ \begin{matrix}{v}_{l , m} & {v}_{l , m} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}} & {φ}_{n} * {v}_{{l}^{′′′} , {m}^{′′′}} & - {φ}_{n} * {v}_{{l}^{′′′} , {m}^{′′′}}\end{matrix} ]$ or
${W}_{l , {l}^{′} , {l}^{″} , {l}^{′′′} , m , {m}^{′} , {m}^{″} , {m}^{′′′} , n}^{( 7 )} = \frac{1}{\sqrt{7 * P}} [ \begin{matrix}{v}_{l , m} & {v}_{l , m} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & {v}_{{l}^{″} , {m}^{″}} & - {v}_{{l}^{″} , {m}^{″}} & {v}_{{l}^{′′′} , {m}^{′′′}} & - {v}_{{l}^{′′′} , {m}^{′′′}}\end{matrix} ] .$

In some embodiments, N₁ may equal to 4, N₂ equals to 1, O₁ may equal to 2 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The first subset of precoding matrixes corresponding to 7 layers (e.g. “Set_f7_1”) may comprise 16 precoding matrixes. In some embodiments, the first subset of precoding matrixes “Set_f7_1” may comprise 8 precoding matrixes. Alternatively, the first subset of precoding matrixes “Set_f7_1” may comprise 4 precoding matrixes. In other embodiments, the first subset of precoding matrixes “Set_f7_1” may comprise 2 precoding matrixes.

Alternatively, N₁ may equal to 2, N₂ equals to 2, O₁ may equal to 1 or 4, and O₂ may equal to 2 or 4, i_{1,1} or i_{1,2} may be one of {0, . . . 7} or {0, 2, 4, 6} or {0, 4} or {0, . . . 3} or {0, 2} or {0,1} or 0. The second subset of precoding matrixes corresponding to 7 layers (e.g. “Set_f7_2”) may comprise 128 precoding matrixes. In some embodiments, the second subset of precoding matrixes “Set_f7_2” may comprise 32 precoding matrixes. Alternatively, the second subset of precoding matrixes “Set_f7_2” may comprise 8 precoding matrixes. In other embodiments, the second subset of precoding matrixes “Set_f7_2” may comprise 2 precoding matrixes.

In some embodiments, the terminal device 110-1 is indicated with the number of layers as 7, there may be a second set of precoding matrixes corresponding to 7 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 7 layers, for example, represented as “Set_p7_1”, and the size of a partial coherent precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be 4 columns or rows out of the 7 columns or rows (e.g. a first set of 4 columns or rows) in the precoding matrix, and in each column or row, the non-zero values may be mapped on 4 out of 8 elements and 0 for the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of the 4 antenna ports in the first group. In some embodiments, for the other 3 columns or rows out of the 7 columns or rows (e.g. a second set of 3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1;j], [1; −1;j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the set of precoding matrixes “Set_p7_1” may comprise C(2,1)*C(7,4)*C(2,1)*C(4,3) precoding matrixes. In some embodiments, Table 10 below shows example of vectors of 4 non-zero values mapping on 4 elements out of 8 elements in a column or row in a partial coherent precoding matrix.

TABLE 10
a first set of vectors
$[ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$
or a second set of vectors
$[ \begin{matrix}1 & 1 & 1 & 1 \\ 1 & - 1 & 1 & - 1 \\ j & j & - j & - j \\ j & - j & - j & j\end{matrix} ]$

In some embodiments, examples of a precoding matrix of the second set of precoding matrixes corresponding to 7 layers may be as:

$$\begin{matrix}\frac{1}{\sqrt{{s}_{7}}} [ \begin{matrix}a 1 & b 1 & c 1 & d 1 & 0 & 0 & 0 \\ a 2 & b 2 & c 2 & d 2 & 0 & 0 & 0 \\ a 3 & b 3 & c 3 & d 3 & 0 & 0 & 0 \\ a 4 & b 4 & c 4 & d 4 & 0 & 0 & 0 \\ 0 & 0 & 0 & 0 & e 1 & f 1 & g 1 \\ 0 & 0 & 0 & 0 & e 2 & f 2 & g 2 \\ 0 & 0 & 0 & 0 & e 3 & f 3 & g 3 \\ 0 & 0 & 0 & 0 & e 4 & f 4 & g 4\end{matrix} ] or \\ \frac{1}{\sqrt{{s}_{7}}} [ \begin{matrix}a 1 & b 1 & c 1 & d 1 & 0 & 0 & 0 \\ 0 & 0 & 0 & 0 & e 1 & f 1 & g 1 \\ a 2 & b 2 & c 2 & d 2 & 0 & 0 & 0 \\ 0 & 0 & 0 & 0 & e 2 & f 2 & g 2 \\ a 3 & b 3 & c 3 & d 3 & 0 & 0 & 0 \\ 0 & 0 & 0 & 0 & e 3 & f 3 & g 3 \\ a 4 & b 4 & c 4 & d 4 & 0 & 0 & 0 \\ 0 & 0 & 0 & 0 & e 4 & f 4 & g 4\end{matrix} ]\end{matrix}$$

For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f3, f4], [g1, g2, g3, g4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j, respectively. For example, [e1, e2, e3, e4], [f1, f2, f3, f4], [g1, g2, g3, g4] may be 3 vectors out of [1; 1; 1; 1], [1; −1; 1; −1], [1;1;−1;−1] and [1;−1;−1;1]. For another example, [e1, e2, e3, e4], [f1, f2, 3, f4], [g1, g2, g3, g4]] may be 3 vectors out of [1; 1; j; j], [1; −1; j; −j], [1; 1; −j, −j] and [1; −1; −j; j].

In some embodiments, s₇ may a positive integer. For example, 1≤s₇≤64. For example, s₇ may be 64 or 32 or 16 or 8 or 4 or 2 or 56 or 28 or 14.

In some embodiments, if the terminal device 110-1 is indicated with the number of layers as 7, there may be a third set of precoding matrixes (e.g. a third set of partial coherent precoding matrixes) corresponding to 7 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p7_2”, and the size of a precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 7 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 7 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of the other two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 2 columns or rows out of the 7 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 column or row out of the 7 columns or rows (e.g. a fourth set of 1 column or row) in the precoding matrix, and in each column or row, non-zero values may be mapped on 2 out of 8 elements and 0 may be mapped on the other 6 elements. For example, the indexes of the 2 elements with non-zero values may be same in the fourth set of 1 column or row. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other.

In some embodiments, there may be a set of 4 length-2 vectors, and each one of the length-2 vector may be applied as the two non-zero values in a column or row of the precoding matrix. In some embodiments, for the third set of precoding matrix corresponding to 7 layers, e.g. Set_p7_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. For example, Table 11 below shows example of the set of length-2 vectors. In some embodiments, for the first set of 2 columns or rows and/or for the second set of 2 columns or rows and/or for the third set of 2 columns or rows and/or for the fourth set of 1 column or row, the two vectors selected for mapping to 2 non-zero values on 2 elements out of 8 elements in each column or row may be {[1; 1] and [1; −1]} or {[1; j] and [1; −j]}.

TABLE 11

[1; 1], [1; −1], [1; j], [1; −j]

In some embodiments, examples of a precoding matrix of the third set of precoding matrixes corresponding to 7 layers may be as:

$$\frac{1}{\sqrt{{s}_{7}}} [ \begin{matrix}a 1 & b 1 & 0 & 0 & 0 & 0 & 0 \\ a 2 & b 2 & 0 & 0 & 0 & 0 & 0 \\ 0 & 0 & c 1 & d 1 & 0 & 0 & 0 \\ 0 & 0 & c 2 & d 2 & 0 & 0 & 0 \\ 0 & 0 & 0 & 0 & e 1 & f 1 & 0 \\ 0 & 0 & 0 & 0 & e 2 & f 2 & 0 \\ 0 & 0 & 0 & 0 & 0 & 0 & g 1 \\ 0 & 0 & 0 & 0 & 0 & 0 & g 2\end{matrix} ] or$$

$$\frac{1}{\sqrt{{s}_{7}}} [ \begin{matrix}a 1 & b 1 & 0 & 0 & 0 & 0 & 0 \\ 0 & 0 & c 1 & d 1 & 0 & 0 & 0 \\ a 2 & b 2 & 0 & 0 & 0 & 0 & 0 \\ 0 & 0 & c 2 & d 2 & 0 & 0 & 0 \\ 0 & 0 & 0 & 0 & e 1 & f 1 & 0 \\ 0 & 0 & 0 & 0 & 0 & 0 & g 1 \\ 0 & 0 & 0 & 0 & e 2 & f 2 & 0 \\ 0 & 0 & 0 & 0 & 0 & 0 & g 2\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, [g1, g2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [g1, g2] may be one of [1; 1], [1; −1]. For another example, [g1, g2] may be one of [1; j], [1; −j], respectively.

In some embodiments, if the terminal device 110-1 is indicated with the number of layers as 7, there may be a fourth set of precoding matrixes (e.g. a fourth set of non-coherent precoding matrixes) corresponding to 7 layers. For example, each one of 8 antenna ports may be non-coherent with each other. In some embodiments, there may be a fourth set of precoding matrixes (e.g. a fourth set of non-coherent precoding matrixes), for example, represented as “Set_n7_1”, and the size of a precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 7 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5, idx_6, idx_7 for the first, second, third, fourth, fifth, sixth, seventh column or row of the precoding matrix, respectively, and for each one of idx_1, idx_2, idx_3, idx_4, idx_5, idx_6, idx_7, the value may be 1 value out of {0,1,2,3,4,5,6,7} or {1,2,3,4,5,6,7,8}. For example, the value of idx_1, idx_2, idx_3, idx_4, idx_5, idx_6, idx_7 may be 0, 1, 2, 3, 4, 5, 6, respectively. For another example, the value of idx_1, idx_2, idx_3, idx_4, idx_5, idx_6, idx_7 may be 1, 2, 3, 4, 5, 6, 7, respectively. In some embodiments, the values of idx_1, idx_2, idx_3, idx_4 may be based on the indexes of the 4 antenna ports in the first group. In some embodiments, the values of idx_5, idx_6 and idx_7 may be based on the indexes of three out of the 4 antenna ports in the second group. In some embodiments, the values of idx_1, idx_2 may be based on the indexes of the 2 antenna ports in the third group. In some embodiments, the values of idx_3, idx_4 may be based on the indexes of the 2 antenna ports in the fourth group. In some embodiments, the values of idx_5, idx_6 may be based on the indexes of the 2 antenna ports in the fifth group. In some embodiments, the values of idx_7 may be based on the indexes of one out of the 2 antenna ports in the sixth group. For example, the value of idx_1, idx_2, idx_3, idx_4, idx_5, idx_6, idx_7 may be different from each other.

In some embodiments, if the terminal device 110-1 is indicated with number of layers is indicated as 7, there may be a fourth set of precoding matrixes corresponding to 7 layers. For example, there may be only one precoding matrix in the fourth set (e.g. non-coherent precoding matrix) corresponding to 7 layers. In some embodiments, Table 12 shows an example non-coherent precoding matrix. For example, the rows or columns of the precoding matrix in Table 12 can be swapped.

TABLE 12
$\frac{1}{\sqrt{{s}_{7}}} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$

For example, s₇=8.

In some embodiments, if the terminal device 110-1 is indicated with the number of layers as 7, there may be a fifth set of precoding matrixes (for example, mixed partial coherent precoding matrixes) corresponding to 7 layers. For example, the structure of the 8 ports may be 4+2+2, which means that 4 antenna ports can be coherent, 2 antenna ports can be coherent, and the other 2 antenna ports can be coherent. In this case, 4 out of 8 columns may be mapped with length-4 vectors, and for remaining 3 columns, each column may be mapped with length-2 vectors, and with ports swapped. Table 13 shows an example mixed partial coherent precoding matrix Set_p7_3, where rows or columns can be swapped.

TABLE 13
$\frac{1}{\sqrt{{s}_{7}}} [ \begin{matrix}a 1 & b 1 & c 1 & d 1 & 0 & 0 & 0 \\ a 2 & b 2 & c 2 & d 2 & 0 & 0 & 0 \\ a 3 & b 3 & c 3 & d 3 & 0 & 0 & 0 \\ a 4 & b 4 & c 4 & d 4 & 0 & 0 & 0 \\ 0 & 0 & 0 & 0 & e 1 & f 1 & 0 \\ 0 & 0 & 0 & 0 & e 2 & f 2 & 0 \\ 0 & 0 & 0 & 0 & 0 & 0 & g 1 \\ 0 & 0 & 0 & 0 & 0 & 0 & g 2\end{matrix} ]$

In other embodiments, if the terminal device 110-1 is indicated with the number of layers as 7, there may be a sixth set of precoding matrixes (for example, mixed partial and non coherent precoding matrixes) corresponding to 7 layers. For example, the structure of 8 antenna ports may be 4+1+1+1+1, which means that 4 antenna ports can be coherent. Table 14 shows an example of the sixth set of precoding matrix corresponding to 7 layers, e.g. Set_p7_4, where rows or columns can be swapped.

TABLE 14
$\frac{1}{\sqrt{{s}_{7}}} [ \begin{matrix}a 1 & b 1 & c 1 & d 1 & 0 & 0 & 0 \\ a 2 & b 2 & c 2 & d 2 & 0 & 0 & 0 \\ a 3 & b 3 & c 3 & d 3 & 0 & 0 & 0 \\ a 4 & b 4 & c 4 & d 4 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$

In some embodiments, if the terminal device 110-1 is indicated with the number of layers as 7, there may be a seventh set of precoding matrixes (for example, mixed partial and non coherent precoding matrixes) corresponding to 7 layers. For example, the structure of the 8 ports may be 4+2+1+1, which means that 4 antenna ports can be coherent and 2 antenna ports can be coherent. Table 15 shows an example of the seventh set of precoding matrix corresponding to 7 layers, e.g. Set_p7_5, where rows or columns can be swapped.

TABLE 15
$\frac{1}{\sqrt{{s}_{7}}} [ \begin{matrix}a 1 & b 1 & c 1 & d 1 & 0 & 0 & 0 \\ a 2 & b 2 & c 2 & d 2 & 0 & 0 & 0 \\ a 3 & b 3 & c 3 & d 3 & 0 & 0 & 0 \\ a 4 & b 4 & c 4 & d 4 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$

In some other embodiments, if the terminal device 110-1 is indicated with the number of layers as 7, there may be an eighth set of precoding matrixes (for example, mixed partial and non coherent precoding matrixes) corresponding to 7 layers. For example, the structure of the 8 ports may be 2+2+1+1+1+1, which means that 2 antenna ports can be coherent and 2 antenna ports can be coherent. Table 16 shows an example of the eighth precoding matrix corresponding to 7 layers, e.g. Set_p7_6, where rows or columns can be swapped. In some other embodiments, the antenna structure may be 2+1+1+1+1+1+1. Alternatively, the antenna structure may be 2+2+2+1+1.

TABLE 16
$\frac{1}{\sqrt{{s}_{7}}} [ \begin{matrix}a 1 & b 1 & 0 & 0 & 0 & 0 & 0 \\ a 2 & b 2 & 0 & 0 & 0 & 0 & 0 \\ 0 & 0 & c 1 & d 1 & 0 & 0 & 0 \\ 0 & 0 & c 2 & d 2 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$

In some embodiments, the terminal device 110-1 is indicated with the number of layers as 6, there may be a first set of precoding matrixes corresponding to 6 layers (e.g. a first set of full coherent precoding matrixes), and a full coherent precoding matrix may be represented as W_{l,l′,l″,l′″,m,m′,m″,m′″,n}⁽⁶⁾.

In some embodiments, W_{l,l′,l″,l′″,m,m′,m″,m′″,n}⁽⁶⁾ may be

$$\frac{1}{\sqrt{6 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}}\end{matrix} ] .$$

In some embodiments, W_{l,l′,l″,l′″,m,m′,m″,m′″,n}⁽⁶⁾ may be

$$\frac{1}{\sqrt{6 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {v}_{{l}^{″} , {m}^{″}} & - {v}_{{l}^{″} , {m}^{″}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, m and m′ and m″ may be 0. In some embodiments, l′=l+O₁. In some embodiments, l″=l+O₁. In some embodiments, m′=m. In some embodiments, m″=m+O₂.

In some embodiments, there may be more than one subset of precoding matrixes corresponding to 6 layers. In some embodiments, the first set of precoding matrixes corresponding to 6 layers may comprise more than one subset. For example, there may be two subsets of precoding matrixes.

In some embodiments, there may be a first subset of precoding matrixes corresponding to 6 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments corresponding to the first subset, m and m′ and m″ may be 0. In some embodiments, corresponding to the first subset, l′=l+O₁, l″=l+2O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 6 layers may be 32 or 16 or 8 or 4 or 2.

In some embodiments, there may be a second subset of precoding matrixes corresponding to 6 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π t}{{O}_{1} {N}_{1}}} ]}^{T} .$$

In some embodiments, corresponding to the second subset, l′=l+O₁, l″=l+O₁. In some embodiments, corresponding to the second subset, m′=m, m″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 6 layers may be 128 or 32 or 16 or 8 or 4 or 2.

In some embodiments, if the terminal device 110-1 is indicated with the number of layers as 6, the full coherent precoding matrix may be shown as Table 17 below.

TABLE 17

| | i_{1,1} | i_{1,2} | i₂ | Precoding Matrix |
|---|---|---|---|---|
| N₁ = 4, N₂ = 1 | 0, . . . , N₁O₁ − 1 | 0 | 0, 1 | Wᵢ_{_{1,1}}_{,i}_{_{1,1}}_{+O}_{₁}_{,i}_{_{1,1}}_{+2O}_{₁}_{,0,0,0,i}_{₂}⁽⁶⁾ |
| N₁ = 2, N₂ = 2 | 0, . . . , N₁O₁ − 1 | 0, . . . , N₂O₂ − 1 | 0, 1 | Wᵢ_{_{1,1}}_{,i}_{_{1,1}}_{+O}_{₁}_{,i}_{_{1,1}}_{+O}_{₁}_{,i}_{_{1,2}}_{,i}_{_{1,2}}_{,i}_{_{1,2}}_{+O}_{₂}_{,i}_{₂}⁽⁶⁾ |

Where
${W}_{l , {l}^{′} , {l}^{″} , m , {m}^{′} , {m}^{″} , n}^{( 6 )} = \frac{1}{\sqrt{6 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}}\end{matrix} ]$ or
${W}_{l , {l}^{′} , {l}^{″} , m , {m}^{′} , {m}^{″} , n}^{( 6 )} = \frac{1}{\sqrt{6 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {v}_{{l}^{″} , {m}^{″}} & - {v}_{{l}^{″} , {m}^{″}}\end{matrix} ] .$

In some embodiments, N₁ may equal to 4, N₂ equals to 1, O₁ may equal to 2 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The first subset of precoding matrixes corresponding to 6 layers, e.g. “Set_f6_1” may comprise 16 precoding matrixes. In some embodiments, the first subset of precoding matrixes “Set_f6_1” may comprise 8 precoding matrixes. Alternatively, the first subset of precoding matrixes “Set_f6_1” may comprise 4 precoding matrixes. In other embodiments, the first subset of precoding matrixes “Set_f6_1” may comprise 2 precoding matrixes.

Alternatively, N₁ may equal to 2, N₂ equals to 2, O₁ may equal to 1 or 4, and O₂ may equal to 2 or 4, i_{1,1} or i_{1, 2} may be one of {0, . . . 7} or {0, 2, 4, 6} or {0, 4} or {0, . . . 3} or {0, 2} or {0,1} or 0. The second subset of precoding matrixes corresponding to 6 layers, e.g. “Set_f6_2” may comprise 128 precoding matrixes. In some embodiments, the second subset of precoding matrixes “Set_f6_2” may comprise 32 precoding matrixes. Alternatively, the second subset of precoding matrixes “Set_f6_2” may comprise 8 precoding matrixes. In other embodiments, the second subset of precoding matrixes “Set_f6_2” may comprise 2 precoding matrixes.

In some embodiments, the terminal device 110-1 is indicated with the number of layers as 6, there may be a second set of precoding matrixes corresponding to 6 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 6 layers, for example, represented as “Set_p6_1”, and the size of a partial coherent precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be 4 columns or rows out of the 6 columns or rows (e.g. a first set of 4 columns or rows) in the precoding matrix, and in each column, the non-zero value may be mapped on 4 out of 8 elements and 0 for the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of of the 4 antenna ports in the first group. In some embodiments, for other 2 columns, 2 of the first set or the second set of length-4 vectors may be selected. In some embodiments, for the other 2 columns or rows out of the 6 columns or rows (e.g. a second set of 2 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 2 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of two out of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, alternatively, 3 columns or rows out of the 6 columns or rows (e.g. a first set of 3 columns or rows) may be selected. In each column, the non-zero value may be mapped on 4 out of 8 elements, and 0 may be mapped for other 4 elements. For example, the indexes of the 4 elements with non-zero values may be same in the first set of 3 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of of the 4 antenna ports in the first group. For example, idx_1 may be {0,1,2,3} or {0,2,4,6} or {1,2,3,4} or {1,3,5,7}. In some embodiments, for other 3 columns or rows, 3 length-4 vectors of the first set or second set of length-4 vectors may be selected. In some embodiments, for other 3 columns, 3 of the first set or the second set of length-4 vectors may be selected. In some embodiments, for the other 3 columns or rows out of the 6 columns or rows (e.g. a second set of 3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group. For example, idx_2 may be {4,5,6,7} or {1,3,5,7} or {5,6,7,8} or {2,4,6,8}. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, Table 18 below shows example of the set of length-4 vectors.

TABLE 18
a first set of vectors
$[ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$
or a second set of vectors
$[ \begin{matrix}1 & 1 & 1 & 1 \\ 1 & - 1 & 1 & - 1 \\ j & j & - j & - j \\ j & - j & - j & j\end{matrix} ]$

In some embodiments, examples of a precoding matrix of the second set of precoding matrixes corresponding to 6 layers may be as:

$$\frac{1}{\sqrt{{s}_{6}}} [ \begin{matrix}a 1 & b 1 & c 1 & d 1 & 0 & 0 \\ a 2 & b 2 & c 2 & d 2 & 0 & 0 \\ a 3 & b 3 & c 3 & d 3 & 0 & 0 \\ a 4 & b 4 & c 4 & d 4 & 0 & 0 \\ 0 & 0 & 0 & 0 & e 1 & f 1 \\ 0 & 0 & 0 & 0 & e 2 & f 2 \\ 0 & 0 & 0 & 0 & e 3 & f 3 \\ 0 & 0 & 0 & 0 & e 4 & f 4\end{matrix} ] or \frac{1}{\sqrt{{s}_{6}}} [ \begin{matrix}a 1 & b 1 & c 1 & 0 & 0 & 0 \\ a 2 & b 2 & c 2 & 0 & 0 & 0 \\ a 3 & b 3 & c 3 & 0 & 0 & 0 \\ a 4 & b 4 & c 4 & 0 & 0 & 0 \\ 0 & 0 & 0 & d 1 & e 1 & f 1 \\ 0 & 0 & 0 & d 2 & e 2 & f 2 \\ 0 & 0 & 0 & d 3 & e 3 & f 3 \\ 0 & 0 & 0 & d 4 & e 4 & f 4\end{matrix} ]$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f3, f4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4], [f1, f2, 3, f4] may be 2 vectors out of [1; 1; 1; 1], [1; −1; 1; −1], [1;1;−1;−1] and [1;−1;−1;1]. For another example, [e1, e2, e3, e4], [f1, f2, f3, f4] may be 2 vectors out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, each of [d1, d2, d3, d4], [e1, e2, e3, e4], [f1, f2, f3, f4] may be one of the length-4 vectors in the first set of length-4 vectors or in the second set of length-4 vectors. For example, [a1, a2, a3, a4], [b1, b2, b3, b4], [c1, c2, c3, c4] may be three vectors out of [1; 1; 1; 1], [1; −1; 1; −1], [1;1;−1;−1] and [1;−1;−1;1]. For another example, [a1, a2, a3, a4], [b1, b2, b3, b4], [c1, c2, c3, c4] may be three of [1; 1; j; j], [1; −1; j; −j], [1; 1; −j; −j] and [1; −1; −j; j]. For example, [d1, d2, d3, d4], [e1, e2, e3, e4], [f1, f2, f3, f4] may be 3 vectors out of [1; 1; 1; 1], [1; −1; 1; −1], [1;1;−1;−1] and [1;−1;−1;1]. For another example, [d1, d2, d3, d4], [e1, e2, e3, e4], [f1, f2, f3, f4] may be 3 vectors out of [1; 1; j; j], [1; −1; j; −j], [1; 1; −j; −j] and [1; −1; −j; j].

In some embodiments, s₆ may a positive integer. For example, 1≤s₆≤64. For example, s₆ may be 64 or 32 or 16 or 8 or 4 or 2 or 48 or 24 or 12.

In some embodiments, if the terminal device 110-1 is indicated with the number of layers as 6, there may be a third set of precoding matrixes (e.g. a third set of partial coherent precoding matrixes) corresponding to 6 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p6_2”, and the size of a precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 6 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 6 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 6 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_1 may be based on the indexes of two out of the 4 antenna ports in the second group. In some embodiments, the 2 values of idx_1 may be based on the indexes of the 2 antenna ports in the fifth group. For example, idx_3 may be {4,5} or {4,6} or {5,6} or {5,7} or {2,6} or {3,7}. In some embodiments, there may be 1 or 2 columns or rows out of the 6 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 6. In some embodiments, there may be the first set, the second set and the third set, and each set with 2 columns or rows. In some embodiments, there may be the first set, the second set and the third set and fourth set, and each of two of the four sets with 2 columns or rows, and each of other two of the four sets with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 6 layers, e.g. Set_p6_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. For example, Table 19 below shows example of the set of length-2 vectors. In some embodiments, for the first set of 2 columns or rows and/or for the second set of 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

TABLE 19

[1; 1], [1; −1], [1; j], [1; −j]

In some embodiments, examples of a precoding matrix of the third set of precoding matrixes corresponding to 6 layers may be as:

$$\frac{1}{\sqrt{{s}_{6}}} [ \begin{matrix}a 1 & b 1 & 0 & 0 & 0 & 0 \\ a 2 & b 2 & 0 & 0 & 0 & 0 \\ 0 & 0 & c 1 & d 1 & 0 & 0 \\ 0 & 0 & c 2 & d 2 & 0 & 0 \\ 0 & 0 & 0 & 0 & e 1 & f 1 \\ 0 & 0 & 0 & 0 & e 2 & f 2 \\ 0 & 0 & 0 & 0 & 0 & 0 \\ 0 & 0 & 0 & 0 & 0 & 0\end{matrix} ] or \frac{1}{\sqrt{{s}_{6}}} [ \begin{matrix}a 1 & b 1 & 0 & 0 & 0 & 0 \\ a 2 & b 2 & 0 & 0 & 0 & 0 \\ 0 & 0 & c 1 & d 1 & 0 & 0 \\ 0 & 0 & c 2 & d 2 & 0 & 0 \\ 0 & 0 & 0 & 0 & e 1 & 0 \\ 0 & 0 & 0 & 0 & e 2 & 0 \\ 0 & 0 & 0 & 0 & 0 & f 1 \\ 0 & 0 & 0 & 0 & 0 & f 2\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [e1, e2] may be one of [1; 1], [1; −1], [1; j], [1; −j]. For example, [f1, f2] may be one of [1; 1], [1; −1], [1; j], [1; −j].

In some embodiments, if the terminal device 110-1 is indicated with the number of layers as 6, there may be a fourth set of precoding matrixes (e.g. a fourth set of non-coherent precoding matrixes) corresponding to 6 layers. For example, each one of 8 antenna ports may be non-coherent with each other. In some embodiments, there may be a fourth set of precoding matrixes (e.g. a fourth set of non-coherent precoding matrixes), for example, represented as “Set_n6_1”, and the size of a precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 6 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5, idx_6 for the first, second, third, fourth, fifth, sixth column or row of the precoding matrix, respectively, and for each one of idx_1, idx_2, idx_3, idx_4, idx_5, idx_6 the value may be 1 value out of {0,1,2,3,4,5,6,7} or {1,2,3,4,5,6,7,8}. In some embodiments, the values of idx_1, idx_2, idx_3, idx_4 may be based on the indexes of the 4 antenna ports in the first group. In some embodiments, the values of idx_1, idx_2, idx_3 may be based on the indexes of the three out of 4 antenna ports in the first group. In some embodiments, the values of idx_1 and idx_2 may be based on the indexes of 2 antenna ports in the third group. In some embodiments, the values of idx_3 and idx_4 may be based on the indexes of the 2 antenna ports in the fourth group. In some embodiments, the values of idx_5, idx_6 may be based on the indexes of two out of the 4 antenna ports in the second group. In some embodiments, the values of idx_5, idx_6 may be based on the indexes of the 2 antenna ports in the fifth group. In some embodiments, the values of idx_5, idx_6 may be based on the indexes of the 2 antenna ports in the sixth group. For example, the value of idx_1, idx_2, idx_3, idx_4, idx_5, idx_6 may be 0, 1, 2, 3, 4, 5, respectively. For another example, the value of idx_1, idx_2, idx_3, idx_4, idx_5, idx_6 may be 1, 2, 3, 4, 5, 6, respectively. For example, the value of idx_1, idx_2, idx_3, idx_4, idx_5, idx_6 may be different from each other.

In some embodiments, if the terminal device 110-1 is indicated with number of layers is indicated as 6, there may be a fourth set of precoding matrixes corresponding to 6 layers. For example, there may be only one precoding matrix in the fourth set (e.g. non-coherent precoding matrix) corresponding to 6 layers. In some embodiments, Table 20 shows an example non-coherent precoding matrix. For example, the rows or columns of the precoding matrix in Table 20 can be swapped.

TABLE 20
$\frac{1}{\sqrt{{s}_{6}}} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ]$

For example, s₆=8.

In some embodiments, if there are 6 layers at the terminal device 110-1, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 2, 3, or 4) columns may be mapped with length-4 vectors, and 6-r1 column may be mapped with length-2 vectors, and with ports swapped. Table 21 shows example mixed partial coherent precoding matrixes Set_p6_3, where rows can be swapped.

TABLE 21
$\frac{1}{\sqrt{{s}_{6}}} [ \begin{matrix}a 1 & b 1 & c 1 & d 1 & 0 & 0 \\ a 2 & b 2 & c 2 & d 2 & 0 & 0 \\ a 3 & b 3 & c 3 & d 3 & 0 & 0 \\ a 4 & b 4 & c 4 & d 4 & 0 & 0 \\ 0 & 0 & 0 & 0 & e 1 & 0 \\ 0 & 0 & 0 & 0 & e 2 & 0 \\ 0 & 0 & 0 & 0 & 0 & f 1 \\ 0 & 0 & 0 & 0 & 0 & f 2\end{matrix} ]$
or
$\frac{1}{\sqrt{{s}_{6}}} [ \begin{matrix}a 1 & b 1 & 0 & 0 & 0 & 0 \\ a 2 & b 2 & 0 & 0 & 0 & 0 \\ a 3 & b 3 & 0 & 0 & 0 & 0 \\ a 4 & b 4 & 0 & 0 & 0 & 0 \\ 0 & 0 & c 1 & d 1 & 0 & 0 \\ 0 & 0 & c 2 & d 2 & 0 & 0 \\ 0 & 0 & 0 & 0 & e 1 & f 1 \\ 0 & 0 & 0 & 0 & e 2 & f 2\end{matrix} ]$
or
$\frac{1}{\sqrt{{s}_{6}}} [ \begin{matrix}a 1 & b 1 & c 1 & 0 & 0 & 0 \\ a 2 & b 2 & c 2 & 0 & 0 & 0 \\ a 3 & b 3 & c 3 & 0 & 0 & 0 \\ a 4 & b 4 & c 4 & 0 & 0 & 0 \\ 0 & 0 & 0 & d 1 & e 1 & 0 \\ 0 & 0 & 0 & d 2 & e 2 & 0 \\ 0 & 0 & 0 & 0 & 0 & f 1 \\ 0 & 0 & 0 & 0 & 0 & f 2\end{matrix} ]$

In other embodiments, the antenna structure may be 4+1+1+1+1, which means that 4 antenna ports can be coherent. In this case, r1 (for example, 2 or 3 or 4) columns may be with length-4 vectors, 6-r1 columns may be with 1 on one element, and rows can be swap. Table 22 shows an example mixed partial coherent precoding matrix Set_p6_4, where rows can be swapped.

TABLE 22
$\frac{1}{\sqrt{{s}_{6}}} [ \begin{matrix}a 1 & b 1 & c 1 & d 1 & 0 & 0 \\ a 2 & b 2 & c 2 & d 2 & 0 & 0 \\ a 3 & b 3 & c 3 & d 3 & 0 & 0 \\ a 4 & b 4 & c 4 & d 4 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ]$
or
$\frac{1}{\sqrt{{s}_{6}}} [ \begin{matrix}a 1 & b 1 & 0 & 0 & 0 & 0 \\ a 2 & b 2 & 0 & 0 & 0 & 0 \\ a 3 & b 3 & 0 & 0 & 0 & 0 \\ a 4 & b 4 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1\end{matrix} ]$
or
$\frac{1}{\sqrt{{s}_{6}}} [ \begin{matrix}a 1 & b 1 & c 1 & 0 & 0 & 0 \\ a 2 & b 2 & c 2 & 0 & 0 & 0 \\ a 3 & b 3 & c 3 & 0 & 0 & 0 \\ a 4 & b 4 & c 4 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$

In some embodiments, the antenna structure may be 4+2+1+1, which means that 4 antenna ports can be coherent and 2 antenna ports can be coherent. For example, r1 (for example, 2 or 3 or 4) columns may be with length-4 vectors, and r2 (for example, 0,1,2) columns may be with length-2 vectors, and 6-r1-r2 columns may be with 1 on one element. Table 23 shows an example mixed partial coherent precoding matrix Set_p6_5, where rows can be swapped.

TABLE 23
$[ \begin{matrix}a 1 & b 1 & c 1 & d 1 & 0 & 0 \\ a 2 & b 2 & c 2 & d 2 & 0 & 0 \\ a 3 & b 3 & c 3 & d 3 & 0 & 0 \\ a 4 & b 4 & c 4 & d 4 & 0 & 0 \\ 0 & 0 & 0 & 0 & e 1 & f 1 \\ 0 & 0 & 0 & 0 & e 2 & f 2 \\ 0 & 0 & 0 & 0 & 0 & 0 \\ 0 & 0 & 0 & 0 & 0 & 0\end{matrix} ]$
or
$[ \begin{matrix}a 1 & b 1 & 0 & 0 & 0 & 0 \\ a 2 & b 2 & 0 & 0 & 0 & 0 \\ a 3 & b 3 & 0 & 0 & 0 & 0 \\ a 4 & b 4 & 0 & 0 & 0 & 0 \\ 0 & 0 & c 1 & d 1 & 0 & 0 \\ 0 & 0 & c 2 & d 2 & 0 & 0 \\ 0 & 0 & 0 & 0 & 1 & 0 \\ 0 & 0 & 0 & 0 & 0 & 1\end{matrix} ]$
or
$[ \begin{matrix}a 1 & b 1 & c 1 & 0 & 0 & 0 \\ a 2 & b 2 & c 2 & 0 & 0 & 0 \\ a 3 & b 3 & c 3 & 0 & 0 & 0 \\ a 4 & b 4 & c 4 & 0 & 0 & 0 \\ 0 & 0 & 0 & d 1 & e 1 & 0 \\ 0 & 0 & 0 & d 2 & e 2 & 0 \\ 0 & 0 & 0 & 0 & 0 & 1 \\ 0 & 0 & 0 & 0 & 0 & 0\end{matrix} ]$
or
$[ \begin{matrix}a 1 & b 1 & c 1 & 0 & 0 & 0 \\ a 2 & b 2 & c 2 & 0 & 0 & 0 \\ a 3 & b 3 & c 3 & 0 & 0 & 0 \\ a 4 & b 4 & c 4 & 0 & 0 & 0 \\ 0 & 0 & 0 & d 1 & 0 & 0 \\ 0 & 0 & 0 & d 2 & 0 & 0 \\ 0 & 0 & 0 & 0 & 1 & 0 \\ 0 & 0 & 0 & 0 & 0 & 1\end{matrix} ]$
or
$[ \begin{matrix}a 1 & b 1 & c 1 & d 1 & 0 & 0 \\ a 2 & b 2 & c 2 & d 2 & 0 & 0 \\ a 3 & b 3 & c 3 & d 3 & 0 & 0 \\ a 4 & b 4 & c 4 & d 4 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ]$

In some other embodiments, the antenna structure may be 2+2+1+1+1+1, which means that 2 antenna ports can be coherent and 2 antenna ports can be coherent. For example, r1 (for example, 2 or 3 or 4) columns may be with length-2 vectors, and 6-r1 columns may be with 1 on one element. Table 24 shows an example mixed partial coherent precoding matrix Set_p6_6, where rows can be swapped. In some other embodiments, the antenna structure may be 2+1+1+1+1+1+1. Alternatively, the antenna structure may be 2+2+2+1+1.

TABLE 24
$[ \begin{matrix}a 1 & b 1 & 0 & 0 & 0 & 0 \\ a 2 & b 2 & 0 & 0 & 0 & 0 \\ 0 & 0 & c 1 & d 1 & 0 & 0 \\ 0 & 0 & c 2 & d 2 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ]$
or
$[ \begin{matrix}a 1 & b 1 & 0 & 0 & 0 & 0 \\ a 2 & b 2 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ]$
or
$[ \begin{matrix}a 1 & b 1 & 0 & 0 & 0 & 0 \\ a 2 & b 2 & 0 & 0 & 0 & 0 \\ 0 & 0 & c 1 & 0 & 0 & 0 \\ 0 & 0 & c 2 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0\end{matrix} ]$

In some embodiments, the terminal device 110-1 is indicated with the number of layers as 5, there may be a first set of precoding matrixes corresponding to 5 layers (e.g. a first set of full coherent precoding matrixes), and a full coherent precoding matrix may be represented as W_{l,l′,l″,l′″,m,m′,m″,m′″,n}⁽⁵⁾.

In some embodiments, W_{l,l′,l″,l′″,m,m′,m″,m′″,n}⁽⁵⁾ may be

$$\frac{1}{\sqrt{5 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}}\end{matrix} ] .$$

In some embodiments, W_{l,l′,l″,l′″,m,m′,m″,m′″,n}⁽⁵⁾ may be

$$\frac{1}{\sqrt{5 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} * {v}_{l , m} & - {φ}_{n} * {v}_{l , m} & {v}_{{l}^{′} , {m}^{′}} & - {v}_{{l}^{′} , {m}^{′}} & {v}_{{l}^{″} , {m}^{″}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, m and m′ and m″ may be 0. In some embodiments, l′=l+O₁. In some embodiments, l″=l+O₁. In some embodiments, m′=m. In some embodiments, m″=m+O₂.

In some embodiments, there may be more than one subset of precoding matrixes corresponding to 5 layers. In some embodiments, the first set of precoding matrixes corresponding to 5 layers may comprise more than one subset. For example, there may be two subsets of precoding matrixes.

In some embodiments, there may be a first subset of precoding matrixes corresponding to 5 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ and m″ may be 0. In some embodiments, corresponding to the first subset, l′=l+O₁, l″=l+2O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 5 layers may be 32 or 16 or 8 or 4 or 2.

In some embodiments, there may be a second subset of precoding matrixes corresponding to 5 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l+O₁. In some embodiments, corresponding to the second subset, m′=m, m″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 5 layers may be 128 or 32 or 16 or 8 or 4 or 2.

In some embodiments, if the terminal device 110-1 is indicated with the number of layers as 5, the full coherent precoding matrix may be shown as Table 25 below.

TABLE 25

| | i_{1,1} | i_{1,2} | i₂ | Precoding Matrix |
|---|---|---|---|---|
| N₁ = 4, N₂ = 1 | 0, . . . , N₁O₁ − 1 | 0 | 0, 1 | Wᵢ_{_{1,1}}_{,i}_{_{1,1}}_{+2O}_{₁}_{,0,0,0i}_{₂}⁽⁵⁾ |
| N₁ = 2, N₂ = 2 | 0, . . . , N₁O₁ − 1 | 0, . . . , N₂O₂ − 1 | 0, 1 | Wᵢ_{_{1,1}}_{,i}_{_{1,1}}_{+O}_{₁}_{,i}_{_{1,1}}_{+O}_{₁}_{,i}_{_{1,2}}_{,i}_{_{1,2}}_{,i}_{_{1,2}}_{+O}_{₂}ᵢ_{₂}⁽⁵⁾ |

Where
${W}_{l , {l}^{′} , {l}^{″} , m , {m}^{′} , {m}^{″} , n}^{( 5 )} = \frac{1}{\sqrt{5 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}}\end{matrix} ]$ or
${W}_{l , {l}^{′} , {l}^{″} , m , {m}^{′} , {m}^{″} , n}^{( 5 )} = \frac{1}{\sqrt{5 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} * {v}_{l , m} & - {φ}_{n} * {v}_{l , m} & {v}_{{l}^{′} , {m}^{′}} & - {v}_{{l}^{′} , {m}^{′}} & {v}_{{l}^{″} , {m}^{″}}\end{matrix} ] .$

In some embodiments, N₁ may equal to 4, N₂ equals to 1, O₁ may equal to 2 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The first subset of precoding matrixes corresponding to 5 layers, e.g. “Set_f5_1” may comprise 16 precoding matrixes. In some embodiments, the first subset of precoding matrixes “Set_f5_1” may comprise 8 precoding matrixes. Alternatively, the first subset of precoding matrixes “Set_f5_1” may comprise 4 precoding matrixes. In other embodiments, the first subset of precoding matrixes “Set_f5_1” may comprise 2 precoding matrixes.

Alternatively, N₁ may equal to 2, N₂ equals to 2, O₁ may equal to 1 or 4, and O₂ may equal to 2 or 4, i_{1,1} or i_{1,2} may be one of {0, . . . 7} or {0, 2, 4, 6} or {0, 4} or {0, . . . 3} or {0, 2} or {0,1} or 0. The second subset of precoding matrixes corresponding to 5 layers, e.g. “Set_f5_2” may comprise 128 precoding matrixes. In some embodiments, the second subset of precoding matrixes “Set_f5_2” may comprise 32 precoding matrixes. Alternatively, the second subset of precoding matrixes “Set_f5_2” may comprise 8 precoding matrixes. In other embodiments, the second subset of precoding matrixes “Set_f5_2” may comprise 2 precoding matrixes.

In some embodiments, the terminal device 110-1 is indicated with the number of layers as 5, there may be a second set of precoding matrixes corresponding to 5 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 5 layers, for example, represented as “Set_p5_1”, and the size of a partial coherent precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C1 columns or rows out of the 5 columns or rows (e.g. a first set of C1 columns or rows. For example, C1 may be 1 or 2 or 3 or 4) in the precoding matrix, and in each column, the non-zero value may be mapped on 4 out of 8 elements and 0 for the other 4 elements. For example, the indexes of the 4 elements with non-zero values may be same in the first set of C1 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group. For example, idx_1 may be {0,1,2,3} or {0,2,4,6} or {1,2,3,4} or {1,3,5,7}. In some embodiments, for the other 5-C1 column, 5-C1 of the first set or second set of length-4 vectors may be selected. In some embodiments, for the other 5-C1 columns or rows out of the 5 columns or rows (e.g. a second set of 5-C1 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 5-C1 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, alternatively, 3 columns may be selected. In each column, the non-zero value may be mapped on 4 out of 8 elements, and 0 may be mapped for other 4 elements. For other 2 columns, one matrix and 2 vectors may be selected.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1;j], [1; −1;j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, Table 26 below shows of the set of length-4 vectors.

TABLE 26
a first set of vectors
$[ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$
or a second set of vectors
$[ \begin{matrix}1 & 1 & 1 & 1 \\ 1 & - 1 & 1 & - 1 \\ j & j & - j & - j \\ j & - j & - j & j\end{matrix} ]$

In some embodiments, examples of a precoding matrix of the second set of precoding matrixes corresponding to 5 layers may be as:

$$\frac{1}{\sqrt{{s}_{5}}} [ \begin{matrix}a 1 & b 1 & c 1 & d 1 & 0 \\ a 2 & b 2 & c 2 & d 2 & 0 \\ a 3 & b 3 & c 3 & d 3 & 0 \\ a 4 & b 4 & c 4 & d 4 & 0 \\ 0 & 0 & 0 & 0 & e 1 \\ 0 & 0 & 0 & 0 & e 2 \\ 0 & 0 & 0 & 0 & e 3 \\ 0 & 0 & 0 & 0 & e 4\end{matrix} ] or \frac{1}{\sqrt{{s}_{5}}} [ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & d 1 & e 1 \\ 0 & 0 & 0 & d 2 & e 2 \\ 0 & 0 & 0 & d 3 & e 3 \\ 0 & 0 & 0 & d 4 & e 4\end{matrix} ]$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [e1, e2, e3, e4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4] may be 1 vector out of [1; 1; 1; 1], [1; −1; 1; −1], [1;1;−1;−1] and [1;−1;−1;1]. For another example, [e1, e2, e3, e4] may be 1 vector out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, each of [d1, d2, d3, d4], [e1, e2, e3, e4] may be one of the length-4 vectors in the first set of length-4 vectors or in the second set of length-4 vectors. For example, [a1, a2, a3, a4], [b1, b2, b3, b4], [c1, c2, c3, c4] may be three vectors out of [1; 1; 1; 1], [1; −1; 1; −1], [1;1;−1;−1] and [1;−1;−1;1]. For another example, [a1, a2, a3, a4], [b1, b2, b3, b4], [c1, c2, c3, c4] may be three of [1; 1; j; j], [1; −1; j; −j], [1; 1; −j; −j] and [1; −1; −j; j]. For example, [d1, d2, d3, d4], [e1, e2, e3, e4] may be 2 vectors out of [1; 1; 1; 1], [1; −1; 1; −1], [1;1;−1;−1] and [1;−1;−1;1]. For another example, [d1, d2, d3, d4], [e1, e2, e3, e4] may be 2 vectors out of [1; 1;j; j], [1; −1; j; −j], [1; 1; −j; −j] and [1; −1; −j; j].

In some embodiments, s₅ may a positive integer. For example, 1≤s₅≤64. For example, s₅ may be 64 or 32 or 16 or 8 or 4 or 2 or 40 or 20 or 10.

In some embodiments, if the terminal device 110-1 is indicated with the number of layers as 5, there may be a third set of precoding matrixes (e.g. a third set of partial coherent precoding matrixes) corresponding to 5 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p5_2”, and the size of a precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 5 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 1 or 2 columns or rows out of the 5 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 5 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 or 2 columns or rows out of the 5 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of (0,1,2,3,4,5,6,7) or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 5. In some embodiments, there may be the first set, the second set and the third set, and each of two of the three sets with 2 columns or rows, and one of the three sets with 1 column or row. In some embodiments, there may be the first set, the second set, the third set and the fourth set, and one of the four sets with 2 columns or rows, and each of three of the fourth sets with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 5 layers, e.g. Set_p5_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. For example, Table 27 below shows example of the set of length-2 vectors. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

TABLE 27

[1; 1], [1; −1], [1; j], [1; −j]

In some embodiments, examples of a precoding matrix of the third set of precoding matrixes corresponding to 5 layers may be as:

$$\frac{1}{\sqrt{{s}_{5}}} [ \begin{matrix}a 1 & b 1 & 0 & 0 & 0 \\ a 2 & b 2 & 0 & 0 & 0 \\ 0 & 0 & c 1 & d 1 & 0 \\ 0 & 0 & c 2 & d 2 & 0 \\ 0 & 0 & 0 & 0 & e 1 \\ 0 & 0 & 0 & 0 & e 2 \\ 0 & 0 & 0 & 0 & 0 \\ 0 & 0 & 0 & 0 & 0\end{matrix} ] or \frac{1}{\sqrt{{s}_{5}}} [ \begin{matrix}a 1 & b 1 & 0 & 0 & 0 \\ a 2 & b 2 & 0 & 0 & 0 \\ 0 & 0 & c 1 & 0 & 0 \\ 0 & 0 & c 2 & 0 & 0 \\ 0 & 0 & 0 & d 1 & 0 \\ 0 & 0 & 0 & d 2 & 0 \\ 0 & 0 & 0 & 0 & e 1 \\ 0 & 0 & 0 & 0 & e 2\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, [e1, e2], may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1;j], [1; −j], respectively. For example, [c1, c2] and [d1, d2] may be [1; 1], [1; −1], respectively. For another example, [c1, c2] and [d1, d2] may be [1; j], [1; −j], respectively. For example, [c1, c2],[d1, d2], [e1, e2] may be any one of [1; 1], [1; −1], [1; j], [1; −j].

In some embodiments, if the terminal device 110-1 is indicated with the number of layers as 5, there may be a fourth set of precoding matrixes (e.g. a fourth set of non-coherent precoding matrixes) corresponding to 5 layers. For example, each one of 8 antenna ports may be non-coherent with each other. In some embodiments, there may be a fourth set of precoding matrixes (e.g. a fourth set of non-coherent precoding matrixes), for example, represented as “Set_n5_1”, and the size of a precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 5 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5 for the first, second, third, fourth, fifth column or row of the precoding matrix, respectively, and for each one of idx_1, idx_2, idx_3, idx_4, idx_5 the value may be 1 value out of {0,1,2,3,4,5,6,7} or {1,2,3,4,5,6,7,8}. For example, the value of idx_1, idx_2, idx_3, idx_4, idx_5 may be 0, 1, 2, 3, 4, respectively. For another example, the value of idx_1, idx_2, idx_3, idx_4, idx_5, may be 1, 2, 3, 4, 5, respectively. For example, the value of idx_1, idx_2, idx_3, idx_4, idx_5 may be different from each other.

In some embodiments, if the terminal device 110-1 is indicated with number of layers is indicated as 5, there may be a fourth set of precoding matrixes corresponding to 5 layers. For example, there may be only one precoding matrix in the fourth set (e.g. non-coherent precoding matrix) corresponding to 6 layers. In some embodiments, Table 28 shows an example non-coherent precoding matrix. For example, the rows or columns of the precoding matrix in Table 28 can be swapped.

TABLE 28
$\frac{1}{\sqrt{{s}_{5}}} [ \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0 \\ 0 & 0 & 0 & 0 & 0\end{matrix} ]$

For example, s₅=8.

In some embodiments, if there are 5 layers at the terminal device 110-1, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 1, 2, 3, or 4) columns may be mapped with length-4 vectors, and 5-r1 column may be mapped with length-2 vectors, and with ports swapped. Table 29 shows example mixed partial coherent precoding matrixes Set_p5_3, where rows can be swapped.

TABLE 29
$[ \begin{matrix}a 1 & b 1 & c 1 & d 1 & 0 \\ a 2 & b 2 & c 2 & d 2 & 0 \\ a 3 & b 3 & c 3 & d 3 & 0 \\ a 4 & b 4 & c 4 & d 4 & 0 \\ 0 & 0 & 0 & 0 & e 1 \\ 0 & 0 & 0 & 0 & e 2 \\ 0 & 0 & 0 & 0 & 0 \\ 0 & 0 & 0 & 0 & 0\end{matrix} ]$
or
$[ \begin{matrix}a 1 & b 1 & 0 & 0 & 0 \\ a 2 & b 2 & 0 & 0 & 0 \\ a 3 & b 3 & 0 & 0 & 0 \\ a 4 & b 4 & 0 & 0 & 0 \\ 0 & 0 & c 1 & d 1 & 0 \\ 0 & 0 & c 2 & d 2 & 0 \\ 0 & 0 & 0 & 0 & e 1 \\ 0 & 0 & 0 & 0 & e 2\end{matrix} ]$
or
$[ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & d 1 & e 1 \\ 0 & 0 & 0 & d 2 & e 2 \\ 0 & 0 & 0 & 0 & 0 \\ 0 & 0 & 0 & 0 & 0\end{matrix} ]$
or
$[ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & d 1 & 0 \\ 0 & 0 & 0 & d 2 & 0 \\ 0 & 0 & 0 & 0 & e 1 \\ 0 & 0 & 0 & 0 & e 2\end{matrix} ]$
or
$[ \begin{matrix}a 1 & 0 & 0 & 0 & 0 \\ a 2 & 0 & 0 & 0 & 0 \\ a 3 & 0 & 0 & 0 & 0 \\ a 4 & 0 & 0 & 0 & 0 \\ 0 & b 1 & c 1 & 0 & 0 \\ 0 & b 2 & c 2 & 0 & 0 \\ 0 & 0 & 0 & d 1 & e 1 \\ 0 & 0 & 0 & d 2 & e 2\end{matrix} ]$

In other embodiments, the antenna structure may be 4+1+1+1+1, which means that 4 antenna ports can be coherent. In this case, r1 (for example, 1 or 2 or 3 or 4) columns may be with length-4 vectors, 5-r1 columns may be with 1 on one element, and rows can be swap. Table 26 shows an example mixed partial coherent precoding matrix Set_p5_4, where rows can be swapped.

TABLE 26
$[ \begin{matrix}a 1 & b 1 & c 1 & d 1 & 0 \\ a 2 & b 2 & c 2 & d 2 & 0 \\ a 3 & b 3 & c 3 & d 3 & 0 \\ a 4 & b 4 & c 4 & d 4 & 0 \\ 0 & 0 & 0 & 0 & 1 \\ 0 & 0 & 0 & 0 & 0 \\ 0 & 0 & 0 & 0 & 0 \\ 0 & 0 & 0 & 0 & 0\end{matrix} ]$
or
$[ \begin{matrix}a 1 & b 1 & 0 & 0 & 0 \\ a 2 & b 2 & 0 & 0 & 0 \\ a 3 & b 3 & 0 & 0 & 0 \\ a 4 & b 4 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0\end{matrix} ]$
or
$[ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0\end{matrix} ]$
or
$[ \begin{matrix}a 1 & 0 & 0 & 0 & 0 \\ a 2 & 0 & 0 & 0 & 0 \\ a 3 & 0 & 0 & 0 & 0 \\ a 4 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix} ]$

In some embodiments, the antenna structure may be 4+2+1+1, which means that 4 antenna ports can be coherent and 2 antenna ports can be coherent. For example, r1 (for example, 1 or 2 or 3 or 4) columns may be with length-4 vectors, and r2 (for example, 0,1,2) columns may be with length-2 vectors, and 5-r1-r2 columns may be with 1 on one element. Table 27 shows an example mixed partial coherent precoding matrix Set_p5_5, where rows can be swapped.

TABLE 27
$[ \begin{matrix}a 1 & b 1 & c 1 & d 1 & 0 \\ a 2 & b 2 & c 2 & d 2 & 0 \\ a 3 & b 3 & c 3 & d 3 & 0 \\ a 4 & b 4 & c 4 & d 4 & 0 \\ 0 & 0 & 0 & 0 & e 1 \\ 0 & 0 & 0 & 0 & e 2 \\ 0 & 0 & 0 & 0 & 0 \\ 0 & 0 & 0 & 0 & 0\end{matrix} ]$
or
$[ \begin{matrix}a 1 & 0 & 0 & 0 & 0 \\ a 2 & 0 & 0 & 0 & 0 \\ a 3 & 0 & 0 & 0 & 0 \\ a 4 & 0 & 0 & 0 & 0 \\ 0 & b 1 & c 1 & 0 & 0 \\ 0 & b 2 & c 2 & 0 & 0 \\ 0 & 0 & 0 & 1 & 0 \\ 0 & 0 & 0 & 0 & 1\end{matrix} ]$
or
$[ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & d 1 & e 1 \\ 0 & 0 & 0 & d 2 & e 2 \\ 0 & 0 & 0 & 0 & 0 \\ 0 & 0 & 0 & 0 & 0\end{matrix} ]$
or
$[ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & d 1 & 0 \\ 0 & 0 & 0 & d 2 & 0 \\ 0 & 0 & 0 & 0 & e 1 \\ 0 & 0 & 0 & 0 & e 2\end{matrix} ]$
or
$[ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0\end{matrix} ]$
or
$[ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & d 1 & 0 \\ 0 & 0 & 0 & d 2 & 0 \\ 0 & 0 & 0 & 0 & 1 \\ 0 & 0 & 0 & 0 & 0\end{matrix} ]$
or
$[ \begin{matrix}a 1 & b 1 & c 1 & d 1 & 0 \\ a 2 & b 2 & c 2 & d 2 & 0 \\ a 3 & b 3 & c 3 & d 3 & 0 \\ a 4 & b 4 & c 4 & d 4 & 0 \\ 0 & 0 & 0 & 0 & 1 \\ 0 & 0 & 0 & 0 & 0 \\ 0 & 0 & 0 & 0 & 0 \\ 0 & 0 & 0 & 0 & 0\end{matrix} ]$

In some other embodiments, the antenna structure may be 2+2+1+1+1+1, which means that 2 antenna ports can be coherent and 2 antenna ports can be coherent. For example, r1 (for example, 1 or 2 or 3 or 4) columns may be with length-2 vectors, and 5-ri columns may be with 1 on one element. Table 28 shows an example mixed partial coherent precoding matrix Set_p5_6, where rows can be swapped. In some other embodiments, the antenna structure may be 2+1+1+1+1+1+1. Alternatively, the antenna structure may be 2+2+2+1+1.

TABLE 28
$[ \begin{matrix}a 1 & b 1 & 0 & 0 & 0 \\ a 2 & b 2 & 0 & 0 & 0 \\ 0 & 0 & c 1 & d 1 & 0 \\ 0 & 0 & c 2 & d 2 & 0 \\ 0 & 0 & 0 & 0 & 1 \\ 0 & 0 & 0 & 0 & 0 \\ 0 & 0 & 0 & 0 & 0 \\ 0 & 0 & 0 & 0 & 0\end{matrix} ]$
or
$[ \begin{matrix}a 1 & b 1 & 0 & 0 & 0 \\ a 2 & b 2 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0 \\ 0 & 0 & 0 & 0 & 0\end{matrix} ]$
or
$[ \begin{matrix}a 1 & b 1 & 0 & 0 & 0 \\ a 2 & b 2 & 0 & 0 & 0 \\ 0 & 0 & c 1 & 0 & 0 \\ 0 & 0 & c 2 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0\end{matrix} ]$
or
$[ \begin{matrix}a 1 & 0 & 0 & 0 & 0 \\ a 2 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0\end{matrix} ]$

In some embodiments, the terminal device 110-1 is indicated with the number of layers as 4, there may be a first set of precoding matrixes corresponding to 4 layers (e.g. a first set of full coherent precoding matrixes). In some embodiments, a full coherent precoding matrix may be represented as W_{l,l′,m,m′,n}⁽⁴⁾.

In some embodiments, W W_{l,l′,m,m′,n}⁽⁴⁾ may be

$$\frac{1}{\sqrt{4 * P}} [ \begin{matrix}{v}_{l , m} & {v}_{{l}^{′} , {m}^{′}} & {v}_{l , m} & {v}_{{l}^{′} , {m}^{′}} \\ {φ}_{n} * {v}_{l , m} & {φ}_{n} * {v}_{{l}^{′} , {m}^{′}} & - {φ}_{n} * {v}_{l , m} & - {φ}_{n} * {v}_{{l}^{′} , {m}^{′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, O₁, 2O₁, 3O₁}. For another example, k₁ may be 0. In some embodiments, k₂ may be a non-negative integer. For example, k₂ may at least one of {0, O₂}. In some embodiments, k₂ may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1,2,3}. For another example, i_{1,3} may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=O₁ and/or k₂=0. In some embodiments, in case of N₁=4 and N₂=1, and in case of i_{1,3}=2, k₁=2O₁ and/or k₂=0. In some embodiments, in case of N₁=4 and N₂=1, and in case of i_{1,3}=3, k₁=3O₁ and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=O₁ and/or k₂=0.

In some embodiments, there may be more than one subset of precoding matrixes corresponding to 4 layers. In some embodiments, the first set of precoding matrixes corresponding to 4 layers may comprise more than one subset. For example, there may be two or three or four subsets of precoding matrixes.

In some embodiments, there may be a first subset of precoding matrixes corresponding to 4 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 4 layers may be 128 or 64 or 32 or 16 or 8 or 4 or 2.

In some embodiments, there may be a second subset of precoding matrixes corresponding to 4 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 4 layers may be 256 or 128 or 32 or 16 or 8 or 4 or 2.

In some embodiments, if the terminal device 110-1 is indicated with the number of layers as 4, the first subset or second subset of full coherent precoding matrix may be shown as Table 29 below.

TABLE 29

| i_{1,1} | i_{1,2} | i₂ | Precoding Matrix |
|---|---|---|---|
| 0, . . . , N₁O₁ − 1 | 0, . . . , N₂O₂ − 1 | 0, 1 | Wᵢ_{_{1,1}}_{,i}_{_{1,1}}₊ₖ_{₁}_{,i}_{_{1,2}}_{,i}_{_{1,2}}₊ₖ_{₂}_{,i}_{₂}⁽⁴⁾ |

Where
${W}_{l , {l}^{′} , {l}^{″} , m , {m}^{′} , {m}^{″} , n}^{( 5 )} = \frac{1}{\sqrt{4 * P}} [ \begin{matrix}{v}_{l , m} & {v}_{{l}^{′} , {m}^{′}} & {v}_{l , m} & {v}_{{l}^{′} , {m}^{′}} \\ {φ}_{n} * {v}_{l , m} & {φ}_{n} * {v}_{{l}^{′} , {m}^{′}} & - {φ}_{n} * {v}_{l , m} & - {φ}_{n} * {v}_{{l}^{′} , {m}^{′}}\end{matrix} ] .$

In some embodiments, N₁ may equal to 4, N₂ equals to 1, O₁ may equal to 4 or 2 or 1 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The first subset of precoding matrixes corresponding to 4 layers, e.g. “Set_f4_1” may comprise 16 precoding matrixes. In some embodiments, the first subset of precoding matrixes “Set_f4_1” may comprise 8 precoding matrixes. Alternatively, the first subset of precoding matrixes “Set_f4_1” may comprise 4 precoding matrixes. In other embodiments, the first subset of precoding matrixes “Set_f4_1” may comprise 2 precoding matrixes.

Alternatively, N₁ may equal to 2, N₂ may equal to 2, O₁ may equal to 1 or 2 or 4, and O₂ may equal to 1 or 2 or 4, i_{1,3} may be 0 or 1 or 2 or 3, i_{1,1} or i_{1,2} may be one of {0, . . . 3} or {0, 2} or 0. In some embodiments, the second subset of precoding matrixes corresponding to 4 layers, e.g. “Set_f4_2” may comprise 32 precoding matrixes. Alternatively, the second subset of precoding matrixes “Set_f4_2” may comprise 8 precoding matrixes. In other embodiments, the second subset of precoding matrixes “Set_f4_2” may comprise 2 precoding matrixes.

In some embodiments, there may be a second factor aₚ. In some embodiments,

$${a}_{p} = {e}^{j \frac{π}{4}} * {e}^{j \frac{π p}{2}} .$$

In some embodiments, p may be a non-negative integer. For example, p may be at least one of {0, 1, 2, 3}. For another example, p may be 0 or 1. For another example, p may be 0 or 2. For another example, p may be 0.

In some embodiments, if the terminal device 110-1 is indicated with the number of layers as 4, there may be a third subset or a fourth subset of precoding matrixes. In some embodiments, there may be a third factor b_{nb}. In some embodiments,

$${b}_{n \_ b} = {e}^{- j \frac{π}{4}} * {e}^{j \frac{π n \_ b}{2}} .$$

In some embodiments, n_b may be a non-negative integer. For example, n_b may be at least one of {0, 1, 2, 3}. For another example, n_b may be 0 or 1. For another example, n_b may be 0 or 2. For another example, n_b may be 0.

In some embodiments, there may be a third vector W_{l,m,p,n}^{1,2,1}. In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, there may be a fourth vector W_{l,m,p,n}^{2,2,1} In some embodiments,

$${W}_{l , m , p , n}^{2 , 2 , 1} = \frac{1}{\sqrt{8}} [ {v}_{l , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1}. For another example, i_{1,3} may be 0. In some embodiments, in case of N₁=2 and N₂=1, and in case of i_{1,3}=0, k₁=O₁ and/or k₂₌₀.

In some embodiments, there may be a third subset of precoding matrixes corresponding to 4 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 4 layers may be 64 or 32 or 16 or 8 or 4 or 2. In some embodiments, the terminal device 110-1 may be indicated with the number of layers as 4, a precoding matrix in the third subset of precoding matrixes corresponding to 4 layers may be represented as W_{l,l′,m,m′,p,n}⁽⁴⁾. In some embodiments, W_{l,l′,m,m′,p,n}⁽⁴⁾ may be

$$\frac{1}{\sqrt{4}} [ \begin{matrix}{W}_{l , m , p , n}^{1 , 2 , 1} & {W}_{{l}^{′} , {m}^{′} , p , n}^{1 , 2 , 1} & {W}_{l , m , p , n}^{2 , 2 , 1} & {W}_{{l}^{′} , {m}^{′} , p , n}^{2 , 2 , 1}\end{matrix} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p₁.

In some embodiments, there may be a fifth vector W_{l,m,p,n}^{1,2,2}. In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments there may be a sixth vector W_{l,m,p,n}^{2,2,2}. In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 4 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 4 layers may be 64 or 32 or 16 or 8 or 4 or 2. In some embodiments, the terminal device 110-1 may be indicated with the number of layers as 4, a precoding matrix in the fourth subset of precoding matrixes corresponding to 4 layers may be represented as W_{l,l′,m,m′,p,n}⁽⁴⁾. In some embodiments, W_{l,l′,m,m′,p,n}⁽⁴⁾ may be

$$\frac{1}{\sqrt{4}} [ \begin{matrix}{W}_{l , m , p , n}^{1 , 2 , 2} & {W}_{{l}^{′} , {m}^{′} , p , n}^{1 , 2 , 2} & {W}_{l , m , p , n}^{2 , 2 , 2} & {W}_{{l}^{′} , {m}^{′} , p , n}^{2 , 2 , 2}\end{matrix} ] .$$

In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110-1 is indicated with the number of layers is indicated as 4, there may be a second set of precoding matrixes corresponding to 4 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 4 layers, for example, represented as “Set_p4_1”, and the size of a partial coherent precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C2 columns or rows out of the 4 columns or rows (e.g. a first set of C2 columns or rows. For example, C2 may be 1 or 2 or 3 or 4) in the precoding matrix, and in each column, the non-zero value may be mapped on 4 out of 8 elements and 0 for the other 4 elements. For example, the indexes of the 4 elements with non-zero values may be same in the first set of C2 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group. For example, idx_1 may be {0,1,2,3} or {0,2,4,6} or {1,2,3,4} or {1,3,5,7}. In some embodiments, for the other 4-C2 column, 4-C2 of the first set or second set of length-4 vectors may be selected. In some embodiments, for the other 4-C2 columns or rows out of the 4 columns or rows (e.g. a second set of 4-C2 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 4-C2 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, C2 may be 4 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, Table 30 below shows example of the set of length-4 vectors.

TABLE 30
a first set of vectors
$[ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$
or a second set of vectors
$[ \begin{matrix}1 & 1 & 1 & 1 \\ 1 & - 1 & 1 & - 1 \\ j & j & - j & - j \\ j & - j & - j & j\end{matrix} ]$

In some embodiments, examples of a precoding matrix of the second set of precoding matrixes corresponding to 4 layers may be as:

$$\frac{1}{\sqrt{{s}_{4}}} [ \begin{matrix}a 1 & b 1 & c 1 & d 1 \\ a 2 & b 2 & c 2 & d 2 \\ a 3 & b 3 & c 3 & d 3 \\ a 4 & b 4 & c 4 & d 4 \\ 0 & 0 & 0 & 0 \\ 0 & 0 & 0 & 0 \\ 0 & 0 & 0 & 0 \\ 0 & 0 & 0 & 0\end{matrix} ] or \frac{1}{\sqrt{{s}_{4}}} [ \begin{matrix}a 1 & b 1 & c 1 & 0 \\ a 2 & b 2 & c 2 & 0 \\ a 3 & b 3 & c 3 & 0 \\ a 4 & b 4 & c 4 & 0 \\ 0 & 0 & 0 & d 1 \\ 0 & 0 & 0 & d 2 \\ 0 & 0 & 0 & d 3 \\ 0 & 0 & 0 & d 4\end{matrix} ] or \\ \frac{1}{\sqrt{{s}_{4}}} [ \begin{matrix}a 1 & b 1 & 0 & 0 \\ a 2 & b 2 & 0 & 0 \\ a 3 & b 3 & 0 & 0 \\ a 4 & b 4 & 0 & 0 \\ 0 & 0 & c 1 & e 1 \\ 0 & 0 & c 2 & e 2 \\ 0 & 0 & c 3 & e 3 \\ 0 & 0 & c 4 & e 4\end{matrix} ] or \frac{1}{\sqrt{{s}_{4}}} [ \begin{matrix}a 1 & 0 & 0 & 0 \\ a 2 & 0 & 0 & 0 \\ a 3 & 0 & 0 & 0 \\ a 4 & 0 & 0 & 0 \\ 0 & b 1 & c 1 & d 1 \\ 0 & b 2 & c 2 & d 2 \\ 0 & b 3 & c 3 & d 3 \\ 0 & b 4 & c 4 & d 4\end{matrix} ]$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, each of [a1, a2, a3, a4], [b1, b2, b3, b4], [c1, c2, c3, c4] may be one of the length-4 vectors in the first set of length-4 vectors or in the second set of length-4 vectors. For example, [d1, d2, d3, d4] may be one of the length-4 vectors in the first set of length-4 vectors or in the second set of length-4 vectors. For example, [at, a2, a3, a4], [b1, b2, b3, b4], may be two vectors out of [1; 1; 1; 1], [1; −1; 1; −1], [1;1;−1;−1] and [1;−1;−1;i]. For another example, [a1, a2, a3, a4], [b1, b2, b3, b4], may be two of [1; 1; j; j], [1; −1; j; −j], [1; 1; −j; −j] and [1; −1; −j; j]. For example, [c1, c2, c3, c4], [d1, d2, d3, d4] may be 2 vectors out of [1; 1; 1; 1], [1; −1; 1; −1], [1;1;−1;−1] and [1;−1;−1;1]. For another example, [c1, c2, c3, c4], [d1, d2, d3, d4] may be 2 vectors out of [1; 1; j; j], [1; −1; j; −j], [1; 1; −j; −j] and [1; −1; −j; j].

In some embodiments, s₄ may a positive integer. For example, 1≤s₄≤64. For example, s₄ may be 64 or 32 or 16 or 8 or 4 or 2 or 32 or 16 or 8.

In some embodiments, the third subset of full coherent precoding matrix corresponding to 4 layers may be shown as Table 31 below.

TABLE 31

| i_{1,1} [symbol] | i_{1,1} [symbol] | i_{1,4,q}, q = 1, . . . , N_{q} − 1 [symbol] | i₂ [symbol] | [symbol] |
|---|---|---|---|---|
| 0, . . . , N₁O₁ − 1 [symbol] | 0, . . . , N₂O₂ − 1 [symbol] | 0, 1, 2, 3 [symbol] | 0, 1 [symbol] | Wᵢ_{_{1,1}}_{,i} [symbol] ₊ₖ_{₁}_{,i}_{_{1,2}}_{,i}_{_{1,2}}₊ₖ_{₂}_{,i}_{_{1,4}}_{,i}_{₂}⁽⁴⁾ [symbol] |

where
${W}_{l , {l}^{′} , m , {m}^{′} , p , n}^{( 4 )} = \frac{1}{\sqrt{4}} [ \begin{matrix}\text{?} & \text{?} & \text{?} & \text{?}\end{matrix} ]$ [symbol] indicates data missing or illegible when filed

In some embodiments, N_{g} may equal to 2, N₁ may equal to 2, N₂ equals to 1, O₁ may equal to 2 or 4, i_{1,3} may be 0, and i_{1,1} may be one of {0, . . . N1O1−1} or {0, 2, 4, 6} or {0, 4} or {0,2} or {0,1} or 0, or i_{1,4,1} may be one of {0, 1, 2, 3} or {0,2} or 0. In some embodiments, the third subset of precoding matrixes corresponding to 4 layers, e.g. “Set_f4_3” may comprise 64 precoding matrixes. In some embodiments, the third subset of precoding matrixes “Set_f4_3” may comprise 32 precoding matrixes. The third subset of precoding matrixes “Set_f4_3” may comprise 16 precoding matrixes. In some embodiments, the third subset of precoding matrixes “Set_f4_3” may comprise 8 precoding matrixes. Alternatively, the third subset of precoding matrixes “Set_f4_3” may comprise 4 precoding matrixes. In other embodiments, the third subset of precoding matrixes “Set_f4_3” may comprise 2 precoding matrixes.

In some embodiments, the fourth subset of full coherent precoding matrix corresponding to 4 layers may be shown as Table 32 below.

TABLE 32

| i_{1,1} [symbol] | i_{1,1} [symbol] | i_{1,4,q}, q = 1, 2 [symbol] | i_{2,q}, q = 0, 1, 2 [symbol] | [symbol] |
|---|---|---|---|---|
| 0, . . . , N₁O₁ − 1 [symbol] | 0, . . . , N₂O₂ − 1 [symbol] | 0, 1, 2, 3 [symbol] | 0, 1 [symbol] | Wᵢ_{_{1,1}}_{,i}_{_{1,1}}₊ₖ_{₁}_{,i}_{_{1,2}}_{,i}_{_{1,2}}₊ₖ_{₂}_{,i}_{_{1,4}}_{,i}_{₂}⁽⁴⁾ [symbol] |

where
${W}_{l , {l}^{′} , {l}^{″} , m , {m}^{′} , {m}^{″} , n}^{( 5 )} = \frac{1}{\sqrt{4 * P}} [ \begin{matrix}{v}_{l , m} & {v}_{{l}^{′} , {m}^{′}} & {v}_{l , m} & {v}_{{l}^{′} , {m}^{′}} \\ {φ}_{n} * {v}_{l , m} & {φ}_{n} * {v}_{{l}^{′} , {m}^{′}} & - {φ}_{n} * {v}_{l , m} & - {φ}_{n} * {v}_{{l}^{′} , {m}^{′}}\end{matrix} ] .$

In some embodiments, N_{g} may equal to 2, N₁ may equal to 2, N₂ equals to 1, O₁ may equal to 2 or 4, i_{1,3} may be 0, and i_{1,1} may be one of {0, . . . N₁O₁−1} or {0, 2, 4, 6} or {0, 4} or {0, 2} or {0, 1}, or i_{1,4,q} may be one of {0, 1, 2, 3} or {0,2} or 0, where q may be 0 or 1. In some embodiments, the fourth subset of precoding matrixes corresponding to 4 layers, e.g. “Set_f4_4” may comprise 256 precoding matrixes. In some embodiments, the fourth subset of precoding matrixes “Set_f4_4” may comprise 128 precoding matrixes. In some embodiments, the fourth subset of precoding matrixes “Set_f4_4” may comprise 64 precoding matrixes. In some embodiments, the fourth subset of precoding matrixes “Set_f4_4” may comprise 32 precoding matrixes. The fourth subset of precoding matrixes “Set_f4_4” may comprise 16 precoding matrixes. In some embodiments, the fourth subset of precoding matrixes “Set_f4_4” may comprise 8 precoding matrixes. Alternatively, the fourth subset of precoding matrixes “Set_f4_4” may comprise 4 precoding matrixes. In other embodiments, the fourth subset of precoding matrixes “Set_f4_4” may comprise 2 precoding matrixes.

In some embodiments, if the terminal device 110-1 is indicated with the number of layers is indicated as 4, there may be a third set of precoding matrixes (e.g. a third set of partial coherent precoding matrixes) corresponding to 4 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p4_2”, and the size of a precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 4 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 1 or 2 columns or rows out of the 4 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 4 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 or 2 columns or rows out of the 4 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two out of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 4. In some embodiments, there may be the first set and the second set, and each set with 2 columns or rows. In some embodiments, there may be the first set, the second set and the third set, and each of two of the three sets with 2 columns or rows, and one of the three sets with 1 column or row. In some embodiments, there may be the first set, the second set, the third set and the fourth set, and each set with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 4 layers, e.g. Set_p4_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. For example, Table 33 below shows example of the set of length-2 vectors. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

TABLE 33

[1; 1], [1; −1], [1; j], [1; −j]

In some embodiments, examples of a precoding matrix of the third set of precoding matrixes corresponding to 4 layers may be as.

$$\frac{1}{\sqrt{{s}_{4}}} [ \begin{matrix}a 1 & b 1 & 0 & 0 \\ a 2 & b 2 & 0 & 0 \\ 0 & 0 & c 1 & d 1 \\ 0 & 0 & c 2 & d 2 \\ 0 & 0 & 0 & 0 \\ 0 & 0 & 0 & 0 \\ 0 & 0 & 0 & 0 \\ 0 & 0 & 0 & 0\end{matrix} ] or \frac{1}{\sqrt{{s}_{4}}} [ \begin{matrix}a 1 & b 1 & 0 & 0 \\ a 2 & b 2 & 0 & 0 \\ 0 & 0 & c 1 & 0 \\ 0 & 0 & c 2 & 0 \\ 0 & 0 & 0 & d 1 \\ 0 & 0 & 0 & d 2 \\ 0 & 0 & 0 & 0 \\ 0 & 0 & 0 & 0\end{matrix} ] or \\ \frac{1}{\sqrt{{s}_{4}}} [ \begin{matrix}a 1 & 0 & 0 & 0 \\ a 2 & 0 & 0 & 0 \\ 0 & b 1 & 0 & 0 \\ 0 & b 2 & 0 & 0 \\ 0 & 0 & c 1 & 0 \\ 0 & 0 & c 2 & 0 \\ 0 & 0 & 0 & d 1 \\ 0 & 0 & 0 & d 2\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [a1, a2], [b1, b2], [c1, c2],[d1, d2] may be any one of [1; 1], [1; −1], [1; j], [1; −j].

In some embodiments, if the terminal device 110-1 is indicated with the number of layers is indicated as 4, there may be a fourth set of precoding matrixes (e.g. a fourth set of non-coherent precoding matrixes) corresponding to 4 layers. For example, each one of 8 antenna ports may be non-coherent with each other. In some embodiments, there may be a fourth set of precoding matrixes (e.g. a fourth set of non-coherent precoding matrixes), for example, represented as “Set_n4_1”, and the size of a precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 4 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4 for the first, second, third, fourth column or row of the precoding matrix, respectively, and for each one of idx_1, idx_2, idx_3, idx_4, the value may be 1 value out of {0,1,2,3,4,5,6,7} or {1,2,3,4,5,6,7,8}. For example, the value of idx_1, idx_2, idx_3, idx_4 may be {0, 1, 2, 3} or {0,2,4,6} or {4,5,6,7} or {1,3,5,7}, respectively. For another example, the value of idx_1, idx_2, idx_3, idx_4 may be {1, 2, 3, 4} or {5,6,7,8} or {1,3,5,7} or {2,4,6,8}, respectively. For example, the value of idx_1, idx_2, idx_3, idx_4 may be different from each other. In some embodiments, the values of idx_1, idx_2, idx_3, idx_4 may be based on the indexes of the 4 antenna ports in the first group or the second group.

In some embodiments, if the terminal device 110-1 is indicated with number of layers as 4 there may be a fourth set of precoding matrixes corresponding to 4 layers. For example, there may be one or two or four precoding matrixes in the fourth set (e.g. non-coherent precoding matrix) corresponding to 4 layers. In some embodiments, Table 34 shows an example non-coherent precoding matrix.

TABLE 34

| | | |
|---|---|---|
| $\frac{1}{\sqrt{{s}_{4}}} [ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ]$ | or | $\frac{1}{\sqrt{{s}_{4}}} [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ]$ |

For example, s₄=8.

In some embodiments, if there are 4 layers at the terminal device 110-1, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 1, 2, or 3) columns may be mapped with length-4 vectors, and 4−r1 column may be mapped with length-2 vectors, and with ports swapped. Table 35 shows example mixed partial coherent precoding matrixes Set_p4_3, where rows can be swapped.

TABLE 35

| | | | | | | |
|---|---|---|---|---|---|---|
| $[ \begin{matrix}a 1 & b 1 & 0 & 0 \\ a 2 & b 2 & 0 & 0 \\ a 3 & b 3 & 0 & 0 \\ a 4 & b 4 & 0 & 0 \\ 0 & 0 & c 1 & 0 \\ 0 & 0 & c 2 & 0 \\ 0 & 0 & 0 & d 1 \\ 0 & 0 & 0 & d 2\end{matrix} ]$ | or | $[ \begin{matrix}a 1 & b 1 & 0 & 0 \\ a 2 & b 2 & 0 & 0 \\ a 3 & b 3 & 0 & 0 \\ a 4 & b 4 & 0 & 0 \\ 0 & 0 & c 1 & d 1 \\ 0 & 0 & c 2 & d 2 \\ 0 & 0 & 0 & 0 \\ 0 & 0 & 0 & 0\end{matrix} ]$ | or | $[ \begin{matrix}a 1 & b 1 & c 1 & 0 \\ a 2 & b 2 & c 2 & 0 \\ a 3 & b 3 & c 3 & 0 \\ a 4 & b 4 & c 4 & 0 \\ 0 & 0 & 0 & d 1 \\ 0 & 0 & 0 & d 2 \\ 0 & 0 & 0 & 0 \\ 0 & 0 & 0 & 0\end{matrix} ]$ | or | $[ \begin{matrix}a 1 & 0 & 0 & 0 \\ a 2 & 0 & 0 & 0 \\ a 3 & 0 & 0 & 0 \\ a 4 & 0 & 0 & 0 \\ 0 & b 1 & c 1 & 0 \\ 0 & b 2 & c 2 & 0 \\ 0 & 0 & 0 & d 1 \\ 0 & 0 & 0 & d 2\end{matrix} ]$ |

In other embodiments, the antenna structure may be 4+1+1+1+1, which means that 4 antenna ports can be coherent. In this case, r1 (for example, 1 or 2 or 3) columns may be with length-4 vectors, 4-r1 columns may be with 1 on one element, and rows can be swap. Table 36 shows an example mixed partial coherent precoding matrix Set_p4_4, where rows can be swapped.

TABLE 36

| | | | | |
|---|---|---|---|---|
| $[ \begin{matrix}a 1 & b 1 & 0 & 0 \\ a 2 & b 2 & 0 & 0 \\ a 3 & b 3 & 0 & 0 \\ a 4 & b 4 & 0 & 0 \\ 0 & 0 & 1 & 0 \\ 0 & 0 & 0 & 1 \\ 0 & 0 & 0 & 0 \\ 0 & 0 & 0 & 0\end{matrix} ]$ | or | $[ \begin{matrix}a 1 & b 1 & c 1 & 0 \\ a 2 & b 2 & c 2 & 0 \\ a 3 & b 3 & c 3 & 0 \\ a 4 & b 4 & c 4 & 0 \\ 0 & 0 & 0 & 1 \\ 0 & 0 & 0 & 0 \\ 0 & 0 & 0 & 0 \\ 0 & 0 & 0 & 0\end{matrix} ]$ | or | $[ \begin{matrix}a 1 & 0 & 0 & 0 \\ a 2 & 0 & 0 & 0 \\ a 3 & 0 & 0 & 0 \\ a 4 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ]$ |

In some embodiments, the antenna structure may be 4±2±1±1, which means that 4 antenna ports can be coherent and 2 antenna ports can be coherent. For example, r1 (for example, 1 or 2) columns may be with length-4 vectors, and r2 (for example, 1 or 2) columns may be with length-2 vectors, and 4-r1-r2 columns may be with 1 on one element. Table 37 shows an example mixed partial coherent precoding matrix Set_p4_5, where rows can be swapped.

TABLE 37

| | | | | |
|---|---|---|---|---|
| $[ \begin{matrix}a 1 & 0 & 0 & 0 \\ a 2 & 0 & 0 & 0 \\ a 3 & 0 & 0 & 0 \\ a 4 & 0 & 0 & 0 \\ 0 & b 1 & c 1 & 0 \\ 0 & b 2 & c 2 & 0 \\ 0 & 0 & 0 & 1 \\ 0 & 0 & 0 & 0\end{matrix} ]$ | or | $[ \begin{matrix}a 1 & 0 & 0 & 0 \\ a 2 & 0 & 0 & 0 \\ a 3 & 0 & 0 & 0 \\ a 4 & 0 & 0 & 0 \\ 0 & b 1 & 0 & 0 \\ 0 & b 2 & 0 & 0 \\ 0 & 0 & 1 & 0 \\ 0 & 0 & 0 & 1\end{matrix} ]$ | or | $[ \begin{matrix}a 1 & b 1 & 0 & 0 \\ a 2 & b 2 & 0 & 0 \\ a 3 & b 3 & 0 & 0 \\ a 4 & b 4 & 0 & 0 \\ 0 & 0 & c 1 & 0 \\ 0 & 0 & c 2 & 0 \\ 0 & 0 & 0 & 1 \\ 0 & 0 & 0 & 0\end{matrix} ]$ |

In some other embodiments, the antenna structure may be 2+2+1+1+1+1, which means that 2 antenna ports can be coherent and 2 antenna ports can be coherent. For example, r1 (for example, 1 or 2 or 3) columns may be with length-2 vectors, and 4−r1 columns may be with 1 on one element. Table 38 shows an example mixed partial coherent precoding matrix Set_45_6, where rows can be swapped. In some other embodiments, the antenna structure may be 2+1+1±1±1±1±1. Alternatively, the antenna structure may be 2±2±2±1+1.

TABLE 38

| | | | | |
|---|---|---|---|---|
| $[ \begin{matrix}a 1 & b 1 & 0 & 0 \\ a 2 & b 2 & 0 & 0 \\ 0 & 0 & c 1 & 0 \\ 0 & 0 & c 2 & 0 \\ 0 & 0 & 0 & 1 \\ 0 & 0 & 0 & 0 \\ 0 & 0 & 0 & 0 \\ 0 & 0 & 0 & 0\end{matrix} ]$ | or | $[ \begin{matrix}a 1 & b 1 & 0 & 0 \\ a 2 & b 2 & 0 & 0 \\ 0 & 0 & 0 & 0 \\ 0 & 0 & 0 & 0 \\ 0 & 0 & 1 & 0 \\ 0 & 0 & 0 & 1 \\ 0 & 0 & 0 & 0 \\ 0 & 0 & 0 & 0\end{matrix} ]$ | or | $[ \begin{matrix}a 1 & 0 & 0 & 0 \\ a 2 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ]$ |

In some embodiments, the terminal device 110-1 is indicated with the number of layers as 3, there may be a first set of precoding matrixes corresponding to 3 layers (e.g. a first set of full coherent precoding matrixes). In some embodiments, a full coherent precoding matrix may be represented as W_{l,l′,m,m′,n}⁽³⁾.

In some embodiments, W_{l,l′,m,m′,n}⁽³⁾ may be

$$\frac{1}{\sqrt{3 * P}} [ \begin{matrix}{v}_{l , m} & {v}_{{l}^{′} , {m}^{′}} & {v}_{l , m} \\ {φ}_{n} * {v}_{l , m} & {φ}_{n} * {v}_{{l}^{′} , {m}^{′}} & - {φ}_{n} * {v}_{l , m}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, O₁, 2O₁, 3O₁}. For another example, k₁ may be 0. In some embodiments, k₂ may be a non-negative integer. For example, k₂ may at least one of {0, O₂}. In some embodiments, k₂ may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1,2,3}. For another example, i_{1,3} may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=O₁ and/or k₂=0. In some embodiments, in case of N₁=4 and N₂=1, and in case of i_{1,3}=2, k₁=2O₁ and/or k₂=0. In some embodiments, in case of N₁=4 and N₂=1, and in case of i_{1,3}=3, k₁=3O₁ and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=O₁ and/or k₂=0.

In some embodiments, there may be more than one subset of precoding matrixes corresponding to 3 layers. In some embodiments, the first set of precoding matrixes corresponding to 3 layers may comprise more than one subset. For example, there may be two or three or four subsets of precoding matrixes.

In some embodiments, there may be a first subset of precoding matrixes corresponding to 3 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 3 layers may be 128 or 64 or 32 or 16 or 8 or 4 or 2.

In some embodiments, there may be a second subset of precoding matrixes corresponding to 3 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 3 layers may be 256 or 128 or 32 or 16 or 8 or 4 or 2.

In some embodiments, if the terminal device 110-1 is indicated with the number of layers as 3, there may be a third subset of precoding matrixes. In some embodiments, In some embodiments, there may be a third vector W_{l,m,p,n}^{1,2,1}. In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, there may be a fourth vector W_{l,m,p,n}^{2,2,1}. In some embodiments,

$${W}_{l , m , p , n}^{2 , 2 , 1} = \frac{1}{\sqrt{8}} [ {v}_{l , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of kᵢ and/or k₂ may be based on the value of i_{1,3}, and i_{1,3} may be a non-negative integer. For example, i_{1,3} may be at least one of {0,1}. For another example, i_{1,3} may be 0. In some embodiments, in case of N₁=2 and N₂=1, and in case of i_{1,3}=0, k₁=O₁ and/or k₂=0.

In some embodiments, there may be a third subset of precoding matrixes corresponding to 3 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 3 layers may be 64 or 32 or 16 or 8 or 4 or 2.

In some embodiments, the terminal device 110-1 may be indicated with the number of layers as 3, a precoding matrix in the third subset of precoding matrixes corresponding to 3 layers may be represented as W_{l,l′,m,m′,p,n}⁽³⁾. In some embodiments, W_{l,l′,m,m′,p,n}⁽³⁾ may be

$$\frac{1}{\sqrt{3}} [ {W}_{l , m , p , n}^{1 , 2 , 1} {W}_{{l}^{′} , {m}^{′} , p , n}^{1 , 2 , 1} {W}_{l , m , p , n}^{2 , 2 , 1} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p₁.

In some embodiments, if the terminal device 110-1 is indicated with the number of layers as 3, there may be a fourth subset of precoding matrixes. In some embodiments, In some embodiments, there may be a fifth vector W_{l,m,p,n}^{1,2,2}. In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments, there may be a sixth vector W_{l,m,p,n}^{2,2,2}. In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 3 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 3 is layers may be 64 or 32 or 16 or 8 or 4 or 2.

In some embodiments, the terminal device 110-1 may be indicated with the number of layers as 3, a precoding matrix in the fourth subset of precoding matrixes corresponding to 3 layers may be represented as W_{l,l′,m,m′,p,n}⁽³⁾. In some embodiments, W_{l,l′,m,m′,p,n}⁽³⁾ may be

$$\frac{1}{\sqrt{3}} [ {W}_{l , m , p , n}^{1 , 2 , 2} {W}_{{l}^{′} , {m}^{′} , p , n}^{1 , 2 , 2} {W}_{l , m , p , n}^{2 , 2 , 2} ] .$$

In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110-1 is indicated with the number of layers is indicated as 3, there may be a second set of precoding matrixes corresponding to 3 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 3 layers, for example, represented as “Set_p3_1”, and the size of a partial coherent precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C3 columns or rows out of the 3 columns or rows (e.g. a first set of C3 columns or rows. For example, C3 may be 1 or 2 or 3) in the precoding matrix, and in each column, the non-zero value may be mapped on 4 out of 8 elements and 0 for the other 4 elements. For example, the indexes of the 4 elements with non-zero values may be same in the first set of C3 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or the second group. For example, idx_1 may be {0,1,2,3} or {0,2,4,6} or {1,2,3,4} or {1,3,5,7}. In some embodiments, for the other 3-C3 column, 3-C3 of the first set or second set of length-4 vectors may be selected. In some embodiments, for the other 3-C3 columns or rows out of the 3 columns or rows (e.g. a second set of 3-C3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3-C3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group or the second group. For example, idx_2 may be {4,5,6,7} or {1,3,5,7} or {5,6,7,8} or {2,4,6,8}. In some embodiments, any value of idx_1 may be different from any value of idx_2. In some embodiments, C3 may be 3 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments,

In some embodiments, examples of a precoding matrix of the second set of precoding matrixes corresponding to 3 layers may be as:

$$\frac{1}{\sqrt{{s}_{3}}} [ \begin{matrix}a 1 & b 1 & c 1 \\ a 2 & b 2 & c 2 \\ a 3 & b 3 & c 3 \\ a 4 & b 4 & c 4 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}a 1 & b 1 & 0 \\ a 2 & b 2 & 0 \\ a 3 & b 3 & 0 \\ a 4 & b 4 & 0 \\ 0 & 0 & c 1 \\ 0 & 0 & c 2 \\ 0 & 0 & c 3 \\ 0 & 0 & c 4\end{matrix} ] or \frac{1}{\sqrt{{s}_{3}}} [ \begin{matrix}a 1 & 0 & 0 \\ a 2 & 0 & 0 \\ a 3 & 0 & 0 \\ a 4 & 0 & 0 \\ 0 & b 1 & c 1 \\ 0 & b 2 & c 2 \\ 0 & b 3 & c 3 \\ 0 & b 4 & c 4\end{matrix} ]$$

For example, rows or columns can be swapped. For example, rows or columns can be swapped. For example, each of [a1, a2, a3, a4], [b1, b2, b3, b4], [c1, c2, c3, c4] may be one of the length-4 vectors in the first set of length-4 vectors or in the second set of length-4 vectors. For example, [a1, a2, a3, a4], [b1, b2, b3, b4], [c1, c2, c3, c4] may be three out of [1; 1; 1; 1], [1; −1; 1; −1], [1;1;−1;−1] and [1;−1;−1;1]. For another example, [a1, a2, a3, a4], [b1, b2, b3, b4], [c1, c2, c3, c4] may be three out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, [a1, a2, a3, a4], [b1, b2, b3, b4], may be two vectors out of [1; 1; 1; 1], [1; −1; 1; −1], [1;1;−1;−1] and [1;−1;−1;1]. For another example, [a1, a2, a3, a4], [b1, b2, b3, b4], may be two of [1; 1; j; j], [1; −1; j; −j], [1; 1; −j; −j] and [1; −1; −j; j]. For example, [c1, c2, c3, c4] may be 1 vector out of [1; 1; 1; 1], [1; −1; 1; −1], [1;1;−1;−1] and [1;−1;−1;1]. For another example, [c1, c2, c3, c4] may be 1 vector out of [1; 1; j; j], [1; −1; j; −j], [1; 1; −j; −j] and [1; −1; −j; j].

In some embodiments, s₃ may a positive integer. For example, 1<s₃<64. For example, s₃ may be 64 or 32 or 16 or 8 or 4 or 2 or 24 or 12 or 6 or 3.

In some embodiments, if the terminal device 110-1 is indicated with the number of layers is indicated as 3, there may be a third set of precoding matrixes (e.g. a third set of partial coherent precoding matrixes) corresponding to 3 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p3_2”, and the size of a precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 3 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group or fourth group or fifth group or sixth group. For example, idx_1 may be {0,1} or {0, 2} or {1, 2} or {1, 3} or {0, 4} or {1, 5}. In some embodiments, there may be 1 or 2 columns or rows out of the 3 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of two out of the 4 antenna ports in the first group or second group. In some embodiments, the 2 values of idx_2 may be based on the indexes of the 2 antenna ports in the third group or fourth group or fifth group or sixth group. For example, idx_2 may be {2,3} or {1,3} or {3,4} or {2,4} or {1,5} or {2,6}. In some embodiments, there may be 1 or 2 columns or rows out of the 3 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. For example, idx_3 may be {4,5} or {4,6} or {5,6} or {5,7} or {2,6} or {3,7}. In some embodiments, the 2 values of idx_3 may be based on the indexes of two out of the 4 antenna ports in the first group or second group. In some embodiments, the 2 values of idx_3 may be based on the indexes of the 2 antenna ports in the third group or fourth group or fifth group or sixth group. In some embodiments, there may be 1 or 2 columns or rows out of the 3 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two out of the 4 antenna ports in the first group or second group. In some embodiments, the 2 values of idx_4 may be based on the indexes of the 2 antenna ports in the third group or fourth group or fifth group or sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, there may be three out of the first set and the second set and the third set and the fourth set. In some embodiments, the total number of columns or rows in the first set and/or the second set and/or the third set and/or the fourth set may be 3. In some embodiments, there may be two out of the four sets, and one set with 2 columns or rows, and the other set with 1 column or row. In some embodiments, there may be three of the four sets, and each set with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 3 layers, e.g. Set_p3_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 3 layers may be as:

$$\frac{1}{\sqrt{{s}_{3}}} [ \begin{matrix}a 1 & b 1 & 0 \\ a 2 & b 2 & 0 \\ 0 & 0 & c 1 \\ 0 & 0 & c 2 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}a 1 & 0 & 0 \\ a 2 & 0 & 0 \\ 0 & b 1 & 0 \\ 0 & b 2 & 0 \\ 0 & 0 & c 1 \\ 0 & 0 & c 2 \\ 0 & 0 & 0 \\ 0 & 0 & 0\end{matrix} ] or \frac{1}{\sqrt{{s}_{3}}} [ \begin{matrix}0 & 0 & 0 \\ 0 & 0 & 0 \\ 0 & 0 & 0 \\ 0 & 0 & 0 \\ a 1 & b 1 & 0 \\ a 2 & b 2 & 0 \\ 0 & 0 & c 1 \\ 0 & 0 & c 2\end{matrix} ]$$

For example, rows or columns can be swapped. For example, each of [a1, a2], [b1, b2], [c1, c2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [a1, a2], [b1, b2], [c1, c2] may be any one of [1; 1], [1; −1], [1; j], [1; −j].

In some embodiments, if the terminal device 110-1 is indicated with the number of layers is indicated as 3, there may be a fourth set of precoding matrixes (e.g. a fourth set of non-coherent precoding matrixes) corresponding to 3 layers. For example, each one of 8 antenna ports may be non-coherent with each other. In some embodiments, there may be a fourth set of precoding matrixes (e.g. a fourth set of non-coherent precoding matrixes), for example, represented as “Set_n3_1”, and the size of a precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 3 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3 for the first, second, third column or row of the precoding matrix, respectively, and for each one of idx_1, idx_2, idx_3, the value may be 1 value out of {0,1,2,3,4,5,6,7} or {1,2,3,4,5,6,7,8}. In some embodiments, the values of idx_1, idx_2 and idx_3 may be based on the indexes of three out of the 4 antenna ports in the first group or second group. In some embodiments, the values of idx_1, idx_2 and idx_3 may be based on the indexes of the 2 antenna ports in the third group or fourth group or fifth group or sixth group and based on an index of one out of 2 antenna ports in the third group or fourth group or fifth group. For example, the value of idx_1, idx_2, idx_3 may be one value out of {0, 1, 2, 3} or {0,2,4,6} or {4,5,6,7} or {1,3,5,7}, respectively. For another example, the value of idx_1, idx_2, idx_3 may be one value out of {1, 2, 3, 4} or {5,6,7,8} or {1,3,5,7} or {2,4,6,8}, respectively. For example, the value of idx_1, idx_2, idx_3 may be different from each other.

In some embodiments, if the terminal device 110-1 is indicated with number of layers as 3 there may be a fourth set of precoding matrixes corresponding to 3 layers. For example, there may be one or two or four precoding matrixes in the fourth set (e.g. non-coherent precoding matrix) corresponding to 3 layers. For example, a precoding matrix in the fourth set of precoding matrixes corresponding to 3 layers may be

$$\frac{1}{\sqrt{{s}_{3}}} [ \begin{matrix}1 & 0 & 0 \\ 0 & 1 & 0 \\ 0 & 0 & 1 \\ 0 & 0 & 0 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}0 & 0 & 0 \\ 0 & 0 & 0 \\ 0 & 0 & 0 \\ 0 & 0 & 0 \\ 1 & 0 & 0 \\ 0 & 1 & 0 \\ 0 & 0 & 1 \\ 0 & 0 & 0\end{matrix} ] .$$

In some embodiments, if the terminal device 110-1 is indicated with the number of layers as 3, the precoding matrixes may be shown as Table 39 below.

TABLE 39

| Precoding Matrix | | | | | Description |
|---|---|---|---|---|---|
| ▪ | i_{1,1} [symbol] | i_{1,2} [symbol] | i₂ [symbol] | [symbol] | Full-coherent |
| ▪ | 0, . . . , N₁O₁ −1 [symbol] | 0,1, . . . , N₂O₂ −1 [symbol] | 0,1 [symbol] | W [symbol] [symbol] | Set_f3_1 (N1 = 4, N2 = |

| ${W}_{l , {l}^{′} , m , {m}^{′} , n}^{( 3 )} = \frac{1}{\sqrt{3 * P}} [ \begin{matrix}{v}_{l , m} \\ {φ}_{n} * {v}_{l , m}\end{matrix} \begin{matrix}{v}_{{l}^{′} , {m}^{′}} \\ {φ}_{n} * {v}_{{l}^{′} , {m}^{′}}\end{matrix} \begin{matrix}{v}_{l , m} \\ - {φ}_{n} * {v}_{l , m}\end{matrix} ]$ | | | | 1, O1 = 2, O2 = 1, i1,3 = 0, il,1 = {0, . . . N1O1-1} or {0, 2, 4, 6}) (number of precoders: 16 or 8) |
|---|---|---|---|---|
| | | | | Set_f3_2 (N1 = 2, |
| | | | | N2 = 2, O1 = 2, |
| | | | | O2 = 2, i1,3 = 0, i1,1/i1,2 = |
| | | | | {0, ... 3} or {0, 2}) (number |
| | | | | of precoders: 32 or 8) |
| $[ \begin{matrix}1 & 1 & 1 \\ 1 & - 1 & 1 \\ 1 & 1 & - 1 \\ 1 & - 1 & - 1\end{matrix} ]$ | $[ \begin{matrix}1 & 1 & 1 \\ 1 & - 1 & 1 \\ j & j & - j \\ j & - j & - j\end{matrix} ]$ | $[ \begin{matrix}1 & 1 & 1 \\ - 1 & 1 & - 1 \\ 1 & 1 & - 1 \\ - 1 & 1 & 1\end{matrix} ]$ | $[ \begin{matrix}1 & 1 & 1 \\ - 1 & 1 & - 1 \\ j & j & - j \\ - j & j & j\end{matrix} ]$ | Partial-coherent (4 out of 8 elements with non-zero value) Set_p3_1 (4-port full-coherent precoder) mapping on 4 out of 8 elements, and 0 for other 4 |

| | | | | | | elements (number of precoders: |
|---|---|---|---|---|---|---|
| | | | | | | 4*C(8,4) = 280), with/with- |
| | | | | | | out ports swapped |
| [1;1], [1; -1], [1;j], [1; -j] | | | | | | Partial-coherent (2 out of 8 |
| | | | | | | elements with non-zero value, |
| | | | | | | 4-port partial coherent precoders) |
| | | | | | | Set_p3_2 The non-zero value |
| | | | | | | mapping on 2 out of 8 elements, |
| | | | | | | and 0 for other elements (with |
| | | | | | | ports swapped) |
| ▪ | i_{1,1} [symbol] | i_{1,2} [symbol] | i_{1,4,q} , q = 1, . . . ,N_{g} −1 [symbol] | i₂ [symbol] | [symbol] | Full-coherent |
| ▪ | 0, . . . , N₁O₁ −1 [symbol] | 0, . . . , N₂O₂ −1 [symbol] | 0,1,2,3 [symbol] | 0,1 [symbol] | W [symbol] ⁽³⁾ [symbol] | Set_f3_3 (Ng = 2, N1 = 2, |

| | | | | | | N2 = 1, O1 = 2 or 4, i1,3 = 0, |
|---|---|---|---|---|---|---|
| ▪ | $where {W}_{\text{?}}^{\text{?}} = \frac{1}{\sqrt{3}} {W}_{\text{?}}^{\text{?}} {W}_{\text{?}}^{\text{?}} {W}_{\text{?}}^{\text{?}}$ | | | | | il,1 = {0, ... N1O1-1} or {0, 2, 4, 6} or {0, 4} or {0,2} or {0,1} or 0; i1,4,1 = |
| | | | | | | {0, 1, 2, 3} or {0,2} or 0) |
| | | | | | | (number of precoders: 64 |
| | | | | | | or 32 or 16 or 8 or 4 or 2) |
| ▪ | i_{1,1} [symbol] | i_{1,2} [symbol] | i_{1,4,q}, q = 1,2 [symbol] | i_{2,q}, q = 0, 1, 2 [symbol] | [symbol] | Full-coherent |
| | 0, . . . ,N₁O₁−1 [symbol] | 0, . . . , N₂O₂−1 [symbol] | 0,1,2,3 [symbol] | 0,1 [symbol] | W [symbol] ⁽³⁾ [symbol] | Set_f3_4 (Ng = 2, N1 = 2, |

| $where {W}_{\text{?}}^{\text{?}} = \frac{1}{\sqrt{3}} [ {W}_{\text{?}}^{\text{?}} {W}_{\text{?}}^{\text{?}} {W}_{\text{?}}^{\text{?}} ]$ | | | N2 = 1, O1 = 2 or 4, i1,3 = 0, il,1 = {0, . . . N1O1-1} or {0, 2, 4, 6} or {0, 4} or |
|---|---|---|---|
| | | | {0,2} or {0,1} or 0; i1,4,q = |
| | | | {0, 1, 2, 3} or {0,2} or 0; |
| | | | i2,q = 0,1) (number of |
| | | | precoders: 256 or 128 or 64 |
| | | | or 32 or 16 or 8 or 4 or 2) |
| | $[ \begin{matrix}1 & 0 & 0 \\ 0 & 1 & 0 \\ 1 & 0 & 0 \\ 0 & 0 & 1\end{matrix} ]$ | $⌈ \begin{matrix}1 & 0 & 0 \\ 0 & 1 & 0 \\ - 1 & 0 & 0 \\ 0 & 0 & 1\end{matrix} ⌉$ | Partial-coherent (1 or 2 out of 8 elements with non-zero value, 4-port partial coherent precoders) Set_p3_3 |

The non-zero value mapping
on 1 or 2 out of 8 elements,
and 0 for other elements
(with ports swapped, number
of precoders: 2*C(8,2)*C
(7,1)*C(6,1) = 2352)
Non-coherent (in each
column, 1 out of 8
elements with value
1, 0 for other 7 elements)
(number of precoders:
C(8,1)*C(7,1)*C(6,1)=
336) Set_n3_1

[symbol]

indicates data missing or illegible when filed

In some embodiments, the terminal device 110-1 is indicated with the number of layers as 2, there may be a first set of precoding matrixes corresponding to 2 layers (e.g. a first set of full coherent precoding matrixes). In some embodiments, a full coherent precoding matrix may be represented as W_{l,l′,m,m′,n}⁽²⁾.

In some embodiments, W_{l,l′,m,m′,n}⁽²⁾ may be

$$\frac{1}{\sqrt{2 * P}} [ \begin{matrix}{v}_{l , m} & {v}_{{l}^{′} , {m}^{′}} \\ {φ}_{n} * {v}_{l , m} & - {φ}_{n} * {v}_{{l}^{′} , {m}^{′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, O₁, 2O₁, 3O₁}. For another example, k₁ may be 0. In some embodiments, k₂ may be a non-negative integer. For example, k₂ may at least one of {0, O₂}. In some embodiments, k₂ may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1,2,3}. For another example, i_{1,3} may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=O₁ and/or k₂=0. In some embodiments, in case of N₁=4 and N₂=1, and in case of i_{1,3}=2, k₁=2O₁ and/or k₂=0. In some embodiments, in case of N₁=4 and N₂=1, and in case of i_{1,3}=3, k₁=3O₁ and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=O₁ and/or k₂=0.

In some embodiments, there may be more than one subset of precoding matrixes corresponding to 2 layers. In some embodiments, the first set of precoding matrixes corresponding to 2 layers may comprise more than one subset. For example, there may be two or three or four subsets of precoding matrixes.

In some embodiments, there may be a first subset of precoding matrixes corresponding to 2 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{{1}^{N} 1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 2 layers may be 128 or 64 or 32 or 16 or 8 or 4 or 2.

In some embodiments, there may be a second subset of precoding matrixes corresponding to 2 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{{O}_{1}}_{} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 2 layers may be 256 or 128 or 32 or 16 or 8 or 4 or 2.

In some embodiments, if the terminal device 110-1 is indicated with the number of layers as 2, there may be a third subset of precoding matrixes. In some embodiments, In some embodiments, there may be a third vector W_{l,m,p,n}^{1,2,1}. In some embodiments,

$${W}_{l , m , p , n}^{1 , 2 , 1} = \frac{1}{\sqrt{8}} [ {v}_{1 , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, there may be a fourth vector W_{l,m,p,n}^{2,2,1}. In some embodiments,

$${W}_{l , m , p , n}^{2 , 2 , 1} = \frac{1}{\sqrt{8}} [ {v}_{l , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1}. For another example, i_{1,3} may be 0. In some embodiments, in case of N₁=2 and N₂=1, and in case of i_{1,3}=0, k₁=O₁ and/or k₂=0.

In some embodiments, there may be a third subset of precoding matrixes corresponding to 2 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 2 layers may be 64 or 32 or 16 or 8 or 4 or 2.

In some embodiments, the terminal device 110-1 may be indicated with the number of layers as 2, a precoding matrix in the third subset of precoding matrixes corresponding to 2 layers may be represented as W_{l,l′,m,m′,p,n}⁽²⁾. In some embodiments, W_{l,l′,m,m′,p,n}⁽²⁾ may be

$$\frac{1}{\sqrt{2}} [ \begin{matrix}{W}_{l , m , p , n}^{1 , 2 , 1} & {W}_{{l}^{′} , {m}^{′} , p , n}^{2 , 2 , 1}\end{matrix} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p₁.

In some embodiments, if the terminal device 110-1 is indicated with the number of layers as 2, there may be a fourth subset of precoding matrixes. In some embodiments, In some embodiments, there may be a fifth vector W_{l,m,p,n}^{1,2,2}. In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments, there may be a sixth vector W_{l,m,p,n}^{2,2,2}. In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 2 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, 1 may be 0 or 1. For another example, l may be 0 or 2. In some embodiments, the number of precoding matrixes in the fourth subset corresponding to 2 layers may be 64 or 32 or 16 or 8 or 4 or 2.

In some embodiments, the terminal device 110-1 may be indicated with the number of layers as 2, a precoding matrix in the fourth subset of precoding matrixes corresponding to 2 layers may be represented as W_{l,l′,m,m′,p,n}⁽²⁾. In some embodiments, W_{l,l′,m,m′,p,n}⁽²⁾ may be

$$\frac{1}{\sqrt{2}} [ \begin{matrix}{W}_{l , m , p , n}^{1 , 2 , 2} & {W}_{{l}^{′} , {m}^{′} , p , n}^{2 , 2 , 2}\end{matrix} ] .$$

In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110-1 is indicated with the number of layers is indicated as 2, there may be a second set of precoding matrixes corresponding to 2 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 2 layers, for example, represented as “Set_p2_1”, and the size of a partial coherent precoding matrix may be 2 multiplies 8 or 8 multiplies 2. In some embodiments, there may be 2 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C4 columns or rows out of the 2 columns or rows (e.g. a first set of C4 columns or rows. For example, C4=1 or 2) in the precoding matrix, and in each column, the non-zero value may be mapped on 4 out of 8 elements and 0 for the other 4 elements. For example, the indexes of the 4 elements with non-zero values may be same in the first set of C4 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or second group. For example, idx_1 may be {0,1,2,3} or {0,2,4,6} or {1,2,3,4} or {1,3,5,7}. In some embodiments, for the other 2-C4 column or row, 2-C4 of the first set or second set of length-4 vectors may be selected. In some embodiments, for the other 2-C4 columns or rows out of the 2 columns or rows (e.g. a second set of 2-C4 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 2-C4 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group or second group. For example, idx_2 may be {4,5,6,7} or {1,3,5,7} or {5,6,7,8} or {2,4,6,8}. In some embodiments, any value of idx_1 may be different from any value of idx_2. In some embodiments, C4 may be 2 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments,

In some embodiments, examples of a precoding matrix of the second set of precoding matrixes corresponding to 2 layers may be as:

$$\frac{1}{\sqrt{{s}_{2}}} [ \begin{matrix}a 1 & 0 \\ a 2 & 0 \\ a 3 & 0 \\ a 4 & 0 \\ 0 & b 1 \\ 0 & b 2 \\ 0 & b 3 \\ 0 & b 4\end{matrix} ] or \frac{1}{\sqrt{{s}_{2}}} [ \begin{matrix}a 1 & b 1 \\ a 2 & b 2 \\ a 3 & b 3 \\ a 4 & b 4 \\ 0 & 0 \\ 0 & 0 \\ 0 & 0 \\ 0 & 0\end{matrix} ]$$

For example, rows or columns can be swapped. For example, rows or columns can be swapped. For example, each of [a1, a2, a3, a4], [b1, b2, b3, b4] may be one of the length-4 vectors in the first set of length-4 vectors or in the second set of length-4 vectors. For example, [a1, a2, a3, a4], [b1, b2, b3, b4] may be two out of [1; 1; 1; 1], [L; −1; 1; −1], [1;1;−1;−1] and [1;−1;−1;1]. For another example, [a1, a2, a3, a4], [b1, b2, b3, b4] may be 5 two out of [1; 1; j; j], [1; −1;j; −j], [1; 1; −j; −j] and [1; −1; −j; j]. For example, each of [a1, a2, a3, a4], [b1, b2, b3, b4] may be one of the length-4 vectors in the first set of length-4 vectors or in the second set of length-4 vectors.

In some embodiments, s₂ may a positive integer. For example, 1≤s₂≤64. For example, s₂ may be 64 or 32 or 16 or 8 or 4 or 2.

In some embodiments, if the terminal device 110-1 is indicated with the number of layers as 2, there may be a third set of precoding matrixes (e.g. a third set of partial coherent precoding matrixes) corresponding to 2 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p2_2”, and the size of a precoding matrix may be 2 multiplies 8 or 8 multiplies 2. In some embodiments, there may be 2 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 2 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 1 or 2 values out of {0,1,2,3,4,5,6,7} or {1,2,3,4,5,6,7,8}. In some embodiments, the 2 values of idx_1 may be based on the indexes of two out of the 4 antenna ports in the first group or second group. In some embodiments, the 2 values of idx_1 may be based on the indexes of the 2 antenna ports in the third group or fourth group or fifth group or sixth group. For example, idx_1 may be {0,1} or {0, 2} or {1, 2} or {1, 3} or {0, 4} or {1, 5}. In some embodiments, there may be 1 or 2 columns or rows out of the 2 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 1 or 2 values out of {0,1,2,3,4,5,6,7} or {1,2,3,4,5,6,7,8}. In some embodiments, the 2 values of idx_2 may be based on the indexes of remaining two out of the 4 antenna ports in the first group or second group. In some embodiments, the 2 values of idx_2 may be based on the indexes of the 2 antenna ports in the third group or fourth group or fifth group or sixth group. For example, idx_2 may be {2,3} or {1,3} or {3,4} or {2,4} or {1,5} or {2,6}. In some embodiments, any value of idx_1 and any value of idx_2 may be different from each other. In some embodiments, the total number of columns or rows in the first set and/or the second set may be 2. In some embodiments, there may be the first set and the second set, and each set with 1 column or row. In some embodiments, there may be only one first set, and the first set with 2 columns or rows.

In some embodiments, there may be a set of 4 length-2 vectors, and each one of the length-2 vector may be applied as the two non-zero values in a column or row of the precoding matrix. In some embodiments, for the third set of precoding matrix corresponding to 2 layers, e.g. Set_p2_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 2 layers may be as:

$$\frac{1}{\sqrt{{s}_{2}}} [ \begin{matrix}a 1 & b 1 \\ a 2 & b 2 \\ 0 & 0 \\ 0 & 0 \\ 0 & 0 \\ 0 & 0 \\ 0 & 0 \\ 0 & 0\end{matrix} ] or \frac{1}{\sqrt{{s}_{2}}} [ \begin{matrix}a 1 & 0 \\ a 2 & 0 \\ 0 & b 1 \\ 0 & b 2 \\ 0 & 0 \\ 0 & 0 \\ 0 & 0 \\ 0 & 0\end{matrix} ]$$

For example, rows or columns can be swapped. For example, each of [a1, a2], [b1, b2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [a1, a2], [b1, b2] may be any one of [1, 1], [1; −1], [1; j], [1; −j].

In some embodiments, if the terminal device 110-1 is indicated with the number of layers is indicated as 2, there may be a fourth set of precoding matrixes (e.g. a fourth set of non-coherent precoding matrixes) corresponding to 2 layers. For example, each one of 8 antenna ports may be non-coherent with each other. In some embodiments, there may be a fourth set of precoding matrixes (e.g. a fourth set of non-coherent precoding matrixes), for example, represented as “Set_n2_1”, and the size of a precoding matrix may be 2 multiplies is 8 or 8 multiplies 2. In some embodiments, there may be 2 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 2 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2 for the first, second column or row of the precoding matrix, respectively, and for each one of idx_1, idx_2, the value may be 1 value out of {0,1,2,3,4,5,6,7} or {1,2,3,4,5,6,7,8}. In some embodiments, the values of idx_1 and idx_2 may be based on the indexes of two out of the 4 antenna ports in the first group or second group. In some embodiments, the values of idx_1 and idx_2 may be based on the indexes of the 2 antenna ports in the third group or fourth group or fifth group or sixth group. For example, the value of idx_1, idx_2 may be one value of {0, 1, 2, 3} or {0,2,4,6} or {4,5,6,7} or {1,3,5,7}, respectively. For another example, the value of idx_1, idx_2 may be {1, 2}{3, 4} or {5,6}, {7,8} or {1,3},{5,7} or {2,4}, {6,8}. For example, the value of idx_1, idx_2 may be different from each other.

In some embodiments, if the terminal device 110-1 is indicated with number of layers as 2, there may be a fourth set of precoding matrixes corresponding to 2 layers. For example, there may be one or two or four or six or twelve precoding matrixes in the fourth set (e.g. non-coherent precoding matrix) corresponding to 2 layers. For example, a precoding matrix in the fourth set of precoding matrixes corresponding to 2 layers may be

$$\frac{1}{\sqrt{{s}_{2}}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ] or \frac{1}{\sqrt{{s}_{2}}} [ \begin{matrix}1 & 0 \\ 0 & 0 \\ 0 & 1 \\ 0 & 0 \\ 0 & 0 \\ 0 & 0 \\ 0 & 0 \\ 0 & 0\end{matrix} ] or \frac{1}{\sqrt{{s}_{2}}} [ \begin{matrix}0 & 0 \\ 0 & 0 \\ 1 & 0 \\ 0 & 1 \\ 0 & 0 \\ 0 & 0 \\ 0 & 0 \\ 0 & 0\end{matrix} ] or \\ \frac{1}{\sqrt{{s}_{2}}} [ \begin{matrix}1 & 0 \\ 0 & 0 \\ 0 & 0 \\ 0 & 1 \\ 0 & 0 \\ 0 & 0 \\ 0 & 0 \\ 0 & 0\end{matrix} ] or \frac{1}{\sqrt{{s}_{2}}} [ \begin{matrix}0 & 0 \\ 1 & 0 \\ 0 & 0 \\ 0 & 1 \\ 0 & 0 \\ 0 & 0 \\ 0 & 0 \\ 0 & 0\end{matrix} ] or \frac{1}{\sqrt{{s}_{2}}} [ \begin{matrix}0 & 0 \\ 1 & 0 \\ 0 & 1 \\ 0 & 0 \\ 0 & 0 \\ 0 & 0 \\ 0 & 0 \\ 0 & 0\end{matrix} ] .$$

For example, s₂=8.

In some embodiments, if there are 2 layers at the terminal device 110-1, the precoding matrixes may be shown as Table 40 below.

TABLE 40

| Precoding Matrix | | | | | Description |
|---|---|---|---|---|---|
| ▪ | i_{1,1} [symbol] | i_{1,2} [symbol] | i₂ [symbol] | [symbol] | Full-coherent |
| ▪ | 0, . . . , N₁O₁ −1 [symbol] | 0, . . . , N₂O₂ −1 [symbol] | 0, 1 [symbol] | Wᵢ_{_{1,1}}_{,i}_{_{1,1}} _{+ k}_{₁}_{, i}_{_{1,2}}_{,i}_{_{1,2}}₊ₖ_{_{2,}}ᵢ_{₂}⁽²⁾ [symbol] | Set_f2_1 (N1 = 4, |

| ▪ | $where {W}_{\text{?}}^{\text{?}} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ]$ | | | | N2 = 1, O1 = 2 or 4, O2 = 1) (number of precoders: 16 or 32) |
|---|---|---|---|---|---|
| | and the mapping from i_{1,3} to k₁ and k₂ is given in Table 5.2.2.2.1-3. [symbol] | | | | |
| | | | | | Set_f2_2 (N1 = 2, |
| | | | | | N2 = 2, O1 = 2 or 4, |
| | | | | | O2 = 2 or 4) (number of |
| | | | | | precoders: 32 or 128) |
| ▪ | i_{1,1} [symbol] | i_{1,2} [symbol] | i₂ [symbol] | [symbol] | Partial-coherent (4 out |
| ▪ | 0, 1, . . . , N₁O₁ −1 [symbol] | 0, . . . , N₂O₂ −1 [symbol] | 0, 1 [symbol] | Wᵢ_{_{1,1}},ᵢ_{_{1,1}}₊ₖ_{₁},ᵢ_{_{1,2}},ᵢ_{_{1,2}}₊ₖ_{₂},ᵢ_{₂}⁽²⁾ [symbol] | of 8 elements with |

| ▪ | $where {W}_{\text{?}}^{( 2 )} = \frac{1}{\sqrt{2 {P}_{CSI - RS}}} [ \begin{matrix}{v}_{l , m} & {v}_{{l}^{′} , {m}^{′}} \\ {φ}_{n} {v}_{l , m} & - {φ}_{n} {v}_{{l}^{′} , {m}^{′}}\end{matrix} ]$ | | | | | non-zero value) Set_p2_1 (N1 = 2, N2 = 1, O1 = 2) (4-port |
|---|---|---|---|---|---|---|
| | and the mapping from i_{1,3} to k₁ and k₂ is given in Table 5.2.2.2.1-3. [symbol] | | | | | full-coherent precoder) |
| | | | | | | mapping on 4 out of 8 |
| | | | | | | elements, and 0 for |
| | | | | | | other 4 elements |
| | | | | | | (number of precoders: |
| | | | | | | 8*C(8,4) = 560), |
| | | | | | | with/without ports |
| | | | | | | swapped |
| | [1;1], [1;-1], [1;j], [1;-j] | | | | | Partial-coherent (2 out |
| | | | | | | of 8 elements with |
| | | | | | | non-zero value) |
| | | | | | | Set_p2_2 The two |
| | | | | | | values mapping on 2 |
| | | | | | | out of 8 elements, and |
| | | | | | | 0 for other 6 elements |
| | | | | | | (with ports swapped, |
| | | | | | | number of precoders: |
| | | | | | | 4*C(8,2)*C(6,2) = 1680) |
| | | | | | | Non-coherent (in each |
| | | | | | | column, 1 out of 8 |
| | | | | | | elements with value 1, |
| | | | | | | 0 for other 7 elements) |
| | | | | | | (number of precoders: |
| | | | | | | C(8,1)*C(7,1) = 56) |
| | | | | | | Set_n2_1 |
| ▪ | i_{1,1} [symbol] | i_{1,2} [symbol] | i_{1,4,q}, q = 1, . . . ,N_{g} −1 [symbol] | i₂ [symbol] | [symbol] | Full-coherent |
| ▪ | 0, ... ,N₁O₁−1 [symbol] | 0, ... ,N₂O₂−1 [symbol] | 0, 1, 2, 3 [symbol] | 0, 1 [symbol] | Wᵢ_{_{1,1}}_{,i}_{_{1,1}}₊ₖ_{₁}_{,i}_{_{1,2}}_{,i}_{_{1,2}}₊ₖ_{₂}_{,i}_{_{1,4}}_{,i}_{₂} [symbol] ⁽²⁾ | Set_f2_3 (Ng = 2, |

| ▪ | $where {W}_{\text{?}}^{( 2 )} = \frac{1}{\sqrt{2}} [ {W}_{\text{?}}^{\text{?}} {W}_{\text{?}}^{\text{?}} ]$ | | | | | N1 = 2, N2 = 1, O1 = 2 or 4, i1,3 = 0, il,1 = {0, ... N1O1-1} or {0, |
|---|---|---|---|---|---|---|
| | and the mapping from i_{1,3} to k₁ and k₂ is given in Table 5.2.2.2.1-3. [symbol] | | | | | 2, 4, 6} or {0, 4} or |
| | | | | | | {0,2} or {0,1} or 0; |
| | | | | | | i1,4,1 = {0, 1, 2, 3} or |
| | | | | | | {0,2} or 0) (number of |
| | | | | | | precoders: 64 or 32 or |
| | | | | | | 16 or 8 or 4 or 2) |
| ▪ | i_{1,1} [symbol] | i_{1,2} [symbol] | i_{1,4,q}, q = 1, 2 [symbol] | i_{1,2,q}, q = 0, 1, 2 [symbol] | [symbol] | Full-coherent |
| ▪ | 0, ... ,N₁O₁−1 [symbol] | 0, ... ,N₂O₂−1 [symbol] | 0,1,2,3 [symbol] | 0, 1 [symbol] | Wᵢ_{_{1,1}}_{,i}_{_{1,1}}₊ₖ_{₁}_{,i}_{_{1,2}}_{,i}_{_{1,2}}₊ₖ_{₂}_{,i}_{_{1,4}}_{,i}_{₂} [symbol] ⁽²⁾ | Set_f2_4 (Ng = 2, |

| | | |
|---|---|---|
| ▪ | $where {W}_{\text{?}}^{( 2 )} = \frac{1}{\sqrt{2}} [ {W}_{\text{?}}^{\text{?}} {W}_{\text{?}}^{\text{?}} ]$ | N1 = 2, N2 = 1, O1 = 2 or 4, il,3 = 0, il,1 = {0, ... N1O1-1} or {0, |
| | and the mapping from i_{1,3} to k₁ and k₂ is given in Table 5.2.2.2.1-3. [symbol] | 2, 4, 6} or {0, 4} or |
| | | {0,2} or {0,1} or 0; |
| | | i1,4,q = {0, 1, 2, 3} or |
| | | {0,2} or 0; i2,q = 0,1) |
| | | (number of precoders: |
| | | 256 or 128 or 64 or 32 |
| | | or 16 or 8 or 4 or 2) |

In some embodiments, the terminal device 110-1 is indicated with the number of layers as 1, there may be a first set of precoding matrixes corresponding to 1 layer (e.g. a first set of full coherent precoding matrixes). In some embodiments, a full coherent precoding matrix may be represented as W_{l,m,n}⁽¹⁾.

In some embodiments, W_{l,m,n}⁽¹⁾ may be

$$\frac{1}{\sqrt{P}} [ \begin{matrix}{v}_{l , m} \\ {φ}_{n} * {v}_{l , m}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0.

In some embodiments, there may be more than one subset of precoding matrixes corresponding to 1 layer. In some embodiments, the first set of precoding matrixes corresponding to 1 layer may comprise more than one subset. For example, there may be two or three or four subsets of precoding matrixes.

In some embodiments, there may be a first subset of precoding matrixes corresponding to 1 layer, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 1 layer may be 32 or 16 or 8 or 4 or 2.

In some embodiments, there may be a second subset of precoding matrixes corresponding to 1 layer, and corresponding to the second subset of precoding matrixes, the value of “N₁” may be 2, the value of “N₂” may be 2, and the value of “O1” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 1 layer may be 256 or 128 or 32 or 16 or 8 or 4 or 2.

In some embodiments, if the terminal device 110-1 is indicated with the number of layers as 1, there may be a third subset of precoding matrixes. In some embodiments, In some embodiments, there may be a third vector W_{l,m,p,n}^{1,2,1}. In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a third subset of precoding matrixes corresponding to 1 layer, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T}$$

In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 1 layer may be 256 or 128 or 64 or 32 or 16 or 8 or 4 or 2.

In some embodiments, the terminal device 110-1 may be indicated with the number of layers as 1, a precoding matrix in the third subset of precoding matrixes corresponding to 1 layer may be represented as W_{l,m,p,n}⁽¹⁾. In some embodiments, WW_{l,m,p,n}⁽¹⁾ may be [W_{l,m,p,n}^{1,2,1}]. In some embodiments, p may be p₁.

In some embodiments, if the terminal device 110-1 is indicated with the number of layers as 1, there may be a fourth subset of precoding matrixes. In some embodiments, In some embodiments, there may be a fifth vector W_{l,m,p,n}^{1,2,1}. In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments, N₁=2 and N₂=1,

$${v}_{l , m} = [ 1 , {e}^{j \frac{2 π l}{{O}_{1} {N}_{1}}} ] .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0.

In some embodiments, there may be a fourth subset of precoding matrixes corresponding to 1 layer, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π i}{{O}_{1} {N}_{1}}} ]}^{T} .$$

In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 1 layer may be 256 or 128 or 64 or 32 or 16 or 8 or 4 or 2.

In some embodiments, the terminal device 110-1 may be indicated with the number of layers as 1, a precoding matrix in the fourth subset of precoding matrixes corresponding to 1 layer may be represented as W_{l,m,p,n}⁽¹⁾. In some embodiments, W_{l,m,p,n}⁽¹⁾ may be [W_{l,m,p,n}^{1,2,2}]. In some embodiments, p may be [p₁ p₂]. In some embodiments, n may be [n₀ n₁ n₂].

In some embodiments, if the terminal device 110-1 is indicated with the number of layers is indicated as 1, there may be a second set of precoding matrixes corresponding to 1 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 2 layers, for example, represented as “Set_p1_1”, and the size of a partial coherent precoding matrix may be 1 multiplies 8 or 8 multiplies 1. In some embodiments, there may be 1 column or row of the precoding matrix. In some embodiments, there may be 8 elements in the column or row of the precoding matrix. In some embodiments, for the column or row of the partial coherent precoding matrix, 4 elements out of 8 elements in the partial coherent matrix may be with non-zero value. And the other 4 elements in the partial coherent precoding matrix may be with value of 0. In some embodiments, in the precoding matrix, and in the column or row, the non-zero value may be mapped on 4 out of 8 elements and 0 for the other 4 elements. For example, the indexes of the 4 elements with non-zero values idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or second group. For example, idx_1 may be {0,1,2,3} or {0,2,4,6} or {1,2,3,4} or {1,3,5,7} or {4,5,6,7} or {1,3,5,7} or {5,6,7,8} or {2,4,6,8}.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in the column or row of the precoding matrix. In some embodiments,

In some embodiments, examples of a precoding matrix of the second set of precoding matrixes corresponding to 1 layer1 may be as:

$$\frac{1}{\sqrt{{s}_{1}}} [ \begin{matrix}a 1 \\ a 2 \\ a 3 \\ a 4 \\ 0 \\ 0 \\ 0 \\ 0\end{matrix} ] or \frac{1}{\sqrt{{s}_{1}}} [ \begin{matrix}0 \\ 0 \\ 0 \\ 0 \\ a 1 \\ a 2 \\ a 3 \\ a 4\end{matrix} ]$$

For example, rows or columns can be swapped. For example, rows or columns can be swapped. For example, each of [a1, a2, a3, a4] may be one of the length-4 vectors in the first set of length-4 vectors or in the second set of length-4 vectors. For example, [a1, a2, a3, a4] may be one of [; 1; 1; 1], [1; −1; 1; −1], [1;1;−1;−1], [1; −1; −1; 1], [; 1; j; j], [1; −1; j; −j], [1; 1; −j; −j] and [1; −1; −j; j].

In some embodiments, s₁ may a positive integer. For example, 1≤s₁≤64. For example, s₁ may be 64 or 32 or 16 or 8 or 4 or 2 or 1.

In some embodiments, if the terminal device 110-1 is indicated with the number of layers as 1, there may be a third set of precoding matrixes (e.g. a third set of partial coherent precoding matrixes) corresponding to 1 layer. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p1_2”, and the size of a precoding matrix may be 1 multiplies 8 or 8 multiplies 1. In some embodiments, there may be 1 column or row of the precoding matrix. In some embodiments, there may be 8 elements in the column or row of the precoding matrix. In some embodiments, for the column or the row of the precoding matrix, 2 elements out of 8 elements in the precoding matrix may be with non-zero value. And the other 6 elements in the precoding matrix may be with value of 0. In some embodiments, in the column or row of the precoding matrix, non-zero values may be mapped on 2 out of 8 elements and 0 may be mapped on the other 6 elements. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group or second group. In some embodiments, the 2 values of idx_1 may be based on the indexes of the 2 antenna ports in the third group or fourth group or fifth group or sixth group.

In some embodiments, there may be a set of 4 length-2 vectors, and each one of the length-2 vector may be applied as the two non-zero values in a column or row of the precoding matrix. In some embodiments, for the third set of precoding matrix corresponding to 1 layer, e.g. Set_p1_2, two length-2 vectors can be selected from the 4 length-2 vectors, and the 2 values in each vector may be mapped on 2 out of 8 elements, and 0 may be mapped on other elements in the column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in the column or row of the precoding matrix. In some embodiments, for the column or row, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 1 layer may be as:

$$\frac{1}{\sqrt{{s}_{1}}} [ \begin{matrix}a 1 \\ a 2 \\ 0 \\ 0 \\ 0 \\ 0 \\ 0 \\ 0\end{matrix} ] or \frac{1}{\sqrt{{s}_{1}}} [ \begin{matrix}0 \\ 0 \\ a 1 \\ a 2 \\ 0 \\ 0 \\ 0 \\ 0\end{matrix} ] or \frac{1}{\sqrt{{s}_{1}}} [ \begin{matrix}a 1 \\ 0 \\ a 2 \\ 0 \\ 0 \\ 0 \\ 0 \\ 0\end{matrix} ] or \\ \frac{1}{\sqrt{{s}_{1}}} [ \begin{matrix}0 \\ 0 \\ 0 \\ 0 \\ a 1 \\ a 2 \\ 0 \\ 0\end{matrix} ] or \frac{1}{\sqrt{{s}_{1}}} [ \begin{matrix}0 \\ 0 \\ 0 \\ 0 \\ a 1 \\ 0 \\ a 2 \\ 0\end{matrix} ] or \frac{1}{\sqrt{{s}_{1}}} [ \begin{matrix}0 \\ 0 \\ 0 \\ 0 \\ 0 \\ 0 \\ a 1 \\ a 2\end{matrix} ]$$

For example, rows or columns can be swapped. For example, [a1, a2], may be one of the length-2 vectors in the first set of length-2 vectors or in the second set of length-2 vectors. For example, [a1, a2] may be any one of [1; 1], [1; −1], [1; j], [1; −j].

In some embodiments, if the terminal device 110-1 is indicated with the number of layers is indicated as 1, there may be a fourth set of precoding matrixes (e.g. a fourth set of non-coherent precoding matrixes) corresponding to 1 layer. For example, each one of 8 antenna ports may be non-coherent with each other. In some embodiments, there may be a fourth set of precoding matrixes (e.g. a fourth set of non-coherent precoding matrixes), for example, represented as “Set_n1_1”, and the size of a precoding matrix may be 1 multiplies 8 or 8 multiplies 1. In some embodiments, there may be 1 column or row of the precoding matrix. In some embodiments, there may be 8 elements in a column or row of the precoding matrix. In some embodiments, for the column orrow of the precoding matrix, 1 elements out of 8 elements in the precoding matrix may be with non-zero value. For example, the non-zero value may be 1. And the other 7 elements in the precoding matrix may be with value of 0. In some embodiments, the indexes of the element with non-zero value may be in the row or column of the precoding matrix may be idx_1, and idx_1 may be 1 value out of {0,1,2,3,4,5,6,7} or {1,2,3,4,5,6,7,8}. In some embodiments, the value of idx_1 may be based on the indexes of one out of the 4 antenna ports in the first group or second group. In some embodiments, the values of idx_1 may be based on the indexes of one of the 2 antenna ports in the third group or fourth group or fifth group or sixth group.

In some embodiments, if the terminal device 110-1 is indicated with number of layers as 1, there may be a fourth set of precoding matrixes corresponding to 1 layer. For example, there may be one or two or four or eight precoding matrixes in the fourth set (e.g. non-coherent precoding matrix) corresponding to 1 layer. For example, a precoding matrix in the fourth set of precoding matrixes corresponding to 1 layer may be

$$\frac{1}{\sqrt{{s}_{1}}} [ \begin{matrix}1 \\ 0 \\ 0 \\ 0 \\ 0 \\ 0 \\ 0 \\ 0\end{matrix} ] or \frac{1}{\sqrt{{s}_{1}}} [ \begin{matrix}0 \\ 1 \\ 0 \\ 0 \\ 0 \\ 0 \\ 0 \\ 0\end{matrix} ] or \frac{1}{\sqrt{{s}_{1}}} [ \begin{matrix}0 \\ 0 \\ 1 \\ 0 \\ 0 \\ 0 \\ 0 \\ 0\end{matrix} ] or \frac{1}{\sqrt{{s}_{1}}} [ \begin{matrix}0 \\ 0 \\ 0 \\ 1 \\ 0 \\ 0 \\ 0 \\ 0\end{matrix} ] or \\ \frac{1}{\sqrt{{s}_{1}}} [ \begin{matrix}0 \\ 0 \\ 0 \\ 0 \\ 1 \\ 0 \\ 0 \\ 0\end{matrix} ] or \frac{1}{\sqrt{{s}_{1}}} [ \begin{matrix}0 \\ 0 \\ 0 \\ 0 \\ 0 \\ 1 \\ 0 \\ 0\end{matrix} ] or \frac{1}{\sqrt{{s}_{1}}} [ \begin{matrix}0 \\ 0 \\ 0 \\ 0 \\ 0 \\ 0 \\ 1 \\ 0\end{matrix} ] or \frac{1}{\sqrt{{s}_{1}}} [ \begin{matrix}0 \\ 0 \\ 0 \\ 0 \\ 0 \\ 0 \\ 0 \\ 1\end{matrix} ]$$

For example, s₁=8.

In some embodiments, if there is 1 layer at the terminal device 110-1, the precoding matrixes may be shown as Table 41 below.

TABLE 41

| Precoding Matrix | | | | | Description |
|---|---|---|---|---|---|
| ▪ | i_{1,1} [symbol] | i_{1,2} [symbol] | i₂ [symbol] | [symbol] | Full-coherent |
| ▪ | 0, 1, . . . , N₁O₁ −1 [symbol] | 0, . . . , N₂O₂ −1 [symbol] | 0,1,2,3 [symbol] | Wᵢ_{_{1,1}}_{,i}_{_{1,2}}_{,i}_{₂} [symbol] ⁽¹⁾ | Set_f1_1 (N1 = 4, |

| | | |
|---|---|---|
| ▪ | $where {W}_{l , m , n}^{( 1 )} = \frac{1}{\sqrt{{P}_{CSI - RS}}} [ \begin{matrix}{v}_{l , m} \\ {φ}_{n} {v}_{l , m}\end{matrix} ]$ | N2 = 1, O1 = 2 or 4, O2 = 1) (number of precoders: 32 or |

| | | | | | 64) |
|---|---|---|---|---|---|
| | | | | | Set_fl_2 (N1 = 2, |
| | | | | | N2 = 2, O1 = 2 or 4, |
| | | | | | O2 = 2 or 4) |
| | | | | | (number of |
| | | | | | precoders: 64 or |
| | | | | | 256) |
| ▪ | i_{1,1} [symbol] | i_{1,2} [symbol] | i₂ [symbol] | [symbol] | Partial-coherent (4 |
| ▪ | 0, 1, . . . , N₁O₁ −1 [symbol] | 0, . . . , N₂O₂ -1 [symbol] | 0, 1, 2, 3 [symbol] | Wᵢ_{_{1,1}}_{,i}_{_{1,2}}_{,i}_{₂} [symbol] ⁽¹⁾ | out of 8 elements |

| | | |
|---|---|---|
| ▪ | $where {W}_{l , m , n}^{( 1 )} = \frac{1}{\sqrt{{P}_{CSI - RS}}} [ \begin{matrix}{v}_{l , m} \\ {φ}_{n} {v}_{l , m}\end{matrix} ]$ | with non-zero value) Set_p1_1 (N1 = 2, |

N2 = 1, O1 = 2)
(4-port
full-coherent
precoder) mapping
on 4 out of 8
elements, and 0 for
other 4 elements
(number of
precoders:
16*C(8,4) = 1120)

| [1;1], [1;-1], [1; j], [1;-j] | | | | | | Partial-coherent (2 |
|---|---|---|---|---|---|---|
| | | | | | | out of 8 elements |
| | | | | | | with non-zero |
| | | | | | | value) |
| | | | | | | Set_p1_2 The two |
| | | | | | | values mapping on |
| | | | | | | 2 out of 8 elements, |
| | | | | | | and 0 for other 6 |
| | | | | | | elements (number |
| | | | | | | of precoders: |
| | | | | | | 4*C(8,2) = 112) |
| | | | | | | Non-coherent (1 |
| | | | | | | out of 8 elements |
| | | | | | | with value 1, 0 for |
| | | | | | | other 7 elements) |
| | | | | | | (number of |
| | | | | | | precoders: |
| | | | | | | C(8,1) = 8) |
| | | | | | | Set_n1_1 |
| ▪ | i_{1,1} [symbol] | i_{1,2} [symbol] | i_{1,4,q}, | i₂ [symbol] | [symbol] | Full-coherent |
| ▪ | 0, . . . , N₁O₁ −1 [symbol] | 0, . . . , N₂O₂ −1 [symbol] | q = 1, ..., N_{g} −1 | 0,1,2,3 [symbol] | Wᵢ_{_{1,1}}_{,i}_{_{1,2}}_{,i}_{_{1,4}}_{,i}_{₂}⁽¹⁾ [symbol] | Set_f1_3 (Ng = 2, |
| | | | 0,1,2,3 [symbol] | | | N1 = 2, N2 = 1, O1 = 2 |

| | | |
|---|---|---|
| ▪ | where W_{l,m,p,n}⁽¹⁾ = W_{l,m,p,n}^{1,N}^{_{g}}^{,1}. [symbol] | or 4, i1,3 = 0, i1,1 = |

{0, . . . N1O1-1} or
{0, 2, 4, 6} or {0,
4} or {0,2} or
{0,1} or 0; i1,4,1 =
{0, 1, 2, 3} or {0, 2}
or 0) (number of
precoders: 64 or 32
or 16 or 8 or 4 or 2)

| | | | | | | | |
|---|---|---|---|---|---|---|---|
| ▪ | i_{1,1} [symbol] | i_{1,2} [symbol] | i_{1,4,}q = 1, 2 [symbol] | i₂ [symbol] | i_{2,q,}q = 1, 2 [symbol] | [symbol] | Full-coherent |
| ▪ | 0, . . . , N₁O₁ −1 [symbol] | 0, . . . , N₂O₂ −1 [symbol] | 0,1,2,3 [symbol] | 0,1,2,3 [symbol] | 0,1 [symbol] | Wᵢ_{_{1,1}}_{,i}_{_{1,2}}_{,i}_{_{1,4}}_{,i}_{₂}⁽¹⁾ [symbol] | Set_f1_4 (Ng = 2, |

| | | |
|---|---|---|
| ▪ | where W_{l,m,p,n}⁽¹⁾ = W_{l,m,p,n}^{1,N}^{_{g}}^{,1}. [symbol] | N1 = 2, N2 = 1, O1 = 2 |

or 4, i1,3 = 0, il,1 =
{0, ... N1O1-1} or
{0, 2, 4, 6} or {0,
4} or {0,2} or {0,1} or
{0,1} or 0; i1,4,q =
{0, 1, 2, 3} or {0,2}
or 0; i2,q = 0,1)
(number of
precoders: 256 or
128 or 64 or 32 or
16 or 8 or 4 or 2)

Alternatively or in addition, the terminal device 110-1 may transmit 2020 capability information to the network device 120. In some embodiments, the capability information may indicate a capability of precoding matrix supported by the terminal device 110-1. For example, the capability information may indicate a type of precoding matrix supported by the terminal device 110-1. In some embodiments, the capability information may comprise at least one of: a full coherent, a partial coherent, a first partial coherent, a second partial coherent, a non coherent.

In some embodiments, the capability information may indicate the full coherent, the set of precoding matrix (for example, one of the set of precoding matrixes corresponding to v_ri layers can be indicated by the network device or one or more of the set of precoding matrixes can be configured by the network device) may comprise at least one of the first set (or at least one of the first subset, or at least one of the second subset or at least one of the third subset or at least one of fourth subset) of precoding matrixes corresponding to v_ri layers (e.g. a full-coherent precoding matrix type). For example, the set of precoding matrix may further comprise at least one of the second set of precoding matrixes corresponding to v_ri layers (e.g. a first partial-coherent precoding matrix type). For another example, the set of precoding matrixes may further comprise at least one of the third set of precoding matrixes corresponding to v_ri layers (e.g. a second partial-coherent is precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the partial coherent or indicate the first partial coherent, the set of precoding matrix corresponding to v_ri layers (for example, one of the set of precoding matrixes can be indicated by the network device or one or more of the set of precoding matrixes can be configured by the network device) may comprise at least one of the second set of precoding matrixes corresponding to v_ri layers (e.g. a first partial-coherent precoding matrix type). For another example, the set of precoding matrixes may further comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the second partial coherent, the set of precoding matrix corresponding to v_ri layers (for example, one of the set of precoding matrixes can be indicated by the network device or one or more of the set of precoding matrixes can be configured by the network device) may comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the non coherent, the set of precoding matrix corresponding to v_ri layers (for example, one of the set of precoding matrixes can be indicated by the network device or one or more of the set of precoding matrixes can be configured by the network device) may comprise at least one of the fourth set of precoding matrixes corresponding to v_ri layers (e.g. a non-coherent precoding matrix type).

In some embodiments, the capability information may comprise any one or combination of the above precoding matrix types. In some embodiments, the capability information may be transmitted via radio resource control (RRC) signaling.

In some embodiments, the network device 120 may configure the type of precoding matrixes or at least one set of precoding matrixes corresponding to v_ri layers which can be indicated or configured to the terminal device 110-1. In some embodiments, corresponding to v_ri layers, the at least one configuration may configure at least one of the first subset of precoding matrixes corresponding to v_ri layers, the second subset of precoding matrixes corresponding to v_ri layers, the third subset of precoding matrixes corresponding to v_ri layers, the fourth subset of precoding matrixes corresponding to v_ri layers, the first set of precoding matrixes corresponding to v_ri layers, the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the full coherent, corresponding to v_ri layers, the at least one configuration may configure at least one of the first subset of precoding matrixes corresponding to v_ri layers, the second subset of precoding matrixes corresponding to v_ri layers, the third subset of precoding matrixes corresponding to v_ri layers, the fourth subset of precoding matrixes corresponding to v_ri layers, the first set of precoding matrixes corresponding to v_ri layers, the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the partial coherent or the first partial coherent, corresponding to v_ri layers, the at least one configuration may configure at least one of the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the second partial coherent, corresponding to v_ri layers, the at least one configuration may configure at least one of the third set of precoding matrixes corresponding to v_ri layers and the fourth set of precoding matrixes corresponding to v_ri layers.

In some embodiments, if the capability information is indicated as the non coherent, corresponding to v_ri layers, the at least one configuration may configure at least one of the fourth set of precoding matrixes corresponding to v_ri layers.

In some embodiments, the network device 120 may determine the type of precoding matrix which can be supported by the terminal device. In this case, the network device 120 may transmit an indication of the type of the precoding matrix. The type of the precoding matrix may be any one or combination of: a full-coherent precoding matrix type, a full-coherent and partial-coherent and non-coherent precoding matrix type, a partial-coherent precoding matrix type, a partial-coherent and a non-coherent precoding matrix type or a non-coherent precoding matrix type.

In some embodiments, the network device 120 may transmit 2030 at least one configuration associated with precoding matrix to the terminal device 110-1. In some embodiments, the terminal device 110-1 may transmit the at least one configuration associated with precoding matrix to the network device 120. In some embodiments, the at least one configuration may comprise one or more configurations of antenna port groups. Alternatively or in addition, the at least one configuration may comprise at least one antenna port group. In other embodiments, the at least one configuration may comprise one or more configurations of antenna pattern. In some other embodiments, the at least one configuration may comprise one or more configurations of precoding matrix type. Alternatively or in addition, the at least one configuration may comprise one or more configurations of precoding matrix subsets. In some embodiments, the at least one configuration may comprise the number of antenna port groups. In other embodiments, the at least one configuration may comprise the number of antenna ports in an antenna port group.

In some embodiments, the at least one configuration may comprise a first number of antenna groups and each of the antenna groups may comprise 4 antenna ports. For example, the first number may be 0 or 1 or 2. In this case, the first number may be a first integer which is not larger than 2. Alternatively or in addition, the at least one configuration may comprise a second number of antenna groups and each of the antenna groups may comprise 2 antenna ports. For example, the second number may be 0 or 1 or 2 or 3 or 4. In this case, the second number may be a second integer which is not larger than 4. In some other embodiments, the at least one configuration may comprise a third number of antenna groups and each of the antenna groups may comprise 1 antenna port. The third number may be a third integer which is not larger than 8. In another embodiment, the at least one configuration may comprise at least one of: a subset of full-coherent precoding matrixes, a subset of partial-coherent precoding matrixes, or a subset of non-coherent precoding matrixes.

Only as an example, the terminal device 110-1 may be configured with 8Tx for uplink or 8 ports SRS, (e.g. AP_0, AP1, AP_2, AP_3, AP_4, AP_5, AP_6, AP_7). In some embodiments, the at least one configuration may include N groups where each group comprises 4 antenna ports, (N may be 0, 1, 2) and/or M groups where each group comprises 2 antenna ports, (M is integer, and 0<=M<=(8−N*4)/2 or 0<=M<=4)), and/or L groups where each group comprises 1 antenna port (or L antenna ports) (L is integer, and 0<=L<=8−N*4−M*2 or 0<=L<=8). Alternatively, the at least one configuration may indicate a subset of full-coherent and/or partial-coherent and/or a first partial-coherent (e.g. partial-coherent4) and/or a second partial-coherent (e.g. partial-coherent2) and/or non-coherent precoding matrix.

In some embodiments, the at least one configuration may be configured per value of number of layers or per precoder type. For example, N1, M1 may be configured for the first set of precoding matrixes corresponding to v_ri layers or for the full coherent precoding matrixes, N2, M2 may be configured for the second or the third set of precoding matrixes corresponding to v_ri layers or for the partial coherent precoding matrixes, N3, M3 may be configured for the fourth set of precoding matrixes corresponding to v_ri layers or for the non-coherent precoding matrixes.

In some embodiments, the 8 antenna ports for PUSCH transmission or the 8 antenna ports of the 8-port SRS may be {AP0, AP1, AP2, AP3, AP4, AP5, AP6, AP7}. And AP0 or AP1 or AP2 or AP3 or AP4 or AP5 or AP6 or AP7 may be any one of {0, 1, 2,3, 4, 5, 6, 7} or any one of {1000, 1001, 1002, 1003, 1004, 1005, 1006, 1007} or any one of {3000,3001, 3002, 3003, 3004, 3005, 3006, 3007}. In some embodiments, the values of AP0 or AP1 or AP2 or AP3 or AP4 or AP5 or AP6 or AP7 may be different from each other.

In some embodiments, in each group, 1 or 2 or 4 of {AP_a, AP_b, AP_c, AP_d, AP_e, AP_f, AP_g, AP_h} can be included. The {a,b,c,d,e,f,g,h}, {AP_a, AP_b, AP_c, AP_d, AP_e, AP_f, AP_g, AP_h} may integer and can be {0, 1, 2, 3,4,5,6,7}. The numbers may be different from each other. For example, there are several port grouping configurations (4 ports in a group), {0, 1, 2, 3}, {4,5,6,7} or {0,2,4,6}, {1,3,5,7}. As another embodiment, there are several port grouping configurations (2 ports in a group), {0, 1}, {2,3}, {4,5}, {6,7} or {0,2}, {1,3}, {4,6}, {5,7}.

In some embodiments, the at least one configuration may indicate one of the port grouping configurations. For example, DMRS ports in same group may share a same PTRS port. In some embodiments, the precoding matrix may be an 8*v matrix, where v represents number of layers, v may be integer and 1<=v<=8 or 4<=v<=8. In some embodiments, v may be same as v_ri.

In some embodiments, the terminal device 110-1 may be configured with 8Tx for uplink transmission or configured with PUSCH transmission associated with SRS with 8 ports. The at least one configuration may include at least one of: values for i_{1,1}, values for i_{1,2}, values for i_{1,3}, values for i₂, values for i_{1,4,1}, values for i_{1,4,2}, values for i_{2,0}, values for i_{2,1}, values for i_{2,2}, values for Ng, values for N₁, values for N₂, values for O₁, values for O₂, and a configuration pattern (e.g. for antenna ports). The configuration pattern and/or the values may be applied at least for full-coherent precoding matrixes. Table 42 shows examples of configuration patterns. Table 43 shows values of N₁ and/or N₂, and corresponding values of O₁ and/or O₂.

TABLE 42

| Pattern | Configuration |
|---|---|
| Pattern1 | N1 = 4, O1 = 2 |
| Pattern2 | N1 = 4, O1 = 4 |
| Pattern3 | N1 = 2, O1 = 2, N2 = 2, O2 = 2 |
| Pattern4 | N1 = 2, O1 = 4, N2 = 2, O2 = 2 or |
| | N1 = 2, O1 = 2, N2 = 2, O2 = 4 |
| Pattern5 | N1 = 2, O1 = 4, N2 = 2, O2 = 4 |
| Pattern6 | Ng = 2, N1 = 2, O1 = 2 or 4, Type 1 |
| Pattern7 | Ng = 2, N1 = 2, O1 = 2 or 4, Type 2 |

TABLE 43

| ([Ng], N1, N2) | (O1, O2) |
|---|---|
| ([NA], 4, 1) | (2, 1) |
| ([NA], 2, 2) | (2, 2) |
| (2, 2, 1) | (2, 1) |

In some embodiments, the at least one configuration may indicate the first subset or the second subset or the third subset or the fourth subset of precoding matrixes corresponding to v_ri layers may be applied for the PUSCH transmission. For example, the DCI may indicate one of the applicable precoding matrixes for the PUSCH transmission.

In some embodiments, the at least one configuration may indicate two groups of antenna ports, and each group may comprise 4 antenna ports, and based on the at least one configuration, a DCI may indicate one precoding matrix of the first subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the second subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the third subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the fourth subset of precoding matrixes corresponding to v_ri layers for the PUSCH transmission.

In some embodiments, the at least one configuration may indicate one or two groups of antenna ports, and each group may comprise 4 antenna ports, and based on the at least one configuration, a DCI may indicate one precoding matrix from the second subset of precoding matrixes corresponding to v_ri layers for the PUSCH transmission.

In some embodiments, in a column or row of a precoding matrix in the second subset of precoding matrixes corresponding to v_ri layers, the indexes of the 4 non-zero values may be based on the indexes of antenna port indexes in a group. For example, the non-zero values in a column or row may be only mapped on indexes based on the index of antenna ports in the one or two groups. In some embodiments, a first group may comprise 4 antenna ports, and the 4 antenna ports may be {AP0, AP1, AP2, AP3}. In some embodiments, a second group may comprise 4 antenna ports, and the 4 antenna ports may be {AP4, AP5, AP6, AP7}. In some embodiments, in a column or row of the precoding matrix, one of length-4 vectors in the first set or second set of length-4 vectors may be mapped on the indexes of elements based on the antenna port indexes in the first group and/or the second group.

In some embodiments, for the second set of precoding matrixes corresponding to 8 layers, for a first set of 4 columns or rows (e.g. the first 4 columns or rows), a set of length-4 vectors may be mapped on element with indexes based on the 4 antenna ports in the first group, and for a second set of 4 columns or rows (e.g. the remaining or last 4 columns or rows), a set of length-4 vectors may be mapped on elements with indexes based on the 4 antenna ports in the second group.

In some embodiments, for the third set of precoding matrixes corresponding to 8 layers, for a first set of 2 columns or rows (e.g. the first and second columns or rows), a set of length-2 vectors may be mapped on elements with indexes based on two out of the 4 antenna ports in the first group, and for a second set of 2 columns or rows (e.g. the third and fourth columns or rows), a set of length-2 vectors may be mapped on elements with indexes based on remaining two antenna ports in the first group, and for a third set of 2 columns or rows (e.g. the fifth and sixth columns or rows), a set of length-2 vectors may be mapped on element with indexes based on two out of the 4 antenna ports in the second group, and for a fourth set of 2 columns or rows (e.g. the seventh and eighth columns or rows), a set of length-2 vectors may be mapped on elements with indexes based on remaining two antenna ports in the second group,

In some embodiments, in a column or row of a precoding matrix in the third subset of precoding matrixes corresponding to v_ri layers, the indexes of the 2 non-zero values may be based on the indexes of two out of the four antenna port indexes in a group. For example, the non-zero values in a column or row may be only mapped on indexes based on the index of antenna ports in the one or two groups. For example, a first group with 4 antenna ports may be {AP0, AP1, AP2, AP3}. For another example, a second group with 4 antenna ports may be {AP4, AP5, AP6, AP7}. In some embodiments, in a column or row of the precoding matrix, one of length-2 vectors in the first set or second set of length-2 vectors may be mapped on the indexes of elements based on two out of 4 antenna port indexes in the first group and/or the second group.

In some embodiments, in a column or row of a precoding matrix in the fourth subset of precoding matrixes corresponding to v_ri layers, the indexes of the 1 non-zero value (with value 1) may be based on the indexes of one out of the four antenna port indexes in a group. For example, the non-zero values in a column or row may be only mapped on indexes based on the index of antenna ports in the one or two groups. For example, a first group with 4 antenna ports may be {AP0, AP1, AP2, AP3}. For another example, a second group with 4 antenna ports may be {AP4, AP5, AP6, AP7}. In some embodiments, in a column or row of the precoding matrix, the value 1 may be mapped on the index of elements based on one out of 4 antenna port indexes in the first group and/or the second group.

In some embodiments, the at least one configuration may indicate one or two or three or four groups of antenna ports, and each group may comprise 2 antenna ports, and based on the at least one configuration, a DCI may indicate one precoding matrix from the second subset of precoding matrixes corresponding to v_ri layers for the PUSCH transmission. In some embodiments, in a column or row of the precoding matrix, the indexes of the 2 non-zero values may be based on the indexes of antenna port indexes in a group. For example, the non-zero values in a column or row may be only mapped on indexes based on the index of antenna ports in the one or two or three or four groups.

In some embodiments, there may be a third group, and the third group may comprise 2 antenna ports with indexes {AP0, AP1}. In some embodiments, there may be a fourth group, and the fourth group may comprise 2 antenna ports with indexes {AP2, AP3}. In some embodiments, there may be a fifth group, and the fifth group may comprise 2 antenna ports with indexes {AP4, AP5}. In some embodiments, there may be a sixth group, and the sixth group may comprise 2 antenna ports with indexes {AP6, AP7}. In some embodiments, in a column or row of the precoding matrix, one of length-2 vectors in the first set or second set of length-2 vectors may be mapped on the indexes of elements based on the antenna port indexes in the third group and/or the fourth group and/or the fifth group and/or the sixth group.

The network device 120 transmits 2040 DCI for scheduling a PUSCH to the terminal device 110-1. The terminal device 110-1 determines 2050 a precoding matrix based on the at least one configuration and the DCI. For example, the DCI may indicate the fourth number of layers. In this case, the terminal device 110-1 may determine the precoding matrix based on the fourth number of layers. For example, the precoding matrix may be a matrix with size 8 multiplies the fourth number. Alternatively or in addition, the precoding matrix may be a matrix with size the fourth number multiplies 8. In some embodiments, the precoding matrix may be a matrix with the fourth number of columns, and each column with 8 elements. In some other embodiments, the precoding matrix may be a matrix with the fourth number of rows, and each row with 8 elements. The terminal device 110-1 transmits 2060 the PUSCH based on the precoding matrix.

In some embodiments, the DCI may indicate which full coherent precoding matrixes for the terminal device 110-1. In some embodiments, the at least one configuration comprises none or at least one of: a first full coherent precoding matrix or a second full coherent precoding matrix. For example, the at least one configuration may indicate none or one or both of Set_fv_1 and Set_fv_2. Alternatively, the at least one configuration comprises one or more of a number of antenna ports in a first dimension, a number of antenna ports in a second dimension, a first DFT oversampling in the first dimension, or a second DFT oversampling in the second dimension. For example, the at least one configuration may indicate candidate values for at least one of N1, N2, i1, 1, O1, O2, i1, 2, i1,3 to generate the precoding matrix. Table 44 shows an example of the at least one configuration. Table 45 shows an example of the precoding matrix.

TABLE 44

| Full-coherent | Configuration | |
|---|---|---|
| precoders | Config_f_1 Or | Set_fv_1 included |
| | N1 = 2 or N1 ≠ 0 | |
| | Config_f_2 Or | Set_fv_2 included |
| | M1 = 4 or M1 ≠ 0 | Or Set_fv_3 included (e.g. |
| | | indicating Ng = 2, |
| | | and/or ype 1) |
| | | Or Set_fv_4 included (e.g. |
| | | indicating Ng = 2, |
| | | and/or type 2) |
| | Config_f_3 Or | No full-coherent precoders |
| | N1 = 0, M1 = 0 | Or not expected in case |
| | or N1 ≠ 2, M1 ≠ 4 | of condition 1A-1 |

Or a configuration (Config_f_4) indicating none
or one or two of Set_fv_1 nd Set_fv_2

TABLE 45
$\frac{1}{\sqrt{8 * v}} [ \begin{matrix}a 1 & & k 1 \\ a 2 & & k 2 \\ a 3 & & k 3 \\ a 4 & & k 4 \\ a 5 & … & k 5 \\ a 6 & & k 6 \\ a 7 & & k 7 \\ a 8 & & k 8\end{matrix} ]$

In some embodiments, the DCI may indicate which partial coherent precoding matrixes for the terminal device 110-1. In some embodiments, the at least one configuration may indicate that if there is at least one antenna port group with 4 antenna ports, at least one column or at least one row of the precoding matrix is with 4 non-zero values on 4 of the 8 elements. The indexes of the 4 elements may be based on the indexes of the 4 antenna ports in one antenna port group, and zero values on other 4 of the 8 elements in the column or the row. For example, the at least one configuration may indicate that if there is at least one group with 4 ports, at least one column of the precoder can be with 4 non-zero values (mapping on the 4 indexes (AP_i+1)). Otherwise, there may be no such kind of precoders. Table 46 shows an example of the at least one configuration.

TABLE 46

| Partial- | Configuration | |
|---|---|---|
| coherent4 | Config_{—} | Set_pv_1 included (In each column, |
| precoders | p4_1 Or | length-4 vectors mapping on 4 |
| | N2 = 2 | elements with indexes (AP_i + 1) |
| | | (AP_i in a group), other elements 0) |
| | Config_{—} | v <= 4, Set_pv_1 and/or Set_pv_4 |
| | p4_2 Or | included (4 elements with indexes |
| | N2 = 1, | (AP_i + 1) with non-zero values |
| | M2 = 0 | for some columns, and 1 mapping on |
| | | only one element for remaining columns) |
| | | v > 4, Set_pv_4 included or none |
| | | (or not expected) |
| | Config_{—} | v <= 4, Set_pv_1 and/or Set_pv_3 |
| | p4_3 Or | and/or Set_pv_5 included |
| | N2 = 1, | v > 4, Set_pv_3 and/or Set_pv_5 included |
| | M2 ≠ 0 | or none (or not expected) |
| | Config_{—} | No partial-coherent4 precoders |
| | p4_4 Or | |
| | N2 = 0 | |

In some embodiments, the at least one configuration may indicate that if there is at least one antenna port group with 2 antenna ports, at least one column or at least one row of the precoding matrix is with 2 non-zero values on 2 of the 8 elements. The indexes of the 2 elements may be based on the indexes of the 2 antenna ports in one antenna port group, and zero values on other 6 of the 8 elements in the column or the row. For example, the at least one configuration may indicate that if there is at least one group with 2 ports, at least one column of the precoder can be with 2 non-zero values (mapping on the 2 indexes (AP_i+1)), otherwise, there is no such kind of precoders. Table 47 shows an example of the at least one configuration.

TABLE 47

| | | |
|---|---|---|
| Partial- | Configuration | |
| coherent2 | Config_{—} | Set_pv_2 included (In each column, |
| precoders | p2_1 Or | length-2 vectors mapping on 2 elements |
| | M2 = 4 | with indexes (AP_i + 1) (AP_i in |
| | | a group), other elements 0) |
| | Config_{—} | v <= 6, Set_pv_2 included |
| | p2_2 Or | v >= 7, Set_pv_2 included (2 |
| | M2 =3 | elements with indexes (AP_i + 1) |
| | | with non-zero values for some columns, |
| | | and 1 mapping on only one element for |
| | | remaining columns) or none |
| | Config_{—} | v <= 4, Set_pv_2 included |
| | p2_3 Or | v >= 5, Set_pv_2 included (2 |
| | M2 = 2 | elements with indexes (AP_i + 1) |
| | | with non-zero values for some columns, |
| | | and 1 mapping on only one element for |
| | | remaining columns) or none |
| | Config_{—} | v <= 2, Set_pv_2 included |
| | p2_4 Or | v >= 3, Set_pv_2 included (2 |
| | M2 = 1 | elements with indexes (AP_i + 1) |
| | | with non-zero values for some columns, |
| | | and 1 mapping on only one element for |
| | | remaining columns) or none |
| | Config_{—} | No partial-coherent2 precoders |
| | p2_5 Or | |
| | M2 = 0 | |

In some embodiments, at least one configuration may indicate that if there is at least one antenna port group with 1 antenna port, at least one column or at least one row of the precoding matrix is with 1 non-zero value on 1 of the 8 elements, and the non-zero value is 1. The index of the 1 element may be based on the index of the antenna port in one antenna port group, and zero values on other 7 of the 8 elements in the column or the row.

In some embodiments, if the third number is no larger than the fourth number, a set of non-coherent precoding matrixes associated with the fourth number may be available for the PUSCH. In this case, each column or each row of the non-coherent precoding matrix may be with 1 non-zero value on 1 of the 8 elements. The non-zero value may be 1. The index of the 1 element may be based on the index of the antenna port in one antenna port group, and zero values on other 7 of the 8 elements in the column or the row. The indexes of the 1 element in different columns or different rows may be based on different antenna port groups.

Alternatively or in addition, if the third number is larger than the fourth number, a set of non-coherent precoding matrixes associated with the fourth number may not be available for the PUSCH. Alternatively, if the third number is not configured, the set of non-coherent precoding matrixes may be not available for the PUSCH. In some embodiments, if the third number is at least one of: 1, 2, 3, 4, 5, 6, 7, 8, the set of non-coherent precoding matrixes may comprise at least a precoding matrix with each column or each row of the precoding matrix is with 1 non-zero value on 1 of the 8 elements, and the non-zero value is 1. The index of the 1 element may be based on the index of column or row, and zero values on other 7 of the 8 elements in the column or the row. In other embodiments, if the third number is at least one of: 1, 2, 3, 4, the set of non-coherent precoding matrixes may comprise at least a precoding matrix with each column or each row of the precoding matrix is with 1 non-zero value on 1 of the first 4 elements, and the non-zero value is 1. The index of the 1 element may be based on the index of column or row, and zero values on other 7 elements in the column or the row.

In some embodiments, if the third number is same as the fourth number, the set of non-coherent precoding matrixes may comprise that at least a precoding matrix with each column or each row of the precoding matrix is with 1 non-zero value on 1 of the 8 elements, and the non-zero value is 1. The index of the 1 element in each column or row may be based on the index of each antenna port of the third number of antenna ports, and zero values on other 7 of the 8 elements in the column or the row.

Alternatively, if the third number is larger than the fourth number, the set of non-coherent precoding matrixes may comprise that at least a precoding matrix with each column or each row of the precoding matrix is with 1 non-zero value on 1 of the 8 elements, and the non-zero value is 1. The index of the 1 element in each column or row may be based on the index of one antenna port, and the antenna port is one of the fourth number out of the third number of antenna ports, and zero values on other 7 of the 8 elements in the column or the row. In some other embodiments, if the third number is smaller than the fourth number, non-coherent precoding matrix associated with the fourth number may not be available for the PUSCH.

In some embodiments, the at least one configuration may comprise an order of 8 antenna ports. The set of non-coherent precoding matrixes associated with the fourth number may comprise that at least a precoding matrix with each column or each row of the precoding matrix is with 1 non-zero value on 1 of the 8 elements, and the non-zero value is 1. The index of the 1 element in each column or row may be based on the index of one antenna port, and the antenna port is one of first fourth number of antenna ports out of the order of 8 antenna ports, and zero values on other 7 of the 8 elements in the column or the row. Alternatively, the at least one configuration may indicate precoding matrixes with is that a first set of antenna port elements in a 4-antenna port group is mapped with non-zero values.

In some embodiments, if the number of antenna port elements in the first set of antenna port element is smaller than the third number, the at least one configuration may indicate that precoding matrixes with that a second set of antenna port elements in a 2-antenna port group is mapped with non-zero values. Alternatively or in addition, if the number of antenna port elements in the first and second sets of antenna port elements is smaller than the third number, the at least one configuration may indicate that the precoding matrixes with that a third set of antenna port elements which is not in the 4-antenna port group or 2-antenna port group is mapped with non-zero values. In other embodiments, the at least one configuration may indicate that precoding matrixes with that the first third number of antenna ports elements are used for mapping non-zero values in the third number of columns in the precoding matrix.

In some embodiments, if the number of layers is 8, there may be only one non-coherent precoding matrix (Set_n8_1). The non-coherent precoding matrix may always be included.

In some embodiments, if the number of layers (represented as “v”) is 7, there may be only one non-coherent precoding matrix. The non-coherent precoding matrix may always be included. Table 48 shows an example of the non-coherent precoding matrix.

TABLE 48
$\frac{1}{\sqrt{8}} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ]$

For example, if the fourth number (represented as “L”) of columns of the precoding matrix with non-zero values is 7, the non-zero value may be mapped on the 7 AP_i+1 indexes. If L is 8, the non-zero value may be mapped on C(L, 7) AP_i+1 indexes. Otherwise the non-coherent precoder p_n7_1 is included. In some embodiments, the values of AP_i included in a 4-port group may be used firstly, then values of AP_i included in a 2-port group may be used, then values of AP_i not included in any one of 4-port group or 2-port group may be used. And if there are more than 7 available values of AP_i, the lowest 7 indexes are used. For example, if N₁ is 2 or N₂ is 2, p_n7_1 may be included. Alternatively, if N₁ is 1 or N₂ is 1, and M₁ is 1, AP_i included in the 4-port group and the two 2-port groups may be used, and the one with lower value in remaining two APs may be used. In some embodiments, if N₁ is 1 or N₂ is 1, and M₁ is 0, AP_i included in the 4-port group may be used, and the three ones with lower values in remaining four APs may be used. Alternatively, the first 7 APs in config_n1 may be used for mapping the value 1 in 7 columns.

In some embodiments, if the number of layers (represented as “v”) is 6, there may be only one non-coherent precoding matrix. The non-coherent precoding matrix may always be included. Table 49 shows an example of the non-coherent precoding matrix.

TABLE 49
$\frac{1}{\sqrt{8}} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ]$

For example, if the fourth number (represented as “L”) of columns of the precoding matrix with non-zero values is 6, the non-zero value may be mapped on the 6 AP_i+1 indexes. In some embodiments, if L is larger than 6, the non-zero values may be mapped on C(L, 6) AP_i+1 indexes. Otherwise the non-coherent p_n6_1 precoder may be included. Alternatively, the values of AP_i included in a 4-port group may be used firstly, then values of AP_i included in a 2-port group may be used, then values of AP_i not included in any one of 4-port group or 2-port group may be used. And if there are more than 6 available values of AP_i, the lowest 6 indexes may be used. In some other embodiments, the first 6 APs in config_n1 may be used for mapping the value 1 in 6 columns.

In some embodiments, if the number of layers (represented as “v”) is 5, there may be only one non-coherent precoding matrix. The non-coherent precoding matrix may always be included. Table 50 shows an example of the non-coherent precoding matrix.

TABLE 50
$\frac{1}{\sqrt{8}} [ \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0 \\ 0 & 0 & 0 & 0 & 0\end{matrix} ]$

For example, if the fourth number (represented as “L”) of columns of the precoding matrix with non-zero values is 5, the non-zero value may be mapped on the 6 AP_i+1 indexes. Alternatively, if L is larger than 5, the non-zero value may be mapped on C(L, 5) AP_i+1 indexes. Otherwise the non-coherent precoder p_n5_1 may be included. In some embodiments, the values of AP_i included in a 4-port group may be used firstly, then values of AP_i included in a 2-port group may be used, then values of AP_i not included in any one of 4-port group or 2-port group may be used. And if there are more than 5 available values of AP_i, the lowest 5 indexes may be used. In some other embodiments, the first 5 APs in config_n1 may be used for mapping the value 1 in 5 columns.

In some embodiments, if the number of layers (represented as “v”) is 4, there may be only one non-coherent precoding matrix. The non-coherent precoding matrix may always be included. Table 51 shows an example of the non-coherent precoding matrix.

TABLE 51
$\frac{1}{\sqrt{8}} [ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ]$

For example, if the fourth number (represented as “L”) of columns of the precoding matrix with non-zero values is 4, the non-zero value may be mapped on the 4 AP_i+1 indexes. Alternatively, if L is larger than 4, the non-zero value may be mapped on C(L, 4) AP_i+1 indexes. Otherwise the non-coherent p_n4_1 precoder may be included.

In some embodiments, the values of AP_i included in a 4-port group may be used firstly, then values of AP_i included in a 2-port group may be used, then values of A-P_i not included in any one of 4-port group or 2-port group may be used. And if there are more than 4 available values of AP_i, the lowest 4 indexes are used. For example, if N₁ is 1, N₂ is 2 or N₃ is 2, there may be two non-coherent precoders, each precoder with value one mapping on AP_i+1 index in a column, where AP_i is in one group. As another example, if N₁ is 1 or N₂ is 1 or N₃ is 1, there may be one non-coherent precoder, with value one mapping on AP_i+1 index in a column, and AP_i is in the group. In another embodiment, if N₁/N₂/N₃ is 0, and M₁ or M₂ or M₃ is not smaller than 2, the AP_i included in the M1 or M2 or M3 groups may be used, the non-zero value may be mapped on AP_i included in C(M3, 2) groups. In some other embodiments, the first 4 APs in config_n1 may be used for mapping the value 1 in 4 columns.

In some embodiments, if the number of layers (represented as “v”) is 3, there may be only one non-coherent precoding matrix. The non-coherent precoding matrix may always be included. Table 52 shows an example of the non-coherent precoding matrix.

TABLE 52
$\frac{1}{\sqrt{8}} [ \begin{matrix}1 & 0 & 0 \\ 0 & 1 & 0 \\ 0 & 0 & 1 \\ 0 & 0 & 0 \\ 0 & 0 & 0 \\ 0 & 0 & 0 \\ 0 & 0 & 0 \\ 0 & 0 & 0\end{matrix} ]$

For example, if the fourth number (represented as “L”) of columns of the precoding matrix with non-zero values is 3, the non-zero value may be mapped on the 3 AP_i+1 indexes. Alternatively, if L is larger than 3, the non-zero value may be mapped on C(L, 3) AP_i+1 indexes. Otherwise the non-coherent p_n3_1 precoder may be included. Alternatively, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and three values of AP_i may be selected in one group. There may be 2*C(4,3) non-coherent precoders, each precoder with value one mapping on AP_i+1 index in a column, where AP_i is in one group

Alternatively, if N₁ is 1 or N₂ is 1 or N₃ is 1, there may C(4,3) non-coherent precoders, with value one mapping on AP_i+1 index in a column, and three AP_i selected in the group. In other embodiments, if N₁/N₂/N₃ is 0, and M₁ or M₂ or M₃ is not smaller 2, the AP_i included in the M1 or M2 or M3 groups may be used, the non-zero value may be mapped on AP_i includes in C(M3, 2) groups and C(4,3) AP_i+1 indexes (or three lowest AP_i+1 indexes). In some other embodiments, the first 3 APs in config_n1 may be used for mapping the value 1 in 3 columns.

In some embodiments, if the number of layers (represented as “v”) is 2, there may be only one non-coherent precoding matrix. The non-coherent precoding matrix may always be included. Table 53 shows examples of the non-coherent precoding matrix.

TABLE 53

| | | | | | |
|---|---|---|---|---|---|
| $\frac{1}{\sqrt{8}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ]$ | $\frac{1}{\sqrt{8}} [ \begin{matrix}1 & 0 \\ 0 & 0 \\ 0 & 1 \\ 0 & 0 \\ 0 & 0 \\ 0 & 0 \\ 0 & 0 \\ 0 & 0\end{matrix} ]$ | $\frac{1}{\sqrt{8}} [ \begin{matrix}1 & 0 \\ 0 & 0 \\ 0 & 0 \\ 0 & 1 \\ 0 & 0 \\ 0 & 0 \\ 0 & 0 \\ 0 & 0\end{matrix} ]$ | $\frac{1}{\sqrt{8}} [ \begin{matrix}0 & 0 \\ 1 & 0 \\ 0 & 1 \\ 0 & 0 \\ 0 & 0 \\ 0 & 0 \\ 0 & 0 \\ 0 & 0\end{matrix} ]$ | $\frac{1}{\sqrt{8}} [ \begin{matrix}0 & 0 \\ 1 & 0 \\ 0 & 0 \\ 0 & 1 \\ 0 & 0 \\ 0 & 0 \\ 0 & 0 \\ 0 & 0\end{matrix} ]$ | $\frac{1}{\sqrt{8}} [ \begin{matrix}0 & 0 \\ 0 & 0 \\ 1 & 0 \\ 0 & 1 \\ 0 & 0 \\ 0 & 0 \\ 0 & 0 \\ 0 & 0\end{matrix} ]$ |

For example, if the fourth number (represented as “L”) of columns of the precoding matrix with non-zero values is 2, the non-zero value may be mapped on the 2 AP_i+1 indexes. Alternatively, if L is larger than 2, the non-zero value may be mapped on C(L, 2) AP_i+1 indexes. Otherwise the non-coherent p_n2_1 precoders may be included. In some embodiments, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and two values of AP_i may be selected in one group. There may be 2*C(4,2) non-coherent precoders, each precoder with value one mapping on AP_i+1 index in a column, where AP_i is in one group. In some embodiments, if N₁ is 1 or N₂ is 1 or N₃ is 1, there may be C(4,2) non-coherent precoders, with value one mapping on AP_i+1 index in a column, and two AP_i may be selected in the group. Alternatively, if N₁/N₂/N₃ is 0, and M₁ or M₂ or M₃ is not smaller than 2, the AP_i included in the M₁ or M₂ or M₃ groups may be used, the non-zero value may be mapped on AP_i includes in C(M3, 1) groups and the two APi+1 indexes. In some embodiments, the first 2 APs in config_n1 may be for mapping the non-zero value in two columns.

In some embodiments, if the number of layers (represented as “v”) is 1, there may be only one non-coherent precoding matrix. The non-coherent precoding matrix may always be included. Table 54 shows examples of the non-coherent precoding matrix.

TABLE 54

| | | | |
|---|---|---|---|
| $\frac{1}{\sqrt{8}} [ \begin{matrix}1 \\ 0 \\ 0 \\ 0 \\ 0 \\ 0 \\ 0 \\ 0\end{matrix} ]$ | $\frac{1}{\sqrt{8}} [ \begin{matrix}0 \\ 1 \\ 0 \\ 0 \\ 0 \\ 0 \\ 0 \\ 0\end{matrix} ]$ | $\frac{1}{\sqrt{8}} [ \begin{matrix}0 \\ 0 \\ 1 \\ 0 \\ 0 \\ 0 \\ 0 \\ 0\end{matrix} ]$ | $\frac{1}{\sqrt{8}} [ \begin{matrix}0 \\ 0 \\ 0 \\ 1 \\ 0 \\ 0 \\ 0 \\ 0\end{matrix} ]$ |

In some embodiment, there may be no need of configuration to indicate non-coherent precoders for one layer. There may be 8 precoders, with value 1 mapping on any one of the 8 elements.

For example, if the fourth number (represented as “L”) of columns of the precoding matrix with non-zero values is 1, the non-zero value may be mapped on the AP_i+1 index. Alternatively, if L is larger than 1, the non-zero value may be mapped on C(L, 1) AP_i+1 index. Otherwise the non-coherent p_n1_1 precoders may be included.

In some embodiments, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and one value of AP_i may be selected in one group. In some embodiments, there may be 2*C(4,1) non-coherent precoders, each precoder with value one mapping on AP_i+1 index in a column, where AP_i is in one group. In some embodiments, if N₁ is 1 or N₂ is 1 or N₃ is 1, there may be C(4,1) non-coherent precoders, with value one mapping on AP_i+1 index in a column, and one AP_i selected in the group. In some other embodiments, if N₁/N₂/N₃ is 0, and M₁ or M₂ or M₃ is not smaller than 2, the AP_i included in the M₁ or M₂ or M₃ groups may be used, the non-zero value may be mapped on AP_i includes in C(M3, 1) groups and the one of the two APi+1 indexes or fixed to the first one in the group. Alternatively, the first AP in config_n1 may be used for mapping the non-zero value.

As mentioned above, the terminal device 110-1 may receive information indicating that the PUSCH is scheduled associated with 8 antenna ports or associated with an SRS with 8 antenna ports. In this case, the DCI may indicate the fourth number of layers which is not smaller than a minimum number of layers and the minimum number of layers is one of 4, 5, 6, 7, or 8. The minimum number of layers may be predetermined or configured via higher layer. Alternatively, if the information indicates that the fourth number of layers is one of 1, 2, 3, 4, the terminal device 110-1 may expect that the PUSCH is scheduled associated with 1 or 2 or 4 antenna ports or associated with an SRS with 1 or 2 or 4 antenna ports.

For example, if the terminal device 110-1 is configured with 8Tx or 8-port SRS for uplink transmission, the number of layers indicated by a DCI may be at least one of {4, 5, 6, 7, 8}. In some embodiments, the candidate number of layers may be at least 4, for example, Lmin configured by RRC, and Lmin may be any one of {4,5,6,7,8}. In this case, the precoding matrix for PUSCH transmission may be based on the indicated number of layers. Alternatively, PUSCH transmission based on 8-port SRS is not expected to be 1-3 layers.

In some embodiments, for 1-3 or 1-4 layers transmission, the terminal device 110-1 may be configured with SRS resource set with maximum number of SRS ports to be 1 or 2 or 4. The 4-8 layers transmission with 8-port SRS and 1-3 (or 1-4) layers transmission based on 1/2/4-port SRS may be switched based on RRC or medium access control control element (MAC CE).

In some embodiments, the network device 120 may transmit a configuration of a set of SRS resources to the terminal device 110-1. In this case, a first subset of SRS resources in the set of SRS resources may be configured with 8 SRS ports, and a second subset of SRS resources in the set of SRS resources may be configured with a number of SRS ports which is not larger than 4.

For example, the terminal device 110-1 may be configured with a set of SRS resources (N_SRS, N_SRS may be {1, 2, 3, 4}) for codebook uplink transmission, and there may be N_SRS_1 resources configured with 8 ports (N_SRS_1 is integer and 1<=N_SRS_1<=N_SRS), and there may be N_SRS-N_SRS_1 resources configured with 1 or 2 or 4 ports. If the SRI indicates a SRS resource with 8 ports, more than 4 layers transmission may be applied. If the SRI indicates a SRS resource with 1/2/4 ports, 1-3 (or 1-4) layers transmission may be applied. The total bit size may be a maximum value between total size of “Precoding information and number of layers” and “Antenna ports” and a set of MCS/NDI/RV (8 bit) for 1-3 (or 1-4) layers and total size of “Precoding information and number of layers” and “Antenna ports” and two sets of MCS/NDI/RV (16 bits) for PUSCH transmission based on 8-port SRS. In some embodiments, reserved bits or zero padding may be applied for less value.

In some embodiments, 8-port SRS may be configured in a first BWP, and 1/2/4-port SRS may be configured in a second BWP In this case, switching between uplink transmission based on 8-port SRS and uplink transmission based on 1/2/4-port SRS can be based on BWP switching.

In some embodiments, the network device 120 may transmit information indicating that the PUSCH is scheduled associated with 8 antenna ports or associated with an SRS with 8 antenna ports to the terminal device 110-1. In this case, the terminal device 110-1 may apply applying at least one of a subset of precoding matrixes or a subset of number of layers, before the reception of the at least one configuration.

For example, if the terminal device 110-1 is configured with 8Tx or 8-port SRS for uplink transmission, a subset of precoders and/or a subset of number of layers may be applied as default. For example, non-coherent precoders may be used as the default precoding matrix. In some embodiment, the bit size for default precoders in DCI may be fixed, and the size is X bits. X can be positive integer, e.g. 5<=X<=11. For example, in case of non-coherent precoders, at least 5 bits may be needed for 1-8 layers. Table 55 shows examples of the default precoding matrix.

TABLE 55

| Number | |
|---|---|
| of layers | Precoders |
| 6 | Non-coherent precoders (p_n6_1) |
| | Partial-coherent precoders (Set_p6_2 with a |
| | fixed selection of antenna ports (e.g. first 6 |
| | columns for 8 layers)) or not included |
| | Full-coherent precoders (Set_f6_1) or not |
| | included |
| 5 | Non-coherent precoders (p_n5_1) |
| | Partial-coherent precoders (Set_p5_2 with a |
| | fixed selection of antenna ports (e.g. first 5 |
| | columns for 8 layers)) or not included |
| | Full-coherent precoders (Set_f5_1) or not |
| | included |
| 4 | Non-coherent precoders (p_n4_1) |
| | Partial-coherent precoders (Set_p4_2 with a |
| | fixed selection of antenna ports (e.g. first 4 |
| | columns for 8 layers)) or not included |
| | Full-coherent precoders (Set_f4_1) or not |
| | included |
| | Or legacy 4 layers precoders, with first 4 |
| | ports from the 8 ports, or with ports |
| | {0, 2, 4, 6} from the 8 ports |
| 3 | Non-coherent precoders (p_n3_1) |
| | Partial-coherent precoders (Set_p3_2 with a |
| | fixed selection of antenna ports (e.g. first 3 |
| | columns for 8 layers)) or not included |
| | Full-coherent precoders (Set_f3_1) or not |
| | included |
| | Or legacy 3 layers precoders, with first 4 |
| | ports from the 8 ports, or with ports |
| | {0, 2, 4, 6} from the 8 ports |
| 2 | Non-coherent precoders (p_n2_1) |
| | Partial-coherent precoders (Set_p2_2 with a |
| | fixed selection of antenna ports (e.g. first 2 |
| | columns for 8 layers)) or not included |
| | Full-coherent precoders (Set_f2_1) or not |
| | included |
| | Or legacy 2 layers precoders, with first 4 |
| | ports from the 8 ports, or with ports |
| | {0, 2, 4, 6} from the 8 ports |
| 1 | Non-coherent precoders (p_n1_1) |
| | Partial-coherent precoders (Set_p1_2 with a |
| | fixed selection of antenna ports (e.g. first |
| | column for 8 layers)) or not included |
| | Full-coherent precoders (Set_f1_1) or not |
| | included |
| | Or legacy 1 layer precoders, with first 4 |
| | ports from the 8 ports, or with ports |
| | {0, 2, 4, 6} from the 8 ports |

In some embodiment, the DCI may indicate the fourth number of layers in a separate field or combined in an antenna port field. The DCI may also indicate a precoding matrix based on the fourth number of layers. For example, if the terminal device 110-1 is configured with 8Tx or 8-port SRS for uplink transmission, the number of layers may be separately indicated in a separate field (e.g. 3 bits) or jointly indicated with antenna ports field. The precoding field may indicate the precoders based on the indicated number of layers. The size of precoding field may be determined based on the maximum value among the number of precoders for different layers. For example, based on number of precoders for 1 layer or 2 layers. In some embodiments, the bit size for precoding field in DCI may be Y bits. Y may be positive integer, e.g. Y may be {5,6,7,8}.

In some embodiments, the network device 120 may transmit information indicating that the PUSCH is scheduled associated with 8 antenna ports or associated with an SRS with 8 antenna ports. In this case, the DCI comprises at least one of the followings for the number of layers larger than 5: a modulation and coding scheme (MCS), a new data indicator (NDI), or a redundancy version (RV). For example, if the terminal device 110-1 is configured with 8Tx or 8-port SRS for uplink transmission, a second set of MCS/NDI/RV (8 bits) may be included which is used to indicate MCS/NDI/RV for the layers exceeding 4. If the number of layers is not larger than 4, the reserved 8 bits may be applied or combined with field of precoders.

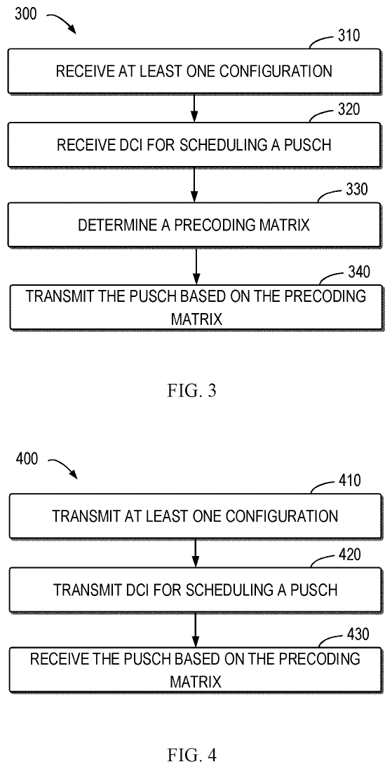

FIG. 3 shows a flowchart of an example method 300 in accordance with an embodiment of the present disclosure. The method 300 can be implemented at any suitable devices. Only for the purpose of illustrations, the method 300 can be implemented at a terminal device 110-1 as shown in FIG. 1.

In some embodiments, the terminal device 110-1 may receive information from the network device 120. The information may indicate that a PUSCH is scheduled associated with 8 antenna ports. For example, total number of antenna ports for the PUSCH transmission may be 8. Alternatively, the information may indicate that the PUSCH is scheduled associated with a sounding reference signal (SRS) with 8 antenna ports. In other words, the total number of antenna ports of a SRS associated with the PUSCH transmission is 8. In some embodiments, the information may be transmitted in a SRS configuration.

In some embodiments, the terminal device 110-1 may be configured or indicated with a number of layers (e.g. represented as v_ri) for the PUSCH transmission. For example, the number of layers v_ri may be at least one of {1,2,3,4,5,6,7,8}. In some embodiments, the terminal device 110-1 may be configured or indicated with a precoding matrix for the PUSCH transmission. In some embodiments, the size of the precoding matrix may be 8*v_ri or v_ri*8. In some embodiments, there may be v_ri columns or rows in the precoding matrix. In some embodiments, in a column or row of the precoding matrix, there may be 8 elements, and index of an element may be represented as idx, idx may be non-negative integer. For example, 0<=idx<=7. For another example, 1<=idx<=8.

For example, there may be a set of precoding matrixes for 8 transmitting (TX) uplink transmission or for PUSCH transmission associated with 8-port SRS. In some embodiments, the set of precoding matrix may comprise one or more full coherent precoding matrixes. Alternatively or in addition, the set of precoding matrix may comprise one or more partial-coherent precoding matrixes. Alternatively or in addition, the set of precoding matrix may comprise one or more non-coherent precoding matrixes. Alternatively or in addition, the set of precoding matrix may comprise one or more mixed partial and non-coherent precoding matrixes. In some embodiments, the set of precoding matrix may comprise one or more partial-coherent precoding matrixes. Alternatively or in addition, the set of precoding matrix may comprise one or more mixed partial and non-coherent precoding matrixes. Alternatively or in addition, the set of precoding matrix may comprise one or more non-coherent precoding matrixes. In some embodiments, the set of precoding matrix may comprise one or more non-coherent precoding matrixes.

In some embodiments, there may be a parameter “N₁”, and “N₁” may represent a number of ports in a first dimension. For example, “N₁” may be at least one of {1, 2, 4, 8}. For another example, “N₁” may be 2 or 4. In some embodiments, there may be a parameter “N2”, and “N2” may represent a number of ports in a second dimension. For example, “N₂” may be at least one of {1, 2, 4, 8}. For another example, “N2” may be 1 or 2. In some embodiments, there may be a parameter “O₁”, and “O₁” may represent a first discrete fourier transform (DFT) oversampling in the first dimension. For example, “O₁” may be at least one of {1, 2, 4}. For another example, “O₁” may be 2 or 4. In some embodiments, there may be a parameter “O₂”, and “O₂” may represent a second DFT oversampling in the second dimension. For example, “O₂” may be at least one of {1, 2, 4}. For another example, “O₂” may be 2 or 4.

In some embodiments, there may be a first vector uₘ. In some embodiments, uₘ may be a DFT vector. In some embodiments, if N₂>1,

$${u}_{m} = [ 1 , {e}^{j \frac{2 π m}{{O}_{2} {N}_{2}}} , … , {e}^{j \frac{2 π m ( {N}_{2} - 1 )}{{O}_{2} {N}_{2}}} ] .$$

In some embodiments, if N₂=2,

$${u}_{m} = [ 1 , {e}^{j \frac{2 π m}{{O}_{2} {N}_{2}}} ] .$$

In some embodiments, if N₂=1, uₘ=1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0.

In some embodiments, there may be a second vector v_{l,m}. In some embodiments,

$${v}_{l , m} = {[ {u}_{m} , {u}_{m} * {e}^{j \frac{2 π l}{{O}_{1} {N}_{1}}} , … , {u}_{m} * {e}^{j \frac{2 π l ( {N}_{1} - 1 )}{{O}_{1} {N}_{1}}} ]}^{T} .$$

In some embodiments, if N₁=2 and N₂=2,

$${v}_{l , m} = {[ 1 , {e}^{j \frac{2 π l}{{O}_{2} {N}_{2}}} , {e}^{j \frac{2 π l}{{O}_{1} {N}_{1}}} , {e}^{j \frac{2 π m}{{O}_{2} {N}_{2}}} , {e}^{j \frac{2 π l}{{O}_{1} {N}_{1}}} ]}^{T} .$$

In some embodiments, if N₁=4 and N₂=1,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, l may be a non-negative integer. For example, 0≤l≤O₁N₁. For another example, l may be at least one of {0, 2, 4, 6, 8}. For another example, l may be at least one of {0, 1, 2, 3}. For another example, l may be 0 or 1. In some embodiments, [ ]^{T} may represent a transposition of a vector or a matrix.

In some embodiments, there may be a factor φₙ. In some embodiments,

$${φ}_{n} = {e}^{j \frac{π n}{2}} .$$

In some embodiments, n may be a non-negative integer. For example, n may be at least one of {0, 1, 2, 3}. For another example, n may be 0 or 1. For another example, n may be 0 or 2. For another example, n may be 0.

In some embodiments, if the terminal device 110-1 is indicated with the number of layers as 8, there may be a first set of precoding matrixes corresponding to 8 layers (e.g. a first set of full coherent precoding matrixes), and a full coherent precoding matrix may be represented as W_{l,l′,l″,l′″,m,m′,m″,m′″,n}⁽⁸⁾.

In some embodiments, W_{l,l′,l″,l′″,m,m′,m″,m′″,n}⁽⁸⁾ may be

$$\frac{1}{\sqrt{8 * P}} [ \begin{matrix}{v}_{l , m} \\ {φ}_{n} * {v}_{l , m}\end{matrix} \begin{matrix}{v}_{l , m} \\ - {φ}_{n} * {v}_{l , m}\end{matrix} \begin{matrix}{v}_{{l}^{′} , {m}^{′}} \\ {φ}_{n} * {v}_{{l}^{′} , {m}^{′}}\end{matrix} \begin{matrix}{v}_{{l}^{′} , {m}^{′}} \\ - {φ}_{n} * {v}_{{l}^{′} , {m}^{′}}\end{matrix} \begin{matrix}{v}_{{l}^{″} , {m}^{″}} \\ {φ}_{n} * {v}_{{l}^{″} , {m}^{″}}\end{matrix} \begin{matrix}{v}_{{l}^{″} , {m}^{″}} \\ - {φ}_{n} * {v}_{{l}^{″} , {m}^{″}}\end{matrix} \begin{matrix}{v}_{{l}^{′′′} , {m}^{′′′}} \\ {φ}_{n} * {v}_{{l}^{′′′} , {m}^{′′′}}\end{matrix} \begin{matrix}{v}_{{l}^{′′′} , {m}^{′′′}} \\ - {φ}_{n} * {v}_{{l}^{′′′} , {m}^{′′′}}\end{matrix} ] .$$

In some embodiments, W_{l,l′,l″,l′″,m,m′,m″,m′″,n}⁽⁸⁾ may be

$$\frac{1}{\sqrt{8 * P}} [ \begin{matrix}{v}_{l , m} \\ {φ}_{n} * {v}_{l , m}\end{matrix} \begin{matrix}{v}_{l , m} \\ - {φ}_{n} * {v}_{l , m}\end{matrix} \begin{matrix}{v}_{{l}^{′} , {m}^{′}} \\ {φ}_{n} * {v}_{{l}^{′} , {m}^{′}}\end{matrix} \begin{matrix}{v}_{{l}^{′} , {m}^{′}} \\ - {φ}_{n} * {v}_{{l}^{′} , {m}^{′}}\end{matrix} \begin{matrix}{v}_{{l}^{″} , {m}^{″}} \\ {v}_{{l}^{″} , {m}^{″}}\end{matrix} \begin{matrix}{v}_{{l}^{″} , {m}^{″}} \\ - {v}_{{l}^{″} , {m}^{″}}\end{matrix} \begin{matrix}{v}_{{l}^{′′′} , {m}^{′′′}} \\ {v}_{{l}^{′′′} , {m}^{′′′}}\end{matrix} \begin{matrix}{v}_{{l}^{′′′} , {m}^{′′′}} \\ - {v}_{{l}^{′′′} , {m}^{′′′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, l′″=l+3O₁. In some embodiments, m and m′ and m″ and m′″ may be 0. In some embodiments, l′=l+O₁. In some embodiments, l″=l. In some embodiments, l′″=l+O₁. In some embodiments, m′=m. In some embodiments, m″=m+O₂. In some embodiments, m′″=m+O₂.

In some embodiments, there may be more than one subset of precoding matrixes corresponding to 8 layers. In some embodiments, the first set of precoding matrixes corresponding to 8 layers may comprise more than one subset. For example, there may be two subsets of precoding matrixes.

In some embodiments, there may be a first subset of precoding matrixes corresponding to 8 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} \int {e}^{j \frac{2 π l * 3}{{O}_{1} {N}_{1}}} ]}^{T} .$$

In some embodiments, corresponding to the first subset, m and m′ and m″ and m′″ may be 0. In some embodiments, corresponding to the first subset, l′=l+O₁, l″=l+2O₁ and l′″=l+3O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 8 layers may be 32 or 16 or 8 or 4 or 2.

In some embodiments, there may be a second subset of precoding matrixes corresponding to 8 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l and l′″=l+O₁. In some embodiments, corresponding to the second subset, m′=m, m″=m+O₂ and m′″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 8 layers may be 128 or 32 or 16 or 8 or 4 or 2.

In some embodiments, N₁ may equal to 4, N₂ equals to 1, O₁ may equal to 2 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The set of precoding matrixes “Set_f8_1” may comprise 16 precoding matrixes. In some embodiments, the set of precoding matrixes “Set_f8_1” may comprise 8 precoding matrixes. Alternatively, the set of precoding matrixes “Set_f8_1” may comprise 4 precoding matrixes. In other embodiments, the set of precoding matrixes “Set_f8_1” may comprise 2 precoding matrixes.

Alternatively, N₁ may equal to 2, N₂ equals to 2, O₁ may equal to 1 or 4, and O₂ may equal to 2 or 4, i_{1,1} or i_{1, 2} may be one of {0, . . . 7} or {0, 2, 4, 6} or {0, 4} or {0, . . . 3} or {0, 2} or {0,1} or 0. The set of precoding matrixes “Set_f8_2” may comprise 128 precoding matrixes. In some embodiments, the set of precoding matrixes “Set_f8_2” may comprise 32 precoding matrixes. Alternatively, the set of precoding matrixes “Set_f8_2” may comprise 8 precoding matrixes. In other embodiments, the set of precoding matrixes “Set_f8_2” may comprise 2 precoding matrixes.

In some embodiments, if the terminal device 110-1 is indicated with the number of layers as 8, there may be a second set of precoding matrixes (e.g. a second set of partial coherent precoding matrixes) corresponding to 8 layers. For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 8 layers, for example, represented as “Set_p8_1”, and the size of a partial coherent precoding matrix may be 8 multiplies 8. In some embodiments, there may be 8 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent precoding matrix may be with non-zero value. And the other 4 elements in the partial coherent precoding matrix may be with value of 0. In some embodiments, there may be 4 columns or rows out of the 8 columns or rows (e.g. a first set of 4 columns or rows) in the precoding matrix, and in each column or row, non-zero values may be mapped on 4 out of 8 elements and 0 may be mapped on the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of antenna ports in the first group with 4 antenna ports. In some embodiments, for the other 4 columns or rows out of the 8 columns or rows (e.g. a second set of 4 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 4 columns or rows. For example, the indexes of the 4 elements with non-zero values may be idx_2, and idx_2 may be 4 values out of {0,1,2,3,4,5,6,7} or {1,2,3,4,5,6,7,8}. For example, idx_2 may be {4,5,6,7} or {1,3,5,7} or {5,6,7,8} or {2,4,6,8}. In some embodiments, the 4 values of idx_2 may be based on the indexes of antenna ports in the second group with 4 antenna ports. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the set of precoding matrixes “Set_p8_1” may comprise 280 precoding matrixes which is C(2,1)*C(2,1)*C(8,4). In some embodiments, C(x,y) may represent permutation and combination. For example, C(x,y) may represent number of possibilities of selecting y values out of x values.

In some embodiments, examples of a precoding matrix of the second set of precoding matrixes corresponding to 8 layers may be as:

$$\frac{1}{\sqrt{{s}_{8}}} [ \begin{matrix}a 1 & b 1 & c 1 & d 1 & 0 & 0 & 0 & 0 \\ a 2 & b 2 & c 2 & d 2 & 0 & 0 & 0 & 0 \\ a 3 & b 3 & c 3 & d 3 & 0 & 0 & 0 & 0 \\ a 4 & b 4 & c 4 & d 4 & 0 & 0 & 0 & 0 \\ 0 & 0 & 0 & 0 & e 1 & f 1 & g 1 & h 1 \\ 0 & 0 & 0 & 0 & e 2 & f 2 & g 2 & h 2 \\ 0 & 0 & 0 & 0 & e 3 & f 3 & g 3 & h 3 \\ 0 & 0 & 0 & 0 & e 4 & f 4 & g 4 & h 4\end{matrix} ] or$$

$$\frac{1}{\sqrt{{s}_{8}}} [ \begin{matrix}a 1 & b 1 & c 1 & d 1 & 0 & 0 & 0 & 0 \\ 0 & 0 & 0 & 0 & e 1 & f 1 & g 1 & h 1 \\ a 2 & b 2 & c 2 & d 2 & 0 & 0 & 0 & 0 \\ 0 & 0 & 0 & 0 & e 2 & f 2 & g 2 & h 2 \\ a 3 & b 3 & c 3 & d 3 & 0 & 0 & 0 & 0 \\ 0 & 0 & 0 & 0 & e 3 & f 3 & g 3 & h 3 \\ a 4 & b 4 & c 4 & d 4 & 0 & 0 & 0 & 0 \\ 0 & 0 & 0 & 0 & e 4 & f 4 & g 4 & h 4\end{matrix} ]$$

For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f, f4], [g1, g2, g3, g4] and [h1, h2, h3, h4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4], [f1, f2, f3, f4], [g1, g2, g3, g4] and [h1, h2, h3, h4] may be [1; 1; 1; 1], [1; −1; 1; −1], [1;1;−1;−1] and [1;−1;−1;1], respectively. For another example, [e1, e2, e3, e4], [f1, f2, f3, f4], [g1, g2, g3, g4] and [h1, h2, h3, h4] may be [1; 1; j; j], [1; −1; j −j], [1; 1; −j; −j] and [1; −1; −j; j], respectively.

In some embodiments, s₈ may a positive integer. For example, 1≤s₈≤64. For example, s₈ may be 64 or 32 or 16 or 8 or 4 or 2.

In some embodiments, if the terminal device 110-1 is indicated with the number of layers as 8, there may be a third set of precoding matrixes (e.g. a third set of partial coherent precoding matrixes) corresponding to 8 layers. For example, the structure of 8 ports may be 2+2+2+2, which means that there are 4 groups, each group including 2 antenna ports and in each group, the 2 antenna ports can be coherent. For example, between the groups, the antenna ports may not be coherent. In some embodiments, there may be a third set of precoding matrixes (e.g. a third set of partial coherent precoding matrixes) corresponding to 8 layers, for example, represented as “Set_p8_2”, and the size of a precoding matrix may be 8 multiplies 8. In some embodiments, there may be 8 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 8 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 8 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of the other two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 2 columns or rows out of the 8 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 2 columns or rows out of the 8 columns or rows (e.g. a fourth set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of the other two of the 4 antenna ports in the first group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other.

In some embodiments, there may be a set of 4 length-2 vectors, and each one of the length-2 vector may be applied as the two non-zero values in a column or row of the precoding matrix. In some embodiments, for the third set of precoding matrix Set_p8_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. For example, Table 3 below shows example of the set of length-2 vectors. In some embodiments, for the first set of 2 columns or rows and/or for the second set of 2 columns or rows and/or for the third set of 2 columns or rows and/or for the fourth set of 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 8 layers may be as:

$$\frac{1}{\sqrt{{s}_{8}}} [ \begin{matrix}a 1 & b 1 & 0 & 0 & 0 & 0 & 0 & 0 \\ a 2 & b 2 & 0 & 0 & 0 & 0 & 0 & 0 \\ 0 & 0 & c 1 & d 1 & 0 & 0 & 0 & 0 \\ 0 & 0 & c 2 & d 2 & 0 & 0 & 0 & 0 \\ 0 & 0 & 0 & 0 & e 1 & f 1 & 0 & 0 \\ 0 & 0 & 0 & 0 & e 2 & f 2 & 0 & 0 \\ 0 & 0 & 0 & 0 & 0 & 0 & g 1 & h 1 \\ 0 & 0 & 0 & 0 & 0 & 0 & g 2 & h 2\end{matrix} ] or$$

$$\frac{1}{\sqrt{{s}_{8}}} [ \begin{matrix}a 1 & b 1 & 0 & 0 & 0 & 0 & 0 & 0 \\ 0 & 0 & c 1 & d 1 & 0 & 0 & 0 & 0 \\ a 2 & b 2 & 0 & 0 & 0 & 0 & 0 & 0 \\ 0 & 0 & c 2 & d 2 & 0 & 0 & 0 & 0 \\ 0 & 0 & 0 & 0 & e 1 & f 1 & 0 & 0 \\ 0 & 0 & 0 & 0 & 0 & 0 & g 1 & h 1 \\ 0 & 0 & 0 & 0 & e 2 & f 2 & 0 & 0 \\ 0 & 0 & 0 & 0 & 0 & 0 & g 2 & h 2\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, each of [g1, g2] and [h1, h2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [g1, g2] and [h1, h2] may be [1; 1], [1; −1], respectively. For another example, [g1, g2] and [h1, h2] may be [1; j], [1; −j], respectively.

In some embodiments, if the terminal device 110-1 is indicated with the number of layers as 8, there may be a fourth set of precoding matrixes (e.g. a fourth set of non-coherent precoding matrixes) corresponding to 8 layers. For example, each one of 8 antenna ports may be non-coherent with each other. In some embodiments, there may be a fourth set of precoding matrixes corresponding to 8 layers(e.g. a fourth set of non-coherent precoding matrixes), for example, represented as “Set_n8_1”, and the size of a precoding matrix may be 8 multiplies 8. In some embodiments, there may be 8 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 8 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5 idx_6 idx_7 idx_8 for the first, second, third, fourth, fifth, sixth, seventh, eighth column or row of the precoding matrix, respectively, and for each one of idx_1, idx_2, idx_3, idx_4, idx_5, idx_6, idx_7, idx_8, the value may be 1 value out of {0,1,2,3,4,5,6,7} or {1,2,3,4,5,6,7,8}. For example, the value of idx_1, idx_2, idx_3, idx_4, idx_5, idx_6, idx_7, idx_8 may be 0, 1, 2, 3, 4, 5, 6, 7, respectively. For another example, the value of idx_1, idx_2, idx_3, idx_4, idx_5, idx_6, idx_7, idx_8 may be 1, 2, 3, 4, 5, 6, 7, 8, respectively. In some embodiments, the value of For example, the value of idx_1, idx_2, idx_3, idx_4, idx_5, idx_6 idx_7 idx_8 may be different from each other.

In some embodiments, if the terminal device 110-1 is indicated with number of layers is indicated as 8, there may be a fourth set of precoding matrixes corresponding to 8 layers. For example, there may be only one precoding matrix in the fourth set (e.g. non-coherent precoding matrix) corresponding to 8 layers. In some embodiments, Table 4 shows an example non-coherent precoding matrix.

In some embodiments, if the terminal device 110-1 is indicated with the number of layers as 8, there may be a fifth set of precoding matrixes (for example, mixed partial coherent precoding matrixes) corresponding to 8 layers. For example, the structure of the 8 ports may be 4+2+2, which means that 4 antenna ports can be coherent, 2 antenna ports can be coherent, and the other 2 antenna ports can be coherent. In some embodiments, there may be a fifth set of precoding matrixes corresponding to 8 layers (e.g. mixed partial coherent precoding matrix), for example, represented as “Set_p8_3”, and the size of a partial coherent precoding matrix may be 8 multiplies 8. In some embodiments, there may be 8 columns or rows of the precoding matrix. In some embodiments, there may be 8 elements in a column or row of the precoding matrix. In some embodiments, there may be 4 columns or rows out of the 8 columns or rows (e.g. a first set of 4 columns or rows) in the precoding matrix, and in each column or row, non-zero values may be mapped on 4 out of 8 elements and 0 may be mapped on the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, there may be 2 columns or rows out of the 8 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. For example, idx_2 may be {4, 5} or {1, 3} or {5, 6} or {2, 4}. In some embodiments, there may be 2 columns or rows out of the 8 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. For example, idx_3 may be {6, 7} or {5, 7} or {7, 8} or {6, 8}. In some embodiments, any value of idx_1, any value of idx_2 and any value of idx_3 may be different from each other. In some embodiments, the values in a length-4 vector of the first set of length-4 vectors or of the second set of length-4 vectors may be applied for the 4 non-zero values mapping on 4 elements in a column or row in the first set of 4 columns or rows of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the two values in a length-2 vector of the first set of length-2 vectors or of the second set of length-2 vectors may be applied as the two non-zero values mapping on 2 elements in a column or row of the second set of 2 columns or rows of the precoding matrix. In some embodiments, the two values in a length-2 vector of the first set of length-2 vectors or of the second set of length-2 vectors may be applied as the two non-zero values mapping on 2 elements in a column or row of the third set of 2 columns or rows of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix.

In some embodiments, 4 out of 8 columns may be mapped with length-4 vectors, and for 2 out of remaining 4 columns, each column may be mapped with length-2 vectors, and f remaining 3 columns, each column may be mapped with length-2 vectors.

In other embodiments, if the terminal device 110-1 is indicated with the number of layers as 8, there may be a sixth set of precoding matrixes (for example, mixed partial and non coherent precoding matrixes) corresponding to 8 layers. For example, the structure of 8 antenna ports may be 4+1+1+1+1, which means that 4 antenna ports can be coherent, and remaining 4 antenna ports may be non-coherent. In some embodiments, if the terminal device 110-1 is indicated with the number of layers as 8, there may be a seventh set of precoding matrixes (for example, mixed partial and non coherent precoding matrixes) corresponding to 8 layers. For example, the structure of the 8 ports may be 4+2+1+1, which means that 4 antenna ports can be coherent and 2 antenna ports can be coherent.

In some other embodiments, if the terminal device 110-1 is indicated with the number of layers as 8, there may be an eighth set of precoding matrixes (for example, mixed partial and non coherent precoding matrixes) corresponding to 8 layers. For example, the structure of the 8 ports may be 2+2+1+1+1+1, which means that 2 antenna ports can be coherent and 2 antenna ports can be coherent.

In some embodiments, the terminal device 110-1 is indicated with the number of layers as 7, there may be a first set of precoding matrixes corresponding to 7 layers (e.g. a first set of full coherent precoding matrixes), and a full coherent precoding matrix may be represented as W_{l,l′,l″,l′″,m,m′,m″,m′″,n}⁽⁷⁾.

In some embodiments, W_{l,l′,l″,l′″,m,m′,m″,m′″,n}⁽⁷⁾ may be

$$\frac{1}{\sqrt{7 * P}} [ \begin{matrix}{v}_{l , m} \\ {φ}_{n} * {v}_{l , m}\end{matrix} \begin{matrix}{v}_{l , m} \\ - {φ}_{n} * {v}_{l , m}\end{matrix} \begin{matrix}{v}_{{l}^{′} , {m}^{′}} \\ {φ}_{n} * {v}_{{l}^{′} , {m}^{′}}\end{matrix} \begin{matrix}{v}_{{l}^{″} , {m}^{″}} \\ {φ}_{n} * {v}_{{l}^{″} , {m}^{″}}\end{matrix} \begin{matrix}{v}_{{l}^{″} , {m}^{″}} \\ - {φ}_{n} * {v}_{{l}^{″} , {m}^{″}}\end{matrix} \begin{matrix}{v}_{{l}^{′′′} , {m}^{′′′}} \\ {φ}_{n} * {v}_{{l}^{′′′} , {m}^{′′′}}\end{matrix} \begin{matrix}{v}_{{l}^{′′′} , {m}^{′′′}} \\ - {φ}_{n} * {v}_{{l}^{′′′} , {m}^{′′′}}\end{matrix} ] .$$

In some embodiments, W_{l,l′,l″,l′″,m,m′,m″,m′″,n}⁽⁷⁾ may be

$$\frac{1}{\sqrt{7 * P}} [ \begin{matrix}{v}_{l , m} \\ {φ}_{n} * {v}_{l , m}\end{matrix} \begin{matrix}{v}_{l , m} \\ - {φ}_{n} * {v}_{l , m}\end{matrix} \begin{matrix}{v}_{{l}^{′} , {m}^{′}} \\ {φ}_{n} * {v}_{{l}^{′} , {m}^{′}}\end{matrix} \begin{matrix}{v}_{{l}^{″} , {m}^{″}} \\ {v}_{{l}^{″} , {m}^{″}}\end{matrix} \begin{matrix}{v}_{{l}^{″} , {m}^{″}} \\ - {v}_{{l}^{″} , {m}^{″}}\end{matrix} \begin{matrix}{v}_{{l}^{′′′} , {m}^{′′′}} \\ {v}_{{l}^{′′′} , {m}^{′′′}}\end{matrix} \begin{matrix}{v}_{{l}^{′′′} , {m}^{′′′}} \\ - {v}_{{l}^{′′′} , {m}^{′′′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, l′″=l+3O₁. In some embodiments, m and m′ and m″ and m′″ may be 0. In some embodiments, l′=l+O₁. In some embodiments, l″=l. In some embodiments, l′″=l+O₁. In some embodiments, m′=m. In some embodiments, m″=m+O₂. In some embodiments, m′″=m+O₂.

In some embodiments, there may be more than one subset of precoding matrixes corresponding to 7 layers. In some embodiments, the first set of precoding matrixes corresponding to 7 layers may comprise more than one subset. For example, there may be two subsets of precoding matrixes.

In some embodiments, there may be a first subset of precoding matrixes corresponding to 7 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π t * 3}{{O}_{1} {N}_{1}}} ]}^{T} .$$

In some embodiments, corresponding to the first subset, m and m′ and m″ and m′″ may be 0. In some embodiments, corresponding to the first subset, l′=l+O₁, l″=l+2O₁ and l′″=l+3O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 7 layers may be 32 or 16 or 8 or 4 or 2.

In some embodiments, there may be a second subset of precoding matrixes corresponding to 7 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l and l′″=l+O₁. In some embodiments, corresponding to the second subset, m′=m, m″=m+O₂ and m′″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 7 layers may be 128 or 32 or 16 or 8 or 4 or 2.

In some embodiments, N₁ may equal to 4, N₂ equals to 1, O₁ may equal to 2 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The first subset of precoding matrixes corresponding to 7 layers (e.g. “Set_f7_1”) may comprise 16 precoding matrixes. In some embodiments, the first subset of precoding matrixes “Set_f7_1” may comprise 8 precoding matrixes. Alternatively, the first subset of precoding matrixes “Set_f7_1” may comprise 4 precoding matrixes. In other embodiments, the first subset of precoding matrixes “Set_f7_1” may comprise 2 precoding matrixes.

Alternatively, N₁ may equal to 2, N₂ equals to 2, O₁ may equal to 1 or 4, and O₂ may equal to 2 or 4, i_{1,1} or i_{1, 2} may be one of {0, . . . 7} or {0, 2, 4, 6} or {0, 4} or {0, . . . 3} or {0, 2} or {0,1} or 0. The second subset of precoding matrixes corresponding to 7 layers (e.g. “Set_f7_2”) may comprise 128 precoding matrixes. In some embodiments, the second subset of precoding matrixes “Set_f7_2” may comprise 32 precoding matrixes. Alternatively, the second subset of precoding matrixes “Set_f7_2” may comprise 8 precoding matrixes. In other embodiments, the second subset of precoding matrixes “Set_f7_2” may comprise 2 precoding matrixes.

In some embodiments, the terminal device 110-1 is indicated with the number of layers as 7, there may be a second set of precoding matrixes corresponding to 7 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 7 layers, for example, represented as “Set_p7_1”, and the size of a partial coherent precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be 4 columns or rows out of the 7 columns or rows (e.g. a first set of 4 columns or rows) in the precoding matrix, and in each column or row, the non-zero values may be mapped on 4 out of 8 elements and 0 for the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of the 4 antenna ports in the first group. In some embodiments, for the other 3 columns or rows out of the 7 columns or rows (e.g. a second set of 3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the set of precoding matrixes “Set_p7_1” may comprise C(2,1)*C(7,4)*C(2,1)*C(4,3) precoding matrixes. In some embodiments, examples of a precoding matrix of the second set of precoding matrixes corresponding to 7 layers may be as:

$$\frac{1}{\sqrt{{s}_{7}}} [ \begin{matrix}\begin{matrix}a 1 & b 1 & c 1 & d 1 \\ a 2 & b 2 & c 2 & d 2 \\ a 3 & b 3 & c 3 & d 3 \\ a 4 & b 4 & c 4 & d 4\end{matrix} & \begin{matrix}0 & 0 & 0 \\ 0 & 0 & 0 \\ 0 & 0 & 0 \\ 0 & 0 & 0\end{matrix} \\ \begin{matrix}0 & 0 & 0 & 0 \\ 0 & 0 & 0 & 0 \\ 0 & 0 & 0 & 0 \\ 0 & 0 & 0 & 0\end{matrix} & \begin{matrix}e 1 & f 1 & g 1 \\ e 2 & f 2 & g 2 \\ e 3 & f 3 & g 3 \\ e 4 & f 4 & g 4\end{matrix}\end{matrix} ] or$$

$$\frac{1}{\sqrt{{s}_{7}}} [ \begin{matrix}a 1 & b 1 & c 1 & d 1 & 0 & 0 & 0 \\ 0 & 0 & 0 & 0 & e 1 & f 1 & g 1 \\ a 2 & b 2 & c 2 & d 2 & 0 & 0 & 0 \\ 0 & 0 & 0 & 0 & e 2 & f 2 & g 2 \\ a 3 & b 3 & c 3 & d 3 & 0 & 0 & 0 \\ 0 & 0 & 0 & 0 & e 3 & f 3 & g 3 \\ a 4 & b 4 & c 4 & d 4 & 0 & 0 & 0 \\ 0 & 0 & 0 & 0 & e 4 & f 4 & g 4\end{matrix} ]$$

For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f3, f4], [g1, g2, g3, g4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4], [f1, f2, f3, f4], [g1, g2, g3, g4] may be 3 vectors out of [1; 1; 1; 1], [1; −1; 1; −1], [1;1;−1;−1] and [1;−1;−1;1]. For another example, [e1, e2, e3, e4], [f1, f2, 3, f4], [g1, g2, g3, g4]] may be 3 vectors out of [1; 1; j; j], [1; −1; j; −j], [1; 1; −j; −j] and [1; −1; −j; j].

In some embodiments, s₇ may a positive integer. For example, 1 s₇≤64. For example, s₇ may be 64 or 32 or 16 or 8 or 4 or 2 or 56 or 28 or 14.

In some embodiments, if the terminal device 110-1 is indicated with the number of layers as 7, there may be a third set of precoding matrixes (e.g. a third set of partial coherent precoding matrixes) corresponding to 7 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p7_2”, and the size of a precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 7 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 7 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of the other two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 2 columns or rows out of the 7 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 column or row out of the 7 columns or rows (e.g. a fourth set of 1 column or row) in the precoding matrix, and in each column or row, non-zero values may be mapped on 2 out of 8 elements and 0 may be mapped on the other 6 elements. For example, the indexes of the 2 elements with non-zero values may be same in the fourth set of 1 column or row. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other.

In some embodiments, there may be a set of 4 length-2 vectors, and each one of the length-2 vector may be applied as the two non-zero values in a column or row of the precoding matrix. In some embodiments, for the third set of precoding matrix corresponding to 7 layers, e.g. Set_p7_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix.

In some embodiments, examples of a precoding matrix of the third set of precoding matrixes corresponding to 7 layers may be as:

$$\frac{1}{\sqrt{{s}_{7}}} [ \begin{matrix}\begin{matrix}a 1 & b 1 & 0 & 0 \\ a 2 & b 2 & 0 & 0 \\ 0 & 0 & c 1 & d 1 \\ 0 & 0 & c 2 & d 2\end{matrix} & \begin{matrix}0 & 0 & 0 \\ 0 & 0 & 0 \\ 0 & 0 & 0 \\ 0 & 0 & 0\end{matrix} \\ \begin{matrix}0 & 0 & 0 & 0 \\ 0 & 0 & 0 & 0 \\ 0 & 0 & 0 & 0 \\ 0 & 0 & 0 & 0\end{matrix} & \begin{matrix}e 1 & f 1 & 0 \\ e 2 & f 2 & 0 \\ 0 & 0 & g 1 \\ 0 & 0 & g 2\end{matrix}\end{matrix} ] or$$

$$\frac{1}{\sqrt{{s}_{7}}} [ \begin{matrix}\begin{matrix}a 1 & b 1 & 0 & 0 \\ 0 & 0 & c 1 & d 1 \\ a 2 & b 2 & 0 & 0 \\ 0 & 0 & c 2 & d 2\end{matrix} & \begin{matrix}0 & 0 & 0 \\ 0 & 0 & 0 \\ 0 & 0 & 0 \\ 0 & 0 & 0\end{matrix} \\ \begin{matrix}0 & 0 & 0 & 0 \\ 0 & 0 & 0 & 0 \\ 0 & 0 & 0 & 0 \\ 0 & 0 & 0 & 0\end{matrix} & \begin{matrix}e 1 & f 1 & 0 \\ 0 & 0 & g 1 \\ e 2 & f 2 & 0 \\ 0 & 0 & g 2\end{matrix}\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, [g1, g2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [g1, g2] may be one of [1; 1], [1; −1]. For another example, [g1, g2] may be one of [1; j], [1; −j], respectively.

In some embodiments, if the terminal device 110-1 is indicated with the number of layers as 7, there may be a fourth set of precoding matrixes (e.g. a fourth set of non-coherent precoding matrixes) corresponding to 7 layers. For example, each one of 8 antenna ports may be non-coherent with each other. In some embodiments, there may be a fourth set of precoding matrixes (e.g. a fourth set of non-coherent precoding matrixes), for example, represented as “Set_n7_1”, and the size of a precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 7 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5, idx_6, idx_7 for the first, second, third, fourth, fifth, sixth, seventh column or row of the precoding matrix, respectively, and for each one of idx_1, idx_2, idx_3, idx_4, idx_5, idx_6, idx_7, the value may be 1 value out of {0,1,2,3,4,5,6,7} or {1,2,3,4,5,6,7,8}. For example, the value of idx_1, idx_2, idx_3, idx_4, idx_5, idx_6, idx_7 may be 0, 1, 2, 3, 4, 5, 6, respectively. For another example, the value of idx_1, idx_2, idx_3, idx_4, idx_5, idx_6, idx_7 may be 1, 2, 3, 4, 5, 6, 7, respectively. In some embodiments, the values of idx_1, idx_2, idx_3, idx_4 may be based on the indexes of the 4 antenna ports in the first group. In some embodiments, the values of idx_5, idx_6 and idx_7 may be based on the indexes of three out of the 4 antenna ports in the second group. In some embodiments, the values of idx_1, idx_2 may be based on the indexes of the 2 antenna ports in the third group. In some embodiments, the values of idx_3, idx_4 may be based on the indexes of the 2 antenna ports in the fourth group. In some embodiments, the values of idx_5, idx_6 may be based on the indexes of the 2 antenna ports in the fifth group. In some embodiments, the values of idx_7 may be based on the indexes of one out of the 2 antenna ports in the sixth group. For example, the value of idx_1, idx_2, idx_3, idx_4, idx_5, idx_6, idx_7 may be different from each other.

In some embodiments, if the terminal device 110-1 is indicated with number of layers is indicated as 7, there may be a fourth set of precoding matrixes corresponding to 7 layers. For example, there may be only one precoding matrix in the fourth set (e.g. non-coherent precoding matrix) corresponding to 7 layers.

In some embodiments, if the terminal device 110-1 is indicated with the number of layers as 7, there may be a fifth set of precoding matrixes (for example, mixed partial coherent precoding matrixes) corresponding to 7 layers. For example, the structure of the 8 ports may be 4+2+2, which means that 4 antenna ports can be coherent, 2 antenna ports can be coherent, and the other 2 antenna ports can be coherent. In this case, 4 out of 8 columns may be mapped with length-4 vectors, and for remaining 3 columns, each column may be mapped with length-2 vectors, and with ports swapped.

In other embodiments, if the terminal device 110-1 is indicated with the number of layers as 7, there may be a sixth set of precoding matrixes (for example, mixed partial and non coherent precoding matrixes) corresponding to 7 layers. For example, the structure of 8 antenna ports may be 4+1+1+1+1, which means that 4 antenna ports can be coherent.

In some embodiments, if the terminal device 110-1 is indicated with the number of layers as 7, there may be a seventh set of precoding matrixes (for example, mixed partial and non coherent precoding matrixes) corresponding to 7 layers. For example, the structure of the 8 ports may be 4+2+1+1, which means that 4 antenna ports can be coherent and 2 antenna ports can be coherent.

In some other embodiments, if the terminal device 110-1 is indicated with the number of layers as 7, there may be an eighth set of precoding matrixes (for example, mixed partial and non coherent precoding matrixes) corresponding to 7 layers. For example, the structure of the 8 ports may be 2+2+1+1+1+1, which means that 2 antenna ports can be coherent and 2 antenna ports can be coherent. In some embodiments, the terminal device 110-1 is indicated with the number of layers as 6, there may be a first set of precoding matrixes corresponding to 6 layers (e.g. a first set of full coherent precoding matrixes), and a full coherent precoding matrix may be represented as W_{l,l′,l″,m,m′,m″,n}⁽⁶⁾.

In some embodiments, W_{l,l′,l″,m,m′,m″,n}⁽⁶⁾ may be

$$\frac{1}{\sqrt{6 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}}\end{matrix} ] .$$

In some embodiments, W_{l,l′,l″,m,m′,m″,n}⁽⁶⁾ may be

$$\frac{1}{\sqrt{6 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {v}_{{l}^{″} , {m}^{″}} & - {v}_{{l}^{″} , {m}^{″}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, m and m′ and m″ may be 0. In some embodiments, l′=l+O₁. In some embodiments, l″=l+O₁. In some embodiments, m′=m. In some embodiments, m″=m+O₂.

In some embodiments, there may be more than one subset of precoding matrixes corresponding to 6 layers. In some embodiments, the first set of precoding matrixes corresponding to 6 layers may comprise more than one subset. For example, there may be two subsets of precoding matrixes.

In some embodiments, there may be a first subset of precoding matrixes corresponding to 6 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ and m″ may be 0. In some embodiments, corresponding to the first subset, l′=l+O₁, l″=l+2O₁. In some embodiments, corresponding to the first subset, 1 may be a non-negative integer, 0≤l≤O₁N₁. For example, l may be at least one of {0, 2, 4, 6}. For another example, 1 may be at least one of {0, 1, 2, 3}. For another example, l may be 0 or 1. For another example, l may be 0 or 2. In some embodiments, the number of precoding matrixes in the first subset corresponding to 6 layers may be 32 or 16 or 8 or 4 or 2.

In some embodiments, there may be a second subset of precoding matrixes corresponding to 6 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l+O₁. In some embodiments, corresponding to the second subset, m′=m, m″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 6 layers may be 128 or 32 or 16 or 8 or 4 or 2.

In some embodiments, N₁ may equal to 4, N₂ equals to 1, O₁ may equal to 2 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The first subset of precoding matrixes corresponding to 6 layers, e.g. “Set_f6_1” may comprise 16 precoding matrixes. In some embodiments, the first subset of precoding matrixes “Set_f6_1” may comprise 8 precoding matrixes. Alternatively, the first subset of precoding matrixes “Set_f6_1” may comprise 4 precoding matrixes. In other embodiments, the first subset of precoding matrixes “Set_f6_1” may comprise 2 precoding matrixes.

Alternatively, N₁ may equal to 2, N₂ equals to 2, O₁ may equal to 1 or 4, and O₂ may equal to 2 or 4, i_{1,1} or i_{1, 2} may be one of {0, . . . 7} or {0, 2, 4, 6} or {0, 4} or {0, . . . 3} or {0, 2} or {0,1} or 0. The second subset of precoding matrixes corresponding to 6 layers, e.g. “Set_f6_2” may comprise 128 precoding matrixes. In some embodiments, the second subset of precoding matrixes “Set_f6_2” may comprise 32 precoding matrixes. Alternatively, the second subset of precoding matrixes “Set_f6_2” may comprise 8 precoding matrixes. In other embodiments, the second subset of precoding matrixes “Set_f6_2” may comprise 2 precoding matrixes.

In some embodiments, the terminal device 110-1 is indicated with the number of layers as 6, there may be a second set of precoding matrixes corresponding to 6 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 6 layers, for example, represented as “Set_p6_1”, and the size of a partial coherent precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be 4 columns or rows out of the 6 columns or rows (e.g. a first set of 4 columns or rows) in the precoding matrix, and in each column, the non-zero value may be mapped on 4 out of 8 elements and 0 for the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of of the 4 antenna ports in the first group. In some embodiments, for other 2 columns, 2 of the first set or the second set of length-4 vectors may be selected. In some embodiments, for the other 2 columns or rows out of the 6 columns or rows (e.g. a second set of 2 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 2 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of two out of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, alternatively, 3 columns or rows out of the 6 columns or rows (e.g. a first set of 3 columns or rows) may be selected. In each column, the non-zero value may be mapped on 4 out of 8 elements, and 0 may be mapped for other 4 elements. For example, the indexes of the 4 elements with non-zero values may be same in the first set of 3 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of of the 4 antenna ports in the first group. For example, idx_1 may be {0,1,2,3} or {0,2,4,6} or {1,2,3,4} or {1,3,5,7}. In some embodiments, for other 3 columns or rows, 3 length-4 vectors of the first set or second set of length-4 vectors may be selected. In some embodiments, for other 3 columns, 3 of the first set or the second set of length-4 vectors may be selected. In some embodiments, for the other 3 columns or rows out of the 6 columns or rows (e.g. a second set of 3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group. For example, idx_2 may be {4,5,6,7} or {1,3,5,7} or {5,6,7,8} or {2,4,6,8}. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, examples of a precoding matrix of the second set of precoding matrixes corresponding to 6 layers may be as:

$$\frac{1}{\sqrt{{s}_{6}}} [ \begin{matrix}\begin{matrix}a 1 & b 1 & c 1 & d 1 \\ a 2 & b 2 & c 2 & d 2 \\ a 3 & b 3 & c 3 & d 3 \\ a 4 & b 4 & c 4 & d 4\end{matrix} & \begin{matrix}0 & 0 \\ 0 & 0 \\ 0 & 0 \\ 0 & 0\end{matrix} \\ \begin{matrix}0 & 0 & 0 & 0 \\ 0 & 0 & 0 & 0 \\ 0 & 0 & 0 & 0 \\ 0 & 0 & 0 & 0\end{matrix} & \begin{matrix}e 1 & f 1 \\ e 2 & f 2 \\ e 3 & f 3 \\ e 4 & f 4\end{matrix}\end{matrix} ] or \frac{1}{\sqrt{{s}_{6}}} [ \begin{matrix}\begin{matrix}a 1 & b 1 & c 1 \\ a 2 & b 2 & c 2 \\ a 3 & b 3 & c 3 \\ a 4 & b 4 & c 4\end{matrix} & \begin{matrix}0 & 0 & 0 \\ 0 & 0 & 0 \\ 0 & 0 & 0 \\ 0 & 0 & 0\end{matrix} \\ \begin{matrix}0 & 0 & 0 & d 1 \\ 0 & 0 & 0 & d 2 \\ 0 & 0 & 0 & d 3 \\ 0 & 0 & 0 & d 4\end{matrix} & \begin{matrix}e 1 & f 1 \\ e 2 & f 2 \\ e 3 & f 3 \\ e 4 & f 4\end{matrix}\end{matrix} ]$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f3, f4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−i] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1;j; −j], [1; 1; −j; −j] and [1; −1; −j; j], respectively. For example, [e1, e2, e3, e4], [f1, f2, f3, f4] may be 2 vectors out of [1; 1; 1; 1], [1; −1; 1; −1], [1;1;−1;−1] and [1;−1;−1;1]. For another example, [e1, e2, e3, e4], [f1, f2, f3, f4] may be 2 vectors out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, each of [d1, d2, d3, d4], [e1, e2, e3, e4], [f1, f2, f3, f4] may be one of the length-4 vectors in the first set of length-4 vectors or in the second set of length-4 vectors. For example, [a1, a2, a3, a4], [b1, b2, b3, b4], [c1, c2, c3, c4] may be three vectors out of [1; 1; 1; 1], [1; −1; 1; −1], [1;1;−1;−1] and [1;−1;−1;1]. For another example, [a1, a2, a3, a4], [b1, b2, b3, b4], [c1, c2, c3, c4] may be three of [1; 1; j; j], [1; −1; j; −j], [1; 1; −j; −j] and [1; −1; −j; j]. For example, [d1, d2, d3, d4], [e1, e2, e3, e4], [f1, f2, f3, f4] may be 3 vectors out of [1; 1; 1; 1], [1; −1; 1; −1], [1;1;−1;−1] and [1;−1;−1;1]. For another example, [d1, d2, d3, d4], [e1, e2, e3, e4], [f1, f2, f3, f4] may be 3 vectors out of [1; 1; j; j], [1; −1; j; −j], [1; 1; −j; −j] and [1; −1; −j; j].

In some embodiments, s₆ may a positive integer. For example, 1≤s₆≤64. For example, s₆ may be 64 or 32 or 16 or 8 or 4 or 2 or 48 or 24 or 12.

In some embodiments, if the terminal device 110-1 is indicated with the number of layers as 6, there may be a third set of precoding matrixes (e.g. a third set of partial coherent precoding matrixes) corresponding to 6 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p6_2”, and the size of a precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 6 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 6 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 6 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_1 may be based on the indexes of two out of the 4 antenna ports in the second group. In some embodiments, the 2 values of idx_1 may be based on the indexes of the 2 antenna ports in the fifth group.For example, idx_3 may be {4,5} or {4,6} or {5,6} or {5,7} or {2,6} or {3,7}. In some embodiments, there may be 1 or 2 columns or rows out of the 6 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 6. In some embodiments, there may be the first set, the second set and the third set, and each set with 2 columns or rows. In some embodiments, there may be the first set, the second set and the third set and fourth set, and each of two of the four sets with 2 columns or rows, and each of other two of the four sets with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 6 layers, e.g. Set_p6_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. In some embodiments, examples of a precoding matrix of the third set of precoding matrixes corresponding to 6 layers may be as:

$$\frac{1}{\sqrt{{s}_{6}}} [ \begin{matrix}\begin{matrix}a 1 & b 1 & 0 & 0 \\ a 2 & b 2 & 0 & 0 \\ 0 & 0 & c 1 & d 1 \\ 0 & 0 & c 2 & d 2\end{matrix} & \begin{matrix}0 & 0 \\ 0 & 0 \\ 0 & 0 \\ 0 & 0\end{matrix} \\ \begin{matrix}0 & 0 & 0 & 0 \\ 0 & 0 & 0 & 0 \\ 0 & 0 & 0 & 0 \\ 0 & 0 & 0 & 0\end{matrix} & \begin{matrix}e 1 & f 1 \\ e 2 & f 2 \\ 0 & 0 \\ 0 & 0\end{matrix}\end{matrix} ] or \frac{1}{\sqrt{{s}_{6}}} [ \begin{matrix}\begin{matrix}a 1 & b 1 & 0 & 0 \\ a 2 & b 2 & 0 & 0 \\ 0 & 0 & c 1 & d 1 \\ 0 & 0 & c 2 & d 2\end{matrix} & \begin{matrix}0 & 0 \\ 0 & 0 \\ 0 & 0 \\ 0 & 0\end{matrix} \\ \begin{matrix}0 & 0 & 0 & 0 \\ 0 & 0 & 0 & 0 \\ 0 & 0 & 0 & 0 \\ 0 & 0 & 0 & 0\end{matrix} & \begin{matrix}e 1 & 0 \\ e 2 & 0 \\ 0 & f 1 \\ 0 & f 2\end{matrix}\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [e1, e2] may be one of [1; 1], [1; −1], [1; j], [1; −j]. For example, [f1, f2] may be one of [1; 1], [1; −1], [1; j], [1; −j].

In some embodiments, if the terminal device 110-1 is indicated with the number of layers as 6, there may be a fourth set of precoding matrixes (e.g. a fourth set of non-coherent precoding matrixes) corresponding to 6 layers. For example, each one of 8 antenna ports may be non-coherent with each other. In some embodiments, there may be a fourth set of precoding matrixes (e.g. a fourth set of non-coherent precoding matrixes), for example, represented as “Set_n6_1”, and the size of a precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 6 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5, idx_6 for the first, second, third, fourth, fifth, sixth column or row of the precoding matrix, respectively, and for each one of idx_1, idx_2, idx_3, idx_4, idx_5, idx_6 the value may be 1 value out of {0,1,2,3,4,5,6,7} or {1,2,3,4,5,6,7,8}. In some embodiments, the values of idx_1, idx_2, idx_3, idx_4 may be based on the indexes of the 4 antenna ports in the first group. In some embodiments, the values of idx_1, idx_2, idx_3 may be based on the indexes of the three out of 4 antenna ports in the first group. In some embodiments, the values of idx_1 and idx_2 may be based on the indexes of 2 antenna ports in the third group. In some embodiments, the values of idx_3 and idx_4 may be based on the indexes of the 2 antenna ports in the fourth group. In some embodiments, the values of idx_5, idx_6 may be based on the indexes of two out of the 4 antenna ports in the second group. In some embodiments, the values of idx_5, idx_6 may be based on the indexes of the 2 antenna ports in the fifth group. In some embodiments, the values of idx_5, idx_6 may be based on the indexes of the 2 antenna ports in the sixth group. For example, the value of idx_1, idx_2, idx_3, idx_4, idx_5, idx_6 may be 0, 1, 2, 3, 4, 5, respectively. For another example, the value of idx_1, idx_2, idx_3, idx_4, idx_5, idx_6 may be 1, 2, 3, 4, 5, 6, respectively. For example, the value of idx_1, idx_2, idx_3, idx_4, idx_5, idx_6 may be different from each other.

In some embodiments, if the terminal device 110-1 is indicated with number of layers is indicated as 6, there may be a fourth set of precoding matrixes corresponding to 6 layers. For example, there may be only one precoding matrix in the fourth set (e.g. non-coherent precoding matrix) corresponding to 6 layers.

In some embodiments, if there are 6 layers at the terminal device 110-1, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 2, 3, or 4) columns may be mapped with length-4 vectors, and 6-r1 column may be mapped with length-2 vectors, and with ports swapped. In other embodiments, the antenna structure may be 4+1+1+1+1, which means that 4 antenna ports can be coherent. In this case, r1 (for example, 2 or 3 or 4) columns may be with length-4 vectors, 6-r1 columns may be with 1 on one element, and rows can be swap.

In some embodiments, the antenna structure may be 4+2+1+1, which means that 4 antenna ports can be coherent and 2 antenna ports can be coherent. For example, r1 (for example, 2 or 3 or 4) columns may be with length-4 vectors, and r2 (for example, 0,1,2) columns may be with length-2 vectors, and 6-r1-r2 columns may be with 1 on one element.

In some other embodiments, the antenna structure may be 2+2+1+1+1+1, which means that 2 antenna ports can be coherent and 2 antenna ports can be coherent. For example, r1 (for example, 2 or 3 or 4) columns may be with length-2 vectors, and 6-r1 columns may be with 1 on one element.

In some embodiments, the terminal device 110-1 is indicated with the number of layers as 5, there may be a first set of precoding matrixes corresponding to 5 layers (e.g. a first set of full coherent precoding matrixes), and a full coherent precoding matrix may be represented as W_{l,l′,l″,m,m′,m″,n}⁽⁵⁾.

In some embodiments, W_{l,l′,l″,m,m′,m″,n}⁽⁵⁾ may be

$$\frac{1}{\sqrt{5 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}}\end{matrix} ] .$$

In some embodiments, W_{l,l′,l″,m,m′,m″,n}⁽⁵⁾ may be

$$\frac{1}{\sqrt{5 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} * {v}_{l , m} & - {φ}_{n} * {v}_{l , m} & {v}_{{l}^{′} , {m}^{′}} & - {v}_{{l}^{′} , {m}^{′}} & {v}_{{l}^{″} , {m}^{″}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, m and m′ and m″ may be 0. In some embodiments, l′=l+O₁. In some embodiments, l″=l+O₁. In some embodiments, m′=m. In some embodiments, m″=m+02.

In some embodiments, there may be more than one subset of precoding matrixes corresponding to 5 layers. In some embodiments, the first set of precoding matrixes corresponding to 5 layers may comprise more than one subset. For example, there may be two subsets of precoding matrixes.

In some embodiments, there may be a first subset of precoding matrixes corresponding to 5 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ and m″ may be 0. In some embodiments, corresponding to the first subset, l′=l+O₁, l″=l+2O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 5 layers may be 32 or 16 or 8 or 4 or 2.

In some embodiments, there may be a second subset of precoding matrixes corresponding to 5 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l+O₁. In some embodiments, corresponding to the second subset, m′=m, m″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 5 layers may be 128 or 32 or 16 or 8 or 4 or 2.

In some embodiments, the terminal device 110-1 is indicated with the number of layers as 5, there may be a second set of precoding matrixes corresponding to 5 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 5 layers, for example, represented as “Set_p5_1”, and the size of a partial coherent precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C1 columns or rows out of the 5 columns or rows (e.g. a first set of C1 columns or rows. For example, C1 may be 1 or 2 or 3 or 4) in the precoding matrix, and in each column, the non-zero value may be mapped on 4 out of 8 elements and 0 for the other 4 elements. For example, the indexes of the 4 elements with non-zero values may be same in the first set of C1 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group. For example, idx_1 may be {0,1,2,3} or {0,2,4,6} or {1,2,3,4} or {1,3,5,7}. In some embodiments, for the other 5-C1 column, 5-C1 of the first set or second set of length-4 vectors may be selected. In some embodiments, for the other 5-C1 columns or rows out of the 5 columns or rows (e.g. a second set of 5-C1 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 5-C1 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, alternatively, 3 columns may be selected. In each column, the non-zero value may be mapped on 4 out of 8 elements, and 0 may be mapped for other 4 elements. For other 2 columns, one matrix and 2 vectors may be selected.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, examples of a precoding matrix of the second set of precoding matrixes corresponding to 5 layers may be as:

$$\frac{1}{\sqrt{{s}_{5}}} [ \begin{matrix}\begin{matrix}a 1 & b 1 & c 1 & d 1 \\ a 2 & b 2 & c 2 & d 2 \\ a 3 & b 3 & c 3 & d 3 \\ a 4 & b 4 & c 4 & d 4\end{matrix} & \begin{matrix}0 \\ 0 \\ 0 \\ 0\end{matrix} \\ \begin{matrix}0 & 0 & 0 & 0 \\ 0 & 0 & 0 & 0 \\ 0 & 0 & 0 & 0 \\ 0 & 0 & 0 & 0\end{matrix} & \begin{matrix}e 1 \\ e 2 \\ e 3 \\ e 4\end{matrix}\end{matrix} ] or \frac{1}{\sqrt{{s}_{5}}} [ \begin{matrix}\begin{matrix}a 1 & b 1 & c 1 \\ a 2 & b 2 & c 2 \\ a 3 & b 3 & c 3 \\ a 4 & b 4 & c 4\end{matrix} & \begin{matrix}0 & 0 \\ 0 & 0 \\ 0 & 0 \\ 0 & 0\end{matrix} \\ \begin{matrix}0 & 0 & 0 & d 1 \\ 0 & 0 & 0 & d 2 \\ 0 & 0 & 0 & d 3 \\ 0 & 0 & 0 & d 4\end{matrix} & \begin{matrix}e 1 \\ e 2 \\ e 3 \\ e 4\end{matrix}\end{matrix} ]$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [e1, e2, e3, e4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4] may be 1 vector out of [1; 1; 1; 1], [1; −1; 1; −1], [1;1;−1;−1] and [1;−1;−1;1]. For another example, [e1, e2, e3, e4] may be 1 vector out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, each of [d1, d2, d3, d4], [e1, e2, e3, e4] may be one of the length-4 vectors in the first set of length-4 vectors or in the second set of length-4 vectors. For example, [a1, a2, a3, a4], [b1, b2, b3, b4], [c1, c2, c3, c4] may be three vectors out of [1; 1; 1; 1], [1; −1; 1; −1], [1;1;−1;−1] and [1;−1;−1;1]. For another example, [a1, a2, a3, a4], [b1, b2, b3, b4], [c1, c2, c3, c4] may be three of [1; 1; j; j], [1; −1; j; −j], [1; 1; −j; −j] and [1; −1; −j; j]. For example, [d1, d2, d3, d4], [e1, e2, e3, e4] may be 2 vectors out of [1; 1; 1; 1], [1; −1; 1; −1], [1;1;−1;−1] and [1;−1;−1;1]. For another example, [d1, d2, d3, d4], [e1, e2, e3, e4] may be 2 vectors out of [1; 1; J; j][1; −1; j; −j], [1; 1; −j; −j] and [1; −1; −j; j].

In some embodiments, s₅ may a positive integer. For example, 1≤s₅≤64. For example, s₅ may be 64 or 32 or 16 or 8 or 4 or 2 or 40 or 20 or 10.

In some embodiments, if the terminal device 110-1 is indicated with the number of layers as 5, there may be a third set of precoding matrixes (e.g. a third set of partial coherent precoding matrixes) corresponding to 5 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p5_2”, and the size of a precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 5 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 1 or 2 columns or rows out of the 5 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 5 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 or 2 columns or rows out of the 5 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 5. In some embodiments, there may be the first set, the second set and the third set, and each of two of the three sets with 2 columns or rows, and one of the three sets with 1 column or row. In some embodiments, there may be the first set, the second set, the third set and the fourth set, and one of the four sets with 2 columns or rows, and each of three of the fourth sets with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 5 layers, e.g. Set_p5_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. In some embodiments, examples of a precoding matrix of the third set of precoding matrixes corresponding to 5 layers may be as:

$$\frac{1}{\sqrt{{s}_{5}}} [ \begin{matrix}\begin{matrix}a 1 & b 1 & 0 & 0 \\ a 2 & b 2 & 0 & 0 \\ 0 & 0 & c 1 & d 1 \\ 0 & 0 & c 2 & d 2\end{matrix} & \begin{matrix}0 \\ 0 \\ 0 \\ 0\end{matrix} \\ \begin{matrix}0 & 0 & 0 & 0 \\ 0 & 0 & 0 & 0 \\ 0 & 0 & 0 & 0 \\ 0 & 0 & 0 & 0\end{matrix} & \begin{matrix}e 1 \\ e 2 \\ 0 \\ 0\end{matrix}\end{matrix} ] or \frac{1}{\sqrt{{s}_{5}}} [ \begin{matrix}\begin{matrix}a 1 & b 1 & 0 & 0 \\ a 2 & b 2 & 0 & 0 \\ 0 & 0 & c 1 & 0 \\ 0 & 0 & c 2 & 0\end{matrix} & \begin{matrix}0 \\ 0 \\ 0 \\ 0\end{matrix} \\ \begin{matrix}0 & 0 & 0 & d 1 \\ 0 & 0 & 0 & d 2 \\ 0 & 0 & 0 & 0 \\ 0 & 0 & 0 & 0\end{matrix} & \begin{matrix}0 \\ 0 \\ e 1 \\ e 2\end{matrix}\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, [e1, e2], may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [c1, c2],[d1, d2], [e1, e2] may be any one of [1; 1], [1; −1], [1; j], [1; −j].

In some embodiments, if the terminal device 110-1 is indicated with the number of layers as 5, there may be a fourth set of precoding matrixes (e.g. a fourth set of non-coherent precoding matrixes) corresponding to 5 layers. For example, each one of 8 antenna ports may be non-coherent with each other. In some embodiments, there may be a fourth set of precoding matrixes (e.g. a fourth set of non-coherent precoding matrixes), for example, represented as “Set_n5_1”, and the size of a precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 5 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5 for the first, second, third, fourth, fifth column or row of the precoding matrix, respectively, and for each one of idx_1, idx_2, idx_3, idx_4, idx_5 the value may be 1 value out of {0,1,2,3,4,5,6,7} or {1,2,3,4,5,6,7,8}. For example, the value of idx_1, idx_2, idx_3, idx_4, idx_5 may be 0, 1, 2, 3, 4, respectively. For another example, the value of idx_1, idx_2, idx_3, idx_4, idx_5, may be 1, 2, 3, 4, 5, respectively. For example, the value of idx_1, idx_2, idx_3, idx_4, idx_5 may be different from each other.

In some embodiments, if the terminal device 110-1 is indicated with number of layers is indicated as 5, there may be a fourth set of precoding matrixes corresponding to 5 layers. For example, there may be only one precoding matrix in the fourth set (e.g. non-coherent precoding matrix) corresponding to 6 layers.

In some embodiments, if there are 5 layers at the terminal device 110-1, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 1, 2, 3, or 4) columns may be mapped with length-4 vectors, and 5-r1 column may be mapped with length-2 vectors, and with ports swapped. In other embodiments, the antenna structure may be 4+1+1+1+1, which means that 4 antenna ports can be coherent. In this case, r1 (for example, 1 or 2 or 3 or 4) columns may be with length-4 vectors, 5-r1 columns may be with 1 on one element, and rows can be swap.

In some embodiments, the antenna structure may be 4+2+1+1, which means that 4 antenna ports can be coherent and 2 antenna ports can be coherent. For example, r1 (for example, 1 or 2 or 3 or 4) columns may be with length-4 vectors, and r2 (for example, 0,1,2) columns may be with length-2 vectors, and 5-r1-r2 columns may be with 1 on one element. In some other embodiments, the antenna structure may be 2+2+1+1+1+1, which means that 2 antenna ports can be coherent and 2 antenna ports can be coherent. For example, r1 (for example, 1 or 2 or 3 or 4) columns may be with length-2 vectors, and 5-r1 columns may be with 1 on one element. In some embodiments, the terminal device 110-1 is indicated with the number of layers as 4, there may be a first set of precoding matrixes corresponding to 4 layers (e.g. a first set of full coherent precoding matrixes). In some embodiments, a full coherent precoding matrix may be represented as W_{l,l′,m,m′,n}⁽⁴⁾.

In some embodiments, W_{l,l′,m,m′,n}⁽⁴⁾ may be

$$\frac{1}{\sqrt{4 * P}} [ \begin{matrix}{v}_{l , m} & {v}_{{l}^{′} , {m}^{′}} & {v}_{l , m} & {v}_{{l}^{′} , {m}^{′}} \\ {φ}_{n} * {v}_{l , m} & {φ}_{n} * {v}_{{l}^{′} , {m}^{′}} & - {φ}_{n} * {v}_{l , m} & - {φ}_{n} * {v}_{{l}^{′} , {m}^{′}}\end{matrix} ]$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, O₁, 2O₁, 3O₁}. For another example, k₁ may be 0. In some embodiments, k₂ may be a non-negative integer. For example, k₂ may at least one of {0, O₂}. In some embodiments, k₂ may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1,2,3}. For another example, i_{1,3} may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=O₁ and/or k₂=0. In some embodiments, in case of N₁=4 and N₂=1, and in case of i_{1,3}=2, k₁=2O₁ and/or k₂=0. In some embodiments, in case of N₁=4 and N₂=1, and in case of i_{1,3}=3, k₁=3O₁ and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=O₁ and/or k₂=0.

In some embodiments, there may be more than one subset of precoding matrixes corresponding to 4 layers. In some embodiments, the first set of precoding matrixes corresponding to 4 layers may comprise more than one subset. For example, there may be two or three or four subsets of precoding matrixes.

In some embodiments, there may be a first subset of precoding matrixes corresponding to 4 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, 1 may be 0 or 2. In some embodiments, the number of precoding matrixes in the first subset corresponding to 4 layers may be 128 or 64 or 32 or 16 or 8 or 4 or 2.

In some embodiments, there may be a second subset of precoding matrixes corresponding to 4 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 4 layers may be 256 or 128 or 32 or 16 or 8 or 4 or 2.

In some embodiments, there may be a second factor aₚ. In some embodiments,

$${a}_{p} = {e}^{j \frac{π}{4}} * {e}^{j \frac{π p}{2}} .$$

In some embodiments, p may be a non-negative integer. For example, p may be at least one of {0, 1, 2, 3}. For another example, p may be 0 or 1. For another example, p may be 0 or 2. For another example, p may be 0.

In some embodiments, if the terminal device 110-1 is indicated with the number of layers as 4, there may be a third subset or a fourth subset of precoding matrixes. In some embodiments, there may be a third factor b_{nb}. In some embodiments,

$${b}_{n \_ b} = {e}^{- j \frac{π}{4}} * {e}^{j \frac{π n \_ b}{2}} .$$

In some embodiments, n_b may be a non-negative integer. For example, n_b may be at least one of {0, 1, 2, 3}. For another example, n_b may be 0 or 1. For another example, n_b may be 0 or 2. For another example, n_b may be 0.

In some embodiments, there may be a third vector W;n. In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, there may be a fourth vector W_{l,m,p,n}^{2,2,1}. In some embodiments,

$${W}_{l , m , p , n}^{2 , 2 , 1} = \frac{1}{\sqrt{8}} [ {v}_{l , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1}. For another example, i_{1,3} may be 0. In some embodiments, in case of N₁=2 and N₂=1, and in case of i_{1,3}=0, k₁=O₁ and/or k₂=0.

In some embodiments, there may be a third subset of precoding matrixes corresponding to 4 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, 1 may be 0 or 2. In some embodiments, the number of precoding matrixes in the third subset corresponding to 4 layers may be 64 or 32 or 16 or 8 or 4 or 2. In some embodiments, the terminal device 110-1 may be indicated with the number of layers as 4, a precoding matrix in the third subset of precoding matrixes corresponding to 4 layers may be represented as W_{l,l′,m,m40,p,n}⁽⁴⁾. In some embodiments, W_{l,l′,m,m40,p,n}⁽⁴⁾ may be

$$\frac{1}{\sqrt{4}} [ {W}_{l , m , p , n}^{1 , 2 , 1} {W}_{{l}^{′} , {m}^{′} , p , n}^{1 , 2 , 1} {W}_{l , m , p , n}^{2 , 2 , 1} {W}_{{l}^{′} , {m}^{′} , p , n}^{2 , 2 , 1} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p1.

In some embodiments, there may be a fifth vector W_{l,m,p,n}^{1,2,2}. In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments, there may be a sixth vector W_{l,m,p,n}^{2,2,2}. In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of no may be at least one of {0,1,2,3} or {0,1} or {0,2}. In some embodiments, the value of no may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 4 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 4 layers may be 64 or 32 or 16 or 8 or 4 or 2 In some embodiments, the terminal device 110-1 may be indicated with the number of layers as 4, a precoding matrix in the fourth subset of precoding matrixes corresponding to 4 layers may be represented as W_{l,l′,m,m′,p,n}⁽⁴⁾. In some embodiments, W_{l,l′,m,m′,p,n}⁽⁴⁾ may be

$$\frac{1}{\sqrt{4}} [ {W}_{l , m , p , n}^{1 , 2 , 2} {W}_{{l}^{′} , {m}^{′} , p , n}^{1 , 2 , 2} {W}_{l , m , p , n}^{2 , 2 , 2} {W}_{{l}^{′} , {m}^{′} , p , n}^{2 , 2 , 2} ] .$$

In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110-1 is indicated with the number of layers is indicated as 4, there may be a second set of precoding matrixes corresponding to 4 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 4 layers, for example, represented as “Set_p4_1”, and the size of a partial coherent precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C2 columns or rows out of the 4 columns or rows (e.g. a first set of C2 columns or rows. For example, C2 may be 1 or 2 or 3 or 4) in the precoding matrix, and in each column, the non-zero value may be mapped on 4 out of 8 elements and 0 for the other 4 elements. For example, the indexes of the 4 elements with non-zero values may be same in the first set of C2 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group. For example, idx_1 may be {0,1,2,3} or {0,2,4,6} or {1,2,3,4} or {1,3,5,7}. In some embodiments, for the other 4-C2 column, 4-C2 of the first set or second set of length-4 vectors may be selected. In some embodiments, for the other 4-C2 columns or rows out of the 4 columns or rows (e.g. a second set of 4-C2 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 4-C2 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, C2 may be 4 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, examples of a precoding matrix of the second set of precoding matrixes corresponding to 4 layers may be as:

$$\frac{1}{\sqrt{{s}_{4}}} [ \begin{matrix}a 1 & b 1 & c 1 & d 1 \\ a 2 & b 2 & c 2 & d 2 \\ a 3 & b 3 & c 3 & d 3 \\ a 4 & b 4 & c 4 & d 4 \\ 0 & 0 & 0 & 0 \\ 0 & 0 & 0 & 0 \\ 0 & 0 & 0 & 0 \\ 0 & 0 & 0 & 0\end{matrix} ] or \frac{1}{\sqrt{{s}_{4}}} [ \begin{matrix}a 1 & b 1 & c 1 & 0 \\ a 2 & b 2 & c 2 & 0 \\ a 3 & b 3 & c 3 & 0 \\ a 4 & b 4 & c 4 & 0 \\ 0 & 0 & 0 & d 1 \\ 0 & 0 & 0 & d 2 \\ 0 & 0 & 0 & d 3 \\ 0 & 0 & 0 & d 4\end{matrix} ] or$$

$$\frac{1}{\sqrt{{s}_{4}}} [ \begin{matrix}a 1 & b 1 & 0 & 0 \\ a 2 & b 2 & 0 & 0 \\ a 3 & b 3 & 0 & 0 \\ a 4 & b 4 & 0 & 0 \\ 0 & 0 & c 1 & e 1 \\ 0 & 0 & c 2 & e 2 \\ 0 & 0 & c 3 & e 3 \\ 0 & 0 & c 4 & e 4\end{matrix} ] or \frac{1}{\sqrt{{s}_{4}}} [ \begin{matrix}a 1 & 0 & 0 & 0 \\ a 2 & 0 & 0 & 0 \\ a 3 & 0 & 0 & 0 \\ a 4 & 0 & 0 & 0 \\ 0 & b 1 & c 1 & d 1 \\ 0 & b 2 & c 2 & d 2 \\ 0 & b 3 & c 3 & d 3 \\ 0 & b 4 & c 4 & d 4\end{matrix} ]$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1;1;−1;−1] and [1;−1;−1;1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, each of [a1, a2, a3, a4], [b1, b2, b3, b4], [c1, c2, c3, c4] may be one of the length-4 vectors in the first set of length-4 vectors or in the second set of length-4 vectors. For example, [d1, d2, d3, d4] may be one of the length-4 vectors in the first set of length-4 vectors or in the second set of length-4 vectors. For example, [a1, a2, a3, a4], [b1, b2, b3, b4], may be two vectors out of [1; 1; 1; 1], [1; −1; 1; −1], [1;1;−1;−1] and [1;−1;−1;1]. For another example, [a1, a2, a3, a4], [b1, b2, b3, b4], may be two of [1; 1; j; j], [1; −1; j; −j], [1; 1; −j; −j] and [1; −1; −j; j]. For example, [c1, c2, c3, c4], [d1, d2, d3, d4] may be 2 vectors out of [1; 1; 1; 1], [1; −1; 1; −1], [1;1;−1;−1] and [1;−1;−1;1]. For another example, [c1, c2, c3, c4], [d1, d2, d3, d4] may be 2 vectors out of [1; 1; j; j], [1; −1; j; −j], [1; 1; −j; −j] and [1; −1; −j; j].

In some embodiments, s₄ may a positive integer. For example, 1≤s₄≤64. For example, s₄ may be 64 or 32 or 16 or 8 or 4 or 2 or 32 or 16 or 8.

In some embodiments, N_{g} may equal to 2, N₁ may equal to 2, N₂ equals to 1, O₁ may equal to 2 or 4, i_{1,3} may be 0, and i_{1,1} may be one of {0, . . . N1O1−1} or {0, 2, 4, 6} or {0, 4} or {0,2} or {0,1} or 0, or i_{1,4,1} may be one of {0, 1, 2, 3} or {0,2} or 0. In some embodiments, the third subset of precoding matrixes corresponding to 4 layers, e.g. “Set_f4_3” may comprise 64 precoding matrixes. In some embodiments, the third subset of precoding matrixes “Set_f4_3” may comprise 32 precoding matrixes. The third subset of precoding matrixes “Set_f4_3” may comprise 16 precoding matrixes. In some embodiments, the third subset of precoding matrixes “Set_f4_3” may comprise 8 precoding matrixes. Alternatively, the third subset of precoding matrixes “Set_f4_3” may comprise 4 precoding matrixes. In other embodiments, the third subset of precoding matrixes “Set_f4_3” may comprise 2 precoding matrixes.

In some embodiments, N_{g} may equal to 2, N₁ may equal to 2, N₂ equals to 1, O₁ may equal to 2 or 4, i_{1,3} may be 0, and i_{1,1} may be one of {0, . . . N₁O₁−1} or {0, 2, 4, 6} or {0, 4} or {0, 2} or {0, 1}, or i_{1,4,q} may be one of {0, 1, 2, 3} or {0,2} or 0, where q may be 0 or 1. In some embodiments, the fourth subset of precoding matrixes corresponding to 4 layers, e.g. “Set_f4_4” may comprise 256 precoding matrixes. In some embodiments, the fourth subset of precoding matrixes “Set_f4_4” may comprise 128 precoding matrixes. In some embodiments, the fourth subset of precoding matrixes “Set_f4_4” may comprise 64 precoding matrixes. In some embodiments, the fourth subset of precoding matrixes “Set_f4_4” may comprise 32 precoding matrixes. The fourth subset of precoding matrixes “Set_f4_4” may comprise 16 precoding matrixes. In some embodiments, the fourth subset of precoding matrixes “Set_f4_4” may comprise 8 precoding matrixes. Alternatively, the fourth subset of precoding matrixes “Set_f4_4” may comprise 4 precoding matrixes. In other embodiments, the fourth subset of precoding matrixes “Set_f4_4” may comprise 2 precoding matrixes.

In some embodiments, if the terminal device 110-1 is indicated with the number of layers is indicated as 4, there may be a third set of precoding matrixes (e.g. a third set of partial coherent precoding matrixes) corresponding to 4 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p4_2”, and the size of a precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 4 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 1 or 2 columns or rows out of the 4 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 4 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 or 2 columns or rows out of the 4 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two out of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 4. In some embodiments, there may be the first set and the second set, and each set with 2 columns or rows. In some embodiments, there may be the first set, the second set and the third set, and each of two of the three sets with 2 columns or rows, and one of the three sets with 1 column or row. In some embodiments, there may be the first set, the second set, the third set and the fourth set, and each set with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 4 layers, e.g. Set_p4_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. In some embodiments, examples of a precoding matrix of the third set of precoding matrixes corresponding to 4 layers may be as:

$$\frac{1}{\sqrt{{S}_{4}}} [ \begin{matrix}a 1 & b 1 & 0 & 0 \\ a 2 & b 2 & 0 & 0 \\ 0 & 0 & c 1 & d 1 \\ 0 & 0 & c 2 & d 2 \\ 0 & 0 & 0 & 0 \\ 0 & 0 & 0 & 0 \\ 0 & 0 & 0 & 0 \\ 0 & 0 & 0 & 0\end{matrix} ] or \frac{1}{\sqrt{{S}_{4}}} [ \begin{matrix}a 1 & b 1 & 0 & 0 \\ a 2 & b 2 & 0 & 0 \\ 0 & 0 & c 1 & 0 \\ 0 & 0 & c 2 & 0 \\ 0 & 0 & 0 & d 1 \\ 0 & 0 & 0 & d 2 \\ 0 & 0 & 0 & 0 \\ 0 & 0 & 0 & 0\end{matrix} ] or$$

$$\frac{1}{\sqrt{{S}_{4}}} [ \begin{matrix}a 1 & 0 & 0 & 0 \\ a 2 & 0 & 0 & 0 \\ 0 & b 1 & 0 & 0 \\ 0 & b 2 & 0 & 0 \\ 0 & 0 & c 1 & 0 \\ 0 & 0 & c 2 & 0 \\ 0 & 0 & 0 & d 1 \\ 0 & 0 & 0 & d 2\end{matrix} ]$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [a1, a2], [b1, b2], [c1, c2],[d1, d2] may be any one of [1; 1], [1; −1], [1; j], [1; −j].

In some embodiments, if the terminal device 110-1 is indicated with the number of layers is indicated as 4, there may be a fourth set of precoding matrixes (e.g. a fourth set of non-coherent precoding matrixes) corresponding to 4 layers. For example, each one of 8 antenna ports may be non-coherent with each other. In some embodiments, there may be a fourth set of precoding matrixes (e.g. a fourth set of non-coherent precoding matrixes), for example, represented as “Set_n4_1”, and the size of a precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 4 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4 for the first, second, third, fourth column or row of the precoding matrix, respectively, and for each one of idx_1, idx_2, idx_3, idx_4, the value may be 1 value out of {0,1,2,3,4,5,6,7} or {1,2,3,4,5,6,7,8}. For example, the value of idx_I, idx_2, idx_3, idx_4 may be {0, 1, 2, 3} or {0,2,4,6} or {4,5,6,7} or {1,3,5,7}, respectively. For another example, the value of idx_1, idx_2, idx_3, idx_4 may be {1, 2, 3, 4} or {5,6,7,8} or {1,3,5,7} or {2,4,6,8}, respectively. For example, the value of idx_1, idx_2, idx_3, idx_4 may be different from each other. In some embodiments, the values of idx_1, idx_2, idx_3, idx_4 may be based on the indexes of the 4 antenna ports in the first group or the second group.

In some embodiments, if the terminal device 110-1 is indicated with number of layers as 4 there may be a fourth set of precoding matrixes corresponding to 4 layers. For example, there may be one or two or four precoding matrixes in the fourth set (e.g. non-coherent precoding matrix) corresponding to 4 layers.

In some embodiments, if there are 4 layers at the terminal device 110-1, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 1, 2, or 3) columns may be mapped with length-4 vectors, and 4-r1 column may be mapped with length-2 vectors, and with ports swapped.

In other embodiments, the antenna structure may be 4+1+1+1+1, which means that 4 antenna ports can be coherent. In this case, r1 (for example, 1 or 2 or 3) columns may be with length-4 vectors, 4-r1 columns may be with 1 on one element, and rows can be swap.

In some embodiments, the antenna structure may be 4+2+1+1, which means that 4 antenna ports can be coherent and 2 antenna ports can be coherent. For example, r1 (for example, 1 or 2) columns may be with length-4 vectors, and r2 (for example, 1 or 2) columns may be with length-2 vectors, and 4-r1-r2 columns may be with 1 on one element.

In some other embodiments, the antenna structure may be 2+2+1+1+1+1, which means that 2 antenna ports can be coherent and 2 antenna ports can be coherent. For example, r1 (for example, 1 or 2 or 3) columns may be with length-2 vectors, and 4-r1 columns may be with 1 on one element. In some other embodiments, the antenna structure may be 2+1+1+1+1+1+1. Alternatively, the antenna structure may be 2+2+2+1+1.

In some embodiments, the terminal device 110-1 is indicated with the number of layers as 3, there may be a first set of precoding matrixes corresponding to 3 layers (e.g. a first set of full coherent precoding matrixes). In some embodiments, a full coherent precoding matrix may be represented as W_{l,l′,m,m′,n}⁽³⁾.

In some embodiments, W_{l,l′,m,m′,n}⁽³⁾ may be

$$\frac{1}{\sqrt{3 * P}} [ \begin{matrix}{v}_{l , m} & {v}_{{l}^{′} , {m}^{′}} & {v}_{l , m} \\ {φ}_{n} * {v}_{l , m} & {φ}_{n} * {v}_{{l}^{′} , {m}^{′}} & - {φ}_{n} * {v}_{l , m}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, 01, 201, 30₁}. For another example, k₁ may be 0. In some embodiments, k₂ may be a non-negative integer. For example, k₂ may at least one of {0, O₂}. In some embodiments, k₂ may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1,2,3}. For another example, i_{1,3} may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=01 and/or k₂=0. In some embodiments, in case of N₁=4 and N₂=1, and in case of i_{1,3}=2, k₁=201 and/or k₂=0. In some embodiments, in case of N₁=4 and N₂=1, and in case of i_{1,3}=3, k₁=3O₁ and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=01 and/or k₂=0.

In some embodiments, there may be more than one subset of precoding matrixes corresponding to 3 layers. In some embodiments, the first set of precoding matrixes corresponding to 3 layers may comprise more than one subset. For example, there may be two or three or four subsets of precoding matrixes.

In some embodiments, there may be a first subset of precoding matrixes corresponding to 3 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, 1 may be 0 or 2. In some embodiments, the number of precoding matrixes in the first subset corresponding to 3 layers may be 128 or 64 or 32 or 16 or 8 or 4 or 2.

In some embodiments, there may be a second subset of precoding matrixes corresponding to 3 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}} *} {e}^{j \frac{2 π l}{{O}_{1} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, 1 may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 3 layers may be 256 or 128 or 32 or 16 or 8 or 4 or 2.

In some embodiments, if the terminal device 110-1 is indicated with the number of layers as 3, there may be a third subset of precoding matrixes. In some embodiments, In some embodiments, there may be a third vector W_{l,m,p,n}^{1,2,1}. In some embodiments,

$${W}_{l , m , p , n}^{1 , 2 , 1} = \frac{1}{\sqrt{8}} [ {v}_{l , m} ; {φ}_{n} + {v}_{l , m} ; {φ}_{{p}_{1}} - {v}_{l , m} ; {φ}_{n} * {φ}_{{p}_{1}} * {v}_{l , m} ] .$$

In some embodiments, there may be a fourth vector W_{l,m,p,n}^{2,2,1}. In some embodiments,

$${W}_{l , m , p , n}^{2 , 2 , 1} = \frac{1}{\sqrt{8}} [ {v}_{l , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1}. For another example, i₁₃ may be 0. In some embodiments, in case of N₁=2 and N₂=1, and in case of i_{1,3}=0, k₁=O₁ and/or k₂=0.

In some embodiments, there may be a third subset of precoding matrixes corresponding to 3 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, 1 may be 0 or 2. In some embodiments, the number of precoding matrixes in the third subset corresponding to 3 layers may be 64 or 32 or 16 or 8 or 4 or 2.

In some embodiments, the terminal device 110-1 may be indicated with the number of layers as 3, a precoding matrix in the third subset of precoding matrixes corresponding to 3 layers may be represented as W_{l,l′,m,m′,p,n}⁽³⁾. In some embodiments, W_{l,l′,m,m′,p,n}⁽³⁾ may be

$$\frac{1}{\sqrt{3}} [ {W}_{l , m , p , n}^{1 , 2 , 1} {W}_{{l}^{′} , {m}^{′} , p , n}^{1 , 2 , 1} {W}_{l , m , p , n}^{2 , 2 , 1} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p₁.

In some embodiments, if the terminal device 110-1 is indicated with the number of layers as 3, there may be a fourth subset of precoding matrixes. In some embodiments, In some embodiments, there may be a fifth vector W_{l,m,p,n}^{1,2,2}. In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments there may be a sixth vector W_{l,m,p,n}^{2,2,2}. In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of no may be at least one of {0,1,2,3} or {0,1} or {0,2}. In some embodiments, the value of no may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 3 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 3 layers may be 64 or 32 or 16 or 8 or 4 or 2.

In some embodiments, the terminal device 110-1 may be indicated with the number of layers as 3, a precoding matrix in the fourth subset of precoding matrixes corresponding to 3 layers may be represented as W_{l,l′,m,m′,p,n}⁽³⁾. In some embodiments, W_{l,l′,m,m′,p,n}⁽³⁾ may be

$$\frac{1}{\sqrt{3}} [ {W}_{l , m , p , n}^{1 , 2 , 2} {W}_{{l}^{′} , {m}^{′} , p , n}^{1 , 2 , 2} {W}_{l , m , p , n}^{2 , 2 , 2} ] .$$

In some embodiments corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110-1 is indicated with the number of layers is indicated as 3, there may be a second set of precoding matrixes corresponding to 3 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 3 layers, for example, represented as “Set_p3_1”, and the size of a partial coherent precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C3 columns or rows out of the 3 columns or rows (e.g. a first set of C3 columns or rows. For example, C3 may be 1 or 2 or 3) in the precoding matrix, and in each column, the non-zero value may be mapped on 4 out of 8 elements and 0 for the other 4 elements. For example, the indexes of the 4 elements with non-zero values may be same in the first set of C3 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or the second group. For example, idx_1 may be {0,1,2,3} or {0,2,4,6} or {1,2,3,4} or {1,3,5,7}. In some embodiments, for the other 3-C3 column, 3-C3 of the first set or second set of length-4 vectors may be selected. In some embodiments, for the other 3-C3 columns or rows out of the 3 columns or rows (e.g. a second set of 3-C3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3-C3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group or the second group. For example, idx_2 may be {4,5,6,7} or {1,3,5,7} or {5,6,7,8} or {2,4,6,8}. In some embodiments, any value of idx_1 may be different from any value of idx_2. In some embodiments, C3 may be 3 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments,

In some embodiments, examples of a precoding matrix of the second set of precoding matrixes corresponding to 3 layers may be as:

$$\frac{1}{\sqrt{{s}_{3}}} [ \begin{matrix}a 1 & b 1 & c 1 \\ a 2 & b 2 & c 2 \\ a 3 & b 3 & c 3 \\ a 4 & b 4 & c 4 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}a 1 & b 1 & 0 \\ a 2 & b 2 & 0 \\ a 3 & b 3 & 0 \\ a 4 & b 4 & 0 \\ 0 & 0 & c 1 \\ 0 & 0 & c 2 \\ 0 & 0 & c 3 \\ 0 & 0 & c 4\end{matrix} ] or$$

$$\frac{1}{\sqrt{{s}_{3}}} [ \begin{matrix}a 1 & 0 & 0 \\ a 2 & 0 & 0 \\ a 3 & 0 & 0 \\ a 4 & 0 & 0 \\ 0 & b 1 & c 1 \\ 0 & b 2 & c 2 \\ 0 & b 3 & c 3 \\ 0 & b 4 & c 4\end{matrix} ]$$

For example, rows or columns can be swapped. For example, rows or columns can be swapped. For example, each of [a1, a2, a3, a4], [b1, b2, b3, b4], [c1, c2, c3, c4] may be one of the length-4 vectors in the first set of length-4 vectors or in the second set of length-4 vectors. For example, [a1, a2, a3, a4], [b1, b2, b3, b4], [c1, c2, c3, c4] may be three out of [1; 1; 1; 1], [1; −1; 1; −1], [1;1;−1;−1] and [1;−1;−1;1]. For another example, [a1, a2, a3, a4], [b1, b2, b3, b4], [c1, c2, c3, c4] may be three out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, [a1, a2, a3, a4], [b1, b2, b3, b4], may be two vectors out of [1; 1; 1; 1], [1; −1; 1; −1], [1;1;−1;−1] and [1;−1;−1;i]. For another example, [a1, a2, a3, a4], [b1, b2, b3, b4], may be two of [1; 1; j; j], [1; −1; j; −j], [1; 1; −j; −j] and [1; −1; −j; j]. For example, [c1, c2, c3, c4] may be 1 vector out of [1; 1; 1; 1], [1; −1; 1; −1], [1;1;−1;−1] and [1;−1;−1;1]. For another example, [c1, c2, c3, c4] may be 1 vector out of [1; 1; j; j], [1; −1; j; −j], [1; 1; −j; −j] and [1; −1; −j; j].

In some embodiments, s₃ may a positive integer. For example, 1≤s₃≤64. For example, s₃ may be 64 or 32 or 16 or 8 or 4 or 2 or 24 or 12 or 6 or 3.

In some embodiments, if the terminal device 110-1 is indicated with the number of layers is indicated as 3, there may be a third set of precoding matrixes (e.g. a third set of partial coherent precoding matrixes) corresponding to 3 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p3_2”, and the size of a precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 3 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group or fourth group or fifth group or sixth group. For example, idx_1 may be {0,1} or {0, 2} or {1, 2} or {1, 3} or {0, 4} or {1, 5}. In some embodiments, there may be 1 or 2 columns or rows out of the 3 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of two out of the 4 antenna ports in the first group or second group. In some embodiments, the 2 values of idx_2 may be based on the indexes of the 2 antenna ports in the third group or fourth group or fifth group or sixth group. For example, idx_2 may be {2,3} or {1,3} or {3,4} or {2,4} or {1,5} or {2,6}. In some embodiments, there may be 1 or 2 columns or rows out of the 3 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. For example, idx_3 may be {4,5} or {4,6} or {5,6} or {5,7} or {2,6} or {3,7}. In some embodiments, the 2 values of idx_3 may be based on the indexes of two out of the 4 antenna ports in the first group or second group. In some embodiments, the 2 values of idx_3 may be based on the indexes of the 2 antenna ports in the third group or fourth group or fifth group or sixth group. In some embodiments, there may be 1 or 2 columns or rows out of the 3 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two out of the 4 antenna ports in the first group or second group. In some embodiments, the 2 values of idx_4 may be based on the indexes of the 2 antenna ports in the third group or fourth group or fifth group or sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, there may be three out of the first set and the second set and the third set and the fourth set. In some embodiments, the total number of columns or rows in the first set and/or the second set and/or the third set and/or the fourth set may be 3. In some embodiments, there may be two out of the four sets, and one set with 2 columns or rows, and the other set with 1 column or row. In some embodiments, there may be three of the four sets, and each set with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 3 layers, e.g. Set_p3_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;1], [1;−j]}. In some embodiments, the 2 values in each vector of the first set or of the second set may be mapped on 2 out of 8 elements, and 0 may be mapped on other 6 elements in a column or row of the precoding matrix. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 3 layers may be as:

$$\frac{1}{\sqrt{{s}_{3}}} [ \begin{matrix}a 1 & b 1 & 0 \\ a 2 & b 2 & 0 \\ 0 & 0 & c 1 \\ 0 & 0 & c 2 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}a 1 & 0 & 0 \\ a 2 & 0 & 0 \\ 0 & b 1 & 0 \\ 0 & b 2 & 0 \\ 0 & 0 & c 1 \\ 0 & 0 & c 2 \\ 0 & 0 & 0 \\ 0 & 0 & 0\end{matrix} ] or \frac{1}{\sqrt{{s}_{3}}} [ \begin{matrix}0 & 0 & 0 \\ 0 & 0 & 0 \\ 0 & 0 & 0 \\ 0 & 0 & 0 \\ a 1 & b 1 & 0 \\ a 2 & b 2 & 0 \\ 0 & 0 & c 1 \\ 0 & 0 & c 2\end{matrix} ]$$

For example, rows or columns can be swapped. For example, each of [a1, a2], [b1, b2], [c1, c2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [a1, a2], [b1, b2], [c1, c2] may be any one of [1; 1], [1; −1], [1; j], [1; −j].

In some embodiments, if the terminal device 110-1 is indicated with the number of layers is indicated as 3, there may be a fourth set of precoding matrixes (e.g. a fourth set of non-coherent precoding matrixes) corresponding to 3 layers. For example, each one of 8 antenna ports may be non-coherent with each other. In some embodiments, there may be a fourth set of precoding matrixes (e.g. a fourth set of non-coherent precoding matrixes), for example, represented as “Set_n3_1”, and the size of a precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 3 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3 for the first, second, third column or row of the precoding matrix, respectively, and for each one of idx_1, idx_2, idx_3, the value may be 1 value out of {0,1,2,3,4,5,6,7} or {1,2,3,4,5,6,7,8}. In some embodiments, the values of idx_1, idx_2 and idx_3 may be based on the indexes of three out of the 4 antenna ports in the first group or second group. In some embodiments, the values of idx_1, idx_2 and idx_3 may be based on the indexes of the 2 antenna ports in the third group or fourth group or fifth group or sixth group and based on an index of one out of 2 antenna ports in the third group or fourth group or fifth group. For example, the value of idx_1, idx_2, idx_3 may be one value out of {0, 1, 2, 3} or {0,2,4,6} or {4,5,6,7} or {1,3,5,7}, respectively. For another example, the value of idx_1, idx_2, idx_3 may be one value out of {1, 2, 3, 4} or {5,6,7,8} or {1,3,5,7} or {2,4,6,8}, respectively. For example, the value of idx_1, idx_2, idx_3 may be different from each other.

In some embodiments, if the terminal device 110-1 is indicated with number of layers as 3 there may be a fourth set of precoding matrixes corresponding to 3 layers. For example, there may be one or two or four precoding matrixes in the fourth set (e.g. non-coherent precoding matrix) corresponding to 3 layers. For example, a precoding matrix in the fourth set of precoding matrixes corresponding to 3 layers may be

$$\frac{1}{\sqrt{{s}_{3}}} [ \begin{matrix}1 & 0 & 0 \\ 0 & 1 & 0 \\ 0 & 0 & 1 \\ 0 & 0 & 0 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}0 & 0 & 0 \\ 0 & 0 & 0 \\ 0 & 0 & 0 \\ 0 & 0 & 0 \\ 1 & 0 & 0 \\ 0 & 1 & 0 \\ 0 & 0 & 1 \\ 0 & 0 & 0\end{matrix} ] .$$

In some embodiments, the terminal device 110-1 is indicated with the number of layers as 2, there may be a first set of precoding matrixes corresponding to 2 layers (e.g. a first set of full coherent precoding matrixes). In some embodiments, a full coherent precoding matrix may be represented as W_{l,l′,m,m′,n}⁽²⁾.

In some embodiments, W_{l,l′,m,m′,n}⁽²⁾ may be

$$\frac{1}{\sqrt{2 * P}} [ \begin{matrix}{v}_{l , m} & {v}_{{l}^{′} , {m}^{′}} \\ {φ}_{n} * {v}_{l , m} & - {φ}_{n} * {v}_{{l}^{′} , {m}^{′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, 01, 201, 301}. For another example, k₁ may be 0. In some embodiments, k₂ may be a non-negative integer. For example, k₂ may at least one of {0, O₂}. In some embodiments, k₂ may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1,2,3}. For another example, i_{1,3} may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=O₁ and/or k₂=0. In some embodiments, in case of N₁=4 and N₂=1, and in case of i_{1,3}=2, k₁=2O₁ and/or k₂=0. In some embodiments, in case of N₁=4 and N₂=1, and in case of i_{1,3}=3, k₁=301 and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=O₁ and/or k₂=0.

In some embodiments, there may be more than one subset of precoding matrixes corresponding to 2 layers. In some embodiments, the first set of precoding matrixes corresponding to 2 layers may comprise more than one subset. For example, there may be two or three or four subsets of precoding matrixes.

In some embodiments, there may be a first subset of precoding matrixes corresponding to 2 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, 1 may be 0 or 2. In some embodiments, the number of precoding matrixes in the first subset corresponding to 2 layers may be 128 or 64 or 32 or 16 or 8 or 4 or 2.

In some embodiments, there may be a second subset of precoding matrixes corresponding to 2 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, 1 may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 2 layers may be 256 or 128 or 32 or 16 or 8 or 4 or 2.

In some embodiments, if the terminal device 110-1 is indicated with the number of layers as 2, there may be a third subset of precoding matrixes. In some embodiments, In some embodiments, there may be a third vector W_{l,m,p,n}^{1,2,1}. In some embodiments,

$${W}_{l , m , p , n}^{1 , 2 , 1} = \frac{1}{\sqrt{8}} [ {v}_{1 , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, there may be a fourth vector W_{l,m,p,n}^{2,2,1}. In some embodiments,

$${W}_{l , m , p , n}^{2 , 2 , 1} = \frac{1}{\sqrt{8}} [ {v}_{1 , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some is embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of k₁ and/or k₂ may be based on the value of i_{1,3}, and i_{1,3} may be a non-negative integer. For example, i_{1,3} may be at least one of {0,1}. For another example, i_{1,3} may be 0. In some embodiments, in case of N₁=2 and N₂=1, and in case of i_{1,3}=0, k₁=O₁ and/or k₂=0.

In some embodiments, there may be a third subset of precoding matrixes corresponding to 2 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 2 layers may be 64 or 32 or 16 or 8 or 4 or 2.

In some embodiments, the terminal device 110-1 may be indicated with the number of layers as 2, a precoding matrix in the third subset of precoding matrixes corresponding to 2 layers may be represented as W_{l,l′,m,m′,p,n}⁽²⁾. In some embodiments, W_{l,l′,m,m′,p,n}⁽²⁾ may be

$$\frac{1}{\sqrt{2}} [ \begin{matrix}{W}_{l , m , p , n}^{1 , 2 , 1} & {W}_{{l}^{′} , {m}^{′} , p , n}^{2 , 2 , 1}\end{matrix} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p₁.

In some embodiments, if the terminal device 110-1 is indicated with the number of layers as 2, there may be a fourth subset of precoding matrixes. In some embodiments, In some embodiments, there may be a fifth vector W_{l,m,p,n}^{1,2,2}. In some embodiments,

$${W}_{l , m , p , n}^{1 , 2 , 2} = \frac{1}{\sqrt{8}} [ {v}_{1 , m} ; {φ}_{{n}_{0}} * {v}_{l , m} ; {a}_{{p}_{1}} * {b}_{{n}_{1}} * {v}_{l , m} ; {a}_{{p}_{z}} * {b}_{{n}_{2}} * {v}_{l , m} ] .$$

In some embodiments, there may be a sixth vector W_{l,m,p,n}^{2,2,2}. In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N1. For another example, 1 may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of no may be at least one of {0,1,2,3} or {0,1} or {0,2}. In some embodiments, the value of no may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 2 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 2 layers may be 64 or 32 or 16 or 8 or 4 or 2.

In some embodiments, the terminal device 110-1 may be indicated with the number of layers as 2, a precoding matrix in the fourth subset of precoding matrixes corresponding to 2 layers may be represented as W_{l,l′,m,m′,p,n}⁽²⁾. In some embodiments, W_{l,l′,m,m′,p,n}⁽²⁾ may be

$$\frac{1}{\sqrt{2}} [ \begin{matrix}{W}_{l , m , p , n}^{1 , 2 , 2} & {W}_{{l}^{′} , {m}^{′} , p , n}^{2 , 2 , 2}\end{matrix} ] .$$

In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110-1 is indicated with the number of layers is indicated as 2, there may be a second set of precoding matrixes corresponding to 2 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 2 layers, for example, represented as “Set_p₂_1”, and the size of a partial coherent precoding matrix may be 2 multiplies 8 or 8 multiplies 2. In some embodiments, there may be 2 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C4 columns or rows out of the 2 columns or rows (e.g. a first set of C4 columns or rows. For example, C4=1 or 2) in the precoding matrix, and in each column, the non-zero value may be mapped on 4 out of 8 elements and 0 for the other 4 elements. For example, the indexes of the 4 elements with non-zero values may be same in the first set of C4 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or second group. For example, idx_1 may be {0,1,2,3} or {0,2,4,6} or {1,2,3,4} or {1,3,5,7}. In some embodiments, for the other 2-C4 column or row, 2-C4 of the first set or second set of length-4 vectors may be selected. In some embodiments, for the other 2-C4 columns or rows out of the 2 columns or rows (e.g. a second set of 2-C4 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 2-C4 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group or second group. For example, idx_2 may be {4,5,6,7} or {1,3,5,7} or {5,6,7,8} or {2,4,6,8}. In some embodiments, any value of idx_1 may be different from any value of idx_2. In some embodiments, C4 may be 2 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments,

In some embodiments, examples of a precoding matrix of the second set of precoding matrixes corresponding to 2 layers may be as:

$$\frac{1}{\sqrt{{s}_{2}}} [ \begin{matrix}a 1 & 0 \\ a 2 & 0 \\ a 3 & 0 \\ a 4 & 0 \\ 0 & b 1 \\ 0 & b 2 \\ 0 & b 3 \\ 0 & b 4\end{matrix} ] or \frac{1}{\sqrt{{s}_{2}}} [ \begin{matrix}a 1 & b 1 \\ a 2 & b 2 \\ a 3 & b 3 \\ a 4 & b 4 \\ 0 & 0 \\ 0 & 0 \\ 0 & 0 \\ 0 & 0\end{matrix} ]$$

For example, rows or columns can be swapped. For example, rows or columns can be swapped. For example, each of [a1, a2, a3, a4], [b1, b2, b3, b4] may be one of the length-4 vectors in the first set of length-4 vectors or in the second set of length-4 vectors. For example, [a1, a2, a3, a4], [b1, b2, b3, b4] may be two out of [1; 1; 1; 1], [1; −1; 1; −1], [1;1;−1;−1] and [1;−1;−1;1]. For another example, [a1, a2, a3, a4], [b1, b2, b3, b4] may be two out of [1; 1; j; j], [1; −1;j; −j], [1; 1; −j; −j] and [1; −1; −j; j]. For example, each of [a1, a2, a3, a4], [b1, b2, b3, b4] may be one of the length-4 vectors in the first set of length-4 vectors or in the second set of length-4 vectors.

In some embodiments, s₂ may a positive integer. For example, 1≤s₂≤64. For example, s₂ may be 64 or 32 or 16 or 8 or 4 or 2.

In some embodiments, if the terminal device 110-1 is indicated with the number of layers as 2, there may be a third set of precoding matrixes (e.g. a third set of partial coherent precoding matrixes) corresponding to 2 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p2_2”, and the size of a precoding matrix may be 2 multiplies 8 or 8 multiplies 2. In some embodiments, there may be 2 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 2 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 1 or 2 values out of {0,1,2,3,4,5,6,7} or {1,2,3,4,5,6,7,8}. In some embodiments, the 2 values of idx_1 may be based on the indexes of two out of the 4 antenna ports in the first group or second group. In some embodiments, the 2 values of idx_1 may be based on the indexes of the 2 antenna ports in the third group or fourth group or fifth group or sixth group. For example, idx_1 may be {0,1} or {0, 2} or {1, 2} or {1, 3} or {0, 4} or {1, 5}. In some embodiments, there may be 1 or 2 columns or rows out of the 2 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 1 or 2 values out of {0,1,2,3,4,5,6,7} or {1,2,3,4,5,6,7,8}. In some embodiments, the 2 values of idx_2 may be based on the indexes of remaining two out of the 4 antenna ports in the first group or second group. In some embodiments, the 2 values of idx_2 may be based on the indexes of the 2 antenna ports in the third group or fourth group or fifth group or sixth group. For example, idx_2 may be {2,3} or {1,3} or {3,4} or {2,4} or {1,5} or {2,6}. In some embodiments, any value of idx_1 and any value of idx_2 may be different from each other. In some embodiments, the total number of columns or rows in the first set and/or the second set may be 2. In some embodiments, there may be the first set and the second set, and each set with 1 column or row. In some embodiments, there may be only one first set, and the first set with 2 columns or rows.

In some embodiments, there may be a set of 4 length-2 vectors, and each one of the length-2 vector may be applied as the two non-zero values in a column or row of the precoding matrix. In some embodiments, for the third set of precoding matrix corresponding to 2 layers, e.g. Set_p₂_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in a column or row of the precoding matrix. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 2 layers may be as:

$$\frac{1}{\sqrt{{s}_{2}}} [ \begin{matrix}a 1 & b 1 \\ a 2 & b 2 \\ 0 & 0 \\ 0 & 0 \\ 0 & 0 \\ 0 & 0 \\ 0 & 0 \\ 0 & 0\end{matrix} ] or \frac{1}{\sqrt{{s}_{2}}} [ \begin{matrix}a 1 & 0 \\ a 2 & 0 \\ 0 & b 1 \\ 0 & b 2 \\ 0 & 0 \\ 0 & 0 \\ 0 & 0 \\ 0 & 0\end{matrix} ]$$

For example, rows or columns can be swapped. For example, each of [a1, a2], [b1, b2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [a1, a2], [b1, b2] may be any one of [1; 1], [1; −1], [1; j], [1; −j].

In some embodiments, if the terminal device 110-1 is indicated with the number of layers is indicated as 2, there may be a fourth set of precoding matrixes (e.g. a fourth set of non-coherent precoding matrixes) corresponding to 2 layers. For example, each one of 8 antenna ports may be non-coherent with each other. In some embodiments, there may be a fourth set of precoding matrixes (e.g. a fourth set of non-coherent precoding matrixes), for example, represented as “Set_n2_1”, and the size of a precoding matrix may be 2 multiplies 8 or 8 multiplies 2. In some embodiments, there may be 2 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 2 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2 for the first, second column or row of the precoding matrix, respectively, and for each one of idx_1, idx_2, the value may be 1 value out of {0,1,2,3,4,5,6,7} or {1,2,3,4,5,6,7,8}. In some embodiments, the values of idx_1 and idx_2 may be based on the indexes of two out of the 4 antenna ports in the first group or second group. In some embodiments, the values of idx_1 and idx_2 may be based on the indexes of the 2 antenna ports in the third group or fourth group or fifth group or sixth group. For example, the value of idx_1, idx_2 may be one value of {0, 1, 2, 3} or {0,2,4,6} or {4,5,6,7} or {1,3,5,7}, respectively. For another example, the value of idx_1, idx_2 may be {1, 2}{3, 4} or {5,6}, {7,8} or {1,3},{5,7} or {2,4}, {6,8}. For example, the value of idx_1, idx_2 may be different from each other.

In some embodiments, if the terminal device 110-1 is indicated with number of layers as 2, there may be a fourth set of precoding matrixes corresponding to 2 layers. For example, there may be one or two or four or six or twelve precoding matrixes in the fourth set (e.g. non-coherent precoding matrix) corresponding to 2 layers. For example, a precoding matrix in the fourth set of precoding matrixes corresponding to 2 layers may be

$$\frac{1}{\sqrt{{s}_{2}}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ] or \frac{1}{\sqrt{{s}_{2}}} [ \begin{matrix}1 & 0 \\ 0 & 0 \\ 0 & 1 \\ 0 & 0 \\ 0 & 0 \\ 0 & 0 \\ 0 & 0 \\ 0 & 0\end{matrix} ] or \frac{1}{\sqrt{{s}_{2}}} [ \begin{matrix}0 & 0 \\ 0 & 0 \\ 1 & 0 \\ 0 & 1 \\ 0 & 0 \\ 0 & 0 \\ 0 & 0 \\ 0 & 0\end{matrix} ] or \frac{1}{\sqrt{{s}_{2}}} [ \begin{matrix}1 & 0 \\ 0 & 0 \\ 0 & 0 \\ 0 & 1 \\ 0 & 0 \\ 0 & 0 \\ 0 & 0 \\ 0 & 0\end{matrix} ] or \frac{1}{\sqrt{{s}_{2}}} [ \begin{matrix}0 & 0 \\ 1 & 0 \\ 0 & 0 \\ 0 & 1 \\ 0 & 0 \\ 0 & 0 \\ 0 & 0 \\ 0 & 0\end{matrix} ] or \frac{1}{\sqrt{{s}_{2}}} [ \begin{matrix}0 & 0 \\ 1 & 0 \\ 0 & 1 \\ 0 & 0 \\ 0 & 0 \\ 0 & 0 \\ 0 & 0 \\ 0 & 0\end{matrix} ] .$$

For example, s₂=8.

In some embodiments, the terminal device 110-1 is indicated with the number of layers as 1, there may be a first set of precoding matrixes corresponding to 1 layer (e.g. a first set of full coherent precoding matrixes). In some embodiments, a full coherent precoding matrix may be represented as W_{l,m,n}⁽¹⁾.

In some embodiments, W_{l,m,n}⁽¹⁾ may be

$$\frac{1}{\sqrt{P}} [ \begin{matrix}{v}_{l , m} \\ {φ}_{n} * {v}_{l , m}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0.

In some embodiments, there may be more than one subset of precoding matrixes corresponding to 1 layer. In some embodiments, the first set of precoding matrixes corresponding to 1 layer may comprise more than one subset. For example, there may be two or three or four subsets of precoding matrixes.

In some embodiments, there may be a first subset of precoding matrixes corresponding to 1 layer, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, 1 may be 0 or 2. In some embodiments, the number of precoding matrixes in the first subset corresponding to 1 layer may be 32 or 16 or 8 or 4 or 2.

In some embodiments, there may be a second subset of precoding matrixes corresponding to 1 layer, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l may be a non-negative integer, 0≤l≤O₁N₁. For example, l may be at least one of (0, 2, 4, 6). For another example, l may be at least one of (0, 1, 2, 3). For another example, l may be 0 or 1. For another example, l may be 0 or 2. In some embodiments, corresponding to the second subset, m may be a non-negative integer. For example, 0≤m≤O₂N₂. For another example, m may be at least one of (0, 2, 4, 6). For another example, m may be at least one of (0, 1, 2, 3). For another example, m may be 0 or 1. For another example, m may be 0. In some embodiments, the number of precoding matrixes in the second subset corresponding to 1 layer may be 256 or 128 or 32 or 16 or 8 or 4 or 2.

In some embodiments, if the terminal device 110-1 is indicated with the number of layers as 1, there may be a third subset of precoding matrixes. In some embodiments, In some embodiments, there may be a third vector W_{l,m,p,n}^{1,2,1}. In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, N=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, 1 may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a third subset of precoding matrixes corresponding to 1 layer, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 1 layer may be 256 or 128 or 64 or 32 or 16 or 8 or 4 or 2.

In some embodiments, the terminal device 110-1 may be indicated with the number of layers as 1, a precoding matrix in the third subset of precoding matrixes corresponding to 1 layer may be represented as W_{l,m,p,n}⁽¹⁾. In some embodiments, W_{l,m,p,n}⁽¹⁾ may be [W_{l,m,p,n}^{1,2,1}]. In some embodiments, p may be p₁.

In some embodiments, if the terminal device 110-1 is indicated with the number of layers as 1, there may be a fourth subset of precoding matrixes. In some embodiments, In some embodiments, there may be a fifth vector W_{l,m,p,n}^{1,2,2}. In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0.

In some embodiments, there may be a fourth subset of precoding matrixes corresponding to 1 layer, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 1 layer may be 256 or 128 or 64 or 32 or 16 or 8 or 4 or 2.

In some embodiments, the terminal device 110-1 may be indicated with the number of layers as 1, a precoding matrix in the fourth subset of precoding matrixes corresponding to 1 layer may be represented as W_{l,m,p,n}⁽¹⁾. In some embodiments, W_{l,m,p,n}⁽¹⁾ may be [W_{l,m,p,n}^{1,2,2}]. In some embodiments, p may be [p₁ p₂]. In some embodiments, n may be [n₀ n₁ n₂].

In some embodiments, if the terminal device 110-1 is indicated with the number of layers is indicated as 1, there may be a second set of precoding matrixes corresponding to 1 layers (e.g. a second set of partial coherent precoding matrixes). For example, if the terminal device 110-1 has 8 antenna ports or if a PUSCH transmission of the terminal device 110-1 is associated with 8 antenna ports or if a PUSCH transmission of the terminal device 110-1 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 2 layers, for example, represented as “Set_p₁_1”, and the size of a partial coherent precoding matrix may be 1 multiplies 8 or 8 multiplies 1. In some embodiments, there may be 1 column or row of the precoding matrix. In some embodiments, there may be 8 elements in the column or row of the precoding matrix. In some embodiments, for the column or row of the partial coherent precoding matrix, 4 elements out of 8 elements in the partial coherent matrix may be with non-zero value. And the other 4 elements in the partial coherent precoding matrix may be with value of 0. In some embodiments, in the precoding matrix, and in the column or row, the non-zero value may be mapped on 4 out of 8 elements and 0 for the other 4 elements. For example, the indexes of the 4 elements with non-zero values idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or second group. For example, idx_1 may be {0,1,2,3} or {0,2,4,6} or {1,2,3,4} or {1,3,5,7} or {4,5,6,7} or {1,3,5,7} or {5,6,7,8} or {2,4,6,8}.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1;1;−1;−1], [1;−1;−1;1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in the column or row of the precoding matrix. In some embodiments,

In some embodiments, examples of a precoding matrix of the second set of precoding matrixes corresponding to 1 layer1 may be as:

$$\frac{1}{\sqrt{{s}_{1}}} [ \begin{matrix}a 1 \\ a 2 \\ a 3 \\ a 4 \\ 0 \\ 0 \\ 0 \\ 0\end{matrix} ] or \frac{1}{\sqrt{{s}_{1}}} [ \begin{matrix}0 \\ 0 \\ 0 \\ 0 \\ a 1 \\ a 2 \\ a 3 \\ a 4\end{matrix} ]$$

For example, rows or columns can be swapped. For example, rows or columns can be swapped. For example, each of [a1, a2, a3, a4] may be one of the length-4 vectors in the first set of length-4 vectors or in the second set of length-4 vectors. For example, [a1, a2, a3, a4] may be one of [1; 1; 1; 1], [1; −1; 1; −1], [1;1;−1;−1], [1;−1;−1;1], [1; 1; j; j], [1; −1; j; −j], [1; 1; −j; −j] and [1; −1; −j; j].

In some embodiments, s₁ may a positive integer. For example, 1≤s₁≤64. For example, s₁ may be 64 or 32 or 16 or 8 or 4 or 2 or 1.

In some embodiments, if the terminal device 110-1 is indicated with the number of layers as 1, there may be a third set of precoding matrixes (e.g. a third set of partial coherent precoding matrixes) corresponding to 1 layer. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p₁_2”, and the size of a precoding matrix may be 1 multiplies 8 or 8 multiplies 1. In some embodiments, there may be 1 column or row of the precoding matrix. In some embodiments, there may be 8 elements in the column or row of the precoding matrix. In some embodiments, for the column or the row of the precoding matrix, 2 elements out of 8 elements in the precoding matrix may be with non-zero value. And the other 6 elements in the precoding matrix may be with value of 0. In some embodiments, in the column or row of the precoding matrix, non-zero values may be mapped on 2 out of 8 elements and 0 may be mapped on the other 6 elements. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group or second group. In some embodiments, the 2 values of idx_1 may be based on the indexes of the 2 antenna ports in the third group or fourth group or fifth group or sixth group.

In some embodiments, there may be a set of 4 length-2 vectors, and each one of the length-2 vector may be applied as the two non-zero values in a column or row of the precoding matrix. In some embodiments, for the third set of precoding matrix corresponding to 1 layer, e.g. Set_p₁_2, two length-2 vectors can be selected from the 4 length-2 vectors, and the 2 values in each vector may be mapped on 2 out of 8 elements, and 0 may be mapped on other elements in the column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1;1], [1;−1]}. For another example, the second set of the length-2 vectors may be {[1;j], [1;−j]}. In some embodiments, the 2 values in each vector of the first set or of the second set may be mapped on 2 out of 8 elements, and 0 may be mapped on other 6 elements in the column or row of the precoding matrix. In some embodiments, for the column or row, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 1 layer may be as:

$$\frac{1}{\sqrt{{s}_{1}}} [ \begin{matrix}a 1 \\ a 2 \\ 0 \\ 0 \\ 0 \\ 0 \\ 0 \\ 0\end{matrix} ] or \frac{1}{\sqrt{{s}_{1}}} [ \begin{matrix}0 \\ 0 \\ a 1 \\ a 2 \\ 0 \\ 0 \\ 0 \\ 0\end{matrix} ] or \frac{1}{\sqrt{{s}_{1}}} [ \begin{matrix}a 1 \\ 0 \\ a 2 \\ 0 \\ 0 \\ 0 \\ 0 \\ 0\end{matrix} ] or \frac{1}{\sqrt{{s}_{1}}} [ \begin{matrix}0 \\ 0 \\ 0 \\ 0 \\ a 1 \\ a 2 \\ 0 \\ 0\end{matrix} ] or \frac{1}{\sqrt{{s}_{1}}} [ \begin{matrix}0 \\ 0 \\ 0 \\ 0 \\ a 1 \\ 0 \\ a 2 \\ 0\end{matrix} ] or \frac{1}{\sqrt{{s}_{1}}} [ \begin{matrix}0 \\ 0 \\ 0 \\ 0 \\ 0 \\ 0 \\ a 1 \\ a 2\end{matrix} ]$$

For example, rows or columns can be swapped. For example, [a1, a2], may be one of the length-2 vectors in the first set of length-2 vectors or in the second set of length-2 vectors. For example, [a1, a2] may be any one of [1; 1], [1; −1], [1; j], [1; −j].

In some embodiments, if the terminal device 110-1 is indicated with the number of layers is indicated as 1, there may be a fourth set of precoding matrixes (e.g. a fourth set of non-coherent precoding matrixes) corresponding to 1 layer. For example, each one of 8 antenna ports may be non-coherent with each other. In some embodiments, there may be a fourth set of precoding matrixes (e.g. a fourth set of non-coherent precoding matrixes), for example, represented as “Set_n1_1”, and the size of a precoding matrix may be 1 multiplies 8 or 8 multiplies 1. In some embodiments, there may be 1 column or row of the precoding matrix. In some embodiments, there may be 8 elements in a column or row of the precoding matrix. In some embodiments, for the column orrow of the precoding matrix, 1 elements out of 8 elements in the precoding matrix may be with non-zero value. For example, the non-zero value may be 1. And the other 7 elements in the precoding matrix may be with value of 0. In some embodiments, the indexes of the element with non-zero value may be in the row or column of the precoding matrix may be idx_1, and idx_1 may be 1 value out of {0,1,2,3,4,5,6,7} or {1,2,3,4,5,6,7,8}. In some embodiments, the value of idx_1 may be based on the indexes of one out of the 4 antenna ports in the first group or second group. In some embodiments, the values of idx_1 may be based on the indexes of one of the 2 antenna ports in the third group or fourth group or fifth group or sixth group.

In some embodiments, if the terminal device 110-1 is indicated with number of layers as 1, there may be a fourth set of precoding matrixes corresponding to 1 layer. For example, there may be one or two or four or eight precoding matrixes in the fourth set (e.g. non-coherent precoding matrix) corresponding to 1 layer. For example, a precoding matrix in the fourth set of precoding matrixes corresponding to 1 layer may be

$$\frac{1}{\sqrt{{s}_{1}}} [ \begin{matrix}1 \\ 0 \\ 0 \\ 0 \\ 0 \\ 0 \\ 0 \\ 0\end{matrix} ] or \frac{1}{\sqrt{{s}_{1}}} [ \begin{matrix}0 \\ 1 \\ 0 \\ 0 \\ 0 \\ 0 \\ 0 \\ 0\end{matrix} ] or \frac{1}{\sqrt{{s}_{1}}} [ \begin{matrix}0 \\ 0 \\ 1 \\ 0 \\ 0 \\ 0 \\ 0 \\ 0\end{matrix} ] or \frac{1}{\sqrt{{s}_{1}}} [ \begin{matrix}0 \\ 0 \\ 0 \\ 1 \\ 0 \\ 0 \\ 0 \\ 0\end{matrix} ] or \frac{1}{\sqrt{{s}_{1}}} [ \begin{matrix}0 \\ 0 \\ 0 \\ 0 \\ 1 \\ 0 \\ 0 \\ 0\end{matrix} ] or \frac{1}{\sqrt{{s}_{1}}} [ \begin{matrix}0 \\ 0 \\ 0 \\ 0 \\ 0 \\ 1 \\ 0 \\ 0\end{matrix} ] or \frac{1}{\sqrt{{s}_{1}}} [ \begin{matrix}0 \\ 0 \\ 0 \\ 0 \\ 0 \\ 0 \\ 1 \\ 0\end{matrix} ] or \frac{1}{\sqrt{{s}_{1}}} [ \begin{matrix}0 \\ 0 \\ 0 \\ 0 \\ 0 \\ 0 \\ 0 \\ 1\end{matrix} ]$$

For example, s₁=8.

Alternatively or in addition, the terminal device 110-1 may transmit capability information to the network device 120. In some embodiments, the capability information may indicate a capability of precoding matrix supported by the terminal device 110-1. For example, the capability information may indicate a type of precoding matrix supported by the terminal device 110-1. In some embodiments, the capability information may comprise at least one of: a full coherent, a partial coherent, a first partial coherent, a second partial coherent, a non coherent.

In some embodiments, the capability information may indicate the full coherent, the set of precoding matrix (for example, one of the set of precoding matrixes corresponding to v_ri layers can be indicated by the network device or one or more of the set of precoding matrixes can be configured by the network device) may comprise at least one of the first set (or at least one of the first subset, or at least one of the second subset or at least one of the third subset or at least one of fourth subset) of precoding matrixes corresponding to v_ri layers (e.g. a full-coherent precoding matrix type). For example, the set of precoding matrix may further comprise at least one of the second set of precoding matrixes corresponding to v_ri layers (e.g. a first partial-coherent precoding matrix type). For another example, the set of precoding matrixes may further comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the partial coherent or indicate the first partial coherent, the set of precoding matrix corresponding to v_ri layers (for example, one of the set of precoding matrixes can be indicated by the network device or one or more of the set of precoding matrixes can be configured by the network device) may comprise at least one of the second set of precoding matrixes corresponding to v_ri layers (e.g. a first partial-coherent precoding matrix type). For another example, the set of precoding matrixes may further comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the second partial coherent, the set of precoding matrix corresponding to v_ri layers (for example, one of the set of precoding matrixes can be indicated by the network device or one or more of the set of precoding matrixes can be configured by the network device) may comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the non coherent, the set of precoding matrix corresponding to v_ri layers (for example, one of the set of precoding matrixes can be indicated by the network device or one or more of the set of precoding matrixes can be configured by the network device) may comprise at least one of the fourth set of precoding matrixes corresponding to v_ri layers (e.g. a non-coherent precoding matrix type).

In some embodiments, the capability information may comprise any one or combination of the above precoding matrix types. In some embodiments, the capability information may be transmitted via radio resource control (RRC) signaling.

In some embodiments, the network device 120 may configure the type of precoding matrixes or at least one set of precoding matrixes corresponding to v_ri layers which can be indicated or configured to the terminal device 110-1. In some embodiments, corresponding to v_ri layers, the at least one configuration may configure at least one of the first subset of precoding matrixes corresponding to v_ri layers, the second subset of precoding matrixes corresponding to v_ri layers, the third subset of precoding matrixes corresponding to v_ri layers, the fourth subset of precoding matrixes corresponding to v_ri layers, the first set of precoding matrixes corresponding to v_ri layers, the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the full coherent, corresponding to v_ri layers, the at least one configuration may configure at least one of the first subset of precoding matrixes corresponding to v_ri layers, the second subset of precoding matrixes corresponding to v_ri layers, the third subset of precoding matrixes corresponding to v_ri layers, the fourth subset of precoding matrixes corresponding to v_ri layers, the first set of precoding matrixes corresponding to v_ri layers, the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the partial coherent or the first partial coherent, corresponding to v_ri layers, the at least one configuration may configure at least one of the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the second partial coherent, corresponding to v_ri layers, the at least one configuration may configure at least one of the third set of precoding matrixes corresponding to v_ri layers and the fourth set of precoding matrixes corresponding to v_ri layers.

In some embodiments, if the capability information is indicated as the non coherent, corresponding to v_ri layers, the at least one configuration may configure at least one of the fourth set of precoding matrixes corresponding to v_ri layers.

In some embodiments, the network device 120 may determine the type of precoding matrix which can be supported by the terminal device. In this case, the network device 120 may transmit an indication of the type of the precoding matrix. The type of the precoding matrix may be any one or combination of: a full-coherent precoding matrix type, a full-coherent and partial-coherent and non-coherent precoding matrix type, a partial-coherent precoding matrix type, a partial-coherent and a non-coherent precoding matrix type or a non-coherent precoding matrix type.

At block 310, the terminal device 110-1 receives at least one configuration associated with precoding matrix from the network device 120. In some embodiments, the at least one configuration may comprise one or more configurations of antenna port groups. Alternatively or in addition, the at least one configuration may comprise at least one antenna port group. In other embodiments, the at least one configuration may comprise one or more configurations of antenna pattern. In some other embodiments, the at least one configuration may comprise one or more configurations of precoding matrix type. Alternatively or in addition, the at least one configuration may comprise one or more configurations of precoding matrix subsets. In some embodiments, the at least one configuration may comprise the number of antenna port groups. In other embodiments, the at least one configuration may comprise the number of antenna ports in an antenna port group.

In some embodiments, the at least one configuration may comprise a first number of antenna groups and each of the antenna groups may comprise 4 antenna ports. For example, the first number may be 0 or 1 or 2. In this case, the first number may be a first integer which is not larger than 2. Alternatively or in addition, the at least one configuration may comprise a second number of antenna groups and each of the antenna groups may comprise 2 antenna ports. For example, the second number may be 0 or 1 or 2 or 3 or 4. In this case, the second number may be a second integer which is not larger than 4. In some other embodiments, the at least one configuration may comprise a third number of antenna groups and each of the antenna groups may comprise 1 antenna port. The third number may be a third integer which is not larger than 8. In another embodiment, the at least one configuration may comprise at least one of: a subset of full-coherent precoding matrixes, a subset of partial-coherent precoding matrixes, or a subset of non-coherent precoding matrixes.

Only as an example, the tenrinal device 110-1 may be configured with 8Tx for uplink or 8 ports SRS, (e.g. AP_0, AP_1, AP_2, AP_3, AP_4, AP_5, AP_6, AP_7). In some embodiments, the at least one configuration may include N groups where each group comprises 4 antenna ports, (N may be 0, 1, 2) and/or M groups where each group comprises 2 antenna ports, (M is integer, and 0<=M<=(8−N*4)/2 or 0<=M<=4)), and/or L groups where each group comprises 1 antenna port (or L antenna ports) (L is integer, and 0<=L<=8−N*4−M*2 or 0<=L<=8). Alternatively, the at least one configuration may indicate a subset of full-coherent and/or partial-coherent and/or a first partial-coherent (e.g. partial-coherent4) and/or a second partial-coherent (e.g. partial-coherent2) and/or non-coherent precoding matrix.

In some embodiments, the at least one configuration may be configured per value of number of layers or per precoder type. For example, N1, M1 may be configured for the first set of precoding matrixes corresponding to v_ri layers or for the full coherent precoding matrixes, N2, M2 may be configured for the second or the third set of precoding matrixes corresponding to v_ri layers or for the partial coherent precoding matrixes, N3, M3 may be configured for the fourth set of precoding matrixes corresponding to v_ri layers or for the non-coherent precoding matrixes.

In some embodiments, the 8 antenna ports for PUSCH transmission or the 8 antenna ports of the 8-port SRS may be {AP0, AP1, AP2, AP3, AP4, AP5, AP6, AP7}. And AP0 or AP1 or AP2 or AP3 or AP4 or AP5 or AP6 or AP7 may be any one of {0, 1, 2,3, 4, 5, 6, 7} or any one of {1000, 1001, 1002, 1003, 1004, 1005, 1006, 1007} or any one of {3000,3001, 3002, 3003, 3004, 3005, 3006, 3007}. In some embodiments, the values of 5 AP0 or AP1 or AP2 or AP3 or AP4 or AP5 or AP6 or AP7 may be different from each other.

In some embodiments, in each group, 1 or 2 or 4 of {AP_a, AP_b, AP_c, AP_d, AP_e, AP_f, AP_g, AP_h} can be included. The {a,b,c,d,e,f,g,h}, {AP_a, AP_b, AP_c, NP_d, AP_e, AP_f, AP_g, AP_h} may integer and can be {0, 1, 2, 3,4,5,6,7}. The numbers may be different from each other. For example, there are several port grouping configurations (4 ports in a group), {0, 1, 2, 3}, {4,5,6,7} or {0,2,4,6}, {1,3,5,7}. As another embodiment, there are several port grouping configurations (2 ports in a group), {0, 1}, {2,3}, {4,5}, {6,7} or {0,2}, {1,3}, {4,6}, {5,7}.

In some embodiments, the at least one configuration may indicate one of the port grouping configurations. For example, DMRS ports in same group may share a same PTRS port. In some embodiments, the precoding matrix may be an 8*v matrix, where v represents number of layers, v may be integer and 1<=v<=8 or 4<=v<=8. In some embodiments, v may be same as v_ri.

In some embodiments, the terminal device 110-1 may be configured with 8Tx for uplink transmission or configured with PUSCH transmission associated with SRS with 8 ports. The at least one configuration may include at least one of: values for i_{1,1}, values for i_{1,2}, values for i_{1,3}, values for i₂, values for i_{1,4,1}, values for i_{1,4,2}, values for i_{2,0}, values for i_{2,1}, values for i_{2,2}, values for Ng, values for N₁, values for N₂, values for O₁, values for O₂, and a configuration pattern (e.g. for antenna ports). The configuration pattern and/or the values may be applied at least for full-coherent precoding matrixes.

In some embodiments, the at least one configuration may indicate the first subset or the second subset or the third subset or the fourth subset of precoding matrixes corresponding to v_ri layers may be applied for the PUSCH transmission. For example, the DCI may indicate one of the applicable precoding matrixes for the PUSCH transmission.

In some embodiments, the at least one configuration may indicate two groups of antenna ports, and each group may comprise 4 antenna ports, and based on the at least one configuration, a DCI may indicate one precoding matrix of the first subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the second subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the third subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the fourth subset of precoding matrixes corresponding to v_ri layers for the PUSCH transmission.

In some embodiments, the at least one configuration may indicate one or two groups of antenna ports, and each group may comprise 4 antenna ports, and based on the at least one configuration, a DCI may indicate one precoding matrix from the second subset of precoding matrixes corresponding to v_ri layers for the PUSCH transmission.

In some embodiments, in a column or row of a precoding matrix in the second subset of precoding matrixes corresponding to v_ri layers, the indexes of the 4 non-zero values may be based on the indexes of antenna port indexes in a group. For example, the non-zero values in a column or row may be only mapped on indexes based on the index of antenna ports in the one or two groups. In some embodiments, a first group may comprise 4 antenna ports, and the 4 antenna ports may be {AP0, AP1, AP2, AP3}. In some embodiments, a second group may comprise 4 antenna ports, and the 4 antenna ports may be {AP4, AP5, AP6, AP7}. In some embodiments, in a column or row of the precoding matrix, one of length-4 vectors in the first set or second set of length-4 vectors may be mapped on the indexes of elements based on the antenna port indexes in the first group and/or the second group.

In some embodiments, for the second set of precoding matrixes corresponding to 8 layers, for a first set of 4 columns or rows (e.g. the first 4 columns or rows), a set of length-4 vectors may be mapped on element with indexes based on the 4 antenna ports in the first group, and for a second set of 4 columns or rows (e.g. the remaining or last 4 columns or rows), a set of length-4 vectors may be mapped on elements with indexes based on the 4 antenna ports in the second group.

In some embodiments, for the third set of precoding matrixes corresponding to 8 layers, for a first set of 2 columns or rows (e.g. the first and second columns or rows), a set of length-2 vectors may be mapped on elements with indexes based on two out of the 4 antenna ports in the first group, and for a second set of 2 columns or rows (e.g. the third and fourth columns or rows), a set of length-2 vectors may be mapped on elements with indexes based on remaining two antenna ports in the first group, and for a third set of 2 columns or rows (e.g. the fifth and sixth columns or rows), a set of length-2 vectors may be mapped on element with indexes based on two out of the 4 antenna ports in the second group, and for a fourth set of 2 columns or rows (e.g. the seventh and eighth columns or rows), a set of length-2 vectors may be mapped on elements with indexes based on remaining two antenna ports in the second group,

In some embodiments, in a column or row of a precoding matrix in the third subset of precoding matrixes corresponding to v_ri layers, the indexes of the 2 non-zero values may be based on the indexes of two out of the four antenna port indexes in a group. For example, the non-zero values in a column or row may be only mapped on indexes based on the index of antenna ports in the one or two groups. For example, a first group with 4 antenna ports may be {AP0, AP1, AP2, AP3}. For another example, a second group with 4 antenna ports may be {AP4, AP5, AP6, AP7}. In some embodiments, in a column or row of the precoding matrix, one of length-2 vectors in the first set or second set of length-2 vectors may be mapped on the indexes of elements based on two out of 4 antenna port indexes in the first group and/or the second group.

In some embodiments, in a column or row of a precoding matrix in the fourth subset of precoding matrixes corresponding to v_ri layers, the indexes of the 1 non-zero value (with value 1) may be based on the indexes of one out of the four antenna port indexes in a group. For example, the non-zero values in a column or row may be only mapped on indexes based on the index of antenna ports in the one or two groups. For example, a first group with 4 antenna ports may be {AP0, AP1, AP2, AP3}. For another example, a second group with 4 antenna ports may be {AP4, AP5, AP6, AP7}. In some embodiments, in a column or row of the precoding matrix, the value 1 may be mapped on the index of elements based on one out of 4 antenna port indexes in the first group and/or the second group.

In some embodiments, the at least one configuration may indicate one or two or three or four groups of antenna ports, and each group may comprise 2 antenna ports, and based on the at least one configuration, a DCI may indicate one precoding matrix from the second subset of precoding matrixes corresponding to v_ri layers for the PUSCH transmission. In some embodiments, in a column or row of the precoding matrix, the indexes of the 2 non-zero values may be based on the indexes of antenna port indexes in a group. For example, the non-zero values in a column or row may be only mapped on indexes based on the index of antenna ports in the one or two or three or four groups.

In some embodiments, there may be a third group, and the third group may comprise 2 antenna ports with indexes {AP0, AP1}. In some embodiments, there may be a fourth group, and the fourth group may comprise 2 antenna ports with indexes {AP2, AP3}. In some embodiments, there may be a fifth group, and the fifth group may comprise 2 antenna ports with indexes {AP4, AP5}. In some embodiments, there may be a sixth group, and the sixth group may comprise 2 antenna ports with indexes {AP6, AP7}. In some embodiments, in a column or row of the precoding matrix, one of length-2 vectors in the first set or second set of length-2 vectors may be mapped on the indexes of elements based on the antenna port indexes in the third group and/or the fourth group and/or the fifth group and/or the sixth group.

At block 320, the terminal device 110-1 receives DCI for scheduling a PUSCH from the network device 120. For example, the DCI may indicate the fourth number of layers. In some embodiments, the DCI may indicate which full coherent precoding matrixes for the terminal device 110-1.

At block 330, the terminal device 110-1 determines a precoding matrix based on the at least one configuration and the DCI. In some embodiments, the terminal device 110-1 may determine the precoding matrix based on the fourth number of layers. For example, the precoding matrix may be a matrix with size 8 multiplies the fourth number. Alternatively or in addition, the precoding matrix may be a matrix with size the fourth number multiplies 8. In some embodiments, the precoding matrix may be a matrix with the fourth number of columns, and each column with 8 elements. In some other embodiments, the precoding matrix may be a matrix with the fourth number of rows, and each row with 8 elements.

At block 340, the terminal device 110-1 transmits the PUSCH based on the precoding matrix. In some embodiments, the DCI may indicate which full coherent precoding matrixes for the terminal device 110-1. In some embodiments, the at least one configuration comprises none or at least one of: a first full coherent precoding matrix or a second full coherent precoding matrix. For example, the at least one configuration may indicate none or one or both of Set_fv_1 and Set_fv_2. Alternatively, the at least one configuration comprises one or more of a number of antenna ports in a first dimension, a number of antenna ports in a second dimension, a first DFT oversampling in the first dimension, or a second DFT oversampling in the second dimension. For example, the at least one configuration may indicate candidate values for at least one of N1, N2, i1, 1, O1, O2, i1,2, i1,3 to generate the precoding matrix.

In some embodiments, the DCI may indicate which partial coherent precoding matrixes for the terminal device 110-1. In some embodiments, the at least one configuration may indicate that if there is at least one antenna port group with 4 antenna ports, at least one column or at least one row of the precoding matrix is with 4 non-zero values on 4 of the 8 elements. The indexes of the 4 elements may be based on the indexes of the 4 antenna ports in one antenna port group, and zero values on other 4 of the 8 elements in the column or the row. For example, the at least one configuration may indicate that if there is at least one group with 4 ports, at least one column of the precoder can be with 4 non-zero values (mapping on the 4 indexes (AP_i+1)). Otherwise, there may be no such kind of precoders.

In some embodiments, the at least one configuration may indicate that if there is at least one antenna port group with 2 antenna ports, at least one column or at least one row of the precoding matrix is with 2 non-zero values on 2 of the 8 elements. The indexes of the 2 elements may be based on the indexes of the 2 antenna ports in one antenna port group, and zero values on other 6 of the 8 elements in the column or the row. For example, the at least one configuration may indicate that if there is at least one group with 2 ports, at least one column of the precoder can be with 2 non-zero values (mapping on the 2 indexes (AP_i+1)), otherwise, there is no such kind of precoders.

In some embodiments, at least one configuration may indicate that if there is at least one antenna port group with 1 antenna port, at least one column or at least one row of the precoding matrix is with 1 non-zero value on 1 of the 8 elements, and the non-zero value is 1. The index of the 1 element may be based on the index of the antenna port in one antenna port group, and zero values on other 7 of the 8 elements in the column or the row.

In some embodiments, if the third number is no larger than the fourth number, a set of non-coherent precoding matrixes associated with the fourth number may be available for the PUSCH. In this case, each column or each row of the non-coherent precoding matrix may be with 1 non-zero value on 1 of the 8 elements. The non-zero value may be 1. The index of the 1 element may be based on the index of the antenna port in one antenna port group, and zero values on other 7 of the 8 elements in the column or the row. The indexes of the 1 element in different columns or different rows may be based on different antenna port groups.

Alternatively or in addition, if the third number is larger than the fourth number, a set of non-coherent precoding matrixes associated with the fourth number may not be available for the PUSCH. Alternatively, if the third number is not configured, the set of non-coherent precoding matrixes may be not available for the PUSCH. In some embodiments, if the third number is at least one of: 1, 2, 3, 4, 5, 6, 7, 8, the set of non-coherent precoding matrixes may comprise at least a precoding matrix with each column or each row of the precoding matrix is with 1 non-zero value on 1 of the 8 elements, and the non-zero value is 1. The index of the 1 element may be based on the index of column or row, and zero values on other 7 of the 8 elements in the column or the row. In other embodiments, if the third number is at least one of: 1, 2, 3, 4, the set of non-coherent precoding matrixes may comprise at least a precoding matrix with each column or each row of the precoding matrix is with 1 non-zero value on 1 of the first 4 elements, and the non-zero value is 1. The index of the 1 element may be based on the index of column or row, and zero values on other 7 elements in the column or the row.

In some embodiments, if the third number is same as the fourth number, the set of non-coherent precoding matrixes may comprise that at least a precoding matrix with each column or each row of the precoding matrix is with 1 non-zero value on 1 of the 8 elements, and the non-zero value is 1. The index of the 1 element in each column or row may be based on the index of each antenna port of the third number of antenna ports, and zero values on other 7 of the 8 elements in the column or the row.

Alternatively, if the third number is larger than the fourth number, the set of non-coherent precoding matrixes may comprise that at least a precoding matrix with each column or each row of the precoding matrix is with 1 non-zero value on 1 of the 8 elements, and the non-zero value is 1. The index of the 1 element in each column or row may be based on the index of one antenna port, and the antenna port is one of the fourth number out of the third number of antenna ports, and zero values on other 7 of the 8 elements in the column or the row. In some other embodiments, if the third number is smaller than the fourth number, non-coherent precoding matrix associated with the fourth number may not be available for the PUSCH.

In some embodiments, the at least one configuration may comprise an order of 8 antenna ports. The set of non-coherent precoding matrixes associated with the fourth number may comprise that at least a precoding matrix with each column or each row of the precoding matrix is with 1 non-zero value on 1 of the 8 elements, and the non-zero value is 1. The index of the 1 element in each column or row may be based on the index of one antenna port, and the antenna port is one of first fourth number of antenna ports out of the order of 8 antenna ports, and zero values on other 7 of the 8 elements in the column or the row. Alternatively, the at least one configuration may indicate precoding matrixes with that a first set of antenna port elements in a 4-antenna port group is mapped with non-zero values.

In some embodiments, if the number of antenna port elements in the first set of antenna port element is smaller than the third number, the at least one configuration may indicate that precoding matrixes with that a second set of antenna port elements in a 2-antenna port group is mapped with non-zero values. Alternatively or in addition, if the number of antenna port elements in the first and second sets of antenna port elements is smaller than the third number, the at least one configuration may indicate that the precoding matrixes with that a third set of antenna port elements which is not in the 4-antenna port group or 2-antenna port group is mapped with non-zero values. In other embodiments, the at least one configuration may indicate that precoding matrixes with that the first third number of antenna ports elements are used for mapping non-zero values in the third number of columns in the precoding matrix.

In some embodiments, if the number of layers is 8, there may be only one non-coherent precoding matrix (Set_n8_1). The non-coherent precoding matrix may always be included.

In some embodiments, if the number of layers (represented as “v”) is 7, there may be only one non-coherent precoding matrix. The non-coherent precoding matrix may always be included.

For example, if the fourth number (represented as “L”) of columns of the precoding matrix with non-zero values is 7, the non-zero value may be mapped on the 7 AP_i+1 indexes. If L is 8, the non-zero value may be mapped on C(L, 7) AP_i+1 indexes. Otherwise the non-coherent precoder p_n7_1 is included. In some embodiments, the values of AP_i included in a 4-port group may be used firstly, then values of AP_i included in a 2-port group may be used, then values of AP_i not included in any one of 4-port group or 2-port group may be used. And if there are more than 7 available values of AP_i, the lowest 7 indexes are used. For example, if N₁ is 2 or N₂ is 2, p_n7_1 may be included. Alternatively, if N₁ is 1 or N₂ is 1, and M₁ is 1, AP_i included in the 4-port group and the two 2-port groups may be used, and the one with lower value in remaining two APs may be used. In some embodiments, if N₁ is 1 or N₂ is 1, and M₁ is 0, AP_i included in the 4-port group may be used, and the three ones with lower values in remaining four APs may be used. Alternatively, the first 7 APs in config_n1 may be used for mapping the value 1 in 7 columns.

In some embodiments, if the number of layers (represented as “v”) is 6, there may be only one non-coherent precoding matrix. The non-coherent precoding matrix may always be included. For example, if the fourth number (represented as “L”) of columns of the precoding matrix with non-zero values is 6, the non-zero value may be mapped on the 6 AP_i+1 indexes. In some embodiments, if L is larger than 6, the non-zero values may be mapped on C(L, 6) AP_i+1 indexes. Otherwise the non-coherent p_n6_1 precoder may be included. Alternatively, the values of AP_i included in a 4-port group may be used firstly, then values of AP_i included in a 2-port group may be used, then values of AP_i not included in any one of 4-port group or 2-port group may be used. And if there are more than 6 available values of AP_i, the lowest 6 indexes may be used. In some other embodiments, the first 6 APs in config_n1 may be used for mapping the value 1 in 6 columns.

In some embodiments, if the number of layers (represented as “v”) is 5, there may be only one non-coherent precoding matrix. The non-coherent precoding matrix may always be included. For example, if the fourth number (represented as “L”) of columns of the precoding matrix with non-zero values is 5, the non-zero value may be mapped on the 6 AP_i+1 indexes. Alternatively, if L is larger than 5, the non-zero value may be mapped on C(L, 5) AP_i+1 indexes. Otherwise the non-coherent precoder p_n5_1 may be included. In some embodiments, the values of AP_i included in a 4-port group may be used firstly, then values of AP_i included in a 2-port group may be used, then values of AP_i not included in any one of 4-port group or 2-port group may be used. And if there are more than 5 available values of AP_i, the lowest 5 indexes may be used. In some other embodiments, the first 5 APs in config_n1 may be used for mapping the value 1 in 5 columns.

In some embodiments, if the number of layers (represented as “v”) is 4, there may be only one non-coherent precoding matrix. The non-coherent precoding matrix may always be included. For example, if the fourth number (represented as “L”) of columns of the precoding matrix with non-zero values is 4, the non-zero value may be mapped on the 4 AP_i+1 indexes. Alternatively, if L is larger than 4, the non-zero value may be mapped on C(L, 4) AP_i+1 indexes. Otherwise the non-coherent p_n4_1 precoder may be included.

In some embodiments, the values of AP_i included in a 4-port group may be used firstly, then values of AP_i included in a 2-port group may be used, then values of AP_i not included in any one of 4-port group or 2-port group may be used. And if there are more than 4 available values of AP_i, the lowest 4 indexes are used. For example, if N₁ is 1, N₂ is 2 or N₃ is 2, there may be two non-coherent precoders, each precoder with value one mapping on AP_i+1 index in a column, where AP_i is in one group. As another example, if N₁ is 1 or N₂ is 1 or N₃ is 1, there may be one non-coherent precoder, with value one mapping on AP_i+1 index in a column, and AP_i is in the group. In another embodiment, if N₁/N₂/N₃ is 0, and M₁ or M₂ or M₃ is not smaller than 2, the AP_i included in the M1 or M2 or M3 groups may be used, the non-zero value may be mapped on AP_i included in C(M3, 2) groups. In some other embodiments, the first 4 APs in config_n1 may be used for mapping the value 1 in 4 columns.

In some embodiments, if the number of layers (represented as “v”) is 3, there may be only one non-coherent precoding matrix. The non-coherent precoding matrix may always be included. For example, if the fourth number (represented as “L”) of columns of the precoding matrix with non-zero values is 3, the non-zero value may be mapped on the 3 AP_i+1 indexes. Alternatively, if L is larger than 3, the non-zero value may be mapped on C(L, 3) AP_i+1 indexes. Otherwise the non-coherent p_n3_1 precoder may be included. Alternatively, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and three values of AP_i may be selected in one group. There may be 2*C(4,3) non-coherent precoders, each precoder with value one mapping on AP_i+1 index in a column, where AP_i is in one group

Alternatively, if N₁ is 1 or N₂ is 1 or N₃ is 1, there may C(4,3) non-coherent precoders, with value one mapping on AP_i+1 index in a column, and three AP_i selected in the group. In other embodiments, if N₁/N₂/N₃ is 0, and M₁ or M₂ or M₃ is not smaller 2, the AP_i included in the M1 or M₂ or M₃ groups may be used, the non-zero value may be mapped on AP_i includes in C(M3, 2) groups and C(4,3) AP_i+1 indexes (or three lowest AP_i+1 indexes). In some other embodiments, the first 3 APs in config_n1 may be used for mapping the value 1 in 3 columns.

In some embodiments, if the number of layers (represented as “v”) is 2, there may be only one non-coherent precoding matrix. The non-coherent precoding matrix may always be included. For example, if the fourth number (represented as “L”) of columns of the precoding matrix with non-zero values is 2, the non-zero value may be mapped on the 2 AP_i+1 indexes. Alternatively, if L is larger than 2, the non-zero value may be mapped on C(L, 2) AP_i+1 indexes. Otherwise the non-coherent p_n2_1 precoders may be included. In some embodiments, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and two values of AP_i may be selected in one group. There may be 2*C(4,2) non-coherent precoders, each precoder with value one mapping on AP_i+1 index in a column, where AP_i is in one group. In some embodiments, if N₁ is 1 or N₂ is 1 or N₃ is 1, there may be C(4,2) non-coherent precoders, with value one mapping on AP_i+1 index in a column, and two AP_i may be selected in the group. Alternatively, if N₁/N₂/N₃ is 0, and M₁ or M₂ or M₃ is not smaller than 2, the AP_i included in the M₁ or M₂ or M₃ groups may be used, the non-zero value may be mapped on AP_i includes in C(M3, 1) groups and the two APi+1 indexes. In some embodiments, the first 2 APs in config_n1 may be for mapping the non-zero value in two columns.

In some embodiments, if the number of layers (represented as “v”) is 1, there may be only one non-coherent precoding matrix. The non-coherent precoding matrix may always be included. In some embodiment, there may be no need of configuration to indicate non-coherent precoders for one layer. There may be 8 precoders, with value 1 mapping on any one of the 8 elements.

For example, if the fourth number (represented as “L”) of columns of the precoding matrix with non-zero values is 1, the non-zero value may be mapped on the AP_i+1 index. Alternatively, if L is larger than 1, the non-zero value may be mapped on C(L, 1) AP_i+1 index. Otherwise the non-coherent p_n1_1 precoders may be included.

In some embodiments, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and one value of AP_i may be selected in one group. In some embodiments, there may be 2*C(4,1) non-coherent precoders, each precoder with value one mapping on AP_i+1 index in a column, where AP_i is in one group. In some embodiments, if N₁ is 1 or N₂ is 1 or N₃ is 1, there may be C(4,1) non-coherent precoders, with value one mapping on AP_i+1 index in a column, and one AP_i selected in the group. In some other embodiments, if N₁/N₂/N₃ is 0, and M₁ or M₂ or M₃ is not smaller than 2, the AP_i included in the M₁ or M₂ or M₃ groups may be used, the non-zero value may be mapped on AP_i includes in C(M3, 1) groups and the one of the two APi+1 indexes or fixed to the first one in the group. Alternatively, the first AP in config_n1 may be used for mapping the non-zero value.

As mentioned above, the terminal device 110-1 may receive information indicating that the PUSCH is scheduled associated with 8 antenna ports or associated with an SRS with 8 antenna ports. In this case, the DCI may indicate the fourth number of layers which is not smaller than a minimum number of layers and the minimum number of layers is one of 4, 5, 6, 7, or 8. The minimum number of layers may be predetermined or configured via higher layer. Alternatively, if the information indicates that the fourth number of layers is one of 1, 2, 3, 4, the terminal device 110-1 may expect that the PUSCH is scheduled associated with 1 or 2 or 4 antenna ports or associated with an SRS with 1 or 2 or 4 antenna ports.

For example, if the terminal device 110-1 is configured with 8Tx or 8-port SRS for uplink transmission, the number of layers indicated by a DCI may be at least one of {4, 5, 6, 7, 8}. In some embodiments, the candidate number of layers may be at least 4, for example, Lmin configured by RRC, and Lmin may be any one of {4,5,6,7,8}. In this case, the precoding matrix for PUSCH transmission may be based on the indicated number of layers. Alternatively, PUSCH transmission based on 8-port SRS is not expected to be 1-3 layers.

In some embodiments, for 1-3 or 1-4 layers transmission, the terminal device 110-1 may be configured with SRS resource set with maximum number of SRS ports to be 1 or 2 or 4. The 4-8 layers transmission with 8-port SRS and 1-3 (or 1-4) layers transmission based on 1/2/4-port SRS may be switched based on RRC or medium access control control element (MAC CE).

In some embodiments, the network device 120 may transmit a configuration of a set of SRS resources to the terminal device 110-1. In this case, a first subset of SRS resources in the set of SRS resources may be configured with 8 SRS ports, and a second subset of SRS resources in the set of SRS resources may be configured with a number of SRS ports which is not larger than 4.

For example, the terminal device 110-1 may be configured with a set of SRS resources (N_SRS, N_SRS may be {1, 2, 3, 4}) for codebook uplink transmission, and there may be N_SRS_1 resources configured with 8 ports (N_SRS_1 is integer and 1<=N_SRS_1<=N_SRS), and there may be N_SRS-N_SRS_1 resources configured with 1 or 2 or 4 ports. If the SRI indicates a SRS resource with 8 ports, more than 4 layers transmission may be applied. If the SRI indicates a SRS resource with 1/2/4 ports, 1-3 (or 1-4) layers transmission may be applied. The total bit size may be a maximum value between total size of “Precoding information and number of layers” and “Antenna ports” and a set of MCS/NDI/RV (8 bit) for 1-3 (or 1-4) layers and total size of “Precoding information and number of layers” and “Antenna ports” and two sets of MCS/NDI/RV (16 bits) for PUSCH transmission based on 8-port SRS. In some embodiments, reserved bits or zero padding may be applied for less value.

In some embodiments, 8-port SRS may be configured in a first BWP, and 1/2/4-port SRS may be configured in a second BWP. In this case, switching between uplink transmission based on 8-port SRS and uplink transmission based on 1/2/4-port SRS can be based on BWP switching.

In some embodiments, the network device 120 may transmit information indicating that the PUSCH is scheduled associated with 8 antenna ports or associated with an SRS with 8 antenna ports to the terminal device 110-1. In this case, the terminal device 110-1 may apply applying at least one of a subset of precoding matrixes or a subset of number of layers, before the reception of the at least one configuration.

For example, if the terminal device 110-1 is configured with 8Tx or 8-port SRS for uplink transmission, a subset of precoders and/or a subset of number of layers may be applied as default. For example, non-coherent precoders may be used as the default precoding matrix. In some embodiment, the bit size for default precoders in DCI may be fixed, and the size is X bits. X can be positive integer, e.g. 5<=X<=11. For example, in case of non-coherent precoders, at least 5 bits may be needed for 1-8 layers. In some embodiment, the DCI may indicate the fourth number of layers in a separate field or combined in an antenna port field. The DCI may also indicate a precoding matrix based on the fourth number of layers. For example, if the terminal device 110-1 is configured with 8Tx or 8-port SRS for uplink transmission, the number of layers may be separately indicated in a separate field (e.g. 3 bits) or jointly indicated with antenna ports field. The precoding field may indicate the precoders based on the indicated number of layers. The size of precoding field may be determined based on the maximum value among the number of precoders for different layers, for example, based on number of precoders for 1 layer or 2 layers. In some embodiments, the bit size for precoding field in DCI may be Y bits. Y may be positive integer, e.g. Y may be {5,6,7,8}.

In some embodiments, the network device 120 may transmit information indicating that the PUSCH is scheduled associated with 8 antenna ports or associated with an SRS with 8 antenna ports. In this case, the DCI comprises at least one of the followings for the number of layers larger than 5: a modulation and coding scheme (MCS), a new data indicator (NDI), or a redundancy version (RV). For example, if the terminal device 110-1 is configured with 8Tx or 8-port SRS for uplink transmission, a second set of MCS/NDI/RV (8 bits) may be included which is used to indicate MCS/NDI/RV for the layers exceeding 4. If the number of layers is not larger than 4, the reserved 8 bits may be applied or combined with field of precoders.

FIG. 4 shows a flowchart of an example method 400 in accordance with an embodiment of the present disclosure. The method 400 can be implemented at any suitable devices. Only for the purpose of illustrations, the method 400 can be implemented at a network device 120 as shown in FIG. 1.

In some embodiments, the network device 120 may transmit information to the terminal device 110-1. The information may indicate that a PUSCH is scheduled associated with 8 antenna ports. For example, total number of antenna ports for the PUSCH transmission may be 8. Alternatively, the information may indicate that the PUSCH is scheduled associated with a sounding reference signal (SRS) with 8 antenna ports. In other words, the total number of antenna ports of a SRS associated with the PUSCH transmission is 8. In some embodiments, the information may be transmitted in a SRS configuration.

Alternatively or in addition, the network device 120 may receive capability information from the terminal device 110-1.

In some embodiments, the capability information may indicate a capability of precoding matrix supported by the terminal device 110-1. For example, the capability information may indicate a type of precoding matrix supported by the terminal device 110-1. In some embodiments, the capability information may comprise at least one of: a full coherent, a partial coherent, a first partial coherent, a second partial coherent, a non coherent.

In some embodiments, the capability information may indicate the full coherent, the set of precoding matrix (for example, one of the set of precoding matrixes corresponding to v_ri layers can be indicated by the network device or one or more of the set of precoding matrixes can be configured by the network device) may comprise at least one of the first set (or at least one of the first subset, or at least one of the second subset or at least one of the third subset or at least one of fourth subset) of precoding matrixes corresponding to v_ri layers (e.g. a full-coherent precoding matrix type). For example, the set of precoding matrix may further comprise at least one of the second set of precoding matrixes corresponding to v_ri layers (e.g. a first partial-coherent precoding matrix type). For another example, the set of precoding matrixes may further comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the partial coherent or indicate the first partial coherent, the set of precoding matrix corresponding to v_ri layers (for example, one of the set of precoding matrixes can be indicated by the network device or one or more of the set of precoding matrixes can be configured by the network device) may comprise at least one of the second set of precoding matrixes corresponding to v_ri layers (e.g. a first partial-coherent precoding matrix type). For another example, the set of precoding matrixes may further comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the second partial coherent, the set of precoding matrix corresponding to v_ri layers (for example, one of the set of precoding matrixes can be indicated by the network device or one or more of the set of precoding matrixes can be configured by the network device) may comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the non coherent, the set of precoding matrix corresponding to v_ri layers (for example, one of the set of precoding matrixes can be indicated by the network device or one or more of the set of precoding matrixes can be configured by the network device) may comprise at least one of the fourth set of precoding matrixes corresponding to v_ri layers (e.g. a non-coherent precoding matrix type).

In some embodiments, the capability information may comprise any one or combination of the above precoding matrix types. In some embodiments, the capability information may be transmitted via radio resource control (RRC) signaling.

In some embodiments, the network device 120 may configure the type of precoding matrixes or at least one set of precoding matrixes corresponding to v_ri layers which can be indicated or configured to the terminal device 110-1. In some embodiments, corresponding to v_ri layers, the at least one configuration may configure at least one of the first subset of precoding matrixes corresponding to v_ri layers, the second subset of precoding matrixes corresponding to v_ri layers, the third subset of precoding matrixes corresponding to v_ri layers, the fourth subset of precoding matrixes corresponding to v_ri layers, the first set of precoding matrixes corresponding to v_ri layers, the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the full coherent, corresponding to v_ri layers, the at least one configuration may configure at least one of the first subset of precoding matrixes corresponding to v_ri layers, the second subset of precoding matrixes corresponding to v_ri layers, the third subset of precoding matrixes corresponding to v_ri layers, the fourth subset of precoding matrixes corresponding to v_ri layers, the first set of precoding matrixes corresponding to v_ri layers, the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the partial coherent or the first partial coherent, corresponding to v_ri layers, the at least one configuration may configure at least one of the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the second partial coherent, corresponding to v_ri layers, the at least one configuration may configure at least one of the third set of precoding matrixes corresponding to v_ri layers and the fourth set of precoding matrixes corresponding to v_ri layers.

In some embodiments, if the capability information is indicated as the non coherent, corresponding to v_ri layers, the at least one configuration may configure at least one of the fourth set of precoding matrixes corresponding to v_ri layers.

In some embodiments, the network device 120 may determine the type of precoding matrix which can be supported by the terminal device. In this case, the network device 120 may transmit an indication of the type of the precoding matrix. The type of the precoding matrix may be any one or combination of: a full-coherent precoding matrix type, a full-coherent and partial-coherent and non-coherent precoding matrix type, a partial-coherent precoding matrix type, a partial-coherent and a non-coherent precoding matrix type or a non-coherent precoding matrix type.

At block 410, the network device 120 transmits at least one configuration associated with precoding matrix to the terminal device 110-1. In some embodiments, the at least one configuration may comprise one or more configurations of antenna port groups. Alternatively or in addition, the at least one configuration may comprise at least one antenna port group. In other embodiments, the at least one configuration may comprise one or more configurations of antenna pattern. In some other embodiments, the at least one configuration may comprise one or more configurations of precoding matrix type. Alternatively or in addition, the at least one configuration may comprise one or more configurations of precoding matrix subsets. In some embodiments, the at least one configuration may comprise the number of antenna port groups. In other embodiments, the at least one configuration may comprise the number of antenna ports in an antenna port group.

In some embodiments, the at least one configuration may comprise a first number of antenna groups and each of the antenna groups may comprise 4 antenna ports. For example, the first number may be 0 or 1 or 2. In this case, the first number may be a first integer which is not larger than 2. Alternatively or in addition, the at least one configuration may comprise a second number of antenna groups and each of the antenna groups may comprise 2 antenna ports. For example, the second number may be 0 or 1 or 2 or 3 or 4. In this case, the second number may be a second integer which is not larger than 4. In some other embodiments, the at least one configuration may comprise a third number of antenna groups and each of the antenna groups may comprise 1 antenna port. The third number may be a third integer which is not larger than 8. In another embodiment, the at least one configuration may comprise at least one of: a subset of full-coherent precoding matrixes, a subset of partial-coherent precoding matrixes, or a subset of non-coherent precoding matrixes.

Only as an example, the terminal device 110-1 may be configured with 8Tx for uplink or 8 ports SRS, (e.g. AP_0, AP_1, AP_2, AP_3, AP_4, AP_5, AP_6, AP_7). In some embodiments, the at least one configuration may include N groups where each group comprises 4 antenna ports, (N may be 0, 1, 2) and/or M groups where each group comprises 2 antenna ports, (M is integer, and 0<=M<=(8−N*4)/2 or 0<=M<=4)), and/or L groups where each group comprises 1 antenna port (or L antenna ports) (L is integer, and 0<=L<=8−N*4−M*2 or 0<=L<=8). Alternatively, the at least one configuration may indicate a subset of full-coherent and/or partial-coherent and/or a first partial-coherent (e.g. partial-coherent4) and/or a second partial-coherent (e.g. partial-coherent2) and/or non-coherent precoding matrix.

In some embodiments, the at least one configuration may be configured per value of number of layers or per precoder type. For example, N1, M1 may be configured for the first set of precoding matrixes corresponding to v_ri layers or for the full coherent precoding matrixes, N2, M2 may be configured for the second or the third set of precoding matrixes corresponding to v_ri layers or for the partial coherent precoding matrixes, N3, M3 may be configured for the fourth set of precoding matrixes corresponding to v_ri layers or for the non-coherent precoding matrixes.

In some embodiments, the 8 antenna ports for PUSCH transmission or the 8 antenna ports of the 8-port SRS may be {AP0, AP1, AP2, AP3, AP4, AP5, AP6, AP7}. And AP0 or AP1 or AP2 or AP3 or AP4 or AP5 or AP6 or AP7 may be any one of {0, 1, 2,3, 4, 5, 6, 7} or any one of {1000, 1001, 1002, 1003, 1004, 1005, 1006, 1007} or any one of {3000,3001, 3002, 3003, 3004, 3005, 3006, 3007}. In some embodiments, the values of AP0 or AP1 or AP2 or AP3 or AP4 or AP5 or AP6 or AP7 may be different from each other.

In some embodiments, in each group, 1 or 2 or 4 of {AP_a, AP_b, AP_c, AP_d, AP_e, AP_f, AP_g, AP_h} can be included. The {a,b,c,d,e,f,g,h}, {AP_a, AP_b, AP_c, AP_d, AP_e, AP_f, AP_g, AP_h} may integer and can be {0, 1, 2, 3,4,5,6,7}. The numbers may be different from each other. For example, there are several port grouping configurations (4 ports in a group), {0, 1, 2, 3}, {4,5,6,7} or {0,2,4,6}, {1,3,5,7}. As another embodiment, there are several port grouping configurations (2 ports in a group), {0, 1}, {2,3}, {4,5}, {6,7} or {0,2}, {1,3}, {4,6}, {5,7}.

In some embodiments, the at least one configuration may indicate one of the port grouping configurations. For example, DMRS ports in same group may share a same PTRS port. In some embodiments, the precoding matrix may be an 8*v matrix, where v represents number of layers, v may be integer and 1<=v<=8 or 4<=v<=8. In some embodiments, v may be same as v_ri.

In some embodiments, the terminal device 110-1 may be configured with 8Tx for uplink transmission or configured with PUSCH transmission associated with SRS with 8 ports. The at least one configuration may include at least one of: values for i_{1,1}, values for i_{1,2}, values for i_{1,3}, values for i₂, values for i_{1,4,1}, values for i_{1,4,2}, values for i_{2,0}, values for i_{2,1}, values for i_{2,2}, values for Ng, values for N₁, values for N₂, values for O₁, values for O₂, and a configuration pattern (e.g. for antenna ports). The configuration pattern and/or the values may be applied at least for full-coherent precoding matrixes.

In some embodiments, the at least one configuration may indicate the first subset or the second subset or the third subset or the fourth subset of precoding matrixes corresponding to v_ri layers may be applied for the PUSCH transmission. For example, the DCI may indicate one of the applicable precoding matrixes for the PUSCH transmission.

In some embodiments, the at least one configuration may indicate two groups of antenna ports, and each group may comprise 4 antenna ports, and based on the at least one configuration, a DCI may indicate one precoding matrix of the first subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the second subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the third subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the fourth subset of precoding matrixes corresponding to v_ri layers for the PUSCH transmission.

In some embodiments, the at least one configuration may indicate one or two groups of antenna ports, and each group may comprise 4 antenna ports, and based on the at least one configuration, a DCI may indicate one precoding matrix from the second subset of precoding matrixes corresponding to v_ri layers for the PUSCH transmission.

In some embodiments, in a column or row of a precoding matrix in the second subset of precoding matrixes corresponding to v_ri layers, the indexes of the 4 non-zero values may be based on the indexes of antenna port indexes in a group. For example, the non-zero values in a column or row may be only mapped on indexes based on the index of antenna ports in the one or two groups. In some embodiments, a first group may comprise 4 antenna ports, and the 4 antenna ports may be {AP0, AP1, AP2, AP3}. In some embodiments, a second group may comprise 4 antenna ports, and the 4 antenna ports may be {AP4, AP5, AP6, AP7}. In some embodiments, in a column or row of the precoding matrix, one of length-4 vectors in the first set or second set of length-4 vectors may be mapped on the indexes of elements based on the antenna port indexes in the first group and/or the second group.

In some embodiments, for the second set of precoding matrixes corresponding to 8 layers, for a first set of 4 columns or rows (e.g. the first 4 columns or rows), a set of length-4 vectors may be mapped on element with indexes based on the 4 antenna ports in the first group, and for a second set of 4 columns or rows (e.g. the remaining or last 4 columns or rows), a set of length-4 vectors may be mapped on elements with indexes based on the 4 antenna ports in the second group.

In some embodiments, for the third set of precoding matrixes corresponding to 8 layers, for a first set of 2 columns or rows (e.g. the first and second columns or rows), a set of length-2 vectors may be mapped on elements with indexes based on two out of the 4 antenna ports in the first group, and for a second set of 2 columns or rows (e.g. the third and fourth columns or rows), a set of length-2 vectors may be mapped on elements with indexes based on remaining two antenna ports in the first group, and for a third set of 2 columns or rows (e.g. the fifth and sixth columns or rows), a set of length-2 vectors may be mapped on element with indexes based on two out of the 4 antenna ports in the second group, and for a fourth set of 2 columns or rows (e.g. the seventh and eighth columns or rows), a set of length-2 vectors may be mapped on elements with indexes based on remaining two antenna ports in the second group,

In some embodiments, in a column or row of a precoding matrix in the third subset of precoding matrixes corresponding to v_ri layers, the indexes of the 2 non-zero values may be based on the indexes of two out of the four antenna port indexes in a group. For example, the non-zero values in a column or row may be only mapped on indexes based on the index of antenna ports in the one or two groups. For example, a first group with 4 antenna ports may be {AP0, AP1, AP2, AP3}. For another example, a second group with 4 antenna ports may be {AP4, AP5, AP6, AP7}. In some embodiments, in a column or row of the precoding matrix, one of length-2 vectors in the first set or second set of length-2 vectors may be mapped on the indexes of elements based on two out of 4 antenna port indexes in the first group and/or the second group.

In some embodiments, in a column or row of a precoding matrix in the fourth subset of precoding matrixes corresponding to v_ri layers, the indexes of the 1 non-zero value (with value 1) may be based on the indexes of one out of the four antenna port indexes in a group. For example, the non-zero values in a column or row may be only mapped on indexes based on the index of antenna ports in the one or two groups. For example, a first group with 4 antenna ports may be {AP0, AP1, AP2, AP3}. For another example, a second group with 4 antenna ports may be {AP4, AP5, AP6, AP7}. In some embodiments, in a column or row of the precoding matrix, the value 1 may be mapped on the index of elements based on one out of 4 antenna port indexes in the first group and/or the second group.

In some embodiments, the at least one configuration may indicate one or two or three or four groups of antenna ports, and each group may comprise 2 antenna ports, and based on the at least one configuration, a DCI may indicate one precoding matrix from the second subset of precoding matrixes corresponding to v_ri layers for the PUSCH transmission. In some embodiments, in a column or row of the precoding matrix, the indexes of the 2 non-zero values may be based on the indexes of antenna port indexes in a group. For example, the non-zero values in a column or row may be only mapped on indexes based on the index of antenna ports in the one or two or three or four groups.

In some embodiments, there may be a third group, and the third group may comprise 2 antenna ports with indexes {AP0, AP1}. In some embodiments, there may be a fourth group, and the fourth group may comprise 2 antenna ports with indexes {AP2, AP3}. In some embodiments, there may be a fifth group, and the fifth group may comprise 2 antenna ports with indexes {AP4, AP5}. In some embodiments, there may be a sixth group, and the sixth group may comprise 2 antenna ports with indexes {AP6, AP7}. In some embodiments, in a column or row of the precoding matrix, one of length-2 vectors in the first set or second set of length-2 vectors may be mapped on the indexes of elements based on the antenna port indexes in the third group and/or the fourth group and/or the fifth group and/or the sixth group.

At block 420, the network device 120 transmits DCI for scheduling a PUSCH to the terminal device 110-1. For example, the DCI may indicate the fourth number of layers. In some embodiments, the DCI may indicate which full coherent precoding matrixes for the terminal device 110-1.

At block 430, the network device 120 receives the PUSCH based on the precoding matrix. In some embodiments, the DCI may indicate which full coherent precoding matrixes for the terminal device 110-1. In some embodiments, the at least one configuration comprises none or at least one of: a first full coherent precoding matrix or a second full coherent precoding matrix. For example, the at least one configuration may indicate none or one or both of Set_fv_1 and Set_fv_2. Alternatively, the at least one configuration comprises one or more of a number of antenna ports in a first dimension, a number of antenna ports in a second dimension, a first DFT oversampling in the first dimension, or a second DFT oversampling in the second dimension. For example, the at least one configuration may indicate candidate values for at least one of N1, N2, i1,1, O1, O2, i1,2, i1,3 to generate the precoding matrix.

In some embodiments, the DCI may indicate which partial coherent precoding matrixes for the terminal device 110-1. In some embodiments, the at least one configuration may indicate that if there is at least one antenna port group with 4 antenna ports, at least one column or at least one row of the precoding matrix is with 4 non-zero values on 4 of the 8 elements. The indexes of the 4 elements may be based on the indexes of the 4 antenna ports in one antenna port group, and zero values on other 4 of the 8 elements in the column or the row. For example, the at least one configuration may indicate that if there is at least one group with 4 ports, at least one column of the precoder can be with 4 non-zero values (mapping on the 4 indexes (AP_i+1)). Otherwise, there may be no such kind of precoders.

In some embodiments, the at least one configuration may indicate that if there is at least one antenna port group with 2 antenna ports, at least one column or at least one row of the precoding matrix is with 2 non-zero values on 2 of the 8 elements. The indexes of the 2 elements may be based on the indexes of the 2 antenna ports in one antenna port group, and zero values on other 6 of the 8 elements in the column or the row. For example, the at least one configuration may indicate that if there is at least one group with 2 ports, at least one column of the precoder can be with 2 non-zero values (mapping on the 2 indexes (AP_i+1)), otherwise, there is no such kind of precoders.

In some embodiments, at least one configuration may indicate that if there is at least one antenna port group with 1 antenna port, at least one column or at least one row of the precoding matrix is with 1 non-zero value on 1 of the 8 elements, and the non-zero value is 1. The index of the 1 element may be based on the index of the antenna port in one antenna port group, and zero values on other 7 of the 8 elements in the column or the row.

In some embodiments, if the third number is no larger than the fourth number, a set of non-coherent precoding matrixes associated with the fourth number may be available for the PUSCH. In this case, each column or each row of the non-coherent precoding matrix may be with 1 non-zero value on 1 of the 8 elements. The non-zero value may be 1. The index of the 1 element may be based on the index of the antenna port in one antenna port group, and zero values on other 7 of the 8 elements in the column or the row. The indexes of the 1 element in different columns or different rows may be based on different antenna port groups.

Alternatively or in addition, if the third number is larger than the fourth number, a set of non-coherent precoding matrixes associated with the fourth number may not be available for the PUSCH. Alternatively, if the third number is not configured, the set of non-coherent precoding matrixes may be not available for the PUSCH. In some embodiments, if the third number is at least one of: 1, 2, 3, 4, 5, 6, 7, 8, the set of non-coherent precoding matrixes may comprise at least a precoding matrix with each column or each row of the precoding matrix is with 1 non-zero value on 1 of the 8 elements, and the non-zero value is 1. The index of the 1 element may be based on the index of column or row, and zero values on other 7 of the 8 elements in the column or the row. In other embodiments, if the third number is at least one of: 1, 2, 3, 4, the set of non-coherent precoding matrixes may comprise at least a precoding matrix with each column or each row of the precoding matrix is with 1 non-zero value on 1 of the first 4 elements, and the non-zero value is 1. The index of the 1 element may be based on the index of column or row, and zero values on other 7 elements in the column or the row.

In some embodiments, if the third number is same as the fourth number, the set of non-coherent precoding matrixes may comprise that at least a precoding matrix with each column or each row of the precoding matrix is with 1 non-zero value on 1 of the 8 elements, and the non-zero value is 1. The index of the 1 element in each column or row may be based on the index of each antenna port of the third number of antenna ports, and zero values on other 7 of the 8 elements in the column or the row.

Alternatively, if the third number is larger than the fourth number, the set of non-coherent precoding matrixes may comprise that at least a precoding matrix with each column or each row of the precoding matrix is with 1 non-zero value on 1 of the 8 elements, and the non-zero value is 1. The index of the 1 element in each column or row may be based on the index of one antenna port, and the antenna port is one of the fourth number out of the third number of antenna ports, and zero values on other 7 of the 8 elements in the column or the row. In some other embodiments, if the third number is smaller than the fourth number, non-coherent precoding matrix associated with the fourth number may not be available for the PUSCH.

In some embodiments, the at least one configuration may comprise an order of 8 antenna ports. The set of non-coherent precoding matrixes associated with the fourth number may comprise that at least a precoding matrix with each column or each row of the precoding matrix is with 1 non-zero value on 1 of the 8 elements, and the non-zero value is 1. The index of the 1 element in each column or row may be based on the index of one antenna port, and the antenna port is one of first fourth number of antenna ports out of the order of 8 antenna ports, and zero values on other 7 of the 8 elements in the column or the row. Alternatively, the at least one configuration may indicate precoding matrixes with is that a first set of antenna port elements in a 4-antenna port group is mapped with non-zero values.

In some embodiments, if the number of antenna port elements in the first set of antenna port element is smaller than the third number, the at least one configuration may indicate that precoding matrixes with that a second set of antenna port elements in a 2-antenna port group is mapped with non-zero values. Alternatively or in addition, if the number of antenna port elements in the first and second sets of antenna port elements is smaller than the third number, the at least one configuration may indicate that the precoding matrixes with that a third set of antenna port elements which is not in the 4-antenna port group or 2-antenna port group is mapped with non-zero values. In other embodiments, the at least one configuration may indicate that precoding matrixes with that the first third number of antenna ports elements are used for mapping non-zero values in the third number of columns in the precoding matrix.

In some embodiments, if the number of layers is 8, there may be only one non-coherent precoding matrix (Set_n8_1). The non-coherent precoding matrix may always be included.

In some embodiments, if the number of layers (represented as “v”) is 7, there may be only one non-coherent precoding matrix. The non-coherent precoding matrix may always be included.

For example, if the fourth number (represented as “L”) of columns of the precoding matrix with non-zero values is 7, the non-zero value may be mapped on the 7 AP_i+1 indexes. If L is 8, the non-zero value may be mapped on C(L, 7) AP_i+1 indexes. Otherwise the non-coherent precoder p_n7_1 is included. In some embodiments, the values of AP_i included in a 4-port group may be used firstly, then values of AP_i included in a 2-port group may be used, then values of AP_i not included in any one of 4-port group or 2-port group may be used. And if there are more than 7 available values of AP_i, the lowest 7 indexes are used. For example, if N₁ is 2 or N₂ is 2, p_n7_1 may be included. Alternatively, if N₁ is 1 or N₂ is 1, and M₁ is 1, AP_i included in the 4-port group and the two 2-port groups may be used, and the one with lower value in remaining two APs may be used. In some embodiments, if N₁ is 1 or N₂ is 1, and M₁ is 0, AP_i included in the 4-port group may be used, and the three ones with lower values in remaining four APs may be used. Alternatively, the first 7 APs in config_n1 may be used for mapping the value 1 in 7 columns.

In some embodiments, if the number of layers (represented as “v”) is 6, there may be only one non-coherent precoding matrix. The non-coherent precoding matrix may always be included. For example, if the fourth number (represented as “L”) of columns of the precoding matrix with non-zero values is 6, the non-zero value may be mapped on the 6 AP_i+1 indexes. In some embodiments, if L is larger than 6, the non-zero values may be mapped on C(L, 6) AP_i+1 indexes. Otherwise the non-coherent p_n6_1 precoder may be included. Alternatively, the values of AP_i included in a 4-port group may be used firstly, then values of AP_i included in a 2-port group may be used, then values of AP_i not included in any one of 4-port group or 2-port group may be used. And if there are more than 6 available values of AP_i, the lowest 6 indexes may be used. In some other embodiments, the first 6 APs in config_n1 may be used for mapping the value 1 in 6 columns.

In some embodiments, if the number of layers (represented as “v”) is 5, there may be only one non-coherent precoding matrix. The non-coherent precoding matrix may always be included. For example, if the fourth number (represented as “L”) of columns of the precoding matrix with non-zero values is 5, the non-zero value may be mapped on the 6 AP_i+1 indexes. Alternatively, if L is larger than 5, the non-zero value may be mapped on C(L, 5) AP_i+1 indexes. Otherwise the non-coherent precoder p_n5_1 may be included. In some embodiments, the values of AP_i included in a 4-port group may be used firstly, then values of AP_i included in a 2-port group may be used, then values of AP_i not included in any one of 4-port group or 2-port group may be used. And if there are more than 5 available values of AP_i, the lowest 5 indexes may be used. In some other embodiments, the first 5 APs in config_n1 may be used for mapping the value 1 in 5 columns.

In some embodiments, if the number of layers (represented as “v”) is 4, there may be only one non-coherent precoding matrix. The non-coherent precoding matrix may always be included. For example, if the fourth number (represented as “L”) of columns of the precoding matrix with non-zero values is 4, the non-zero value may be mapped on the 4 AP_i+1 indexes. Alternatively, if L is larger than 4, the non-zero value may be mapped on C(L, 4)AP_i+1 indexes. Otherwise the non-coherent p_n4_1 precoder may be included.

In some embodiments, the values of AP_i included in a 4-port group may be used firstly, then values of AP_i included in a 2-port group may be used, then values of AP_i not included in any one of 4-port group or 2-port group may be used. And if there are more than 4 available values of AP_i, the lowest 4 indexes are used. For example, if N₁ is 1, N₂ is 2 or N₃ is 2, there may be two non-coherent precoders, each precoder with value one mapping on AP_i+1 index in a column, where AP_i is in one group. As another example, if N₁ is 1 or N₂ is 1 or N₃ is 1, there may be one non-coherent precoder, with value one mapping on AP_i+1 index in a column, and AP_i is in the group. In another embodiment, if N₁/N₂/N₃ is 0, and M₁ or M₂ or M₃ is not smaller than 2, the AP_i included in the M1 or M2 or M3 groups may be used, the non-zero value may be mapped on AP_i included in C(M3, 2) groups. In some other embodiments, the first 4 APs in config_n1 may be used for mapping the value 1 in 4 columns.

In some embodiments, if the number of layers (represented as “v”) is 3, there may be only one non-coherent precoding matrix. The non-coherent precoding matrix may always be included. For example, if the fourth number (represented as “L”) of columns of the precoding matrix with non-zero values is 3, the non-zero value may be mapped on the 3 AP_i+1 indexes. Alternatively, if L is larger than 3, the non-zero value may be mapped on C(L, 3) AP_i+1 indexes. Otherwise the non-coherent p_n3_1 precoder may be included. Alternatively, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and three values of AP_i may be selected in one group. There may be 2*C(4,3) non-coherent precoders, each precoder with value one mapping on AP_i+1 index in a column, where AP_i is in one group

Alternatively, if N₁ is 1 or N₂ is 1 or N₃ is 1, there may C(4,3) non-coherent precoders, with value one mapping on AP_i+1 index in a column, and three AP_i selected in the group. In other embodiments, if N₁/N₂/N₃ is 0, and M₁ or M₂ or M₃ is not smaller 2, the AP_i included in the M1 or M2 or M3 groups may be used, the non-zero value may be mapped on AP_i includes in C(M3, 2) groups and C(4,3) AP_i+1 indexes (or three lowest AP_i+1 indexes). In some other embodiments, the first 3 APs in config_n1 may be used for mapping the value 1 in 3 columns.

In some embodiments, if the number of layers (represented as “v”) is 2, there may be only one non-coherent precoding matrix. The non-coherent precoding matrix may always be included. For example, if the fourth number (represented as “L”) of columns of the precoding matrix with non-zero values is 2, the non-zero value may be mapped on the 2 AP_i+1 indexes. Alternatively, if L is larger than 2, the non-zero value may be mapped on C(L, 2) AP_i+1 indexes. Otherwise the non-coherent p_n2_1 precoders may be included. In some embodiments, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and two values of AP_i may be selected in one group. There may be 2*C(4,2) non-coherent precoders, each precoder with value one mapping on AP_i+1 index in a column, where AP_i is in one group. In some embodiments, if N₁ is 1 or N₂ is 1 or N₃ is 1, there may be C(4,2) non-coherent precoders, with value one mapping on AP_i+1 index in a column, and two AP_i may be selected in the group. Alternatively, if N₁/N₂/N₃ is 0, and M₁ or M₂ or M₃ is not smaller than 2, the AP_i included in the M₁ or M₂ or M₃ groups may be used, the non-zero value may be mapped on AP_i includes in C(M3, 1) groups and the two APi+1 indexes. In some embodiments, the first 2 APs in config_n1 may be for mapping the non-zero value in two columns.

In some embodiments, if the number of layers (represented as “v”) is 1, there may be only one non-coherent precoding matrix. The non-coherent precoding matrix may always be included. In some embodiment, there may be no need of configuration to indicate non-coherent precoders for one layer. There may be 8 precoders, with value 1 mapping on any one of the 8 elements.

For example, if the fourth number (represented as “L”) of columns of the precoding matrix with non-zero values is 1, the non-zero value may be mapped on the AP_i+1 index. Alternatively, if L is larger than 1, the non-zero value may be mapped on C(L, 1) AP_i+1 index. Otherwise the non-coherent p_n1_1 precoders may be included.

In some embodiments, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and one value of AP_i may be selected in one group. In some embodiments, there may be 2*C(4,1) non-coherent precoders, each precoder with value one mapping on AP_i+1 index in a column, where AP_i is in one group. In some embodiments, if N₁ is 1 or N₂ is 1 or N₃ is 1, there may be C(4,1) non-coherent precoders, with value one mapping on AP_i+1 index in a column, and one AP_i selected in the group. In some other embodiments, if N₁/N₂/N₃ is 0, and M₁ or M₂ or M₃ is not smaller than 2, the AP_i included in the M₁ or M₂ or M₃ groups may be used, the non-zero value may be mapped on AP_i includes in C(M3, 1) groups and the one of the two APi+1 indexes or fixed to the first one in the group. Alternatively, the first AP in config_n1 may be used for mapping the non-zero value.

As mentioned above, the terminal device 110-1 may receive information indicating that the PUSCH is scheduled associated with 8 antenna ports or associated with an SRS with 8 antenna ports. In this case, the DCI may indicate the fourth number of layers which is not smaller than a minimum number of layers and the minimum number of layers is one of 4, 5, 6, 7, or 8. The minimum number of layers may be predetermined or configured via higher layer. Alternatively, if the information indicates that the fourth number of layers is one of 1, 2, 3, 4, the terminal device 110-1 may expect that the PUSCH is scheduled associated with 1 or 2 or 4 antenna ports or associated with an SRS with 1 or 2 or 4 antenna ports.

For example, if the terminal device 110-1 is configured with 8Tx or 8-port SRS for uplink transmission, the number of layers indicated by a DCI may be at least one of {4, 5, 6, 7, 8}. In some embodiments, the candidate number of layers may be at least 4, for example, Lmin configured by RRC, and Lmin may be any one of {4,5,6,7,8}. In this case, the precoding matrix for PUSCH transmission may be based on the indicated number of layers. Alternatively, PUSCH transmission based on 8-port SRS is not expected to be 1-3 layers.

In some embodiments, for 1-3 or 1-4 layers transmission, the terminal device 110-1 may be configured with SRS resource set with maximum number of SRS ports to be 1 or 2 or 4. The 4-8 layers transmission with 8-port SRS and 1-3 (or 1-4) layers transmission based on 1/2/4-port SRS may be switched based on RRC or medium access control control element (MAC CE).

In some embodiments, the network device 120 may transmit a configuration of a set of SRS resources to the terminal device 110-1. In this case, a first subset of SRS resources in the set of SRS resources may be configured with 8 SRS ports, and a second subset of SRS resources in the set of SRS resources may be configured with a number of SRS ports which is not larger than 4.

For example, the terminal device 110-1 may be configured with a set of SRS resources (N_SRS, N_SRS may be {1, 2, 3, 4}) for codebook uplink transmission, and there may be N_SRS_1 resources configured with 8 ports (N_SRS_1 is integer and 1<=N_SRS_1<=N_SRS), and there may be N_SRS−N_SRS_1 resources configured with 1 or 2 or 4 ports. If the SRI indicates a SRS resource with 8 ports, more than 4 layers transmission may be applied. If the SRI indicates a SRS resource with 1/2/4 ports, 1-3 (or 1-4) layers transmission may be applied. The total bit size may be a maximum value between total size of “Precoding information and number of layers” and “Antenna ports” and a set of MCS/NDI/RV (8 bit) for 1-3 (or 1-4) layers and total size of “Precoding information and number of layers” and “Antenna ports” and two sets of MCS/NDI/RV (16 bits) for PUSCH transmission based on 8-port SRS. In some embodiments, reserved bits or zero padding may be applied for less value.

In some embodiments, 8-port SRS may be configured in a first BWP, and 1/2/4-port SRS may be configured in a second BWP. In this case, switching between uplink transmission based on 8-port SRS and uplink transmission based on 1/2/4-port SRS can be based on BWP switching.

In some embodiments, the network device 120 may transmit information indicating that the PUSCH is scheduled associated with 8 antenna ports or associated with an SRS with 8 antenna ports to the terminal device 110-1. In this case, the terminal device 110-1 may apply applying at least one of: a subset of precoding matrixes or a subset of number of layers, before the reception of the at least one configuration.

For example, if the terminal device 110-1 is configured with 8Tx or 8-port SRS for uplink transmission, a subset of precoders and/or a subset of number of layers may be applied as default. For example, non-coherent precoders may be used as the default precoding matrix. In some embodiment, the bit size for default precoders in DC1 may be fixed, and the size is X bits. X can be positive integer, e.g. 5<=X<=11. For example, in case of non-coherent precoders, at least 5 bits may be needed for 1-8 layers. In some embodiment, the DCI may indicate the fourth number of layers in a separate field or combined in an antenna port field. The DCI may also indicate a precoding matrix based on the fourth number of layers. For example, if the terminal device 110-1 is configured with 8Tx or 8-port SRS for uplink transmission, the number of layers may be separately indicated in a separate field (e.g. 3 bits) or jointly indicated with antenna ports field. The precoding field may indicate the precoders based on the indicated number of layers. The size of precoding field may be determined based on the maximum value among the number of precoders for different layers, for example, based on number of precoders for 1 layer or 2 layers. In some embodiments, the bit size for precoding field in DCI may be Y bits. Y may be positive integer, e.g. Y may be {5,6,7,8}.

In some embodiments, the network device 120 may transmit information indicating that the PUSCH is scheduled associated with 8 antenna ports or associated with an SRS with 8 antenna ports. In this case, the DCI comprises at least one of the followings for the number of layers larger than 5: a modulation and coding scheme (MCS), a new data indicator (NDI), or a redundancy version (RV). For example, if the terminal device 110-1 is configured with 8Tx or 8-port SRS for uplink transmission, a second set of MCS/NDI/RV (8 bits) may be included which is used to indicate MCS/NDI/RV for the layers exceeding 4. If the number of layers is not larger than 4, the reserved 8 bits may be applied or combined with field of precoders.

In some embodiments, a terminal device comprise circuitry configured to perform: receiving, from a network device, at least one configuration associated with precoding matrixes; receiving, from the network device, downlink control information (DCI) for scheduling a physical uplink shared channel (PUSCH), the DCI comprising an indication of a precoding matrix index; determining a precoding matrix based on the at least one configuration and the indication; and transmitting the PUSCH based on the precoding matrix.

In some embodiments, the at least one configuration comprises at least one of: one or more configurations of antenna port groups, at least one antenna port group, one or more configurations of antenna pattern, one or more configurations of precoding matrix type, one or more configurations of precoding matrix subsets, the number of antenna port groups, or the number of antenna ports in an antenna port group.

In some embodiments, a total number of antenna ports for the PUSCH transmission or a total number of antenna ports of a sounding reference signal (SRS) associated with the PUSCH transmission is 8.

In some embodiments, the terminal device comprise circuitry configured to perform: determining the precoding matrix based on a fourth number of layers, and the fourth number is indicated in the DCI, wherein the precoding matrix is at least one of: a matrix with size 8 multiplies the fourth number; a matrix with size the fourth number multiplies 8; a matrix with the fourth number of columns, and each column with 8 elements; and a matrix with the fourth number of rows, and each row with 8 elements.

In some embodiments, the at least one configuration comprises a first number of antenna groups, each of the antenna groups comprises 4 antenna ports, and the first number is a first integer which is not larger than 2, or wherein the at least one configuration comprises a second number of antenna groups, each of the antenna groups comprises 2 antenna ports, and the second number is a second integer which is not larger than 4, or wherein the at least one configuration comprises a third number of antenna groups, each of the antenna groups comprises 1 antenna port, and the third number is a third integer which is not larger than 8, or wherein the at least one configuration comprises at least one of: a subset of full-coherent precoding matrixes, a subset of partial-coherent precoding matrixes, or a subset of non-coherent precoding matrixes.

In some embodiments, the terminal device comprise circuitry configured to perform: transmitting, to the network device, capability information indicating a type of precoding matrix supported by the terminal device, wherein the type of precoding matrix comprises at least one of a full-coherent precoding matrix type, a partial-coherent precoding matrix type, or a non-coherent precoding matrix type.

In some embodiments, the terminal device comprise circuitry configured to perform: receiving, from the network device, an indication of a type of the precoding matrix, wherein the type of precoding matrix comprises at least one of: a full-coherent precoding matrix type, a full-coherent and partial-coherent and non-coherent precoding matrix type, a partial-coherent precoding matrix type, a partial-coherent and a non-coherent precoding matrix type or a non-coherent precoding matrix type.

In some embodiments, the at least one configuration comprises none or at least one of: a first full coherent precoding matrix or a second full coherent precoding matrix, or wherein the at least one configuration comprises candidate values for at least one of a number of antenna ports in a first dimension, a number of antenna ports in a second dimension, a first discrete fourier transform (DFT) oversampling in the first dimension, or a second DFT oversampling in the second dimension.

In some embodiments, the at least one configuration indicates that if there is at least one antenna port group with 4 antenna ports, at least one column or at least one row of the precoding matrix is with 4 non-zero values on 4 of the 8 elements, wherein the indexes of the 4 elements are based on the indexes of the 4 antenna ports in one antenna port group, and zero values on other 4 of the 8 elements in the column or the row.

In some embodiments, the at least one configuration indicates that if there is at least one antenna port group with 2 antenna ports, at least one column or at least one row of the precoding matrix is with 2 non-zero values on 2 of the 8 elements, wherein the indexes of the 2 elements are based on the indexes of the 2 antenna ports in one antenna port group, and zero values on other 6 of the 8 elements in the column or the row.

In some embodiments, the at least one configuration indicates that if there is at least one antenna port group with 1 antenna port, at least one column or at least one row of the precoding matrix is with 1 non-zero value on 1 of the 8 elements, and the non-zero value is 1, wherein the index of the 1 element is based on the index of the antenna port in one antenna port group, and zero values on other 7 of the 8 elements in the column or the row.

In some embodiments, in accordance with a determination that the third number is no larger than the fourth number, a set of non-coherent precoding matrixes associated with the fourth number is available for the PUSCH, and each column or each row of the non-coherent precoding matrix is with 1 non-zero value on 1 of the 8 elements, and the non-zero value is 1, wherein the index of the 1 element is based on the index of the antenna port in one antenna port group, and zero values on other 7 of the 8 elements in the column or the row, and indexes of the 1 element in different columns or different rows are based on different antenna port groups; or in accordance with a determination that the third number is larger than the fourth number, a set of non-coherent precoding matrixes associated with the fourth number is not available for the PUSCH; or in accordance with a determination that the third number is not configured, the set of non-coherent precoding matrixes is not available for the PUSCH; or in accordance with a determination that the third number is at least one of: 1, 2, 3, 4, 5, 6, 7, 8, the set of non-coherent precoding matrixes comprises at least a precoding matrix with each column or each row of the precoding matrix is with 1 non-zero value on 1 of the 8 elements, and the non-zero value is 1, wherein the index of the 1 element is based on the index of column or row, and zero values on other 7 of the 8 elements in the column or the row; or in accordance with a determination that the third number is at least one of 1, 2, 3, 4, the set of non-coherent precoding matrixes comprises at least a precoding matrix with each column or each row of the precoding matrix is with 1 non-zero value on 1 of the first 4 elements, and the non-zero value is 1, wherein the index of the 1 element is based on the index of column or row, and zero values on other 7 elements in the column or the row.

In some embodiments, in accordance with a determination that the third number is same as the fourth number, the set of non-coherent precoding matrixes comprises at least a precoding matrix with each column or each row of the precoding matrix is with 1 non-zero value on 1 of the 8 elements, and the non-zero value is 1, wherein the index of the 1 element in each column or row is based on the index of each antenna port of the third number of antenna ports, and zero values on other 7 of the 8 elements in the column or the row; or in accordance with a determination that the third number is larger than the fourth number, the set of non-coherent precoding matrixes comprises at least a precoding matrix with each column or each row of the precoding matrix is with 1 non-zero value on 1 of the 8 elements, and the non-zero value is 1, wherein the index of the 1 element in each column or row is based on the index of one antenna port, and the antenna port is one of the fourth number out of the third number of antenna ports, and zero values on other 7 of the 8 elements in the column or the row; or in accordance with a determination that the third number is smaller than the fourth number, non-coherent precoding matrix associated with the fourth number is not available for the PUSCH.

In some embodiments, the at least one configuration comprises an order of 8 antenna ports, and the set of non-coherent precoding matrixes associated with the fourth number comprises at least a precoding matrix with each column or each row of the precoding matrix is with 1 non-zero value on 1 of the 8 elements, and the non-zero value is 1, wherein the index of the 1 element in each column or row is based on the index of one antenna port, and the antenna port is one of first fourth number of antenna ports out of the order of 8 antenna ports, and zero values on other 7 of the 8 elements in the column or the row.

In some embodiments, the at least one configuration indicates precoding matrixes with that a first set of antenna port elements in a 4-antenna port group is mapped with non-zero values.

In some embodiments, in accordance with a determination that the number of antenna port elements in the first set of antenna port element is smaller than the third number, the at least one configuration indicates precoding matrixes with that a second set of antenna port elements in a 2-antenna port group is mapped with non-zero values.

In some embodiments, in accordance with a determination that the number of antenna port elements in the first and second sets of antenna port elements is smaller than the third number, the at least one configuration indicates precoding matrixes with that a third set of antenna port elements which is not in the 4-antenna port group or 2-antenna port group is mapped with non-zero values.

In some embodiments, the at least one configuration indicates precoding matrixes with that the first third number of antenna ports elements are used for mapping non-zero values in the third number of columns in the precoding matrix.

In some embodiments, the terminal device comprises circuitry configured to perform: receiving, from the network device, information indicating that the PUSCH is scheduled associated with 8 antenna ports or associated with an SRS with 8 antenna ports, and wherein the DCI indicates the fourth number of layers which is not smaller than a minimum number of layers and the minimum number of layers is one of 4, 5, 6, 7, or 8, wherein the minimum number of layers is predetermined or configured via higher layer.

In some embodiments, the terminal device comprises circuitry configured to perform: receiving, from the network device, information indicating that the fourth number of layers is one of 1, 2, 3, 4, and wherein the PUSCH is scheduled associated with 1 or 2 or 4 antenna ports or associated with an SRS with 1 or 2 or 4 antenna ports.

In some embodiments, the terminal device comprises circuitry configured to perform: receiving, from the network device, a configuration of a set of SRS resources, a first subset of SRS resources in the set of SRS resources is configured with 8 SRS ports, and a second subset of SRS resources in the set of SRS resources is configured with a number of SRS ports which is not larger than 4.

In some embodiments, the terminal device comprises circuitry configured to perform: receiving, from the network device, information indicating that the PUSCH is scheduled associated with 8 antenna ports or associated with an SRS with 8 antenna ports, and the terminal device comprises circuitry configured to perform: applying at least one of a subset of precoding matrixes or a subset of number of layers, before the reception of the at least one configuration.

In some embodiments, the DCI indicates the fourth number of layers in a separate field or combined in an antenna port field, and the DCI indicates a precoding matrix based on the fourth number of layers.

In some embodiments, the terminal device comprises circuitry configured to perform: receiving, from the network device, information indicating that the PUSCH is scheduled associated with 8 antenna ports or associated with an SRS with 8 antenna ports, and the DCI comprises at least one of the followings for the number of layers larger than 5: a modulation and coding scheme (MCS), a new data indicator (NDI), or a redundancy version (RV).

In some embodiments, a network device comprises circuitry configured to perform: transmitting, at a network device and to a terminal device, at least one configuration associated with precoding matrixes; transmitting, to the terminal device, downlink control information (DCI) for scheduling a physical uplink shared channel (PUSCH), the DCI comprising an indication of a precoding matrix index; and receiving the PUSCH based on the precoding matrix.

In some embodiments, the at least one configuration comprises at least one of one or more configurations of antenna port groups, at least one antenna port group, one or more configurations of antenna pattern, one or more configurations of precoding matrix type, one or more configurations of precoding matrix subsets, the number of antenna port groups, or the number of antenna ports in an antenna port group.

In some embodiments, a total number of antenna ports for the PUSCH transmission or a total number of antenna ports of a sounding reference signal (SRS) associated with the PUSCH transmission is 8.

In some embodiments, the DCI indicates a fourth number of layers, and the precoding matrix is at least one of: a matrix with size 8 multiplies the fourth number; a matrix with size the fourth number multiplies 8; a matrix with the fourth number of columns, and each column with 8 elements; and a matrix with the fourth number of rows, and each row with 8 elements.

In some embodiments, the at least one configuration comprises a first number of antenna groups, each of the antenna groups comprises 4 antenna ports, and the first number is a first integer which is not larger than 2, or wherein the at least one configuration comprises a second number of antenna groups, each of the antenna groups comprises 2 antenna ports, and the second number is a second integer which is not larger than 4, or wherein the at least one configuration comprises a third number of antenna groups, each of is the antenna groups comprises 1 antenna port, and the third number is a third integer which is not larger than 8, or the at least one configuration comprises at least one of: a subset of full-coherent precoding matrixes, a subset of partial-coherent precoding matrixes, or a subset of non-coherent precoding matrixes.

In some embodiments, the network device comprises circuitry configured to perform: receiving, from the terminal device, capability information indicating a type of precoding matrix supported by the terminal device, wherein the type of precoding matrix comprises at least one of: a full-coherent precoding matrix type, a partial-coherent precoding matrix type, or a non-coherent precoding matrix type.

In some embodiments, the network device comprises circuitry configured to perform: transmitting, to the terminal device, an indication of a type of the precoding matrix, wherein the type of precoding matrix comprises at least one of: a full-coherent precoding matrix type, a full-coherent and partial-coherent and non-coherent precoding matrix type, a partial-coherent precoding matrix type, a partial-coherent and a non-coherent precoding matrix type or a non-coherent precoding matrix type.

In some embodiments, the at least one configuration comprises none or at least one of a first full coherent precoding matrix or a second full coherent precoding matrix, or the at least one configuration comprises candidate values for at least one of: a number of antenna ports in a first dimension, a number of antenna ports in a second dimension, a first discrete fourier transform (DFT) oversampling in the first dimension, or a second DFT oversampling in the second dimension.

In some embodiments, the at least one configuration indicates that if there is at least one antenna port group with 4 antenna ports, at least one column or at least one row of the precoding matrix is with 4 non-zero values on 4 of the 8 elements, wherein the indexes of the 4 elements are based on the indexes of the 4 antenna ports in one antenna port group, and zero values on other 4 of the 8 elements in the column or the row.

In some embodiments, the at least one configuration indicates that if there is at least one antenna port group with 2 antenna ports, at least one column or at least one row of the precoding matrix is with 2 non-zero values on 2 of the 8 elements, wherein the indexes of the 2 elements are based on the indexes of the 2 antenna ports in one antenna port group, and zero values on other 6 of the 8 elements in the column or the row.

In some embodiments, the at least one configuration indicates that if there is at least one antenna port group with 1 antenna port, at least one column or at least one row of the precoding matrix is with 1 non-zero value on 1 of the 8 elements, and the non-zero value is 1, wherein the index of the 1 element is based on the index of the antenna port in one antenna port group, and zero values on other 7 of the 8 elements in the column or the row.

In some embodiments, in accordance with a determination that the third number is no larger than the fourth number, a set of non-coherent precoding matrixes associated with the fourth number is available for the PUSCH, and each column or each row of the non-coherent precoding matrix is with 1 non-zero value on 1 of the 8 elements, and the non-zero value is 1, wherein the index of the 1 element is based on the index of the antenna port in one antenna port group, and zero values on other 7 of the 8 elements in the column or the row, and indexes of the 1 element in different columns or different rows are based on different antenna port groups; or in accordance with a determination that the third number is larger than the fourth number, a set of non-coherent precoding matrixes associated with the fourth number is not available for the PUSCH; or in accordance with a determination that the third number is not configured, the set of non-coherent precoding matrixes is not available for the PUSCH; or in accordance with a determination that the third number is at least one of: 1, 2, 3, 4, 5, 6, 7, 8, the set of non-coherent precoding matrixes comprises at least a precoding matrix with each column or each row of the precoding matrix is with 1 non-zero value on 1 of the 8 elements, and the non-zero value is 1, wherein the index of the 1 element is based on the index of column or row, and zero values on other 7 of the 8 elements in the column or the row; or in accordance with a determination that the third number is at least one of: 1, 2, 3, 4, the set of non-coherent precoding matrixes comprises at least a precoding matrix with each column or each row of the precoding matrix is with 1 non-zero value on 1 of the first 4 elements, and the non-zero value is 1, wherein the index of the 1 element is based on the index of column or row, and zero values on other 7 elements in the column or the row.

In some embodiments, in accordance with a determination that the third number is same as the fourth number, the set of non-coherent precoding matrixes comprises at least a precoding matrix with each column or each row of the precoding matrix is with 1 non-zero value on 1 of the 8 elements, and the non-zero value is 1, wherein the index of the 1 element in each column or row is based on the index of each antenna port of the third is number of antenna ports, and zero values on other 7 of the 8 elements in the column or the row; or in accordance with a determination that the third number is larger than the fourth number, the set of non-coherent precoding matrixes comprises at least a precoding matrix with each column or each row of the precoding matrix is with 1 non-zero value on 1 of the 8 elements, and the non-zero value is 1, wherein the index of the 1 element in each column or row is based on the index of one antenna port, and the antenna port is one of the fourth number out of the third number of antenna ports, and zero values on other 7 of the 8 elements in the column or the row; or in accordance with a determination that the third number is smaller than the fourth number, non-coherent precoding matrix associated with the fourth number is not available for the PUSCH.

In some embodiments, the at least one configuration comprises an order of 8 antenna ports, and the set of non-coherent precoding matrixes associated with the fourth number comprises at least a precoding matrix with each column or each row of the precoding matrix is with 1 non-zero value on 1 of the 8 elements, and the non-zero value is 1, wherein the index of the 1 element in each column or row is based on the index of one antenna port, and the antenna port is one of first fourth number of antenna ports out of the order of 8 antenna ports, and zero values on other 7 of the 8 elements in the column or the row.

In some embodiments, the at least one configuration indicates precoding matrixes with that a first set of antenna port elements in a 4-antenna port group is mapped with non-zero values.

In some embodiments, in accordance with a determination that the number of antenna port elements in the first set of antenna port element is smaller than the third number, the at least one configuration indicates precoding matrixes with that a second set of antenna port elements in a 2-antenna port group is mapped with non-zero values.

In some embodiments, in accordance with a determination that the number of antenna port elements in the first and second sets of antenna port elements is smaller than the third number, the at least one configuration indicates precoding matrixes with that a third set of antenna port elements which is not in the 4-antenna port group or 2-antenna port group is mapped with non-zero values.

In some embodiments, the at least one configuration indicates precoding matrixes with that the first third number of antenna ports elements are used for mapping non-zero values in the third number of columns in the precoding matrix.

In some embodiments, the network device comprises circuitry configured to perform: transmitting, to the terminal device, information indicating that the PUSCH is scheduled associated with 8 antenna ports or associated with an SRS with 8 antenna ports, and the DCI indicates the fourth number of layers which is not smaller than a minimum number of layers and the minimum number of layers is one of 4, 5, 6, 7, or 8, wherein the minimum number of layers is predetermined or configured via higher layer.

In some embodiments, the network device comprises circuitry configured to perform: transmitting, to the terminal device, information indicating that the fourth number of layers is one of 1, 2, 3, 4, and the PUSCH is scheduled associated with 1 or 2 or 4 antenna ports or associated with an SRS with 1 or 2 or 4 antenna ports.

In some embodiments, the network device comprises circuitry configured to perform: transmitting, to the terminal device, a configuration of a set of SRS resources, a first subset of SRS resources in the set of SRS resources is configured with 8 SRS ports, and a second subset of SRS resources in the set of SRS resources is configured with a number of SRS ports which is not larger than 4.

In some embodiments, the network device comprises circuitry configured to perform: transmitting, to the terminal device, information indicating that the PUSCH is scheduled associated with 8 antenna ports or associated with an SRS with 8 antenna ports.

In some embodiments, the DCI indicates the fourth number of layers in a separate field or combined in an antenna port field, and the DCI indicates a precoding matrix based on the fourth number of layers.

In some embodiments, the network device comprises circuitry configured to perform: transmitting, to the terminal device, information indicating that the PUSCH is scheduled associated with 8 antenna ports or associated with an SRS with 8 antenna ports, and the DCI comprises at least one of the followings for the number of layers larger than 5: a modulation and coding scheme (MCS), a new data indicator (NDI), or a redundancy version (RV).

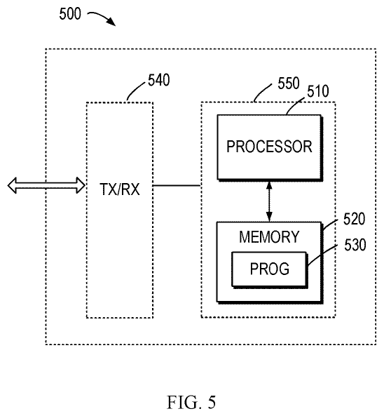

FIG. 5 is a simplified block diagram of a device 500 that is suitable for implementing embodiments of the present disclosure. The device 500 can be considered as a further example implementation of the terminal device or the network device as shown in FIG. 1. Accordingly, the device 500 can be implemented at or as at least a part of the terminal device or the network device.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the device 500 to operate in accordance with the embodiments of the present disclosure, as discussed herein with reference to FIG. 2 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz(THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

I/We claim:

1. A communication method, comprising:
receiving, at a terminal device and from a network device, at least one configuration associated with precoding matrixes;
receiving, from the network device, downlink control information (DCI) for scheduling a physical uplink shared channel (PUSCH), the DCI comprising an indication of a precoding matrix index;
determining a precoding matrix based on the at least one configuration and the indication; and
transmitting the PUSCH based on the precoding matrix.

2. The method of claim 1, wherein the at least one configuration comprises at least one of:
one or more configurations of antenna port groups,
at least one antenna port group,
one or more configurations of antenna pattern,
one or more configurations of precoding matrix type,
one or more configurations of precoding matrix subsets,
the number of antenna port groups, or
the number of antenna ports in an antenna port group.

3. The method of claim 1, wherein a total number of antenna ports for the PUSCH transmission or a total number of antenna ports of a sounding reference signal (SRS) associated with the PUSCH transmission is 8.

4. The method of claim 1, further comprising:
determining the precoding matrix based on a fourth number of layers, and the fourth number is indicated in the DCI, wherein the precoding matrix is at least one of:
a matrix with size 8 multiplies the fourth number;
a matrix with size the fourth number multiplies 8;
a matrix with the fourth number of columns, and each column with 8 elements; and
a matrix with the fourth number of rows, and each row with 8 elements.

5. The method of claim 1, wherein the at least one configuration comprises a first number of antenna groups, each of the antenna groups comprises 4 antenna ports, and the first number is a first integer which is not larger than 2, or
wherein the at least one configuration comprises a second number of antenna groups, each of the antenna groups comprises 2 antenna ports, and the second number is a second integer which is not larger than 4, or
wherein the at least one configuration comprises a third number of antenna groups, each of the antenna groups comprises 1 antenna port, and the third number is a third integer which is not larger than 8, or
wherein the at least one configuration comprises at least one of: a subset of full-coherent precoding matrixes, a subset of partial-coherent precoding matrixes, or a subset of non-coherent precoding matrixes.

6. The method of claim 1, further comprising:
transmitting, to the network device, capability information indicating a type of precoding matrix supported by the terminal device, wherein the type of precoding matrix comprises at least one of: a full-coherent precoding matrix type, a partial-coherent precoding matrix type, or a non-coherent precoding matrix type.

7. The method of claim 1, further comprising:
receiving, from the network device, an indication of a type of the precoding matrix, wherein the type of precoding matrix comprises at least one of: a full-coherent precoding matrix type, a full-coherent and partial-coherent and non-coherent precoding matrix type, a partial-coherent precoding matrix type, a partial-coherent and a non-coherent precoding matrix type or a non-coherent precoding matrix type.

8. The method of claim 1, wherein the at least one configuration comprises none or at least one of: a first full coherent precoding matrix or a second full coherent precoding matrix, or
wherein the at least one configuration comprises candidate values for at least one of:
a number of antenna ports in a first dimension,
a number of antenna ports in a second dimension,
a first discrete fourier transform (DFT) oversampling in the first dimension, or
a second DFT oversampling in the second dimension.

9. The method of claim 1, wherein the at least one configuration indicates that if there is at least one antenna port group with 4 antenna ports, at least one column or at least one row of the precoding matrix is with 4 non-zero values on 4 of the 8 elements, wherein the indexes of the 4 elements are based on the indexes of the 4 antenna ports in one antenna port group, and zero values on other 4 of the 8 elements in the column or the row.

10. The method of claim 1, wherein the at least one configuration indicates that if there is at least one antenna port group with 2 antenna ports, at least one column or at least one row of the precoding matrix is with 2 non-zero values on 2 of the 8 elements, wherein the indexes of the 2 elements are based on the indexes of the 2 antenna ports in one antenna port group, and zero values on other 6 of the 8 elements in the column or the row.

11. The method of claim 1, wherein the at least one configuration indicates that if there is at least one antenna port group with 1 antenna port, at least one column or at least one row of the precoding matrix is with 1 non-zero value on 1 of the 8 elements, and the non-zero value is 1, wherein the index of the 1 element is based on the index of the antenna port in one antenna port group, and zero values on other 7 of the 8 elements in the column or the row.

12. The method of claim 1, wherein:
in accordance with a determination that the third number is no larger than the fourth number, a set of non-coherent precoding matrixes associated with the fourth number is available for the PUSCH, and each column or each row of the non-coherent precoding matrix is with 1 non-zero value on 1 of the 8 elements, and the non-zero value is 1, wherein the index of the 1 element is based on the index of the antenna port in one antenna port group, and zero values on other 7 of the 8 elements in the column or the row, and indexes of the 1 element in different columns or different rows are based on different antenna port groups; or
in accordance with a determination that the third number is larger than the fourth number, a set of non-coherent precoding matrixes associated with the fourth number is not available for the PUSCH; or
in accordance with a determination that the third number is not configured, the set of non-coherent precoding matrixes is not available for the PUSCH; or
in accordance with a determination that the third number is at least one of: 1, 2, 3, 4, 5, 6, 7, 8, the set of non-coherent precoding matrixes comprises at least a precoding matrix with each column or each row of the precoding matrix is with 1 non-zero value on 1 of the 8 elements, and the non-zero value is 1, wherein the index of the 1 element is based on the index of column or row, and zero values on other 7 of the 8 elements in the column or the row; or
in accordance with a determination that the third number is at least one of: 1, 2, 3, 4, the set of non-coherent precoding matrixes comprises at least a precoding matrix with each column or each row of the precoding matrix is with 1 non-zero value on 1 of the first 4 elements, and the non-zero value is 1, wherein the index of the 1 element is based on the index of column or row, and zero values on other 7 elements in the column or the row.

13. The method of claim 1, wherein:
in accordance with a determination that the third number is same as the fourth number, the set of non-coherent precoding matrixes comprises at least a precoding matrix with each column or each row of the precoding matrix is with 1 non-zero value on 1 of the 8 elements, and the non-zero value is 1, wherein the index of the 1 element in each column or row is based on the index of each antenna port of the third number of antenna ports, and zero values on other 7 of the 8 elements in the column or the row; or
in accordance with a determination that the third number is larger than the fourth number, the set of non-coherent precoding matrixes comprises at least a precoding matrix with each column or each row of the precoding matrix is with 1 non-zero value on 1 of the 8 elements, and the non-zero value is 1, wherein the index of the 1 element in each column or row is based on the index of one antenna port, and the antenna port is one of the fourth number out of the third number of antenna ports, and zero values on other 7 of the 8 elements in the column or the row; or
in accordance with a determination that the third number is smaller than the fourth number, non-coherent precoding matrix associated with the fourth number is not available for the PUSCH.

14. The method of claim 1, wherein the at least one configuration comprises an order of 8 antenna ports, and the set of non-coherent precoding matrixes associated with the fourth number comprises at least a precoding matrix with each column or each row of the precoding matrix is with 1 non-zero value on 1 of the 8 elements, and the non-zero value is 1, wherein the index of the 1 element in each column or row is based on the index of one antenna port, and the antenna port is one of first fourth number of antenna ports out of the order of 8 antenna ports, and zero values on other 7 of the 8 elements in the column or the row.

15. The method of claim 1, wherein the at least one configuration indicates precoding matrixes with that a first set of antenna port elements in a 4-antenna port group is mapped with non-zero values.

16. The method of claim 15, wherein in accordance with a determination that the number of antenna port elements in the first set of antenna port element is smaller than the third number, the at least one configuration indicates precoding matrixes with that a second set of antenna port elements in a 2-antenna port group is mapped with non-zero values.

17. The method of claim 15, wherein in accordance with a determination that the number of antenna port elements in the first and second sets of antenna port elements is smaller than the third number, the at least one configuration indicates precoding matrixes with that a third set of antenna port elements which is not in the 4-antenna port group or 2-antenna port group is mapped with non-zero values.

18. The method of claim 1, wherein the at least one configuration indicates precoding matrixes with that the first third number of antenna ports elements are used for mapping non-zero values in the third number of columns in the precoding matrix.

19. The method of claim 1, further comprising:
receiving, from the network device, information indicating that the PUSCH is scheduled associated with 8 antenna ports or associated with an SRS with 8 antenna ports, and
wherein the DCI indicates the fourth number of layers which is not smaller than a minimum number of layers and the minimum number of layers is one of 4, 5, 6, 7, or 8, wherein the minimum number of layers is predetermined or configured via higher layer.

20. The method of claim 1, further comprising:
receiving, from the network device, information indicating that the fourth number of layers is one of 1, 2, 3, 4, and
wherein the PUSCH is scheduled associated with 1 or 2 or 4 antenna ports or associated with an SRS with 1 or 2 or 4 antenna ports.

21. The method of claim 1, further comprising:
receiving, from the network device, a configuration of a set of SRS resources, a first subset of SRS resources in the set of SRS resources is configured with 8 SRS ports, and a second subset of SRS resources in the set of SRS resources is configured with a number of SRS ports which is not larger than 4.

22. The method of claim 1, further comprising:
receiving, from the network device, information indicating that the PUSCH is scheduled associated with 8 antenna ports or associated with an SRS with 8 antenna ports, and the method further comprises:
applying at least one of: a subset of precoding matrixes or a subset of number of layers, before the reception of the at least one configuration.

23. The method of claim 1, wherein the DCI indicates the fourth number of layers in a separate field or combined in an antenna port field, and the DCI indicates a precoding matrix based on the fourth number of layers.

24. The method of claim 1, further comprising:
receiving, from the network device, information indicating that the PUSCH is scheduled associated with 8 antenna ports or associated with an SRS with 8 antenna ports, and the DCI comprises at least one of the followings for the number of layers larger than 5:
a modulation and coding scheme (MCS),
a new data indicator (NDI), or
a redundancy version (RV).

25. A communication method, comprising:
transmitting, at a network device and to a terminal device, at least one configuration associated with precoding matrixes;
transmitting, to the terminal device, downlink control information (DCI) for scheduling a physical uplink shared channel (PUSCH), the DCI comprising an indication of a precoding matrix index; and
receiving the PUSCH based on the precoding matrix.

26. The method of claim 25, wherein the at least one configuration comprises at least one of:
one or more configurations of antenna port groups,
at least one antenna port group,
one or more configurations of antenna pattern,
one or more configurations of precoding matrix type,
one or more configurations of precoding matrix subsets,
the number of antenna port groups, or
the number of antenna ports in an antenna port group.

27. The method of claim 25, wherein a total number of antenna ports for the PUSCH transmission or a total number of antenna ports of a sounding reference signal (SRS) associated with the PUSCH transmission is 8.

28. The method of claim 25, wherein the DCI indicates a fourth number of layers, and the precoding matrix is at least one of:
a matrix with size 8 multiplies the fourth number;
a matrix with size the fourth number multiplies 8;
a matrix with the fourth number of columns, and each column with 8 elements; and
a matrix with the fourth number of rows, and each row with 8 elements.

29. The method of claim 25, wherein the at least one configuration comprises a first number of antenna groups, each of the antenna groups comprises 4 antenna ports, and the first number is a first integer which is not larger than 2, or
wherein the at least one configuration comprises a second number of antenna groups, each of the antenna groups comprises 2 antenna ports, and the second number is a second integer which is not larger than 4, or
wherein the at least one configuration comprises a third number of antenna groups, each of the antenna groups comprises 1 antenna port, and the third number is a third integer which is not larger than 8, or
wherein the at least one configuration comprises at least one of: a subset of full-coherent precoding matrixes, a subset of partial-coherent precoding matrixes, or a subset of non-coherent precoding matrixes.

30. The method of claim 25, further comprising:
receiving, from the terminal device, capability information indicating a type of precoding matrix supported by the terminal device, wherein the type of precoding matrix comprises at least one of: a full-coherent precoding matrix type, a partial-coherent precoding matrix type, or a non-coherent precoding matrix type.

31. The method of claim 25, further comprising:
transmitting, to the terminal device, an indication of a type of the precoding matrix, wherein the type of precoding matrix comprises at least one of: a full-coherent precoding matrix type, a full-coherent and partial-coherent and non-coherent precoding matrix type, a partial-coherent precoding matrix type, a partial-coherent and a non-coherent precoding matrix type or a non-coherent precoding matrix type.

32. The method of claim 25, wherein the at least one configuration comprises none or at least one of a first full coherent precoding matrix or a second full coherent precoding matrix, or
wherein the at least one configuration comprises candidate values for at least one of:
a number of antenna ports in a first dimension,
a number of antenna ports in a second dimension,
a first discrete fourier transform (DFT) oversampling in the first dimension, or
a second DFT oversampling in the second dimension.

33. The method of claim 25, wherein the at least one configuration indicates that if there is at least one antenna port group with 4 antenna ports, at least one column or at least one row of the precoding matrix is with 4 non-zero values on 4 of the 8 elements, wherein the indexes of the 4 elements are based on the indexes of the 4 antenna ports in one antenna port group, and zero values on other 4 of the 8 elements in the column or the row.

34. The method of claim 25, wherein the at least one configuration indicates that if there is at least one antenna port group with 2 antenna ports, at least one column or at least one row of the precoding matrix is with 2 non-zero values on 2 of the 8 elements, wherein the indexes of the 2 elements are based on the indexes of the 2 antenna ports in one antenna port group, and zero values on other 6 of the 8 elements in the column or the row.

35. The method of claim 25, wherein the at least one configuration indicates that if there is at least one antenna port group with 1 antenna port, at least one column or at least one row of the precoding matrix is with 1 non-zero value on 1 of the 8 elements, and the non-zero value is 1, wherein the index of the 1 element is based on the index of the antenna port in one antenna port group, and zero values on other 7 of the 8 elements in the column or the row.

36. The method of claim 25, wherein:
in accordance with a determination that the third number is no larger than the fourth number, a set of non-coherent precoding matrixes associated with the fourth number is available for the PUSCH, and each column or each row of the non-coherent precoding matrix is with 1 non-zero value on 1 of the 8 elements, and the non-zero value is 1, wherein the index of the 1 element is based on the index of the antenna port in one antenna port group, and zero values on other 7 of the 8 elements in the column or the row, and indexes of the 1 element in different columns or different rows are based on different antenna port groups; or
in accordance with a determination that the third number is larger than the fourth number, a set of non-coherent precoding matrixes associated with the fourth number is not available for the PUSCH; or
in accordance with a determination that the third number is not configured, the set of non-coherent precoding matrixes is not available for the PUSCH; or
in accordance with a determination that the third number is at least one of: 1, 2, 3, 4, 5, 6, 7, 8, the set of non-coherent precoding matrixes comprises at least a precoding matrix with each column or each row of the precoding matrix is with 1 non-zero value on 1 of the 8 elements, and the non-zero value is 1, wherein the index of the 1 element is based on the index of column or row, and zero values on other 7 of the 8 elements in the column or the row; or
in accordance with a determination that the third number is at least one of: 1, 2, 3, 4, the set of non-coherent precoding matrixes comprises at least a precoding matrix with each column or each row of the precoding matrix is with 1 non-zero value on 1 of the first 4 elements, and the non-zero value is 1, wherein the index of the 1 element is based on the index of column or row, and zero values on other 7 elements in the column or the row.

37. The method of claim 25, wherein:
in accordance with a determination that the third number is same as the fourth number, the set of non-coherent precoding matrixes comprises at least a precoding matrix with each column or each row of the precoding matrix is with 1 non-zero value on 1 of the 8 elements, and the non-zero value is 1, wherein the index of the 1 element in each column or row is based on the index of each antenna port of the third number of antenna ports, and zero values on other 7 of the 8 elements in the column or the row; or
in accordance with a determination that the third number is larger than the fourth number, the set of non-coherent precoding matrixes comprises at least a precoding matrix with each column or each row of the precoding matrix is with 1 non-zero value on 1 of the 8 elements, and the non-zero value is 1, wherein the index of the 1 element in each column or row is based on the index of one antenna port, and the antenna port is one of the fourth number out of the third number of antenna ports, and zero values on other 7 of the 8 elements in the column or the row; or
in accordance with a determination that the third number is smaller than the fourth number, non-coherent precoding matrix associated with the fourth number is not available for the PUSCH.

38. The method of claim 25, wherein the at least one configuration comprises an order of 8 antenna ports, and the set of non-coherent precoding matrixes associated with the fourth number comprises at least a precoding matrix with each column or each row of the precoding matrix is with 1 non-zero value on 1 of the 8 elements, and the non-zero value is 1, wherein the index of the 1 element in each column or row is based on the index of one antenna port, and the antenna port is one of first fourth number of antenna ports out of the order of 8 antenna ports, and zero values on other 7 of the 8 elements in the column or the row.

39. The method of claim 25, wherein the at least one configuration indicates precoding matrixes with that a first set of antenna port elements in a 4-antenna port group is mapped with non-zero values.

40. The method of claim 39, wherein in accordance with a determination that the number of antenna port elements in the first set of antenna port element is smaller than the third number, the at least one configuration indicates precoding matrixes with that a second set of antenna port elements in a 2-antenna port group is mapped with non-zero values.

41. The method of claim 39, wherein in accordance with a determination that the number of antenna port elements in the first and second sets of antenna port elements is smaller than the third number, the at least one configuration indicates precoding matrixes with that a third set of antenna port elements which is not in the 4-antenna port group or 2-antenna port group is mapped with non-zero values.

42. The method of claim 25, wherein the at least one configuration indicates precoding matrixes with that the first third number of antenna ports elements are used for mapping non-zero values in the third number of columns in the precoding matrix.

43. The method of claim 25, further comprising:
transmitting, to the terminal device, information indicating that the PUSCH is scheduled associated with 8 antenna ports or associated with an SRS with 8 antenna ports, and
wherein the DCI indicates the fourth number of layers which is not smaller than a minimum number of layers and the minimum number of layers is one of 4, 5, 6, 7, or 8, wherein the minimum number of layers is predetermined or configured via higher layer.

44. The method of claim 25, further comprising:
transmitting, to the terminal device, information indicating that the fourth number of layers is one of 1, 2, 3, 4, and
wherein the PUSCH is scheduled associated with 1 or 2 or 4 antenna ports or associated with an SRS with 1 or 2 or 4 antenna ports.

45. The method of claim 25, further comprising:
transmitting, to the terminal device, a configuration of a set of SRS resources, a first subset of SRS resources in the set of SRS resources is configured with 8 SRS ports, and a second subset of SRS resources in the set of SRS resources is configured with a number of SRS ports which is not larger than 4.

46. The method of claim 25, further comprising:
transmitting, to the terminal device, information indicating that the PUSCH is scheduled associated with 8 antenna ports or associated with an SRS with 8 antenna ports.

47. The method of claim 25, wherein the DCI indicates the fourth number of layers in a separate field or combined in an antenna port field, and the DCI indicates a precoding matrix based on the fourth number of layers.

48. The method of claim 1, further comprising:
transmitting, to the terminal device, information indicating that the PUSCH is scheduled associated with 8 antenna ports or associated with an SRS with 8 antenna ports, and the DCI comprises at least one of the followings for the number of layers larger than 5:
a modulation and coding scheme (MCS),
a new data indicator (NDI), or
a redundancy version (RV).

49. A terminal device comprising:
a processor; and
a memory coupled to the processor and storing instructions thereon, the instructions, when executed by the processor, causing the terminal device to perform the method according to any of claims 1-24.

50. A network device comprising:
a processor; and
a memory coupled to the processor and storing instructions thereon, the instructions, when executed by the processor, causing the network device to perform the method according to any of claims 25-48.

51. A computer readable medium having instructions stored thereon, the instructions, when executed on at least one processor, causing the at least one processor to perform the method according to any of claims 1-24.

52. A computer readable medium having instructions stored thereon, the instructions, when executed on at least one processor, causing the at least one processor to perform the method according to any of claims 25-48.

53. A computer readable medium having instructions stored thereon, the instructions, when executed on at least one processor, causing the at least one processor to perform the method according to any of claims 1-24 or 25-48.
